(19) United States
(12) Patent Application Publication
(10) Pub. No.: US 2022/0259332 A1
(43) Pub. Date: Aug. 18, 2022

(54) PARTICLE-BASED METHOD FOR DEFINING A GUT MICROBIOTA IN HUMANS OR OTHER ANIMAL SPECIES

(71) Applicant: Washington University, St. Louis, MO (US)

(72) Inventors: JEFFREY I. GORDON, St. Louis, MO (US); DARRYL WESENER, St. Louis, MO (US); MICHAEL PATNODE, St Louis, MO (US)

(21) Appl. No.: 17/628,497

(22) PCT Filed: Jul. 17, 2020
(86) PCT No.: PCT/US20/42678

§ 371 Date: Jan. 19, 2022

Related U.S. Application Data
(60) Provisional application No. 62/876,379, filed on Jul. 19, 2019.

(51) Int. Cl. C08B 37/00; C08L 3/02; C08L 5/06

(52) U.S. Cl. CPC C08B 37/0003; C08B 37/0006; C08L 5/06; C08L 3/02; C08B 37/006

(57) ABSTRACT

The present disclosure provides retrievable artificial food particles comprising one or more compound of interest, and methods of using the artificial food particles. The methods disclosed herein can be used to characterize the composition and/or functional state of a subjects gut microbiota. Other aspects of the compositions and methods are described in further detail.

### CROSS REFERENCE TO RELATED APPLICATION

This application claims priority to U.S. Provisional Application No. 62/876,379, filed Jul. 19, 2019, the disclosures of which are incorporated herein by reference.

### GOVERNMENT SUPPORT

This invention was made with government support under DK070977, DK078669, and DK107158 awarded by the National Institutes of Health. The government has certain rights in the invention.

### BACKGROUND OF THE INVENTION

Increasing evidence that the gut microbiota impacts multiple features of human biology has catalyzed efforts to develop microbiota-directed interventions that improve health status. For similar reasons, there is also a heightened interest in how drugs and other over-the-counter remedies alter the gut microbial community and vice-versa. Better methods are needed, however, to understand how gut microbial community members dynamically interact with microbiota-directed interventions, drugs, and over-the-counter remedies.

### SUMMARY OF THE INVENTION

In an aspect, the present disclosure provides a composition comprising a plurality particles of one type or a plurality of particles of more than one type, each type comprising (a) a core comprising a tag, (b) a unique compound of interest or a combination of compounds of interest (“the particle-bound compound(s) of interest”) and (b) a unique label, wherein the particle-bound compound(s) of interest are stably attached to the core. Typically, the particle-bound compound(s) of interest remain substantially unaltered during transit through an intestinal tract of a subject that lacks a gut microbiota. In some embodiments, the tag for each particle type is a paramagnetic metal oxide and the core further comprises a coating, wherein the coating comprises an organosilane. A compound of interest may be a drug or a biomolecule.

In another aspect, the present disclosure provides a method for measuring a gut microbiota's functional activity, the method comprising: (a) orally administering to a subject a composition comprising a plurality of particles comprising (i) a core comprising a tag, (ii) a compound of interest or a combination of compounds of interest (“the particle-bound compound(s) of interest”), and (iii) an optional label, wherein the particle-bound compound(s) of interest are stably attached to the core; and wherein structural information and/or amount of the particle-bound compound(s) of interest is known (the “input data”); (b) recovering particles from biological material obtained from the subject; and (c) identifying structural changes to the recovered particle-bound compound(s) of interest and/or measuring the amount of the recovered particle-bound compound(s) of interest (the “recovered data”) and determining the difference between the recovered data and the input data.

In another aspect, the present disclosure provides a method for measuring a gut microbiota's functional activity, the method comprising: (a) orally administering to a subject a composition comprising a plurality of retrievable particles of more than one type, each type of retrievable particle comprising (i) a core comprising a tag, (ii) a compound of interest or a combination of compounds of interest (“the particle-bound compound(s) of interest”), and (iii) a unique label, wherein the particle-bound compound(s) of interest are stably attached to the core, and wherein structural information and/or amount of the particle-bound compound(s) of interest is known (the “input data”); (b) recovering particles from biological material obtained from the subject and then separating the recovered particles by type; and (c) for each type of particle, identifying structural changes to the recovered particle-bound compound(s) of interest and/or measuring the amount of the recovered particle-bound compound(s) of interest (the “recovered data”) and determining the difference between the recovered data and the input data.

In another aspect, the present disclosure encompasses methods to measure modification of a compound of interest in a subject, the methods comprising: (a) orally administering to a subject a composition comprising a plurality of retrievable particles, the retrievable particles comprising a core, a compound of interest or a combination of compounds of interest (“the particle-bound compound(s) of interest”), and an optional label, wherein the particle-bound compound(s) of interest are stably attached to the core, and wherein structural information and/or amount of the particle-bound compound(s) of interest is known (the “input data”), (b) recovering particles from biological material obtained from the subject, and (c) identifying structural changes to the recovered particle-bound compound(s) of interest and/or measuring the amount of the recovered particle-bound compound(s) of interest (the “recovered data”) and determining the difference between the recovered data and the input data.

In another aspect, the present disclosure encompasses methods to measure modification of a compound of interest in a subject, the methods comprising: (a) orally administering to a subject a composition comprising a plurality of retrievable particles of more than one type, each type of retrievable particle comprising a core, a unique compound of interest or a combination of compounds of interest (“the particle-bound compound(s) of interest”), and a unique label, wherein the particle-bound compound(s) of interest are stably attached to the core, and wherein structural information and/or amount of the particle-bound compound(s) of interest is known (the “input data”); (b) recovering particles from biological material obtained from the subject and then separating the recovered particles by type; and (c) for each type of particle, identifying structural changes to the recovered particle-bound compound(s) of interest and/or measuring the amount of the recovered particle-bound compound(s) of interest (the “recovered data”) and determining the difference between the recovered data and the input data.

In another aspect, the present disclosure encompasses methods to measure glycan degradation in a subject, the methods comprising (a) orally administering to a subject a composition comprising a plurality of retrievable particles of more than one type, each type of retrievable particle comprising a core, a unique glycan or a combination of glycans (“the particle-bound glycan(s)”), and a unique label, wherein the particle-bound glycan(s) are stably attached to the core, and wherein the amount of the particle-bound glycan(s) is known (the “input amount”); (b) recovering particles from biological material obtained from the subject and then separating the recovered particles by type; and (c) for each type of particle, measuring the amount of the recovered particle-bound glycan(s) (the “recovered amount”) and determining the difference between the recovered data and the input data.

Other aspects and iterations of the invention are described more thoroughly below.

### BRIEF DESCRIPTION OF THE FIGURES

The application file contains at least one photograph executed in color. Copies of this patent application publication with color photographs will be provided by the Office upon request and payment of the necessary fee.

FIG. 1A and FIG. 1B show the design and results of an in vivo screen of the effects of fiber preparations on members of a defined human gut microbiota. FIG. 1A includes a schematic design of the screen (one of three similar screens). Individually-housed adult germ-free mice were colonized with a consortium of 20 bacterial strains obtained from a single human donor. The 20 strains were B. thetaiotaomicron, B. cellulosilyticus, B. vulgatus 1, B. vulgatus 2, B. caccae, B. ovatus, B finegoldii, B. massiliensis, P. distasonis, E. coli, O. splanchnicus, D. longicatena, P. niger, S. variabile, R. sp., R. albus 1, R. albus 2, R. bromii, C. aerofaciens 1, and C. aerofaciens 2. Animals received a series of supplemented HiSF-LoFV diets, each containing one fiber preparation at 8% (w/w) and another at 2% (w/w) (colored boxes). Fecal samples were collected during the last two days of each week-long diet period. Control animals received the unsupplemented HiSF-LoFV or LoSF-HiFV diet monotonously for four weeks. Also shown are the average relative abundance values for B. thetaiotaomicron and B. caccae on days 6 and 7 of treatment with the indicated fiber-supplemented HiSF-LoFV diets. Bars show mean values. Circles denote individual mice. Black arrows point to data obtained from different mice consuming diets containing 8% (w/w) pea fiber consumed at the indicated periods of their diet oscillation sequence. Green arrowheads in panel B mark mice that received pea fiber as the minor fiber type (2% w/w) while purple arrowheads in panel C highlight animals where high molecular weight (MW) inulin was the minor fiber. See Table A for compositional analysis of the 34 fibers. FIG. 1B depicts estimates of coefficients from linear models for bacterial strains across the three screening experiments where models produced at least one estimated coefficient >0.4. Statistically significant coefficients (P<0.01; ANOVA) are shaded according to the color bar.

FIG. 2A, FIG. 2B, FIG. 2C, FIG. 2D, FIG. 2E, FIG. 2F, FIG. 2G, FIG. 2H, FIG. 2I and FIG. 2J show the results of proteomics and forward genetic experiments to identify arabinan in pea fiber as a nutrient source for multiple bacterial species. FIG. 2A is a schematic representation of polysaccharide structures detected in pea fiber based on monosaccharide and linkage analyses (with stereochemistry of anomeric carbon inferred). FIG. 2B-FIG. 2E are graphs showing relative abundance (y-axis) of the indicated bacterial strains. Adult C57BL/6J germ-free mice were colonized with a 15-member community consisting of INSeq libraries representing four Bacteroides species together with 10 additional bacterial strains used in screening experiments depicted in FIG. 1. Relative abundance is shown for each bacterial strain at each of the indicated time points in mice monotonously fed the control HiSF-LoFV diet (grey), or the HiSF-LoFV diet supplemented with 10% (w/w) pea fiber (green). Circles denote individual mice. Shading denotes the 95% CI. The position of the line within the data points for a given time point represents the mean value (n=15 individually-caged mice per group; Tables S4A-S4C). *, P<0.05; (pea fiber supplemented versus unsupplemented HiSF-LoFV diet; ANOVA). FIG. 2F-FIG. 2I are graphs showing Proteomic and INSeq analyses of fecal samples collected on experimental day 6. On the x-axis, the position of each dot denotes the mean value for the abundance of a single bacterial protein in samples obtained from animals monotonously fed the pea fiber-supplemented HiSF-LoFV diet (relative to controls fed the unsupplemented diet). The y-axis indicates the mean value for the differential enrichment of mutant strains with Tn disruptions in the gene encoding each protein in the pea fiber versus HiSF-LoFV diet groups. The total number of genes represented in both the protein dataset and INSeq mutant pool is shown in the upper left of each plot, and these genes are plotted as grey dots. Green circles highlight genes that are significantly affected by pea fiber (P<0.05, |fold change|>log 2(1.2); limma or limma-voom) as judged by levels of their protein products or their contribution to fitness; open circles mark the subset of these genes that are encoded by PULs. Genes that are present in three homologous arabinan-processing PULs in B. thetaiotaomicron, B. cellulosilyticus, and B. vulgatus are labeled with their PUL number as it appears in PULDB (Terrapon et al., 2018). Genes in an arabinose-processing operon in B. vulgatus are labeled with an CA. Genes in the B. ovatus RGI-processing PUL97 are also labeled. (J) Alignment of B. thetaiotaomicron PUL7, B. cellulosilyticus PUL5, B. vulgatus PUL27, and the B. vulgatus arabinose operon. The direction of transcription is left to right (unless marked by a leftward pointing arrowhead). The first and last genes are labeled above with their locus tag number. Genes are color-coded according to their functional annotation (see key). GH families for enzymes in the CAZy database are shown as numbers inside the gene boxes (characterized members of GH51, GH43:4, GH43:29, and GH146 are predominantly arabinanases or arabinofuranosidases). Shaded regions connecting genes denote significant BLAST homology (E-value <10⁻⁹); the percent amino acid identity of their protein products is shown.

FIG. 3A, FIG. 3B, FIG. 3C, and FIG. 3D show results from experiments that deliberately manipulate a community composition to demonstrate interspecies competition for pea fiber arabinan. FIG. 3A and FIG. 3C are graphs showing relative abundance of the indicated bacterial strains. Adult C57BL/6J germ-free mice were colonized with the same defined community that was used for the experiments in FIG. 2, with or without B. cellulosilyticus (B.c.). Relative abundance of each bacterial strain is shown at each time point in mice fed the control HiSF-LoFV diet in the presence (light grey, closed circles), or absence (dark grey, open circles) of B. cellulosilyticus, or fed the HiSF-LoFV diet supplemented with 10% (w/w) pea fiber in the presence (green, closed circles) or absence (magenta, open circles) of B. cellulosilyticus. Key: circles, individual mice; lines, mean values; shading, 95% Cl (n=4-10 mice per group). *, P<0.05; (diet-by-community interaction; ANOVA). FIG. 3B and FIG. 3D are plots showing mean values±SD (vertical shading) (n=5 animals/treatment group) from proteomics analysis of fecal communities sampled on experimental days 6, 12, 19, and 25. Genes in PULs of interest are shown along the x-axis (as locus tag number only; BT)_XXXX or BVU_XXXX). Genes are color-coded according to their functional annotation (see key). GH families for enzymes in the CAZy database are shown as numbers inside the gene boxes. Key for circles is identical to that used in panels A and C. *, P<0.05, |fold change|>log 2(1.2) (pea fiber supplemented versus unsupplemented HiSF-LoFV diet; limma).

FIG. 4A, FIG. 4B, FIG. 4C, FIG. 4D, and FIG. 4E show results from experiments to characterize glycan processing as a function of community membership with artificial food particles. FIG. 4A is a schematic depiction of a bead-based in vivo glycan degradation assay. FIG. 4B depicts flow cytometry plots showing levels of fluorescence in a pool of three bead types before and after transit though the guts of mice representing two colonization conditions. Axes are labeled with the fluorophore detected in each channel. FIG. 4C graphically depicts the mass of arabinose associated with two types of polysaccharide-coated beads together with empty uncoated beads before (black) and after (green) passage through the intestine of gnotobiotic mice, mono-colonized with either B. cellulosilyticus or B. vulgatus. Beads were purified from cecal and colonic contents four hours after gavage. The mass of arabinose associated with beads is plotted before (black) and after (green) passage through the intestine. Circles denote individual animals. Bars show mean values and 95% CI. FIG. 4D and FIG. 4E graphically depict polysaccharide degradation in mice colonized with the 15-member community (with B. cellulosilyticus), or the 14-member community (lacking B. cellulosilyticus) fed the HiSF-LoFV diet. The mass of bead-associated arabinose (panel D) or glucose (panel E) is plotted before (black) and after collection from cecal and colonic contents on experimental day 12 (grey, 15-member community group; magenta, minus B. cellulosilyticus group). The presence or absence of B. cellulosilyticus in each group of mice is noted along the x-axis. Circles denote individual mice. Mean values+95% Cl are shown (n=3-6 animals/group). *, P<0.05 (Mann-Whitney U test).

FIG. 5A, FIG. 5B, FIG. 5C, FIG. 5D, FIG. 5E, and FIG. 5F show the results of experiments to detect acclimation to the presence of a potential competitor using proteomics and forward genetics. FIG. 5A and FIG. 5B graphically depict the relative abundance of the indicated bacterial strains after adult C57BL/6J germ-free mice were colonized with the same defined community used for the experiments in FIG. 2, with or without B. cellulosilyticus (B.c.) or B. vulgatus (B.v.). Relative abundance of each bacterial strain in fecal samples is shown at each time point in mice colonized with the 15-member community (grey closed circles) or that community lacking B. cellulosilyticus or B. vulgatus (open circles; magenta and brown respectively). All mice received the control base HiSF-LoFV diet. Key: circles, individual mice; lines, mean values; shading, 95% CI. FIG. 5C and FIG. 5D are plots showing protein abundance and INSeq data for genes in arabinoxylan PULs shown along the x-axis (as locus tag number only; Bovatus_0XXXX) according to the order in which they appear in the genome. Mean values±SD (vertical shading) are indicated (n=5 animals/treatment group). Genes are color-coded according to functional annotation. Key for circles: grey, 15-member community; magenta or brown, mice harboring communities without B. cellulosilyticus or B. vulgatus, respectively. *, P <0.05, |fold change|>log 2(1.2) [15-member community versus 14-member (minus B. cellulosilyticus); limma or limma-voom]. FIG. 5E is a plot showing a proteomics analysis of fecal communities sampled on experimental day 6. Proteins whose abundances increase significantly in the absence of B. cellulosilyticus appear in the upper right; those encoded by genes in PULs are highlighted with open circles while those encoded by genes in arabinoxylan processing PULs are labeled with their PUL number. FIG. 5F is a plot showing an INSeq analysis showing the change in abundance of mutant strains from experimental day 2 to day 6 relative to the 15-strain community. Genes that are significantly more important for fitness in the absence of B. cellulosilyticus appear in the upper left. Genes in PULs that have a significant effect on fitness are highlighted with open circles; those located in arabinoxylan processing PULs are labeled with their PUL number.

FIG. 6A, FIG. 6B, FIG. 6C, FIG. 6D, FIG. 6E, FIG. 6F, and FIG. 6G show the results of experiments to alleviate competition between arabinoxylan consuming Bacteroides. FIG. 6A, FIG. 6B, and FIG. 6C graphically depict the relative abundance of bacterial strains after adult C57BL/6J germ-free mice were colonized with the same defined community used for the experiments in FIG. 2, with or without B. cellulosilyticus (B.c.) and/or B. ovatus (B.v.). The relative abundance of each bacterial strain is shown at each time point in mice fed the control HiSF-LoFV diet and colonized with the 15-member community (closed circles) or the derivative communities lacking B. cellulosilyticus or B. ovatus or both species (open circles; magenta, orange, and cyan respectively). Key: circles, individual mice; lines, mean values; shading, 95% CI. FIG. 6D and FIG. 6E graphically show the analysis of B. ovatus or B. cellulosilyticus protein abundances in fecal samples obtained on experimental day 6. Genes in arabinoxylan-processing PULs are shown along the x-axis (as locus tag number only; Bovatus_0XXXX or BcellWH2_0XXXX) according to the order in which they appear in the genome. Mean values±SD (vertical shading) are indicated (n=5-7 animals/treatment group). Genes are color-coded according to functional annotation (see key). Key for circles: grey, 15-member community; magenta, orange, or cyan, mice harboring communities without B. cellulosilyticus, B. ovatus, or both species, respectively. *, P<0.05 [15-member community versus 14-member (minus B. cellulosilyticus); limma]. FIG. 6F and FIG. 6G graphically show the results of a bead-based assay of polysaccharide degradation in mice fed the HiSF-LoFV diet and colonized with the complete 15-member community, or a community lacking B. cellulosilyticus, B. ovatus, or both species. The mass of bead-associated arabinose (FIG. 6F) or mannose (FIG. 6G) is plotted before (black) and after exposure to the indicated communities (grey, complete 15-member community; magenta, community with B. cellulosilyticus omitted; orange, community lacking B. ovatus; cyan, community lacking both Bacteroides species). The presence or absence of B. cellulosilyticus and B. ovatus in each group of mice is noted along the x-axis. Circles denote individual mice. Mean values+95% Cl are shown (n=5-7 animals/group). *, P<0.05 (Mann-Whitney U test).

FIG. 7A, FIG. 7B, FIG. 7C, FIG. 7D, FIG. 7E, FIG. 7F, FIG. 7G, FIG. 7H, and FIG. 7I show the results of proteomics and forward genetic experiments to identify homogalacturonan in citrus pectin as a nutrient source for multiple bacterial species. FIG. 7A is a schematic representation of polysaccharide structures detected in citrus pectin based on monosaccharide and linkage analyses (with stereochemistry of anomeric carbons inferred). FIG. 7B-E are graphs showing relative abundance of the indicated bacterial strains. Adult C57BL/6J germ-free mice were colonized with a 15-member community consisting of INSeq libraries representing four Bacteroides species together with 10 additional bacterial strains used in screening experiments depicted in FIG. 1. Relative abundance is shown for each bacterial strain at each of the indicated time points in mice fed the control HiSF-LoFV diet (grey), or the HiSF-LoFV diet supplemented with 10% (w/w) citrus pectin (blue). Circles denote individual mice, lines the mean value and shading the 95% Cl (n=15 individually caged mice per group; results pooled from three independent experiments). *, P<0.05 (Mann-Whitney U test). FIG. 7F-I are plots showing proteomic and INSeq analyses of fecal samples collected on experimental day 6. On the x-axis, each dot denotes the mean value for the abundance of a single bacterial protein in samples from animals monotonously fed the citrus pectin-supplemented HiSF-LoFV diet (relative to controls fed the unsupplemented diet). The y-axis indicates the mean value for the differential enrichment of mutants with Tn disruptions in the gene encoding each protein in the citrus pectin versus HiSF-LoFV diet groups. Blue dots represent genes that are significantly affected by citrus pectin (P<0.05, |fold change|>log 2(1.2); limma or limma-voom) as judged by levels of their protein products or their contribution to fitness while open circles mark the subset of these genes that are encoded by PULs. Genes present in predicted homogalacturonan-processing PULs in B. thetaiotaomicron, B. cellulosilyticus, and B. vulgatus are labeled with their PUL number as it appears in PULDB (Terrapon et al., 2018).

FIG. 8A, FIG. 8B, FIG. 8C, and FIG. 8D show results from experiments that deliberately manipulate a community composition to demonstrate interspecies competition for homogalacturonan in citrus pectin. FIG. 8A and FIG. 8B are graphs showing relative abundance of the indicated bacterial strains. Adult C57BL/6J germ-free mice were colonized with the same defined community that was used for the experiments in FIG. 2, with or without B. cellulosilyticus (B.c.). Relative abundance of each bacterial strain is shown at each time point in mice fed the control HiSF-LoFV diet in the presence (light grey, closed circles), or absence (dark grey, open circles) of B. cellulosilyticus, or fed the HiSF-LoFV diet supplemented with 10% (w/w) citrus pectin in the presence (green, closed circles) or absence (magenta, open circles) of B. cellulosilyticus. Key: circles, individual mice; lines, mean values; shading, 95% Cl (n=4-10 mice per group). *, P<0.05; (diet-by-community interaction; ANOVA). FIG. 8C and FIG. 8D are plots showing mean values±SD (vertical shading) (n=5 animals/treatment group) from proteomics analysis of fecal communities sampled on experimental days 6, 12, 19, and 25. Genes in predicted homogalacturonan-processing PULs are shown along the x-axis (as locus tag number only; BT_XXXX, BVU_XXXX) according to the order in which they appear in the genome. Mean values±SD (vertical lines) are indicated (n=5 animals/treatment group). Genes are color-coded according to functional annotation (see key). GH families for enzymes in the CAZy database are shown as numbers inside the gene boxes. Key for circles is identical to that used in panels A and B. *, P<0.05, |fold change|>log 2(1.2) (citrus pectin supplemented versus unsupplemented-HiSF-LoFV diet; limma).

FIG. 9A, FIG. 9B, FIG. 9C, FIG. 9D, FIG. 9E, and FIG. 9F show results from experiments to characterize glycan processing as a function of community membership with artificial food particles. FIG. 9A and FIG. 9B graphically depict the mass of arabinose or glucose associated with three types of polysaccharide-coated beads or with empty uncoated beads. Gnotobiotic mice, mono-colonized with either B. cellulosilyticus or B. vulgatus, were gavaged with three types of polysaccharide-coated beads together with empty uncoated beads. Beads were purified from cecal and colonic contents 4 hours after gavage. The mass of arabinose (FIG. 9A) or glucose (FIG. 9B) associated with beads is plotted before (black) and after (green) their transit through the gut. Circles denote individual animals. Bars show mean values with 95% CI. In FIG. 9C and FIG. 9D, adult C57BL/6J germ-free mice were gavaged with four beads types (labeled on the x-axis). Beads were isolated from fecal samples collected from 4 to 12 hours after gavage. The mass of arabinose (FIG. 9C) and glucose (FIG. 9D) associated with beads is plotted before (black) and after (blue) their transit through the gut. Circles denote individual mice. Bars show the mean values+95% Cl (n=13 animals). FIG. 9E and FIG. 9F graphically depict polysaccharide degradation in mice colonized with the 15-member community (with B. cellulosilyticus), or the 14-member community lacking B. cellulosilyticus fed the HiSF-LoFV diet +10% pea fiber. Beads were recovered from cecal and colonic contents. The mass of bead-associated arabinose (FIG. 9E) or glucose (FIG. 9F) is plotted before (black) and after transit through the gut (green, 15-member community group; magenta, minus B. cellulosilyticus group). In FIGS. 9A, B, E, and F, and in FIGS. 4D and 4E, input beads are shared for all plots, since all six groups of mice were analyzed in the same experiment. The presence or absence of B. cellulosilyticus in each group of mice is noted along the x-axis. Circles denote individual mice. Mean values+95% Cl are shown (n=3-6 animals/group). *, P<0.05 (Mann-Whitney U test).

FIG. 10 graphically depicts the results of an adhesion assay using glycan-coated beads and gut microorganisms. The extent of fluorescence (Syto-60+) on the y-axis is measured relative to control beads that are incubated with fluorescent dye but not bacteria.

FIG. 11A, FIG. 11B, FIG. 11C, FIG. 11D, and FIG. 11E illustrate various experimental designs described in the examples. FIG. 11A—Monotonous feeding of the unsupplemented HiSF-LoFV diet or the diet supplemented with one of four different fiber preparations. Fecal samples were collected on days 2, 3, 6, 8, 12, 14, 19 and 21. FIG. 11B—Monotonous feeding of the unsupplemented HiSF-LoFV diet or the HiSF-LoFV diet supplemented with pea fiber or citrus pectin to mice colonized with the community with or without B. cellulosilyticus. Fecal samples were collected on days 2, 3, 6, 8, 12, 14, 19 and 25. FIG. 11C—Monotonous feeding of the HiSF-LoFV with or without pea fiber to mice colonized with the community with or without B. cellulosilyticus. Fecal samples were collected on days 2, 3, 4, 6, 7, 8, 10, 11, and 12. FIG. 11D—Monotonous feeding of HiSF-LoFV with or without citrus pectin to mice colonized with a community with or without B. cellulosilyticus or B. vulgatus. Fecal samples were collected on days 2, 3, 4, 6, 7, 8, 10, and 12. FIG. 11E—Monotonous feeding of the unsupplemented HiSF-LoFV diet to mice harboring communities with or without B. cellulosilyticus and/or B. ovatus. Fecal samples were collected on days 2, 3, 4, 6, 7, 8, and 10.

FIG. 12 is a chemical reaction schematic. Although only a single polysaccharide is used in this depiction, any glycan may be used.

FIG. 13A is a graph depicting the zeta potential of surface modified paramagnetic silica beads. Parent beads and beads modified with only APTS of THPMP were used as standards.

FIG. 13B is a graph depicting bead fluorescence after reaction of each bead type shown with NHS ester fluorescein. Only beads modified with surface amines, and not acetylated, were highly fluorescent.

FIG. 14 is a chemical reaction schematic of CDAP activation of polysaccharides and immobilization on the surface of amine phosphonate beads. Although only a single polysaccharide is used in this depiction, any glycan may be used.

FIG. 15 is a graph depicting arabinoxylan immobilization on surface modified beads. Beads were reacted with CDAP-activated arabinoxylan in the presence of catalytic TEA. The amount of arabinoxylan bound to each bead type was determined by quantifying xylose and arabinose liberated following acid hydrolysis of a set number of beads.

FIG. 16 is a schematic of the use of polysaccharide-coated beads to measure the biochemical function of a gut microbiota within a mouse.

FIG. 17 is a graph depicting arabinose release from polysaccharide-coated beads harvested from cecum 4 hours post bead gavage. Each data point represents a single mouse. Mean±SD. Pairwise Welch's t-test. Benjamini and Hochberg corrected. *p<0.05.

FIG. 18 diagrams a procedure for fractionation of a pea fiber preparation.

FIG. 19 is graph depicting monosaccharide compositions of fractions 1 to 8 of a pea fiber preparation.

FIG. 20A depicts the structure of a pea fiber arabinan. R groups (not shown) are attached to each end, where R may be hydrogen or a pectic fragment.

FIG. 20B depicts the structure of a sugar beet arabinan. An R group (not shown) is attached to the free end, where R may be hydrogen or a pectic fragment.

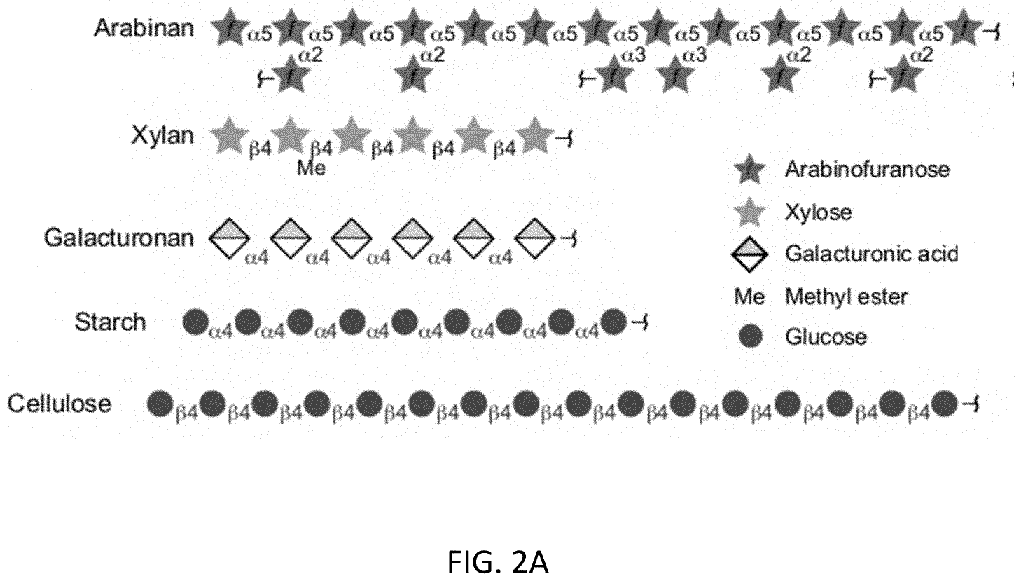

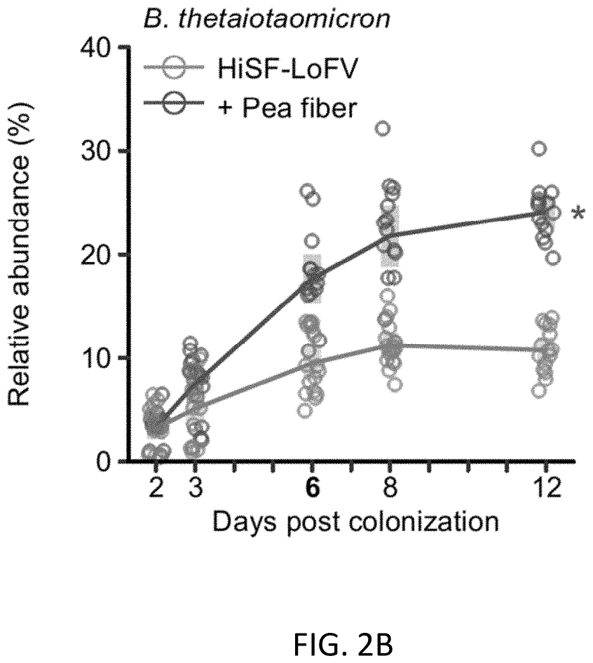

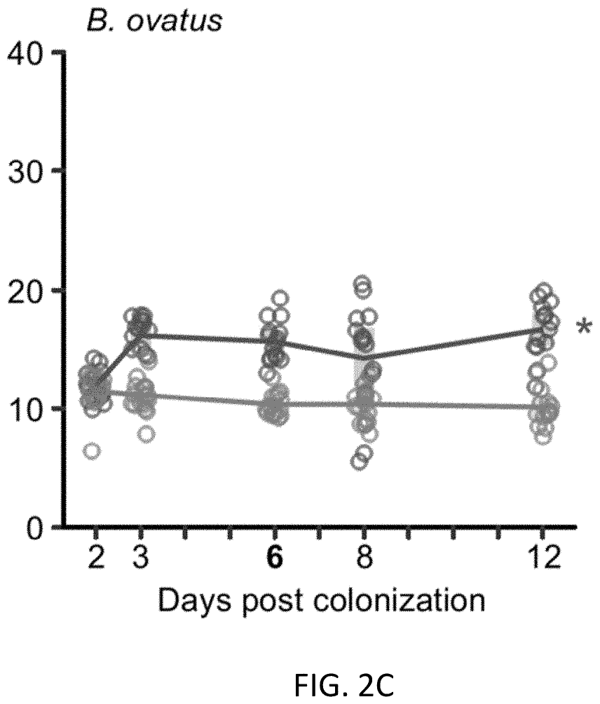

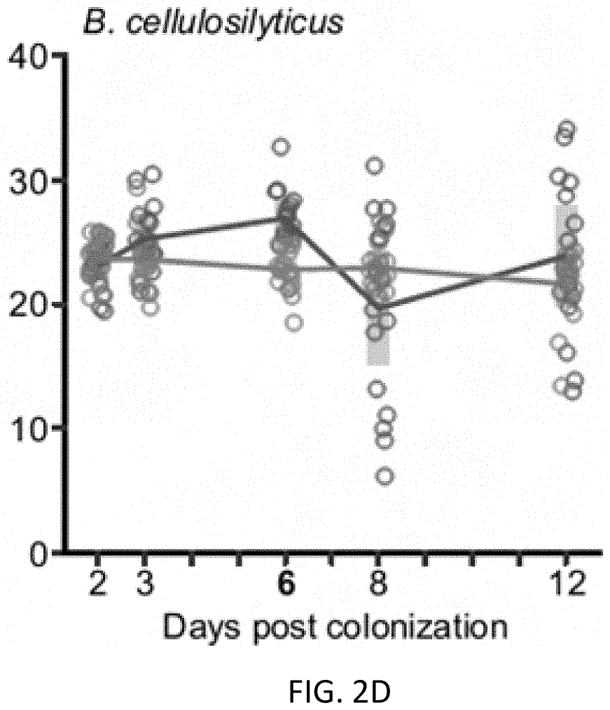

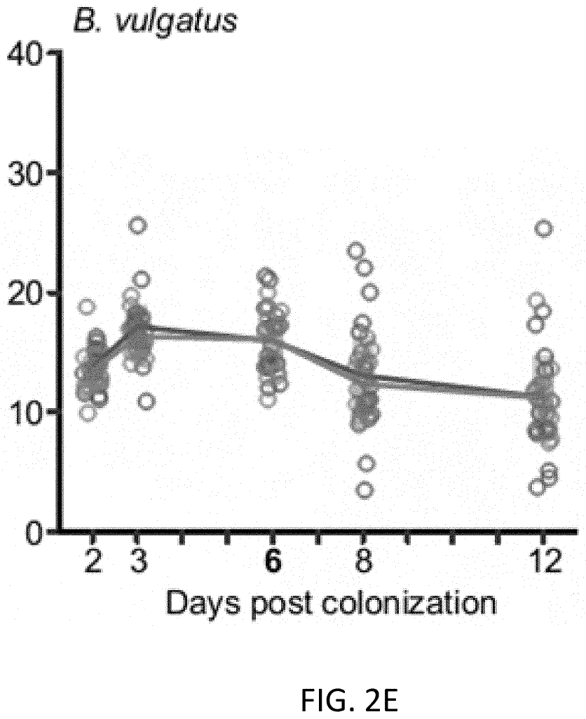

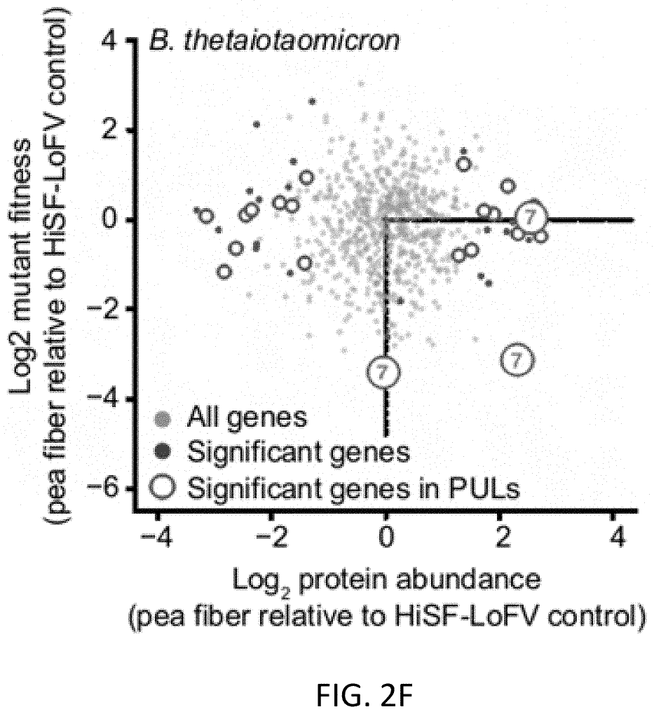

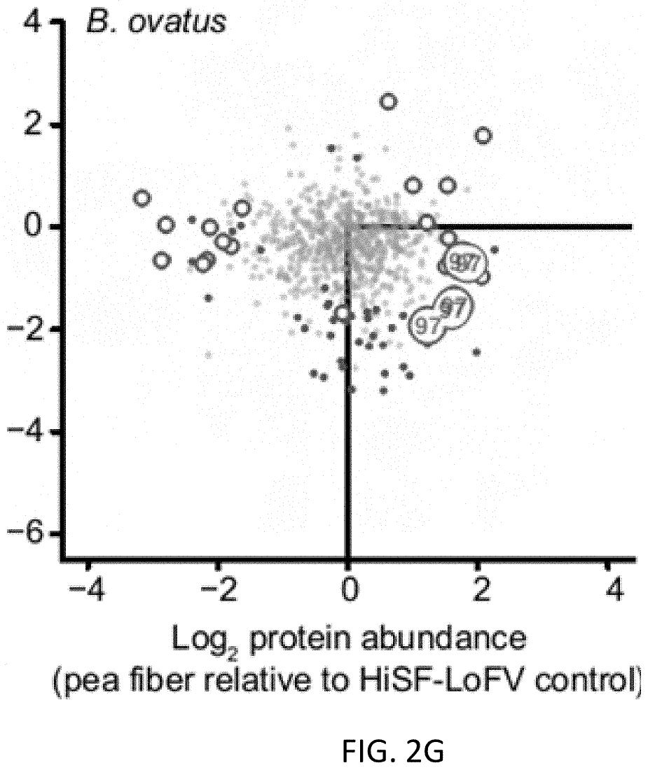

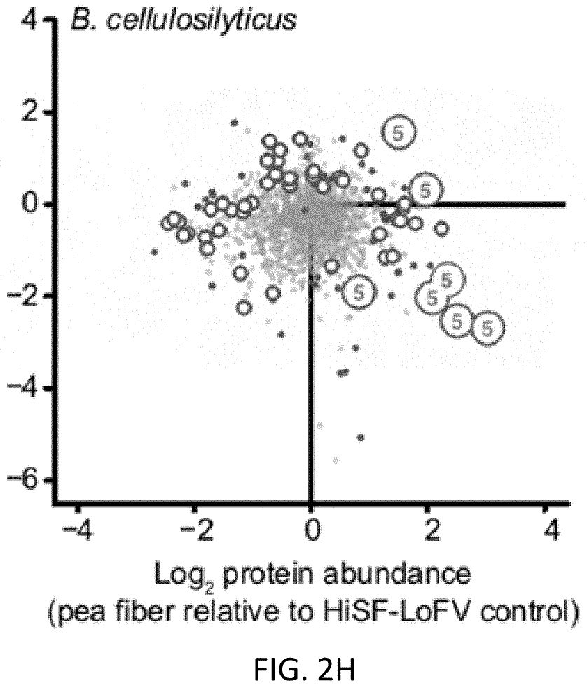

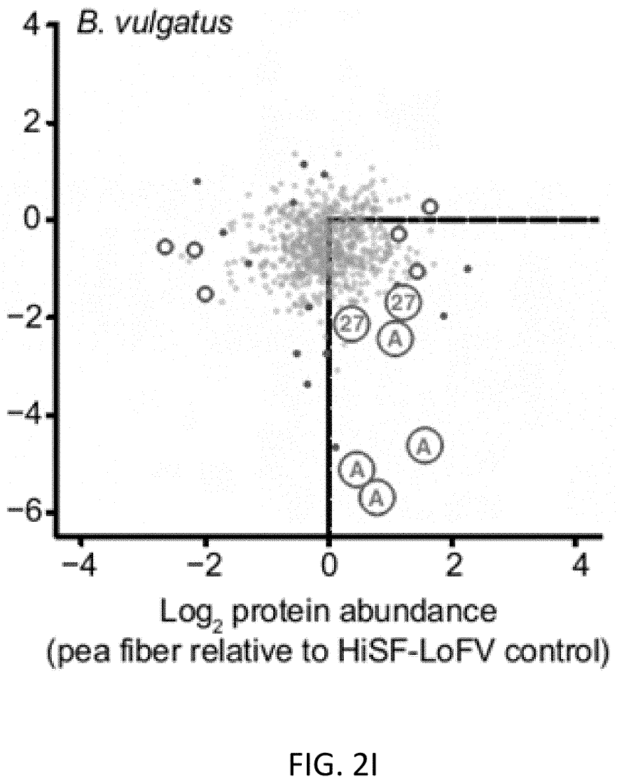

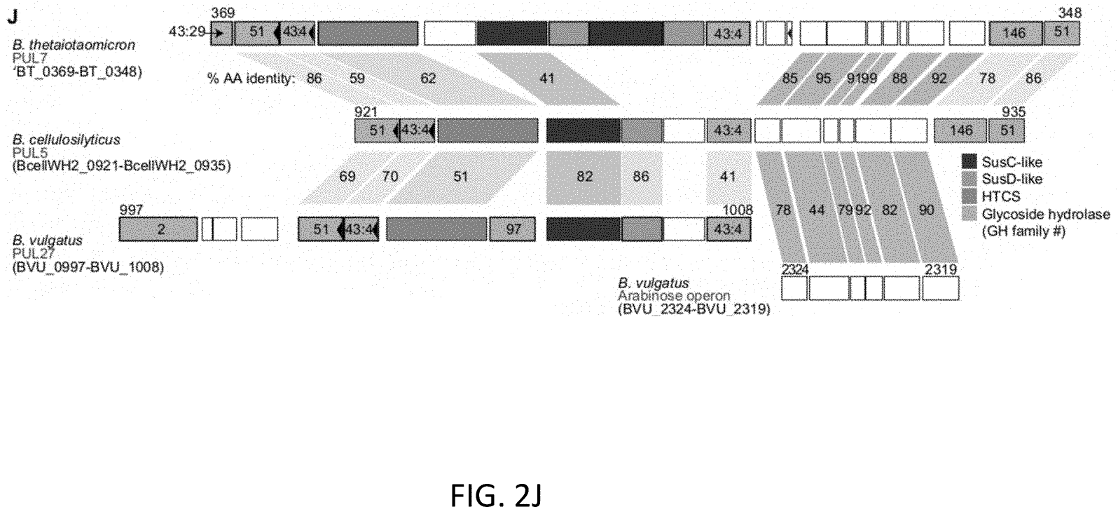

FIG. 2I is graph depicting monosaccharide compositions of sugar beet arabinan and Fraction 8.

FIG. 22 is an illustration of the experimental design described in Example 10. Briefly, four groups of adult C57BL/6J male mice fed the HiSF-LoFV diet were colonized with a defined community comprising 14 cultured, sequenced human gut bacterial strains (see Table 15 for a list of the strains; also see Ridaura et al.) (n=5 mice/arm). Two days after colonization, mice in three experimental groups were switched to the HiSF-LoFV diet supplemented with one of three fiber preparations. A fourth control arm received the unsupplemented HiSF-LoFV diet. Mice were given ad libitum access to the diets for 10 days at which point all animals were gavaged with polysaccharide-coated paramagnetic fluorescent beads. Animals were sacrificed 4 hours after gavage of the beads. Bacterial community composition was assessed via short read shotgun sequencing (COPRO-Seq) of DNA purified from serially-collected fecal samples (days −1, 2, 6, 8, 11) and from cecal contents harvested at the conclusion of the experiment (McNulty et al.). Additionally, genes with significant contributions to bacterial fitness in each diet context were identified by multi-taxon insertion site sequencing (INSeq) of the five strains represented as Tn mutant libraries using DNA purified from fecal samples collected on days 2 and 6 (Wu and Gordon et al., 2015).

FIG. 23 is a graph of a principal component analysis of fecal bacterial community composition in response to diet supplementation. Each data point represents an individual mouse. Shaded regions represent 95% probability region of the s.d. of mean.

FIG. 24 graphically depicts the fractional abundance of several bacterial strains following diet supplementation. Each circle represents an individual mouse. Shaded regions are ±SD.

FIG. 25 is an illustration of the experimental design described in Example 10.

FIG. 26A, FIG. 26B, and FIG. 26C are graphs depicting arabinose mass remaining on the surface of multiple bead types after recovery from mice fed the HiSF-LoFV diet, the HiSF-LoFV diet plus a diet supplement, or input beads never exposed to mice.

FIG. 27A, FIG. 27B, and FIG. 27C are alignments of arabinan-utilization loci arabinan-utilization loci in Bacteroides species (related to FIG. 2). Alignment of B. thetaiotaomicron PUL7 (FIG. 27A), B. cellulosilyticus PUL5 (FIG. 27B), and B. vulgatus PUL27 (FIG. 27C) across multiple strains of each species. The direction of transcription is indicated by the arrowhead. The genes are labeled with their locus tag number and color-coded according to their functional annotation (see key). Shaded regions connecting genes denote (i) significant BLAST homology (E-value <10⁻⁹) and the percent amino acid identity of their protein products (see key).

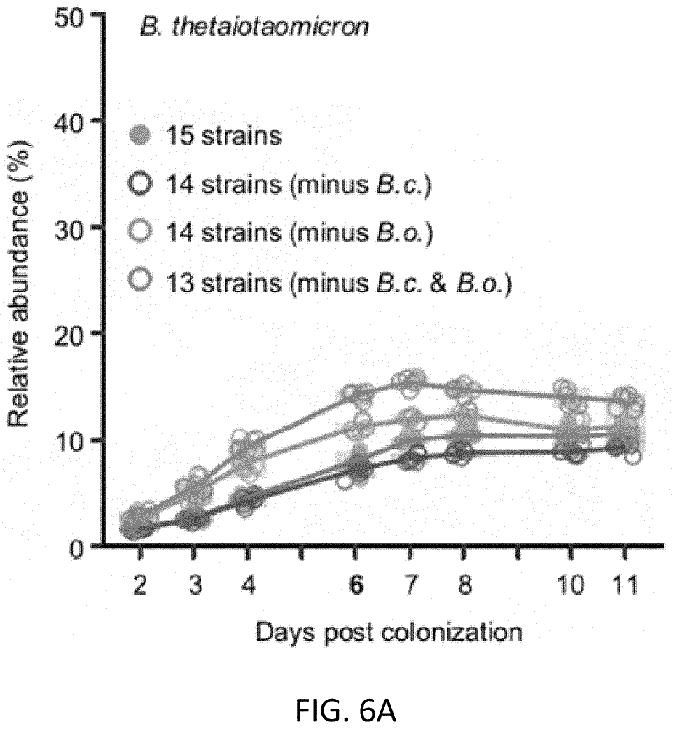

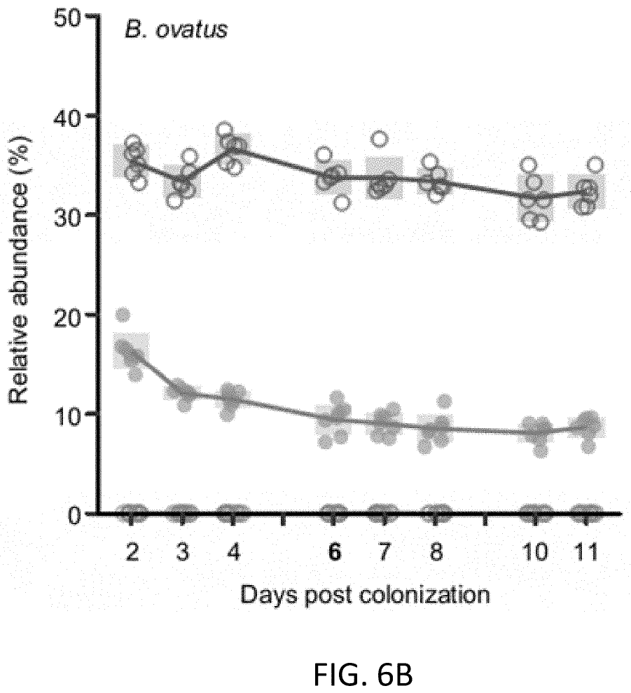

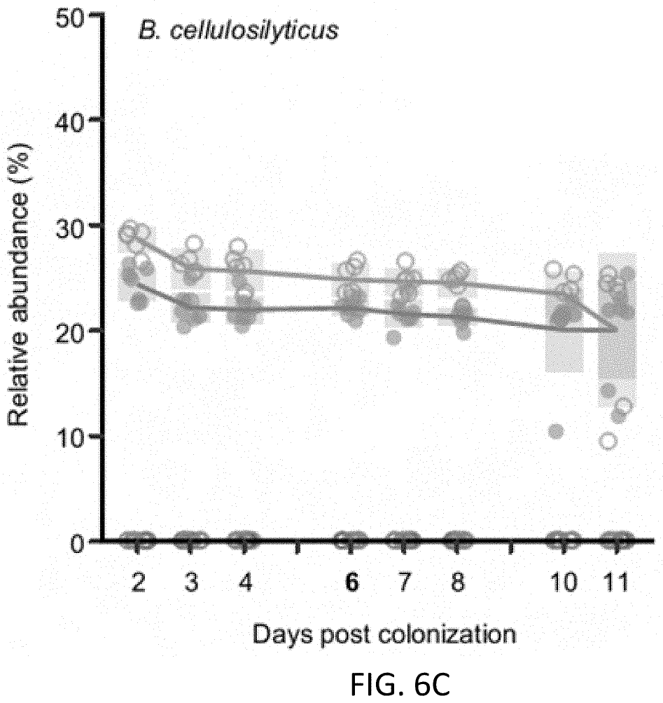

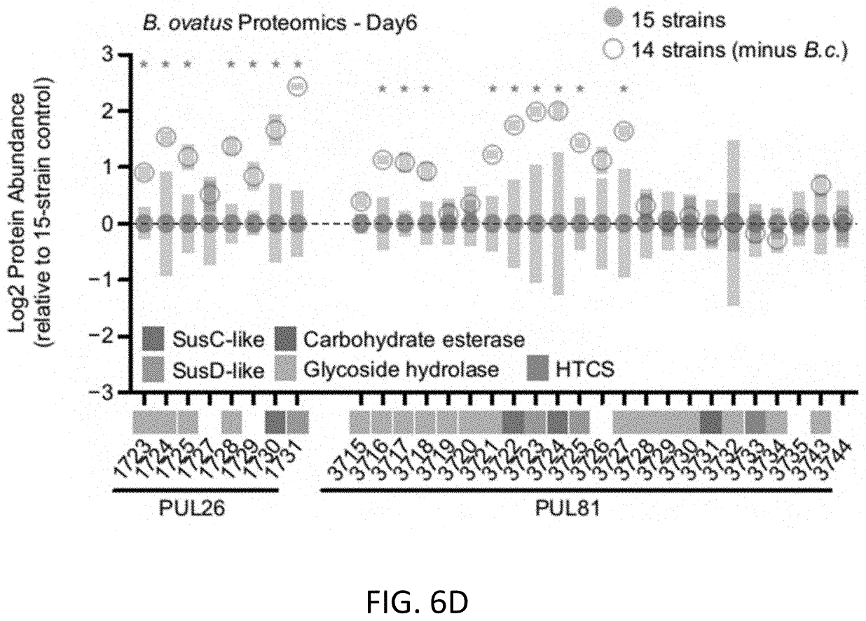

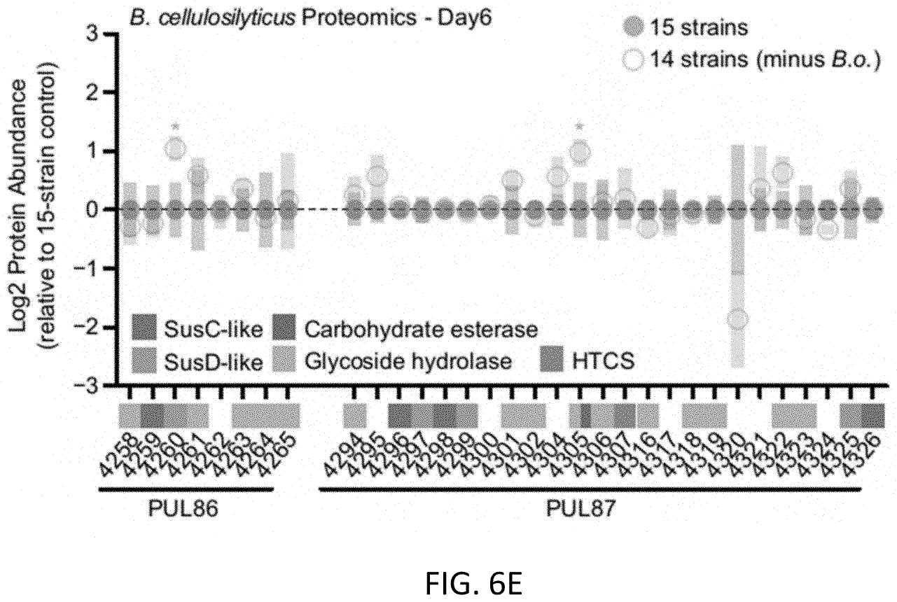

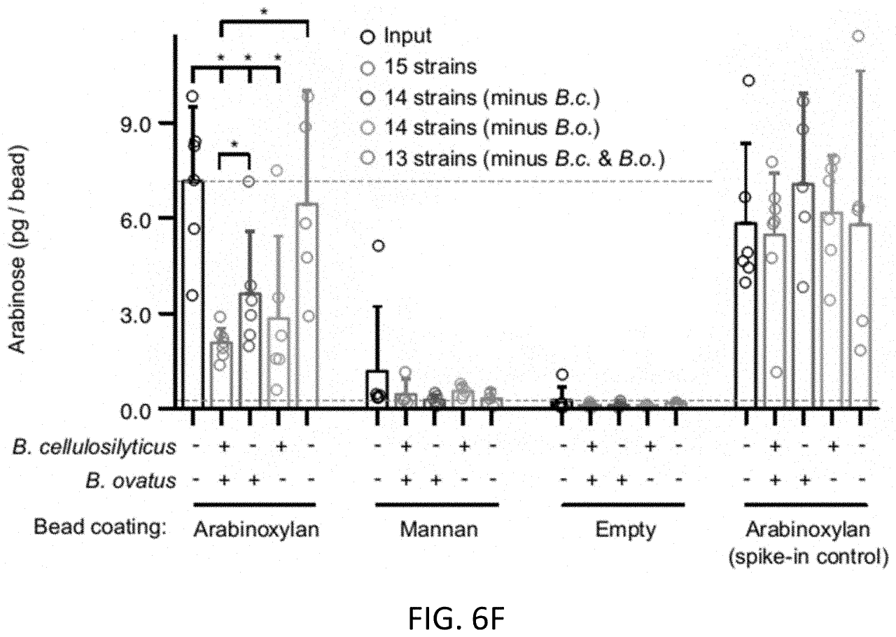

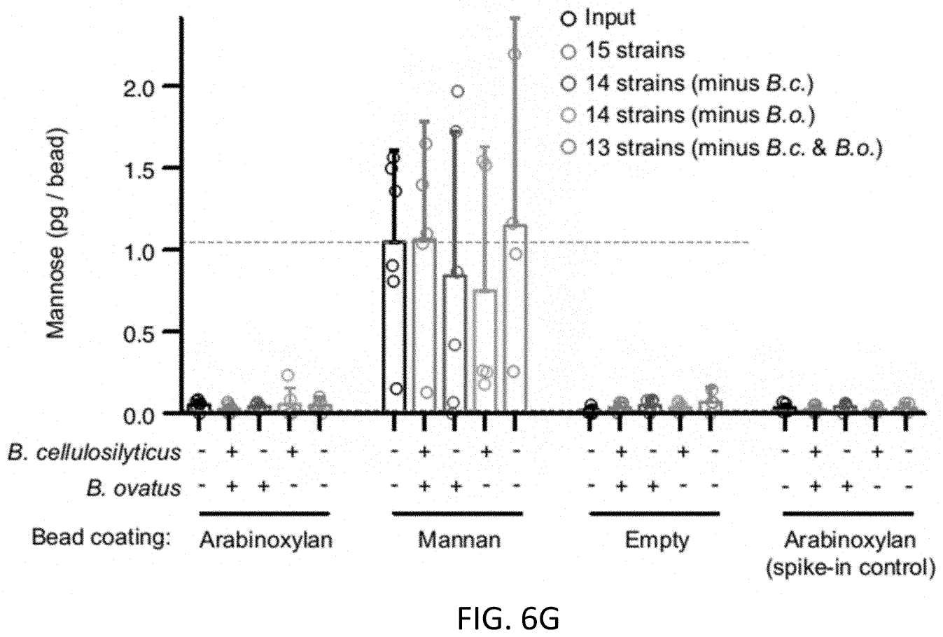

FIG. 28A, FIG. 28B, and FIG. 28C are graphs showing B. cellulosilyticus-dependent glycan use by B. ovatus in the HiSF-LoFV diet context (related to FIG. 6). Proteomics analysis of fecal communities sampled on experimental days 6, 12, 19, and 25. Genes, color-coded according to their functional annotation including GH family assignments, in the indicated PULs are shown along the x-axis together with their locus tag numbers (Bovatus_0XXXX. The abundance of their expressed protein products (mean values±SD) is plotted along the y-axis (n=5 animals/treatment group). Key for circles: grey, 15-member community; magenta, mice harboring communities without B. cellulosilyticus. *, P <0.05, |fold change|>log 2(1.2), [15-member community versus 14-member (minus B. cellulosilyticus); limma].

FIG. 29A and FIG. 29B illustrate steps used for producing MFABs. The transferred cyano-group from CDAP and its modification during ligand immobilization are highlighted in red. Arabinose oligosaccharide is shown as a representative ligand for immobilization. Amine and phosphonate functional groups are denoted with ‘+’ and ‘−’ symbols, respectively.

FIG. 29C graphically depicts arabinose released during acid hydrolysis from amine plus phosphonate beads with and without surface amine groups acetylated. Beads were coated with SBABN that had been activated using increasing molar ratios of CDAP (x-axis). For the purposes of a generalizable calculation, glycans for immobilization are assumed to be composed solely of hexose and the moles present in the reaction are computed. Each point represents a single measurement (n=4). Bar height (arabinose mass (ng/10³ beads)) represents the mean value.

FIG. 30A, FIG. 30B, and FIG. 30C graphically depicts the results of experiments characterizing the modified surface chemistry of paramagnetic glass beads. FIG. 30A depicts alteration in bead surface Zeta potential (mV, y-axis) after modification with organosilanes, with and without amine acetylation. Each point represents the average of at least 12 measurements. FIG. 30B depicts the level of fluorophore immobilization on the surface of beads after modification with organosilanes, with and without amine acetylation. Each bar represents the geometric mean of greater than 1,000 beads. The concentration of NHS-ester-activated fluorophore was 0.1 μM. Results are representative of three independent experiments. FIG. 30C depicts the level of fluorophore immobilized on an amine phosphonate bead after reaction with increasing concentrations of NHS-ester-activated fluorophore, with and without bead surface amine acetylation. Each bar represents the geometric mean of greater than 1,000 beads. Results are representative of those obtained in three independent experiments.

FIG. 31A and FIG. 31B graphically show how conjugation reaction conditions influence immobilization of polysaccharides on the surfaces of the paramagnetic glass beads. In FIG. 31A, SBABN was subjected to CDAP-based bead immobilization across a range of pH values (y-axis, conjugation buffers with different pH values). Immobilized arabinose (ng/10³ beads) was quantified using GC-MS. Each data point represents a single measurement, the bar represents the mean. FIG. 31B depicts levels of SBABN immobilization in the presence of a HEPES or MOPS-based buffer at an identical pH. Monosaccharides (ng/10³ beads) were quantified using GC-MS. Each data point represents a single measurement. Bar height represents the mean and error bars the s.d. The monosaccharides, from left to right, are arabinose, glucose, mannose, galactose, rhamnose, and xylose.

FIG. 32A, FIG. 32B, and FIG. 32C graphically depict the quantification of microbial degradation of PFABN- and SBABN-coated beads in gnotobiotic mice fed unsupplemented or supplemented HiSF-LoFV diets. FIG. 32A depicts monosaccharide composition of beads containing covalently bound PFABN (left) or SBABN (middle). Control beads were subjected to surface amine acetylation (right). In each graph, the monosaccharides are, from left to right, arabinose, glucose, mannose, galactose, rhamnose, xylose. The amount of monosaccharide released after acid hydrolysis was quantified by GC-MS. Each point represents a single measurement. Mean values (bar height, monosaccharide mass (ng/10³ beads)) and standard deviations are shown. Bar height denotes the mean while error bars represent the s.d. (n=6 measurements). FIG. 32B depicts percentage of arabinose (left graph), galactose (middle graph) and xylose (right graph) remaining on the surface of PFABN-coated beads recovered from the ceca of mice fed the indicated diets (n=5 mice/treatment group). *, p<0.05 (Mann-Whitney U test compared to the group furthest to the left). FIG. 32C depicts percentage of arabinose (left graph) and galactose (right graph) remaining on the surface of SBABN-coated beads recovered from the ceca of mice fed the indicated diets (n=5 mice/treatment group). *, p<0.05 (Mann-Whitney U test compared to the group furthest to the left).

FIG. 33A, FIG. 33B, FIG. 33C, FIG. 33D, FIG. 33E, and FIG. 33F graphically depict the results of assays to determine whether bead-linked polysaccharides are degraded in germ-free mice (GF). In each figure, absolute mass of monosaccharide released from three bead types prior to, or after gavage, collection and purification from germ-free mice fed the HiSF-LoFV diet supplemented with PFABN is shown on the y-axis (ng/10³ beads). Beads were collected from the cecum 4 hours after gavage. Each point represents a single measurement or animal (n=6 for input beads, 4 for germ-free animals). Bar height represents the mean while error bars denote the s.d. *, p<0.05, Mann-Whitney U test. PFABN-coated beads are shown in FIG. 33A and FIG. 33B; SBABN-coated beads are shown in FIG. 33C and FIG. 33D, and acetylated control beads are shown in FIG. 33E and FIG. 33F. The monosaccharides quantified in FIG. 33A, FIG. 33B, and FIG. 33C are arabinose, glucose, and mannose, respectively. The monosaccharides quantified in FIG. 33B, FIG. 33D, and FIG. 33F are galactose, rhamnose, and xylose, respectively.

FIG. 34A, FIG. 34B, FIG. 34C, FIG. 34D, FIG. 34E, and FIG. 34F graphically depict the results of experiments showing colocalization of PFABN and glucomannan on the same bead results in augmented degradation of glucomannan in gnotobiotic mice colonized with the defined consortium and fed the pea fiber supplemented HiSF-LoFV diet. FIG. 34A depicts in vitro growth of supplement-responsive Bacteroides species in minimal medium containing glucose (black line with shading) or glucomannan (orange line without shading) as the sole carbon source. The line represents the mean and shaded regions the s.e.m. of quadruplicate measurements. Y-axis is OD (600 nm) and x-axis is time (hours). FIG. 34B and FIG. 34C graphically shows monosaccharide compositions of beads with covalently bound PFABN (FIG. 34B, left graph), glucomannan (FIG. 34B, right graph), or both PFABN and glucomannan (FIG. 34C, left graph). Control beads (FIG. 34C, right graph) were subjected to surface amine acetylation. In each graph, the monosaccharides are, from left to right, arabinose, glucose, mannose, galactose, rhamnose, xylose. The amount of monosaccharide released after acid hydrolysis was quantified by GC-MS. Each point represents a single measurement. Bar height (monosaccharide mass (ng/10³ beads)) represents the mean and error bars the s.d.; n=6 measurements. In FIG. 34D, beads containing PFABN alone, SBABN alone, or both glycans, as well as ‘empty’ acetylated control beads, each containing a unique fluorophore, were simultaneously introduced by oral gavage into gnotobiotic mice, recovered 4 hours later from their cecums. Each bead-type is subsequently purified by FACS. A representative flow cytometry plot of beads isolated from the cecum is shown. FIG. 34E and FIG. 34F graphically depicts monosaccharide remaining on beads coated with PFABN alone and glucomannan alone (FIG. 34E), or both glycans (FIG. 34F) after collection and purification from the cecums of mice fed the unsupplemented or pea fiber-supplemented HiSF-LoFV diet. Colors are identical to those used in panel b. The amount of remaining monosaccharide is expressed relative to the absolute mass of monosaccharide immobilized on the surface of each type of input bead. Each point represents a single animal. *, p<0.05 (Mann-Whitney U test).

FIG. 35A, FIG. 35B, FIG. 35C, and FIG. 35D demonstrate the effects of supplementing the HiSF-LoFV diet with unfractionated pea fiber (PF), PFABN or SBABN on PUL gene expression in B. thetaiotaomicron VIP-5482 (FIG. 35A), B. ovatus ATCC8483 (FIG. 35B), B. cellulosilyticus WH2 (FIG. 35C), is B. vulgatus ATCC 8482 (FIG. 35D). Each figure is a heat map of the average log 2 fold-change in protein abundance of proteins within PULs identified as supplement-responsive using GSEA. *, P<0.05 (unpaired one-sample Z-test, FDR-corrected) compared to PUL protein abundance when mice were fed the base HiSF-LoFV diet.

FIG. 36A, FIG. 36B, FIG. 36C, FIG. 36D, FIG. 36E, FIG. 36F, FIG. 36G identify PULs that function as key fitness determinants in the different diet contexts. Plots represent of the log₂ fitness score versus log₂ fold-change in protein abundance for all genes from a given organism under the specified diet condition. Genes from the specified PUL are highlighted in blue. The overrepresentation of genes positioned in the right lower quadrants of the plots, (i.e., those showing high expression and low fitness when they are disrupted by a transposon), was defined with a chi-squared test using all other genes with both proteomic and INSeq data as the null. The central shaded region represents an ellipse of the inter-quartile range of both the fitness score and protein abundance for that organism under the specified diet condition. This region was excluded from the chi-squared calculation of a PUL being overrepresented in in the lower right quadrant to increase the stringency of the test. The organisms and PULs are B. theaiotaomicron VPI-5482 PUL7 in FIG. 36A, FIG. 36B, and FIG. 36C; B. theaiotaomicron VPI-5482 PUL73 in FIG. 36D, FIG. 36E, and FIG. 36F; B. theaiotaomicron VPI-5482 PUL75 in FIG. 36G, FIG. 36H, and FIG. 36I; B. vulgatus ATCC 8482 PUL27 in FIG. 36J, and FIG. 36K; B. vulgatus ATCC 8482 PUL12 in FIG. 36L; B. ovatus ATCC 8483 PUL97 in FIG. 36M, FIG. 36N, and FIG. 36O; B. cellulosilyticus WH2 PUL5 in FIG. 36P, FIG. 36Q, and FIG. 36R; and B. cellulosilyticus WH2 PUL71 in FIG. 36S, FIG. 36T, and FIG. 36U.

FIG. 37 is a graphically depicts monosaccharides released from maltodextrin-coated beads after TFA hydrolysis. Maltodextrin (DE13-17, Sigma Aldrich; Cat. No.: 419690), resuspended at 50 mg/ml, was attached to beads using CDAP chemistry as illustrated in FIG. 29A and FIG. 29B. The details are as generally described in Example 14. Acid hydrolysis and TMS quantification of monosaccharides released from beads after hydrolysis was performed as described in Example 14.

### DETAILED DESCRIPTION

The present disclosure provides artificial food particles and methods of using the artificial food particles. An “artificial food particle” refers to a retrievable particle that is administered to gut microbiota, the particle comprising a tag, a compound of interest, and optionally a label. Non-limiting examples of suitable compounds of interest include biomolecules and drugs. The tag and optional label provide means to recover food particles and/or to sort recovered food particles into discrete groups. In some embodiments, artificial food particles of the present disclosure are administered to a subject, recovered from the subject, and then analyzed to determine how the artificial food particles changed during transit through the subject's intestinal tract. A variety of changes may occur to the particle including but not limited to degradation of a compound of interest, modification of a compound of interest, attachment or adherence of one or more microbial species, etc. In other embodiments, artificial food particles of the present disclosure are administered to a subject, optionally recovered from the subject, and then the subject's gut microbiota is analyzed to determine how the artificial food particles' transit through the subject's intestinal tract changed the gut mirobiota, gut microbiome, and/or functional outcome(s) of the gut microbiome (e.g., protein expression, enzymatic activities, etc.). In other embodiments, artificial food particles of the present disclosure may be mixed with a biological sample comprising gut microbiota (e.g., a fecal or cecal sample), recovered from the mixture after a suitable amount of time, and then analyzed to determine how the artificial food particle and/or the microbiota and/or microbiome changed. In still further embodiments, artificial food particles of the present disclosure may be mixed with an in vitro culture of one or more gut microbial species (e.g., previously isolated from a biological sample), recovered from the mixture after a suitable amount of time, and then analyzed to determine how the artificial food particle and/or abundance of the microbial species and/or functional activity of the microbial species. Accordingly, artificial food particles of the present disclosure can be used to characterize the composition and/or functional state of a subject's gut microbiota/microbiome, and/or to test the effect of a compound, a drug, a food, a food ingredient, a nutritional supplement, a herbal remedy, a lifestyle modification, or a behavioral modification on the compositional and/or functional state of a subject's gut microbiota/microbiome. In particular, the methods disclosed herein can be used to develop and test microbiota-directed foods.

These and other aspects of the present disclosure are detailed further below. First, several definitions that apply throughout this disclosure are presented.

As used herein, “about” refers to numeric values, including whole numbers, fractions, percentages, etc., whether or not explicitly indicated. The term “about” generally refers to a range of numerical values, for instance, ±0.5-1%, ±1-5% or ±5-10% of the recited value, that one would consider equivalent to the recited value, for example, having the same function or result. In some instances, the term “about” may include numerical values that are rounded to the nearest significant figure.

The term “comprising” means “including, but not necessarily limited to”; it specifically indicates open-ended inclusion or membership in a so-described combination, group, series and the like. The terms “comprising” and “including” as used herein are inclusive and/or open-ended and do not exclude additional, unrecited elements or method processes.

As used herein, the term “fiber preparation” refers to a composition comprising dietary fiber that (i) is intended as an ingredient in a food, and (ii) has been prepared from a plant source including, but not limited to, fruits, vegetables, legumes, oilseeds, and cereals, or has been otherwise manufactured to have a composition similar to a fiber preparation prepared from a plant source. “Prepared from a plant source,” as used herein, indicates plant material has undergone one or more treatment step (e.g., grinding, milling, shelling, hulling, extraction, fractionation, etc.). Plant-derived fiber preparations that are economical for use in human foods typically are mixtures of diverse molecular composition comprising not only dietary fiber but also protein, fat, carbohydrate, etc. A skilled artisan will appreciate that fiber preparations prepared by different manufacturing processes may have different compositions, and a proximate analysis may be used to evaluate the suitability of a fiber preparation.

A proximate analysis of a composition (e.g., a fiber preparation, a food item) refers to an analysis of the composition's moisture, protein, fat, dietary fiber, carbohydrate and ash content, which are expressed as the content (wt %) in the composition, respectively. Fiber, protein, fat, ash, and water content can be defined by Association of Official Agricultural Chemists (AOAC) 2009.01, AOAC 920.123, AOAC 933.05, AOAC 935.42, AOAC 926.08, respectively, and carbohydrate can be defined as (100−(Protein+Fat+Ash+Moisture). Analysis of the dietary fiber may provide further information by which to evaluate the suitability of a preparation.

The term “dietary fiber” refers to edible parts of plants, or analogous glycans and carbohydrates, that are resistant to digestion and adsorption in the human small intestine with complete or partial fermentation in the large intestine. The term “dietary fiber” includes glycans, lignin, and associated plant substances. Total dietary fiber, soluble dietary fiber, and insoluble dietary fiber are terms of art defined by the methodology used to measure their relative amount. As used herein, total dietary fiber is defined by AOAC method 2009.01; soluble dietary fiber and insoluble dietary fiber are defined by AOAC method 2011.25.

The term “carbohydrate” refers to an organic compound with the formula Cₘ(H₂O)ₙ, where m and n may be the same or different number, provided the number is greater than 3.

As used herein, the term “glycan” refers to a homo- or heteropolymer of two or more monosaccharides linked glycosidically. As such, the term “glycan” includes disaccharides, oligosaccharides and polysaccharides. The term also encompasses a polymer that has been modified, whether naturally or otherwise; non-limiting examples of such modifications include acetylation, alkylation, esterification, etherification, oxidation, phosphorylation, selenization, sulfonation, or any other manipulation. Glycans may be linear or branched, may be produced synthetically or obtained from a natural source, and may or may not be purified or processed prior to use.

The term “compositional glycan equivalent” refers to a fiber preparation with a substantially similar glycan content as the composition to which it is being compared. A glycan equivalent may be substituted about 1:1 for its comparison composition because the glycan equivalent has a glycan content similar to the composition it is replacing. For instance, if about 30 wt % of pea fiber preparation is to be replaced with a compositional glycan equivalent thereof, one of skill in the art would use about 30 wt % of the pea fiber glycan equivalent. A compositional glycan equivalent may be defined in terms of its monosaccharide content and optionally by an analysis of the glycosidic linkages. Methods for measuring monosaccharide content and analyzing glycosidic linkages are known in the art, and described herein.

The term “functional glycan equivalent” refers to a fiber preparation with substantially similar function as the composition to which it is being compared. The amount of a functional glycan equivalent needed to achieve a substantially similar function may be about the same as the comparison composition, or may be less. For instance, a compositional glycan equivalent will typically have substantially similar function as its comparison composition on a 1:1 (weight) basis. However, a functional glycan equivalent that is an enriched bioactive fraction of a composition may have substantially similar function as the initial composition, but comprise less material, and therefore, less weight than the initial composition. The present disclosure contemplates these and other functional glycan equivalents, as illustrated in Example 12. Substantially similar function may be measured by any method detailed in the Examples herein, in particular the ability to affect total abundance(s) of microbial community members, relative abundance(s) of microbial community members, expression of microbial genes, abundance of microbial gene products (e.g. proteins), activity of microbial proteins, and/or observed biological function of a microbial community.

A “food” is an article to be taken by mouth. The form of the food can vary, and includes but is not limited to a powder form which may be reconstituted or sprinkled on a different food; a bar; a drink; a gel, a gummy, a candy, or the like; a cookie, a cracker, a cake, or the like; and a dairy product (e.g., yogurt, ice cream or the like).

A “microbiota-directed food,” as used herein, refers to a food that selectively promotes the representation and expressed beneficial functions of targeted human gut microbes.

The term “microbiota” refers to microorganisms that are found within a specific environment, and the term “microbiome” refers to a collection of genomes from all the microorganisms found in a particular environment. Accordingly, the term “gut microbiota” refers to microorganisms that are found within a gastrointestinal tract of a subject, and a “gut microbiome” refers to a collection of genomes from all the microorganisms found in the gastrointestinal tract of a subject. The functional outcome of a microbiome refers to measures of gene expression, protein abundance, enzymatic activity and the like, which are encoded by the microbiome.

The “health” of a subject's gut microbiota may be defined by its features, namely its compositional state and/or its functional state. The “compositional state” of a gut microbiota refers to the presence, absence or abundance (relative or absolute) of microbial community members. The community members can be described by different methods of classification typically based on 16S rRNA sequences, including but not limited to operational taxonomic units (OTUs) and amplicon sequence variants (ASVs). The “functional state” of a gut microbiota refers to expression of microbial genes, observed biological functions, and/or phenotypic states of the community. A subject with an unhealthy gut microbiota has a measure of at least one feature of the gut microbiota or microbiome that deviates by 1.5 standard deviation or more (e.g., 2 std. deviation, 2.5 std. deviation, 3 std. deviation, etc.) from that of healthy subjects with similar environmental exposures, such as geography, diet, and age. To “promote a healthy gut microbiota in a subject” means to change the feature of the microbiota or microbiome of the subject with the unhealthy gut microbiota in a manner towards the healthy subjects, and encompasses complete repair (i.e., the measure of gut microbiota health does not deviate by 1.5 standard deviation or more) and levels of repair that are less than complete. Promoting a healthy gut microbiota in a subject also includes preventing the development of an unhealthy gut microbiota in a subject.

The “fiber degrading capacity” of a subject's gut microbiota is defined by its compositional state and its functional state, specifically the absence, presence and abundance of primary and secondary consumers of dietary fiber. An increase in the fiber degrading capacity of a subject may be effected by increasing the abundance of microorganisms with genomic loci for import and metabolism of glycans, as exemplified by polysaccharide utilization loci (PULs) and/or loci encoding CAZymes; and/or increasing the abundance or expression of one or more proteins encoded by a PUL and/or one or more CAZyme (with or without concomitant changes in microorganism abundance).

As used herein, “statistically significant” is a p-value <0.05, <0.01, <0.001, <0.0001, or <0.00001.

The term “substantially similar” generally refers to a range of numerical values, for instance, ±0.5-1%, ±1-5% or ±5-10% of the recited value, that one would consider equivalent to the recited value, for example, having the same function or result.

The terms “relative abundance” and “fractional abundance” as used herein describe an amount of one or more microorganism. Relative abundance means the percent composition of a microorganism of a particular kind relative to the total number of microorganisms in the area. Fractional abundance is the relative abundance divided by 100. For example, the “relative abundance of Bacteroides in a subject's gut microbiota” is the percent of all Bacteroides species relative to the total number of bacteria constituting the subject's gut microbiota, as measured in a suitable sample. “Total abundance” refers to the total number of microorganisms. Suitable samples for quantifying gut microbiota include a fecal sample, a cecal sample or other sample of the lumen. A variety of methods are known in the art for quantifying gut microbiota. For example, a fecal sample, a cecal sample or other sample of the lumenal contents of the large intestine may be collected, processed, plated on appropriate growth media, cultured under suitable conditions (i.e., temperature, presence or absence of oxygen and carbon dioxide, agitation, etc.), and colony forming units may be determined. Alternatively, sequencing methods or arrays may be used to determine abundance. The Examples detail one method, COPRO-Seq, where relative abundance is defined by the number of sequencing reads that can be unambiguously assigned to the species' genome after adjusting for genome uniqueness. 16S rRNA gene sequencing methods can also be used and are well known in the art.

These and other aspects of the present disclosure are detailed further below.

### I. Artificial Food Particles

One aspect of the present disclosure is an artificial food particle. As used herein, the terms “artificial food particle,” “particle” and “microbiota functional activity biosensor” are interchangeable. Particles of the present disclosure comprise a compound of interest. In some embodiments, a compound of interest is a compound that is altered, degraded and/or removed from the particle by gut microorganisms during the particles' transit through a subject's gut. In other embodiments, a compound of interest is a compound that binds to gut microorganisms or that gut microorganisms bind to, such that the particle-bound microorganisms may be recovered from biological material. Non-limiting examples of suitable compounds of interest include biomolecules and drugs. Particles may be comprised of only one compound of interest (e.g., a specific glycan, lipid, nucleic acid sequence, protein, etc.). Alternatively, a particle may have multiple compounds of interest of the same type (e.g., multiple glycans, multiple lipids, multiple nucleic acid sequences, multiple proteins, etc.) or multiple compounds of interest of different types (e.g., one or more glycan and one or more lipid, etc.). Compounds of interest can be processed into a particle or attached to a core to make a particle by a variety of methods known in the art.

Particles of the present disclosure are also retrievable, meaning particles can be recovered from biological material obtained from a subject, following administration of the particles to the subject, mixing of the particles with a biological sample obtained from the subject, or mixing of the particles with an in vitro culture of gut microbial species. Recovery of particles is facilitated by the use of a tag. Particles of the present disclosure may optionally comprise a label to facilitate further separation of recovered particles for downstream analyses. In addition, particles of the present disclosure are preferably designed such that they remain substantially unaltered during transit through an intestinal tract of a subject that lacks a gut microbiota (e.g., a germ-free animal). These and other details of an artificial food particle of the present disclosure are further described below.

a) Compound of Interest

Particles of the present disclosure comprise one or more compound of interest. Non-limiting examples of suitable compounds of interest include biomolecules and drugs. The term “compound of interest” encompasses derivatives of a given compound. As used herein, a “derivative” refers to a compound that has been modified by a chemical reaction to include one or more new functional groups. For instance, non-limiting examples of a polysaccharide derivative include a cyano-ester, a cyano-ether, an isocyanide, an isonitrile, a carbylamines, a nitrile, and a carbonitrile of the polysaccharide.

In some embodiments, a particle comprises a drug or a combination of drugs. In other embodiments, a particle comprises a drug or a combination of drugs, and at least one other compound of interest. As used herein, the term “drug” refers to a compound intended for use in the diagnosis, cure, mitigation, treatment of disease, or prevention of disease. In certain embodiments, a drug may also be a type of biomolecule. Although studies on the mechanisms of action and off-target spectra of various drugs aim to improve their efficacy and reduce their side effects, the role of gut microorganisms in these processes and/or the effect of the drug on the composition of the gut microbiome is rarely considered. Particles of the present disclosure can be used to systematically test the effect of a given drug on the composition of the gut microbiota and/or microbiome, and/or identify and optionally quantify gut microbiota-dependent changes to a drug (including changes to structure and/or activity). Classes of drugs that affect the gut microbiota/microbiome composition are known in the art. For example, see, Maier et al. Nature, 2018, 555:623-628. Drugs that are affected by gut microbiota are also known in the art. For example, see, Wallace et al. Science, 2010, 330(6005): 831-835, or Zimmermann et al., Science, 2019, 363(6427). Non-limiting examples of drugs classes that may be of interest include antibiotics, antidiabetics, antihistamines, anti-inflammatories, antimetabolites, antineoplastic agents, antipsychotics, calcium-channel blockers, chemotherapeutics, hormones, proton-pump inhibitors, pscyholeptics. However, the present disclosure is not limited to any one particular drug class.

In some embodiments, a particle comprises a biomolecule or a combination of biomolecules. In other embodiments, a particle comprises a biomolecule or a combination of biomolecules, and at least one other compound of interest. In certain embodiments, a particle comprises a first biomolecule and at least one other biomolecule. The term “biomolecule” refers to carbohydrates, lipids, nucleic acids, and proteins, whether produced synthetically or by a cell or living organism. In some examples, artificial food particles may be produced using a food ingredient. Many food ingredients that are economical for use in human foods are mixtures of diverse molecular composition; they contain active and inactive fractions (from the perspective of the gut microbiota) with different structural features and biophysical availability. Without wishing to be bound by theory, it is hypothesized that the source of food ingredient (e.g., the cultivar of a food staple and/or the waste stream from food manufacturing, etc.), as well food-processing technologies may affect the molecular composition of a food ingredient. Although the use of fiber preparations and individual glycans are described in detail below and also in the Examples, these descriptions are not limiting.

In some embodiments, a particle comprises a carbohydrate. In other embodiments, a particle comprises a carbohydrate and at least one other compound of interest. In certain embodiments, a particle comprises a carbohydrate and at least one other biomolecule. A “carbohydrate,” as used herein, refers to a monosaccharide, disaccharide, oligosaccharide or a polysaccharide.

In some embodiments, a particle comprises a lipid or combination of lipids. In other embodiments, a particle comprises a lipid and at least one other compound of interest. In certain embodiments, a particle comprises a lipid or combination of lipids, and at least one other biomolecule. A “lipid,” as used herein, refers to a compound that is soluble in nonpolar solvents, and includes fatty acids, fatty acid derivatives (e.g., monoglycerides, diglycerides, triglycerides, phospholipids, etc.), sterols, and fat-soluble vitamins (e.g. vitamins, A, D, E, K, etc.). The term “lipid” includes glycolipids.

In some embodiments, a particle comprises a nucleic acid or a combination of nucleic acids. In other embodiments, a particle comprises a nucleic acid and at least one other compound of interest. In certain embodiments, a particle comprises a nucleic acid or a combination of nucleic acids, and at least one other biomolecule. The terms “polynucleotide”, “polynucleotide sequence”, “nucleotide sequence”, “nucleic acid” and “oligonucleotide” are used interchangeably. They refer to a polymeric form of nucleotides of any length, either deoxyribonucleotides or ribonucleotides, or analogs thereof. Polynucleotides may have any three dimensional structure, and may perform any function, known or unknown. The following are non-limiting examples of polynucleotides: coding or non-coding regions of a gene or gene fragment, loci (locus) defined from linkage analysis, exons, introns, messenger RNA (mRNA), transfer RNA, ribosomal RNA, short interfering RNA (siRNA), short-hairpin RNA (shRNA), micro-RNA (miRNA), ribozymes, cDNA, recombinant polynucleotides, branched polynucleotides, plasmids, vectors, isolated DNA of any sequence, isolated RNA of any sequence, nucleic acid probes, and primers. A polynucleotide may comprise one or more modified nucleotides, such as methylated nucleotides and nucleotide analogs. If present, modifications to the nucleotide structure may be imparted before or after assembly of the polymer. The sequence of nucleotides may be interrupted by non-nucleotide components. A polynucleotide may be further modified after polymerization, such as by conjugation with a labeling component.

In some embodiments, a particle comprises a protein or a combination of proteins. In other embodiments, a particle comprises a protein or a combination of proteins, and at least one other compound of interest. In certain embodiments, a particle comprises a protein and at least one other biomolecule. The terms “polypeptide,” “peptide” and “protein” are used interchangeably herein to refer to polymers of amino acids of any length. The polymer may be linear or branched, it may comprise modified amino acids, and it may be interrupted by non amino acids. The terms also encompass an amino acid polymer that has been modified; non-limiting examples of such modifications include disulfide bond formation, glycosylation, lipidation, acetylation, phosphorylation, or any other manipulation, such as conjugation with a labeling component. As used herein the term “amino acid” includes natural and/or unnatural or synthetic amino acids, including glycine and both the D or L optical isomers, and amino acid analogs and peptidomimetics.

In some embodiments, a particle comprises a glycan or a combination of glycans. In other embodiments, a particle comprises a glycan and at least one other compound of interest. In certain embodiments, a particle comprises a glycan and at least one other biomolecule. In still other embodiments, a particle comprises a first glycan and at least one other glycan. A “glycan,” as used herein, refers to a homo- or heteropolymer of two or more monosaccharides linked glycosidically. As such, the term “glycan” includes disaccharides, oligosaccharides and polysaccharides. The term also encompasses a polymer that has been modified, whether naturally or otherwise; non-limiting examples of such modifications include acetylation, alkylation, esterification, etherification, oxidation, phosphorylation, selenization, sulfonation, or any other manipulation, such as conjugation with a labeling component. Glycans may be linear or branched, may be produced synthetically or obtained from a natural source, and may or may not be purified or processed prior to use.

A glycan may be defined, in part, in terms of its monosaccharide content and its glycosyl linkages. For example, plant arabinans are composed of 1,5-α-linked L-arabinofuranosyl residues, and these can be branched at 0-2 or 0-3 by single arabinosyl residues or short side chains (Beldman et al., 1997; Ridley et al., 2001; Mohnen, 2008). 1,5-Linked arabinan structures may exist as free polymers unattached to pectic domains or attached to pectic domains (Beldman et al., 1997; Ridley et al., 2001).

As is understood in the art, due to the mechanism of side chain synthesis, a plant glycan is not a single chemical entity but is rather a mixture of glycans that have a defined backbone and variable amounts of substituents/branching. It is routine in the art to indicate the presence of variable amounts of a substituent by indicating its fractional abundance. For instance, when R₁ and R₂ are each H, the glycan depicted below is an arabinan—specifically, a polymer consisting of 1,5-α-linked L-arabinofuranosyl residues:

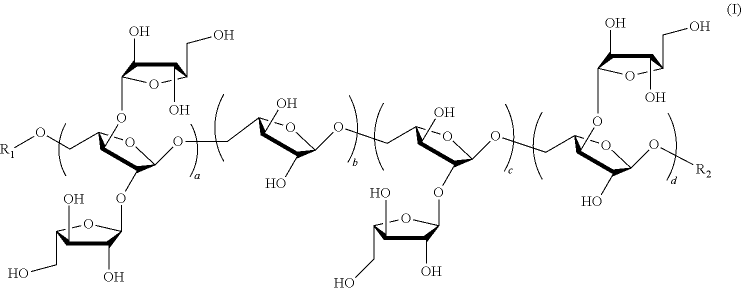

The formula indicates that (1) the polymer backbone consists of 1,5-α-linked L-arabinofuranosyl residues, and (2) there are 4 types of arabinose components—namely, component a—2,3,5-arabinofuranose, component b—5-arabinofuranose, component c—2,5-arabinofuranose, and component d—3,5-arabinofuranose. The fractional abundance of each component is indicated by the values assigned to a, b, c, and d, respectively. The sum of all the values is about 1 (allowing for a small amount of error in the measurements). A value of zero (0) indicates the component is never present in the polymer. A value of one (1) indicates the component accounts for 100% of the polymer. A value of 0.5 indicates that the component accounts for 50% of the polymer. The arrangement of the components within the polymer can vary, as is understood in the art, and is not defined by the order depicted.

Artificial food particles may be produced using a composition comprising a single glycan, or a composition comprising 2, 3, 4, 5, or more glycans (e.g., “a glycan composition”). Glycan compositions may be prepared by using commercially available preparations of a glycan, by first purifying (partially or completely) a desired glycan from a natural source, or by biological or chemical synthesis of a desired glycan. The number and specific structures of glycans to include may be informed by the intended use of the particle and/or by compositional or functional knowledge of the intended subject's gut microbiome, including but not limited to the presence/absence of certain bacterial species, the absolute or relative abundance of certain bacterial species, the level of expression of bacterial genes in polysaccharide utilization loci (PULs), and/or the abundance of bacterial PUL protein products. Additional non-glycan components may also be present in the glycan composition.

In some examples, artificial food particles may be produced using one or more glycans obtained from a fiber preparation. The glycans obtained from a fiber preparation may be partially or completely purified from a fiber preparation prior to use, or a fiber preparation may be used “as is”. Non-limiting examples of fiber preparations include citrus pectin preparations, pea fiber preparations, citrus peel preparations, yellow mustard bran preparations, soy cotyledon preparations, orange fiber preparations, orange peel preparations, tomato peel preparations, inulin preparations, potato fiber preparations, apple pectin preparations, sugar beet fiber preparations, oat hull fiber preparations, acacia extract preparations, barley beta-glucan preparations, barley bran preparations, oat beta-glucan preparations, apple fiber preparations, rye bran preparations, barley malted preparations, wheat bran preparations, wheat aleurone preparations, maltodextrin preparations (including but not limited to resistant maltodextrin preparations), psyllium preparations, cocoa preparations, citrus fiber preparations, tomato pomace preparations, rice bran preparations, chia seed preparations, corn bran preparations, soy fiber preparations, sugar cane fiber preparations, resistant starch 4 preparations. Exemplary fiber preparations are provided in Table A and the paragraphs that follow. Suitable fiber preparations also include those that are substantially similar to the exemplary fiber preparations provided in Table A and the paragraphs that follow. As demonstrated herein, a fiber preparation contains active and inactive fractions with different structural features and biophysical availability, from the perspective of the gut microbiota. Accordingly, preferred fiber preparations may also have substantially similar monosaccharide content and/or glycosyl linkages. Fiber preparations may be prepared from plant material by methods known in the art. Methods for measuring monosaccharide content and performing a glycosyl linkage analysis are known in the art, and described herein.

TABLE A
Compositional analysis of exemplary fiber preparations

| | % | % | % | HMW | LMW | % | % | % | % | % |
|---|---|---|---|---|---|---|---|---|---|---|
| | TDF | IDF | SDF | DF | DF | Prot | Fat | Carb | Moisture | Ash |
| Citrus pectin | 78.9 | 1.4 | 75.5 | 76.9 | 2 | 3.34 | 0.56 | 86.82 | 7.97 | 1.31 |
| Pea fiber | 67.2 | 61.36 | 4.94 | 66.3 | 0.8 | 9.49 | 0.93 | 79.75 | 7.37 | 2.46 |
| Citrus peel | 70.9 | 47.7 | 23.2 | 70.9 | 0.6 | 4.44 | 2.31 | 83.16 | 6.85 | 3.24 |
| Yellow mustard | 41.8 | 40.7 | 0.47 | 40.8 | 1 | 25.34 | 10.68 | 50.86 | 8.12 | 5 |
| Soy cotyledon | 62.9 | 54 | 7.5 | 61.5 | 1.4 | 24.49 | 1.48 | 60.78 | 8.41 | 4.84 |
| Orange fiber | 68.5 | 33.2 | 29.5 | 68.5 | 0.6 | 7.47 | 2.16 | 80.92 | 5.69 | 1.96 |
| (Coarse) | | | | | | | | | | |
| Orange fiber (Fine) | 68 | 28.2 | 28.1 | 66.8 | 1.1 | 9.92 | 4.13 | 78.39 | 4.74 | 1.17 |
| Orange peel | 60.1 | 42.9 | 17.2 | 60.1 | 0.6 | 6.19 | 4.03 | 79.49 | 7.36 | 2.93 |
| Tomato peel | 79.1 | 68.22 | 10.88 | 79.1 | 0.6 | 8.07 | 4.42 | 79.23 | 5.57 | 2.71 |
| Inulin, LMW | 98.5 | 0.5 | 8.5 | 86 | 12.5 | 0.4 | 1.18 | 95.14 | 3.2 | 0.08 |
| Potato Fiber | 65.5 | 53.9 | 9.9 | 63.8 | 1.7 | 7.28 | 1.48 | 79.14 | 9.41 | 2.69 |
| Apple pectin | 60 | 0.47 | 58.65 | 59.3 | 0.7 | 12.04 | 0.98 | 70.61 | 10.76 | 5.61 |
| Oat hull fiber | 95.7 | 92.86 | 2.84 | 95.7 | 0.6 | 0.35 | 0.15 | 94.3 | 3.91 | 1.29 |
| Acacia extract | 72.4 | 0.47 | 72.4 | 72.4 | 0.6 | 0.79 | 0.65 | 84.11 | 9.89 | 4.56 |
| Inulin, HMW | 90.9 | ND | ND | 59.5 | 31.3 | 0.28 | 3.71 | 91.44 | 4.28 | 0.29 |
| Barley beta-glucan | 84.6 | 0.47 | 74.4 | 81.6 | 3 | 3.08 | 1.56 | 88.45 | 5.85 | 1.06 |
| Barley bran | 46 | 11.1 | 20.8 | 45.2 | 0.9 | 18.72 | 4.13 | 69.28 | 5.69 | 1.96 |
| Oat beta-glucan | 46.6 | 25.6 | 20.3 | 45.5 | 1.1 | 21.64 | 4.98 | 65.45 | 4.07 | 3.86 |
| Apple fiber | 73.3 | 57.25 | 7.01 | 73.3 | 0.6 | 9.78 | 1.57 | 81.77 | 4.98 | 1.9 |
| Rye bran | 45.5 | 32.7 | 0.47 | 41.5 | 4 | 13.58 | 4.8 | 70.01 | 6.48 | 5.13 |
| Barley malted | 42.2 | 39.5 | 0.47 | 41.1 | 1.1 | 16.89 | 10.53 | 63.52 | 6.15 | 2.91 |
| Wheat aleurone | 43.7 | 39.89 | 0.47 | 42.3 | 1.5 | 13.64 | 9.05 | 63.55 | 7.14 | 6.62 |
| Wheat bran | 30.2 | 24.54 | 3.46 | 28 | 2.2 | 14.06 | 5.08 | 67.12 | 9.7 | 4.04 |
| Resistant | 72.3 | 0.47 | 1.8 | 1.8 | 70.5 | 0.71 | 0.08 | 95.52 | 3.77 | 0.04 |
| maltodextrin | | | | | | | | | | |
| Psyllium | 95.6 | 87.8 | 3.6 | 91.4 | 4.2 | 1.63 | 0.74 | 88.08 | 6.98 | 2.57 |
| Cocoa | 31.6 | 21.5 | 9.3 | 30.8 | 0.9 | 27.81 | 12.61 | 50.29 | 2.67 | 6.62 |
| Citrus fiber | 91 | 85.3 | 4.7 | 91 | 0.6 | 0.61 | 1.23 | 90.07 | 3.51 | 4.58 |
| Tomato pomace | 56.7 | 49.1 | 7.6 | 56.7 | 0.6 | 15.63 | 14.37 | 62.26 | 4.76 | 2.98 |
| Rice bran | 23.5 | 22.19 | 0.61 | 22.8 | 0.7 | 15.13 | 21.62 | 49.88 | 5.21 | 8.16 |
| Chia seed | 40.8 | 39.17 | 1.63 | 40.8 | 0.6 | 22.07 | 36.91 | 30.67 | 5.62 | 4.73 |
| Corn bran | 76.8 | 72.34 | 4.46 | 76.8 | 0.6 | 4.97 | 4.08 | 83.9 | 6.09 | 0.96 |
| Soy fiber | 93.8 | 89.29 | 3.11 | 92.4 | TBD | 1.58 | 1.05 | 89.97 | 4.88 | 2.52 |
| Sugar cane fiber | 95.6 | 90.6 | 5 | 95.6 | 0.6 | 0.12 | 0.15 | 93.36 | 6.11 | 0.38 |
| Resistant starch 4 | 90.7 | 70.3 | 20.4 | 90.7 | 0.6 | 0.12 | 0.08 | 86.48 | 11.72 | 1.8 |

Abbreviations:
dietary fiber (DF),
total dietary fiber (TDF),
insoluble dietary fiber (IDF),
soluble dietary fiber (SDF),
high molecular weight (HMW),
low molecular weight (LMW),
protein (Prot),
carbohydrate (Carb),
not determined (ND)

(i) Barley Fiber Preparations

In some embodiments, an artificial food particle may be produced using one or more glycan obtained from a barley fiber preparation. Barley fiber preparations may be prepared according to methods known in the art, and evaluated as described herein. Commercial sources may also be used.

In some embodiments, a composition comprises one or more barley fiber preparation in an amount that does not exceed 45 wt % of the composition. The amount may also be expressed as individual values or a range. For instance, the barley fiber preparation(s) in these embodiments may be about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, or 45 wt %. In some examples, the barley fiber preparation(s) may be about 1 wt % to about 45 wt %, about 10 wt % to about 45 wt %, or about 20 wt % to about 45 wt % of the composition. In some examples, the barley fiber preparation(s) may be about 1 wt % to about 25 wt % or about 10 wt % to about 25 wt % of the composition, or about 1 wt % to about 20 wt % or about 10 wt % to about 20 wt % of the composition.

In an exemplary embodiment of a suitable barley fiber preparation, the total dietary fiber is comprised of about 5 wt % to about 15 wt %, or about 10 wt % to about 15% of insoluble dietary fiber and/or about 40 wt % to about 50 wt %, or about 42 wt % to about 47 wt % of high molecular weight dietary fiber. In some embodiments, the total dietary fiber is about 35 wt % to about 55 wt %, about 40 wt % to about 55 wt %, or about 45 wt % to about 55 wt % of the preparation. In other embodiments, the total dietary fiber is about 35 wt % to about 50 wt % or about 30 wt % to about 45 wt % of the preparation. In still further embodiments, the barley fiber preparation comprises about 15 wt % to about 20 wt % protein, about 2 wt % to about 5 wt % fat, about 65 wt % to about 75 wt % carbohydrate, about 2 wt % to about 7 wt % moisture, and about 1 wt % to about 3 wt % ash.

In another exemplary embodiment of a suitable barley fiber preparation, the total dietary fiber is comprised of about 5 wt % to about 15 wt %, or about 10 wt % to about 15% of insoluble dietary fiber and about 40 wt % to about 50 wt %, or about 42 wt % to about 47 wt % of high molecular weight dietary fiber; the total dietary fiber is about 35 wt % to about 55 wt %, about 40 wt % to about 55 wt %, or about 45 wt % to about 55 wt % of the preparation; and the barley fiber preparation comprises about 15 wt % to about 20 wt % protein, about 2 wt % to about 5 wt % fat, about 65 wt % to about 75 wt % carbohydrate, about 2 wt % to about 7 wt % moisture, and about 1 wt % to about 3 wt % ash.

In another exemplary embodiment, a suitable barley fiber preparation is substantially similar to the preparation described in Table B.

In each of the embodiments, a suitable barley fiber preparation may also have a monosaccharide content that is substantially similar to the preparation exemplified in Table C; glycosyl linkages substantially similar to the preparation exemplified in Table F, or both.

In another exemplary embodiment, a suitable barley fiber preparation has a monosaccharide content that is substantially similar to the preparation exemplified in Table B and glycosyl linkages that are substantially similar to the preparation exemplified in Table E

(ii) Citrus Fiber Preparations

In some embodiments, an artificial food particle may be produced using one or more glycan obtained from a citrus fiber preparation.

Citrus fiber preparations may be prepared according to methods known in the art from citrus fruits including, but not limited to, clementine, citron, grapefruit, kumquat, lemon, lime, orange, tangelo, tangerine, and yuzu, and evaluated as described herein. Commercial sources may also be used.

In some embodiments, a composition comprises one or more citrus fiber preparation in an amount that does not exceed 25 wt % of the composition. The amount may also be expressed as individual values or a range. For instance, the citrus fiber preparation(s) in these embodiments may be about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, or 25 wt %. In some examples, the citrus fiber preparation(s) may be about 1 wt % to about 25 wt %, about 1 wt % to about 20 wt %, or about 1 wt % to about 15 wt % of the composition. In some examples, the citrus fiber preparation(s) may be about 5 wt % to about 25 wt %, about 5 wt % to about 20 wt %, or about 5 wt % to about 15 wt % of the composition. In some examples, the citrus fiber preparation(s) may be about 10 wt % to about 25 wt %, about 10 wt % to about 20 wt %, or about 10 wt % to about 15 wt % of the composition.

In an exemplary embodiment of a suitable citrus fiber preparation, the total dietary fiber is comprised of about 30 wt % to about 40 wt %, or about 30 wt % to about 35% of insoluble dietary fiber and/or about 65 wt % to about 75 wt %, or about 65 wt % to about 70 wt % of high molecular weight dietary fiber. In some embodiments, the total dietary fiber is about 60 wt % to about 80 wt %, about 60 wt % to about 75 wt %, or about 60 wt % to about 70 wt % of the preparation. In other embodiments, the total dietary fiber is about 65 wt % to about 80 wt %, about 65 wt % to about 75 wt %, or about 65 wt % to about 70 wt % of the preparation. In still further embodiments, the citrus fiber preparation comprises about 5 wt % to about 10 wt % protein, about 1 wt % to about 3 wt % fat, about 75 wt % to about 85 wt % carbohydrate, about 5 wt % to about 10 wt % moisture, and about 1 wt % to about 4 wt % ash.

In another exemplary embodiment of a suitable citrus fiber preparation, the total dietary fiber is comprised of about 30 wt % to about 40 wt %, or about 30 wt % to about 35% of insoluble dietary fiber and/or about 65 wt % to about 75 wt %, or about 65 wt % to about 70 wt % of high molecular weight dietary fiber; the total dietary fiber is about 65 wt % to about 80 wt %, about 65 wt % to about 75 wt %, or about 65 wt % to about 70 wt % of the preparation; and the citrus fiber preparation comprises about 5 wt % to about 10 wt % protein, about 1 wt % to about 3 wt % fat, about 75 wt % to about 85 wt % carbohydrate, about 5 wt % to about 10 wt % moisture, and about 1 wt % to about 4 wt % ash.

In another exemplary embodiment, a suitable citrus fiber preparation is substantially similar to the preparation described in Table B.

In each of the above embodiments, a suitable citrus fiber preparation may also have a monosaccharide content that is substantially similar to the preparation described in Table C; glycosyl linkages substantially similar to the preparation exemplified in Table G; or both.

In another exemplary embodiment, a suitable citrus fiber preparation has a monosaccharide content that is substantially similar to the preparation exemplified in Table C and glycosyl linkages that are substantially similar to the preparation exemplified in Table G.

(iii) Citrus Pectin Preparations

In some embodiments, an artificial food particle may be produced using one or more glycan obtained from a citrus pectin preparation. Citrus pectin preparations may be prepared according to methods known in the art from citrus fruits including, but not limited to, clementine, citron, grapefruit, kumquat, lemon, lime, orange, tangelo, tangerine, and yuzu, and evaluated as described herein. Commercial sources may also be used.

In some embodiments, a composition comprises one or more citrus pectin preparation in an amount that does not exceed 10 wt % of the composition. The amount may also be expressed as individual values or a range. For instance, the amount of citrus pectin in these embodiments may be about 1 wt %, 2 wt %, 3 wt %, 4 wt %, 5 wt %, 6 wt %, 7 wt %, 8 wt %, 9 wt %, or 10 wt %. In some examples, the citrus pectin preparation(s) may be about 1 wt % to about 10 wt %, about 1 wt % to about 8 wt %, or about 1 wt % to about 6 wt % of the composition. In some examples, the citrus pectin preparation(s) may be about 1 wt % to about 4 wt %, or about 1 wt % to about 2 wt % of the composition.

In an exemplary embodiment of a suitable citrus pectin preparation, the total dietary fiber is comprised of about 1 wt % to about 10 wt %, or about 1 wt % to about 5% of insoluble dietary fiber and/or about 85 wt % to about 95 wt %, or about 90 wt % to about 95 wt % of high molecular weight dietary fiber. In some embodiments, the total dietary fiber is about 75 wt % to about 95 wt %, about 80 wt % to about 95 wt %, or about 85 wt % to about 95 wt % of the preparation. In other embodiments, the total dietary fiber is about 85 wt % to about 90 wt % or about 90 wt % to about 95 wt % of the preparation. In still further embodiments, the citrus pectin preparation comprises about 2 wt % or less of protein, about 1 wt % to about 2 wt % fat, about 85 wt % to about 95 wt % carbohydrate, about 1 wt % to about 6 wt % moisture, and about 3 wt % to about 6 wt % ash.

In another exemplary embodiment of a suitable citrus pectin preparation, the total dietary fiber is comprised of about 1 wt % to about 10 wt %, or about 1 wt % to about 5% of insoluble dietary fiber and about 85 wt % to about 95 wt %, or about 90 wt % to about 95 wt % of high molecular weight dietary fiber; the total dietary fiber is about 85 wt % to about 95 wt %, about 85 wt % to about 90 wt %, or about 90 wt % to about 95 wt % of the preparation; and the citrus pectin preparation comprises about 2 wt % or less of protein, about 1 wt % to about 2 wt % fat, about 85 wt % to about 95 wt % carbohydrate, about 1 wt % to about 6 wt % moisture, and about 3 wt % to about 6 wt % ash.

In another exemplary embodiment, a suitable citrus pectin preparation is substantially similar to the preparation described in Table B.

In each of the above embodiments, a suitable citrus fiber preparation may also have a monosaccharide content substantially similar to the preparation exemplified in Table C; glycosyl linkages substantially similar to the preparation exemplified in Table E; or both.

In another exemplary embodiment, a suitable citrus pectin preparation has a monosaccharide content that is substantially similar to the preparation exemplified in Table C and glycosyl linkages that are substantially similar to the preparation exemplified in Table G.

(iv) High Molecular Weight Inulin Preparations

In some embodiments, an artificial food particle may be produced using one or more glycan obtained from a high molecular weight inulin preparation. Inulin is defined by AOAC method 999.03.

High molecular weight inulin is comprised of fructose units linked together by β-(2,1)-linkages, which are typically terminated by a glucose unit. High molecular weight inulin preparations may be prepared according to methods known in the art, and evaluated as described herein. Commercial sources may also be used.

In some embodiments, a composition comprises one or more high molecular weight inulin preparation in an amount that is at least 28 wt % of the composition. The amount may also be expressed as individual values or a range. For instance, the high molecular weight inulin preparation(s) in these embodiments may be about 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, or more. In some examples, the high molecular weight inulin preparation(s) may be about 30 wt % to about 50 wt %, about 30 wt % to about 45 wt %, or about 30 wt % to about 40 wt % of the composition. In some examples, the high molecular weight inulin preparation(s) may be about 35 wt % to about 50 wt %, about 35 wt % to about 45 wt %, or about 35 wt % to about 40 wt % of the composition. Inulin is defined by AOAC method 999.03.

In an exemplary embodiment of a suitable high molecular weight inulin preparation, the total dietary fiber is comprised of about 0.5 wt % or less of insoluble dietary fiber and/or about 55 wt % to about 65 wt %, or about 57 wt % to about 62 wt % of high molecular weight dietary fiber. In some embodiments, the total dietary fiber is about 75 wt % to about 95 wt %, about 80 wt % to about 95 wt %, or about 85 wt % to about 95 wt % of the preparation. In other embodiments, the total dietary fiber is about 85 wt % to about 99 wt %, 90 wt % to about 99 wt %, or about 95 wt % to about 99 wt % of the preparation. In still further embodiments, the high molecular weight inulin preparation comprises no more than 1 wt % of protein, about 2 wt % to about 5 wt % fat, about 85 wt % to about 95 wt % carbohydrate, about 2 wt % to about 7 wt % moisture, and no more than 2 wt % ash.

In an exemplary embodiment of a suitable high molecular weight inulin preparation, the total dietary fiber is comprised of about 0.5 wt % insoluble dietary fiber and about 55 wt % to about 65 wt %, or about 57 wt % to about 62 wt % of high molecular weight dietary fiber; the total dietary fiber is about 85 wt % to about 99 wt %, 90 wt % to about 99 wt %, or about 95 wt % to about 99 wt % of the preparation; and the high molecular weight inulin preparation comprises no more than 1 wt % of protein, about 2 wt % to about 5 wt % fat, about 85 wt % to about 95 wt % carbohydrate, about 2 wt % to about 7 wt % moisture, and no more than 2 wt % ash.

In another exemplary embodiment, a suitable high molecular weight inulin preparation is substantially similar to the preparation described in Table B.

In each of the above embodiments, about 99% of the inulin in a suitable high molecular weight inulin preparation may have a degree of polymerization (DP) that is greater than or equal to 5. In some example, the DP for the inulin in a suitable preparation may range from 5 to 60. Alternatively or in addition, the average DP may be less than or equal to 23.

(v) Pea Fiber Preparations

In some embodiments, an artificial food particle may be produced using one or more glycan obtained from a pea fiber preparation. Pea fiber preparations may be prepared according to methods known in the art, and evaluated as described herein. Commercial sources may also be used.

In some embodiments, a composition comprises one or more pea fiber preparation in an amount that is at least 15 wt % of the composition. The amount may also be expressed as individual values or a range. For instance, the pea fiber preparation(s) in these embodiments may be about 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, or more. In some examples, the pea fiber preparation(s) may be about 15 wt % to about 75 wt %, about 25 wt % to about 75 wt %, or about 35 wt % to about 75 wt % of the composition. In some examples, the pea fiber preparation(s) may be about 15 wt % to about 65 wt %, about 25 wt % to about 65 wt %, or about 35 wt % to about 65 wt % of the composition. In some examples, the pea fiber preparation(s) may be about 30 wt % to about 85 wt %, about 40 wt % to about 85 wt %, or about 50 wt % to about 85 wt % of the composition.

In an exemplary embodiment of a suitable pea fiber preparation, the total dietary fiber is comprised of about 55 wt % to about 65 wt %, or about 60 wt % to about 65% of insoluble dietary fiber and/or about 60 wt % to about 70 wt %, or about 65 wt % to about 70 wt % of high molecular weight dietary fiber. In some embodiments, the total dietary fiber is about 60 wt % to about 80 wt %, about 60 wt % to about 75 wt %, or about 60 wt % to about 70 wt % of the preparation. In other embodiments, the total dietary fiber is about 65 wt % to about 80 wt %, about 65 wt % to about 75 wt %, or about 65 wt % to about 70 wt % of the preparation. In still further embodiments, the pea fiber preparation comprises about 7 wt % to about 12 wt % protein, no more than 2 wt % fat, about 75 wt % to about 85 wt % carbohydrate, about 5 wt % to about 10 wt % moisture, and about 1 wt % to about 4 wt % ash.

In an exemplary embodiment of a suitable pea fiber preparation, the total dietary fiber is comprised of about 55 wt % to about 65 wt %, or about 60 wt % to about 65% of insoluble dietary fiber and about 60 wt % to about 70 wt %, or about 65 wt % to about 70 wt % of high molecular weight dietary fiber; the total dietary fiber is about 65 wt % to about 80 wt %, about 65 wt % to about 75 wt %, or about 65 wt % to about 70 wt % of the preparation; and the pea fiber preparation comprises about 7 wt % to about 12 wt % protein, no more than 2 wt % fat, about 75 wt % to about 85 wt % carbohydrate, about 5 wt % to about 10 wt % moisture, and about 1 wt % to about 4 wt % ash.

In another exemplary embodiment, a suitable pea fiber preparation is substantially similar to the preparation described in Table B.

In each of the above embodiments, a suitable pea fiber preparation may also have a monosaccharide content that is substantially similar to the preparation exemplified in Table C; glycosyl linkages substantially similar to the preparation exemplified in Table D, Table 13, Table 14, Table 16, or Table 17; or both.

In another exemplary embodiment, a suitable pea fiber preparation has a monosaccharide content that is substantially similar to the preparation exemplified in Table B and glycosyl linkages that are substantially similar to the preparation exemplified in Table C, Table 13, Table 14, Table 16, or Table 17.

In another exemplary embodiment a suitable pea fiber preparation has a monosaccharide content that has about 10 wt % to about 90 wt % arabinose, and arabinose linkages that are substantially similar to the preparation exemplified in Table C, Table 13, Table 14, Table 16, or Table 17. In some examples, arabinose may be about 10 wt % to 20 wt %, or about 15 wt % to about 20 wt %. In some examples, arabinose may be about 20 wt % to 30 wt %, about 20 wt % to about 25 wt %, or about 25 wt % to about 30 wt %. In some examples, arabinose may be about 50 wt % to 90 wt %, about 60 wt % to about 90 wt %, or about 70 wt % to about 90 wt %. In some examples, arabinose may be about 50 wt % to 80 wt %, about 60 wt % to about 80 wt %, or about 70 wt % to about 80 wt %.

In another exemplary embodiment, a suitable pea fiber preparation has a monosaccharide content that has a substantially similar arabinose content as the preparation exemplified in Table B and arabinose glycosyl linkages that are substantially similar to the preparation exemplified in Table C, Table 13, Table 14, Table 16, or Table 17.

In another exemplary embodiment, a suitable pea fiber preparation is substantially similar to the Fiber 8 fraction or the enzymatically destarched Fiber 8 fraction described in Example 10.

In all the aforementioned, a suitable pea fiber preparation may also comprise arabinan of formula (I):

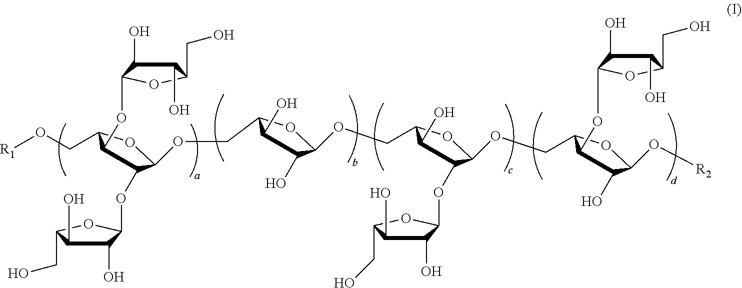

wherein a is about 0.1 to about 0.3, b is about 0.4 to about 0.6, c is about 0.1 to about 0.4, d is about 0.04 to about 0.06 (calculated from the fractional abundance of arabinose linkages where the arabinose contained a 5-linkage, as determined by partially methylated alditol acetate GC-MS analysis); and wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

Alternatively, in all the aforementioned embodiments, a suitable pea fiber preparation may also comprise arabinan of formula (I):

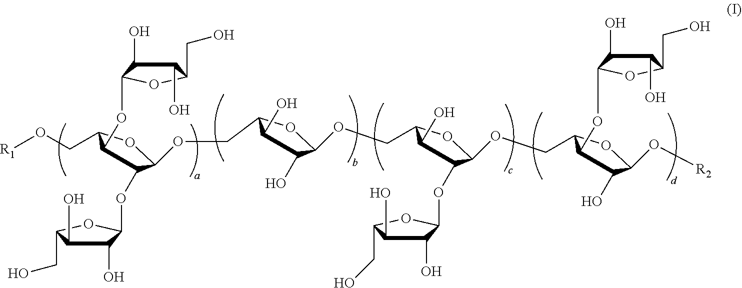

wherein a is about 0.2 to about 0.3, b is about 0.5 to about 0.6, c is about 0.2 to about 0.4, d is about 0.04 to about 0.06 (calculated from the fractional abundance of arabinose linkages where the arabinose contained a 5-linkage, as determined by partially methylated alditol acetate GC-MS analysis); and wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

Alternatively, in all the aforementioned embodiments, a suitable pea fiber preparation may also comprise arabinan of formula (I):

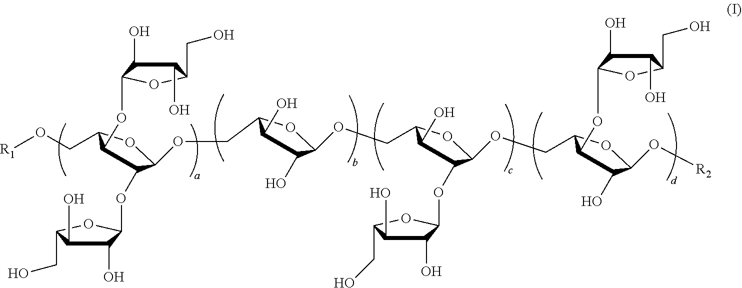

wherein a is about 0.1 to about 0.2, b is about 0.4 to about 0.5, c is about 0.2 to about 0.4, d is about 0.04 to about 0.06 (calculated from the fractional abundance of arabinose linkages where the arabinose contained a 5-linkage, as determined by partially methylated alditol acetate GC-MS analysis); and wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

Alternatively, in all the aforementioned embodiments, a suitable pea fiber preparation may also comprise arabinan of formula (I):

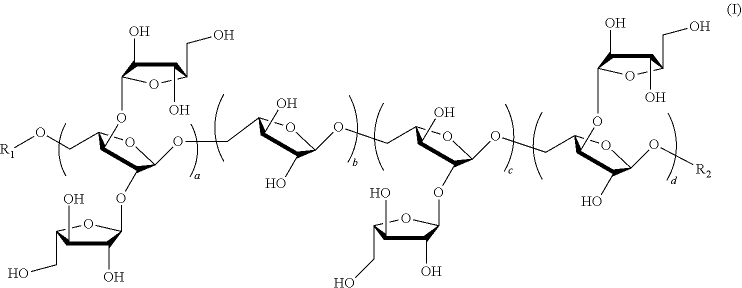

wherein a is about 0.2 to about 0.3, b is about 0.4 to about 0.5, c is about 0.3 to about 0.4, d is about 0.04 to about 0.06 (calculated from the fractional abundance of arabinose linkages where the arabinose contained a 5-linkage, as determined by partially methylated alditol acetate GC-MS analysis); wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

Alternatively, in all the aforementioned embodiments, a suitable pea fiber preparation may also comprise arabinan of formula (I):

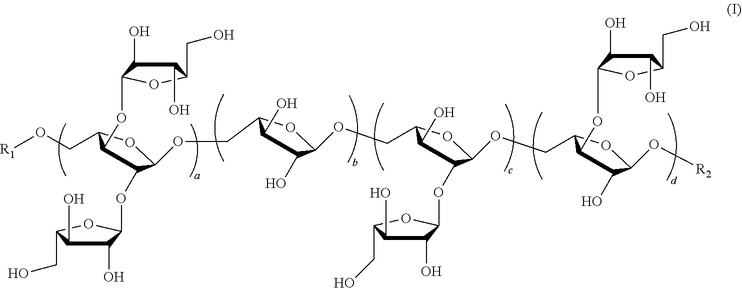

wherein a is about 0.20, b is about 0.47, c is about 0.28, d is about 0.05 (calculated from the fractional abundance of arabinose linkages where the arabinose contained a 5-linkage, as determined by partially methylated alditol acetate GC-MS analysis); wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

The molecular weight of the arabinan may be about 2 kDa to about 500,000 kDa, or more. In one example, the molecular weight of the arabinan may be about 1000 kDa to about 500,000 kDa. In one example, the molecular weight of the arabinan may be about 1000 kDa to about 200,000 kDa. In one example, the molecular weight of the arabinan may be about 1000 kDa to about 100,000 kDa. In one example, the molecular weight of the arabinan may be about 1000 kDa to about 10,000 kDa. In one example, the molecular weight of the arabinan may be about 10,000 kDa to about 500,000 kDa. In one example, the molecular weight of the arabinan may be about 10,000 kDa to about 200,000 kDa. In one example, the molecular weight of the arabinan may be about 100,000 kDa to about 500,000 kDa.

The total amount of all arabinans of formula (I) in a suitable pea fiber preparation may vary. In some embodiments, the total amount may be at least 10 wt %. For example, the total amount may be about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %. In some embodiments, the total amount may be at least 20 wt %, at least 30 wt %, at least 40 wt %, at least 50 wt %, at least, 60 wt %, at least, 70 wt %, at least, 80 wt %, at least 90 wt %. In some embodiments, the total amount may be about 10 wt % to about 50 wt %, about 20 wt % to about 50 wt %, about 30 wt % to about 50 wt %, about 40 wt % to about 50 wt %. In some embodiments, the total amount may be about 30 wt % to about 70 wt %, about 40 wt % to about 70 wt %, about 50 wt % to about 70 wt %, about 60 wt % to about 70 wt %. In some embodiments, the total amount may be about 50 wt % to about 90 wt %, about 60 wt % to about 90 wt %, about 70 wt % to about 90 wt %, about 80 wt % to about 90 wt %.

(vi) Sugar Beet Fiber Preparations:

In some embodiments, an artificial food particle may be produced using one or more glycan obtained from a sugar beet fiber preparation. Sugar beet fiber preparations may be prepared according to methods known in the art, and evaluated as described herein. Commercial sources may also be used.

In some embodiments, a composition comprises one or more sugar beet fiber preparation in an amount that is at least 15 wt % of the composition. The amount may also be expressed as individual values or a range. For instance, the pea fiber preparation(s) in these embodiments may be about 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, or more. In some examples, the sugar beet fiber preparation(s) may be about 15 wt % to about 65 wt %, about 25 wt % to about 65 wt %, or about 35 wt % to about 65 wt % of the composition. In some examples, the sugar beet fiber preparation(s) may be about 15 wt % to about 55 wt %, about 25 wt % to about 55 wt %, or about 35 wt % to about 55 wt % of the composition. In some examples, the sugar beet fiber preparation(s) may be about 15 wt % to about 45 wt %, about 25 wt % to about 45 wt %, or about 35 wt % to about 45 wt % of the composition.

In an exemplary embodiment of a suitable sugar beet fiber preparation, the total dietary fiber is comprised of about 55 wt % to about 65 wt %, or about 60 wt % to about 65% of insoluble dietary fiber and/or about 75 wt % to about 85 wt %, or about 80 wt % to about 85 wt % of high molecular weight dietary fiber. In some embodiments, the total dietary fiber is about 70 wt % to about 90 wt %, about 70 wt % to about 85 wt %, or about 70 wt % to about 80 wt % of the preparation. In other embodiments, the total dietary fiber is about 75 wt % to about 90 wt %, about 80 wt % to about 90 wt %, or about 80 wt % to about 85 wt % of the preparation. In still further embodiments, the sugar beet fiber preparation comprises about 7 wt % to about 12 wt % protein, about 1 wt % to about 3 wt % fat, about 75 wt % to about 85 wt % carbohydrate, about 5 wt % to about 10 wt % moisture, and about 3 wt % to about 6 wt % ash.

In an exemplary embodiment of a suitable sugar beet fiber preparation, the total dietary fiber is comprised of about 55 wt % to about 65 wt %, or about 60 wt % to about 65% of insoluble dietary fiber and about 75 wt % to about 85 wt %, or about 80 wt % to about 85 wt % of high molecular weight dietary fiber, the total dietary fiber is about 75 wt % to about 90 wt %, about 80 wt % to about 90 wt %, or about 80 wt % to about 85 wt % of the preparation; and the sugar beet fiber preparation comprises about 7 wt % to about 12 wt % protein, about 1 wt % to about 3 wt % fat, about 75 wt % to about 85 wt % carbohydrate, about 5 wt % to about 10 wt % moisture, and about 3 wt % to about 6 wt % ash.

In another exemplary embodiment, a suitable sugar beet preparation is substantially similar to the preparation described in Table B.

(vii) Glycan Equivalents

In each of the above embodiments, a compositional glycan equivalent thereof and/or a functional glycan equivalent thereof may be used as an alternative for a barley fiber preparation, a citrus fiber preparation, a citrus pectin preparation, a high molecular weight inulin preparation, a pea fiber preparation, and/or a sugar beet fiber preparation.

In some embodiments, a suitable functional glycan equivalent of a barley fiber preparation, a citrus fiber preparation, a citrus pectin preparation, a high molecular weight inulin preparation, a pea fiber preparation, or a sugar beet fiber preparation has a substantially similar function as a respective preparation identified in Table 2A. Substantially similar function may be measured by any one or more method detailed in the Examples herein, in particular the ability to affect relative or total abundances of microbial community members, in particular primary and secondary fiber degrading microbes, more particularly Bacteroides species; and/or expression of one or more microbial genes or gene product, in particular one or more gene or gene product encoded by polysaccharide utilization loci (PULs) and/or one or more CAZyme. In an exemplary embodiment, a suitable functional glycan equivalent is a fiber preparation that is enriched for one or more bioactive glycan, as compared to a barley fiber preparation, a citrus fiber preparation, a citrus pectin preparation, a high molecular weight inulin preparation, a pea fiber preparation, or a sugar beet fiber preparation used in the Examples.

For instance, a suitable functional glycan equivalent of a fiber preparation may have a similar effect on the relative abundance of Bacteroides species in a subject's gut microbiota. In another example, a suitable functional glycan equivalent of a fiber preparation may have a similar effect on the total abundance of Bacteroides species in a subject's gut microbiota. In another example, a suitable functional glycan equivalent of a fiber preparation may have a similar effect on the relative abundance of a subset of Bacteroides species. In another example, a suitable functional glycan equivalent of a fiber preparation may have a similar effect on the total abundance of a subset of Bacteroides species. In one example, the subset of Bacteroides species may include one or more species chosen from B. caccae, B. cellulosilyticus, B. finegoldfi, B. massiliensis, B. ovatus, B. thetaiotaomicron, and B. vulgatus. In another example, a suitable functional glycan equivalent may have a similar effect on the relative abundance of one or more species chosen from Bacteroides ovatus, Bacteroides cellulosilyticus, Bacteroides thetaiotaomicron, Bacteroides vulgatus, Bacteroides caccae, Bacteroides finegoldfi, Bacteroides massiliensis, Collinsella aerofaciens, Escherichia coli, Odoribacter splanchnicus, Parabacteroides distasonis, a Ruminococcaceae sp., and Subdoligranulum variabile.

Alternatively or in addition, a suitable functional glycan equivalent may have a similar effect on the abundance or activity of one or more protein encoded by one or more polysaccharide utilization locus (PUL) and/or one or more CAZyme. In some examples, the PULs are chosen from PUL5, PULE, PUL7, PUL27, PUL31, PUL34, PUL35, PUL38, PUL42, PUL43, PUL73, PUL75, PUL83, and PUL97.

Although the Examples utilize a gnotobiotic mouse model where the mouse is colonized with a defined gut microbiota, the methods detailed in the Examples may also be used to measure effects in a gnotobiotic mouse model where the mouse is colonized with intact uncultured gut microbiota obtained from human(s), as well as to measure effects directly in humans.

(viii) Bioactive Glycans

Applicants have identified fiber preparations that promote a healthy gut microbiota in a subject, and further discovered that each fiber preparation has a number of bioactive glycans responsible for the observed beneficial effect(s). Thus, in another aspect, the present disclosure provides a composition comprising an enriched amount of a bioactive glycan, wherein “an enriched amount” refers to an amount of the bioactive glycan that is more than is found in a naturally occurring plant or plant part, and more than is found in commercially available fiber preparations. A composition comprising an enriched amount of a bioactive glycan may be a purified (partially or completely) fraction from a commercially available fiber preparation. Alternatively, a composition comprising an enriched amount of a bioactive glycan may comprise a chemically synthesized version of the bioactive glycan. The bioactive glycan may be enriched by about 10 wt % wt to about 50 wt %, about 50 wt % to about 100 wt % or more. For instance, the bioactive glycan may be enriched by about 2-fold, about 3-fold, about 4-fold, about 5-fold, about 6-fold, about 7-fold, about 8-fold, about 9-fold, about 10-fold or more. In another example, the bioactive glycan may be enriched by about 20-fold, about 30-fold, about 40-fold, about 50-fold, about 60-fold, about 70-fold, about 80-fold, about 90-fold, about 100-fold or more. In another example, the bioactive glycan may be enriched by about 500-fold, 1000-fold, or more.

Bioactive glycans of barley fiber, citrus fiber, citrus pectin, high molecular weight inulin, pea fiber, and sugar beet can be identified as detailed herein. For instance, a bioactive glycan of pea fiber includes a compound of formula (I), wherein m is 0.14; n is 1; p is >0.1; and R₁ is a pectic fragment:

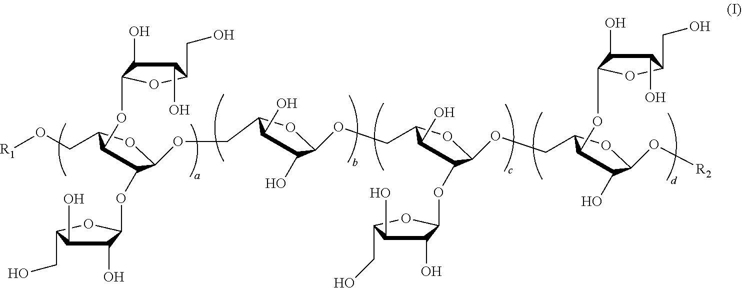

Example 12 describes methods for obtaining a composition that is enriched for this bioactive glycan. Alternative purification methods may be used to obtain a composition that is enriched for this bioactive glycan. Alternatively, a chemically synthesized version of the bioactive glycan may be used.

TABLE B
Compositional Analysis of Fiber Preparations

| | % | % | % | | | | | | | |
|---|---|---|---|---|---|---|---|---|---|---|
| Fiber | Total | Insoluble | Soluble | HMW | LMW | % | % | % | % | % |
| Preparation | DF | DF | DF | DF | DF | Protein | Fat | Carb | Moisture | Ash |
| Barley bran | 46 | 11.1 | 20.8 | 45.2 | 0.9 | 18.72 | 4.13 | 69.28 | 5.69 | 1.96 |
| Citrus fiber | 68.5 | 33.2 | 29.5 | 68.5 | 0.6 | 7.47 | 2.16 | 80.92 | 5.69 | 1.96 |
| Citrus pectin | 91 | 4.7 | 85.3 | 91 | 0.6 | 0.61 | 1.23 | 90.07 | 3.51 | 4.58 |
| HMW inulin | 98.5 | <0.5 | 98.5 | 86 | 12.5 | 0.28 | 3.71 | 91.44 | 4.28 | 0.29 |
| Pea fiber | 67.2 | 61.4 | 4.9 | 66.3 | 0.8 | 9.49 | 0.93 | 79.75 | 7.37 | 2.46 |
| Sugar beet | 83.2 | 61.6 | 20.4 | 82 | 1.1 | 8.5 | 2.45 | 77.97 | 6.66 | 4.42 |

DF = dietary fiber,
HMW = high molecular weight,
LMW = low molecular weight
Protein, fat, ash, and moisture content are measured by methods established by Association of Official Analytical Chemists (AOAC) 2009.01, AOAC 920.123, AOAC 933.05, AOAC 935.42, and AOAC 926.08, respectively.
Carbohydrate is calculated as (100 − (Protein + Fat + Ash + Moisture). Total dietary fiber is measured by AOAC method 2009.01. Soluble and insoluble dietary fiber, and high molecular weight and low molecular weight dietary fiber, are measured by AOAC method 2011.25.

TABLE C
Monosaccharide Analysis of Fiber Preparations

| | Barley | Citrus | Citrus | Pea |
|---|---|---|---|---|
| | fiber | fiber | pectin | fiber |
| Water | 5.7 | 7.2 | 8 | 7.4 |
| Rhamnose | 0 | 1 | 0.8 | 0 |
| Arabinose | 4.5 | 9.9 | 4.1 | 17.3 |
| Xylose | 6.1 | 2.3 | 0 | 4.8 |
| Mannose | 0.9 | 2.7 | 1.4 | 0.5 |
| Galactose | 0.5 | 4.5 | 4.1 | 2.6 |
| Glucose | 48.9 | 17.5 | 0.3 | 38.9 |
| Uronic acids | 0.8 | 45.9 | 71.6 | 13.4 |
| Degree of methylation (%) | 0 | 29 | 72 | 16 |
| Total Carbohydrates | 61.7 | 83.8 | 82.3 | 77.5 |
| Starch | 22 | ND | ND | 16.6 |
| Beta-glucans | 17 | ND | ND | ND |

ND = none detected
Monosaccharide analysis was performed as described in Example 8. Briefly, samples were hydrolyzed with 1M H₂SO₄ for 2 h at 100° C. and individual neutral sugars were analyzed as their alditol acetate derivatives (Englyst and Cummings, 1988) by gas chromatography. To fully release glucose from cellulose, a pre-hydrolysis step was carried out by incubation in 72% H₂SO₄ for 30 minutes at 25° C. prior to the hydrolysis step.

TABLE D
Glycosyl-linkage analysis of a pea fiber preparation
(see Example 10 for a description of the methodology)

| | Σ linked- | Σ linked- | | | | | | | | |
|---|---|---|---|---|---|---|---|---|---|---|
| | sugars/ | sugars/ | Deduced | %/Σ sugars | | | | | | |
| | DW | sugars | linkage | Rha | Ara | Xyl | Gal | Glc | Man | UA |
| Rha | | 1.3% | Terminal | 0.05 | | | | | | |
| | | | Rha(p) | | | | | | | |
| | | | 2-Rha(p) | 0.4 | | | | | | |
| | | | 2,4-Rha(p) | 0.8 | | | | | | |
| Ara | | 26.6% | Terminal Ara(f) | | 9.4 | | | | | |
| | | | 5-Ara(f) | | 12 | | | | | |
| | | | 2,5-Ara(f) | | 3.5 | | | | | |
| | | | 3.5-Ara(f) | | 1.4 | | | | | |
| Xyl | | 8.2% | Terminal Xyl(p) | | | 1.3 | | | | |
| | | | 4-Xyl(p) | | | 6.9 | | | | |
| Gal | | 5.1% | Terminal Gal(p) | | | | 0.5 | | | |
| | | | 3-Gal(p) | | | | 1.5 | | | |
| | | | 4-Gal(p) | | | | 3 | | | |
| | | | 2,3,4-Gal(p) | | | | 0.1 | | | |
| Glc | | 50.2% | Terminal Glc(p) | | | | | 1.3 | | |
| | | | 4-Glc(p) | | | | | 46.5 | | |
| | | | 3,4-Glc(p) | | | | | 0.4 | | |
| | | | 4,6-Glc(p) | | | | | 1.7 | | |
| | | | 2,3,4,6-Glc(p) | | | | | 0.2 | | |
| Man | | ND | | | | | | | ND | |
| UA | | 8.4% | 4-GalA(p) | | | | | | | 6.8 |
| | | | 4-GalA(p)- | | | | | | | 0.7 |
| | | | methyl ester | | | | | | | |
| | | | 3,4-GalA(p) | | | | | | | 0.9 |
| | | | Calculate DM | | | | | | | 8 |
| | 19.7 | | | | | | | | | |

Rha = rhamnose,
Ara = arabinose,
Xyl = xylose,
Gal = galactose,
Glc = glucose,
Man = mannose,
UA = uronic acids,
ND = none detected
Data are expressed in % of the total sugars identified (/Σ sugars). Yields of mass percentages are indicated in each table as % of total sugars identified per dried weight (%/DW).
Deduced linkage - 2018, Double reduction (Pettolino et al.)

TABLE E
Glycosyl-linkage analysis of a citrus pectin preparation
(see Example 10 for a description of the methodology)

| | Σ linked- | Σ linked- | | | | | | | | |
|---|---|---|---|---|---|---|---|---|---|---|
| | sugars/ | sugars/ | Deduced | %/Σ sugars | | | | | | |
| | DW | sugars | linkage | Rha | Ara | Xyl | Gal | Glc | Man | UA |
| Rha | | 1.5% | 2-Rha(p) | 1.2 | | | | | | |
| | | | 2,4-Rha(p) | 0.3 | | | | | | |
| Ara | | 3.4% | Terminal Ara(f) | | 0.8 | | | | | |
| | | | 5-Ara(f) | | 1.2 | | | | | |
| | | | 2,5-Ara(f) | | 0.2 | | | | | |
| | | | 3,5-Ara(f) | | 1.2 | | | | | |
| Xyl | | ND | | | | ND | | | | |
| Gal | | 5.1% | 4-Gal(p) | | | | 4.4 | | | |
| | | | 3,4-Gal | | | | 0.1 | | | |
| | | | 4,6-Gal | | | | 0.9 | | | |
| | | | 2,3,4-Gal | | | | 0.7 | | | |
| Glc | | ND | | | | | | ND | | |
| Man | | ND | | | | | | | ND | |
| UA | | 88.6% | 4-GalA(p) | | | | | | | 26 |
| | | | 4-GalA(p)- | | | | | | | 61 |
| | | | methyl ester | | | | | | | |
| | | | 2,4-GalA(p)- | | | | | | | 0.5 |
| | | | methyl ester | | | | | | | |
| | | | 3,4-GalA(p) | | | | | | | 0.3 |
| | | | 3,4-GalA(p)- | | | | | | | 0.8 |
| | | | methyl ester | | | | | | | |
| | | | Calculate DM | | | | | | | 70 |
| | 42.6 | | | | | | | | | |

Rha = rhamnose,
Ara = arabinose,
Xyl = xylose,
Gal = galactose,
Glc = glucose,
Man = mannose,
UA = uronic acids,
ND = none detected
Data are expressed in % of the total sugars identified (/Σ sugars). Yields of mass percentages are indicated in each table as % of total sugars identified per dried weight (%/DW).
Deduced linkage - 2018, Double reduction (Pettolino et al.)

TABLE F
Glycosyl-linkage analysis of a barley fiber preparation
(see Example 10 for a description of the methodology)

| | Σ linked- | Σ linked- | | | | | | | | | |
|---|---|---|---|---|---|---|---|---|---|---|---|
| | sugars/ | sugars/ | Deduced | %/Σ sugars | | | | | | | |
| | DW | sugars | linkage | Rha | Ara | Xyl | Gal | Glc | Man | UA | Hex |
| Rha | | ND | — | ND | | | | | | | |
| Ara | | 1.6% | Terminal Ara(f) | | 1.6 | | | | | | |
| Xyl | | 6.3% | 4-Xyl(p) | | | 3.0 | | | | | |
| | | | 3,4-Xyl(p) | | | 0.9 | | | | | |
| | | | 2,3,4-Xyl(p) | | | 2.4 | | | | | |
| Gal | | 1.0% | 4-Gal(p) | | | | 1.0 | | | | |
| Glx | | 84.5% | Terminal Glc(p) | | | | | 3.0 | | | |
| | | | 3-Glc | | | | | 5.2 | | | |
| | | | 4-Glc | | | | | 71.3 | | | |
| | | | 2,4-Glc | | | | | 3.4 | | | |
| | | | 2,3,4,6-Glc | | | | | 1.5 | | | |
| Man | | ND | | | | | | | ND | | |
| UA | | ND | — | | | | | | | ND | |
| Hex | | 6.6% | 2,4-Hex | | | | | | | | 1.1 |
| | | | 3,4-Hex | | | | | | | | 2.9 |
| | | | 2,3,4-Hex | | | | | | | | 0.9 |
| | | | 3,4,6-Hex | | | | | | | | 1.7 |
| | 18.2 | | | | | | | | | | |

Rha = rhamnose,
Ara = arabinose,
Xyl = xylose,
Gal = galactose,
Glc = glucose,
Man = mannose,
UA = uronic acids,
Hex, = hexose,
ND = none detected
Data are expressed in % of the total sugars identified (/Σ sugars). Yields of mass percentages are indicated in each table as % of total sugars identified per dried weight (%/DW).
Deduced linkage - 2018, Double reduction (Pettolino et al.)

TABLE G
Glycosyl-linkage analysis of a citrus fiber preparation
(see Example 10 for a description of the methodology)

| Σ linked- | Σ linked- | | | | | | | | | |
|---|---|---|---|---|---|---|---|---|---|---|
| sugars/ | sugars/ | Deduced | %/Σ sugars | | | | | | | |
| DW | sugars | linkage | Rha | Fuc | Ara | Xyl | Gal | Glc | Man | UA |

| | | | | | | | | | | |
|---|---|---|---|---|---|---|---|---|---|---|
| Rha | | 0.9% | 2-Rha(p) | 0.9 | | | | | | |
| Fuc | | ND | | | ND | | | | | |
| Ara | | 15.4% | Terminal Ara(f) | | | 2.4 | | | | |
| | | | 5-Ara(f) | | | 8.3 | | | | |
| | | | 3,5-Ara(f) | | | 4.7 | | | | |
| Xyl | | 2.4% | 4-Xyl(p) | | | | 2.4 | | | |
| Gal | | 10.3% | Terminal Gal(p) | | | | | 0.9 | | |
| | | | 3-Gal(p) | | | | | 1.2 | | |
| | | | 4-Gal(p) | | | | | 8.1 | | |
| | | | 4,6-Gal(p) | | | | | 0.2 | | |
| Man | | ND | — | | | | | | ND | |
| UA | | 57.1% | Terminal | | | | | | | 0.1 |
| | | | GalA(p) | | | | | | | |
| | | | Terminal | | | | | | | 0.4 |
| | | | GalA(p)- | | | | | | | |
| | | | methyl ester | | | | | | | |
| | | | 4-GalA(p) | | | | | | | 24.0 |
| | | | 4-GalA(p)- | | | | | | | 31.5 |
| | | | methyl | | | | | | | |
| | | | ester | | | | | | | |
| | | | 3,4-GalA(p) | | | | | | | 0.4 |
| | | | 3,4-GalA(p)- | | | | | | | 0.2 |
| | | | methyl ester | | | | | | | |
| | | | 4,6-GalA(p) | | | | | | | 0.1 |
| | | | 4,6-GalA(p)- | | | | | | | 0.4 |
| | | | methyl ester | | | | | | | |
| | | | Calculated DM | | | | | | | 57.1 |
| | 9.5 | | | | | | | | | |

Rha = rhamnose,
Ara = arabinose,
Xyl = xylose,
Gal = galactose,
Glc = glucose,
Man = mannose,
UA = uronic acids,
Fuc = fucose,
ND = none detected
Data are expressed in % of the total sugars identified (/Σ sugars). Yields of mass percentages are indicated in each table as % of total sugars identified per dried weight (%/DW).
Deduced linkage - 2018, Double reduction (Pettolino et al.)

b) Particle Design

Compounds of interest can be processed into a particle or attached to a core to make a particle (each instance “particle-bound compound”) by a variety of methods known in the art. The particles may be spherical or irregularly shaped. The particles may have a diameter across the widest portion of about 1 μm and about 100 μm, about 1 μm and about 50 μm, about 1 μm and about 25 μm, about 1 μm and about 15 μm, about 1 μm and about 10 μm, or about 1 μm and about 5 μm.

In some embodiments, a compound of interest or a plurality of compounds of interest may be incorporated into a core or layered over a core as a coating. Generally speaking, these cores or coatings may also comprise binders, lubricants, and/or other excipients that aid in compression, spheronization, granulation, extrusion or other methods known in the art for forming a particle. Without wishing to be bound by theory, incorporation of a compound of interest into a particle may affect the availability of the compound for members of the gut microbiota. Physical partitioning of a compound of interest to different locations within a particle may be a strategy to affect microbial access to and/or utilization of the compound.

In some embodiments, a compound of interest or a combination of compounds of interest are attached to a core. The core may be spherical or irregularly shaped, and typically comprises an inert polymer. Non-limiting examples of suitable cores include nonpareil spheres, latex beads, microcrystalline cellulose beads, silica beads, agarose beads, polystyrene beads or beads made from other polymers, quantum dots (including but not limited to quantum dots of small inorganic dye doped beads, such as those described at www.bangslabs.com/products/fluorescent-microspheres).

A suitable core may also be paramagnetic metal oxide particle comprising a paramagnetic core and an optional coating. The paramagnetic core may be a paramagnetic crystalline core composed of magnetically active metal oxide crystals which range from about 10 to about 500 angstroms in diameter. The cores may be uncoated or, alternatively, coated associated with a polysaccharide, a protein, a polypeptide, an organosilane or any composite thereof. By way of illustration, the polysaccharide coating may comprise dextran of varying molecular weights, the protein coating may comprise bovine or human serum albumin, and the organosilane coating may comprise an alkoxysilane or a halosilane. With coatings, the overall particle diameter may range from about 10 upward to about 5,000 angstroms. In the case of coated particles, the coatings can serve as a base to which a compound of interest or combination of compounds can be attached. In an exemplary embodiment, the core may be a paramagnetic particle comprising ferric oxide and a coating comprising an organosilane. Suitable paramagnetic particles are known in the art. See, for example, U.S. Pat. Nos. 4,695,392, 4,695,393, 4,770,183, 4,827,945, 4,951,675, 5,055,288, 5,069,216, and 5,219,554.

In certain embodiments, a core has a zwitterionic surface. For instance, if the surface of a core is modified by the addition of functional groups with a positive charge (e.g., a reactive amine), it may be desirable to further modify the surface with functional groups that carry a negative charge (e.g., a phosphonate), thereby creating a zwitterionic surface. Without wishing to be bound by theory, creating a zwitterionic surface as described above may reduce non-specific binding to the core's surface. A core's zeta potential can be used to monitor addition of functional groups, such that the zeta potential following derivatization is approximately the same as the zeta potential prior to any derivatization. In some embodiments, suitable cores may have a zeta potential of about −15 mV to about −35 mV, in some embodiments about −20 mV to about −35 mV, in some embodiments about −20 mV to about −30 mV, in some embodiments about −22 mV to about −30 mV, in some embodiments about −25 mV to about −30 mV.

The attachment of a compound of interest, or multiple compounds of interest, to a core is achieved by reaction of functional groups that are present on the exterior surface of the core (each a “surface functional group”) with a functional group on a compound of interest (or derivative thereof). As a result of such a reaction, a stable attachment is formed. As used herein, the terms “stable attachment” or “stably attached” refer to an attachment that remains substantially unaltered during transit through an intestinal tract of subject that lacks a gut microbiota (e.g., a germ-free animal) and/or can resist washing with 1% SDS/6M Urea/HNTB for 10 minutes at room temperature. Compounds of interest may be attached to a core through existing functional groups on the core and compound. Alternatively, the compound of interest and/or core may be derivatized with one or more functional group to produce more desirable properties—for instance, to generate a different reactive group for attachment and/or to add a spacer. A non-limiting example of a suitable spacer is an n PEG spacer, where n is an integer from 1 to 50 (inclusive), preferably 1 to 25 (inclusive), more preferably 1 to 10 (inclusive). Other spacers known in the art may also be used, including but not limited to peptide spacers. Numerous chemistries are known in the art that are suitable for the above purpose.

For instance, a compound of interest may be stably attached to a core via a biotin-avidin interaction. In some embodiments, a compound of interest may be derivatized with streptavidin and a core may be derivatized with biotin. In other embodiments, a compound of interest may be derivatized with biotin and a core may be derivatized with streptavidin. In various embodiments, the avidin protein may be a tetrameric avidin (e.g., chicken egg white avidin or a modified form thereof), a dimeric avidin from bacteria (e.g. streptavidin or a modified form thereof), or a monomeric avidin. In further embodiments, a spacer is present between the functional group (i.e. streptavidin or biotin) and the surface of the core or compound of interest.

In another example, a compound of interest may be stably attached to a core that is derivatized with one or more reactive nucleophile. Suitable nucleophiles include but are not limited to amines, hydroxyl amine, hydrazine, hydrazide, cysteine. In further embodiments, a zwitterionic surface may be generated after derivatization with one or more type of reactive nucleophile. Cores may be functionalized with reactive nucleophiles, and subsequent zwitterionic surfaces created, by methods known in the art or detailed in the examples. If a compound of interest does not have a functional group that is reactive with the nucleophile, the compound of interest can be derivatized with appropriate functional groups.

In another example, a compound of interest may be stably attached to a core that is derivatized with one or more type of reactive amine. In further embodiments, a zwitterionic surface may be generated after derivatization with one or more type of reactive amine. Cores may be functionalized with reactive amines, and subsequent zwitterionic surfaces created, by methods known in the art or detailed in the examples. If a compound of interest does not have a functional group that is reactive with an amine, the compound of interest can be derivatized with appropriate functional groups.

In an exemplary embodiment, a compound of interest with an eletrophilic functional group (e.g., aldehyde, ketone, cyano-ester, etc.) may be stably attached to a core functionalized with one or more reactive nucleophile (e.g., an amine, a hydroxyl amine, a hydrazine, a hydrazide, a cysteine, etc.). The electrophile may be naturally occurring in the compound of interest (e.g. the reducing end chemistry of a polysaccharide) or may be created by derivatization (e.g., creating aldehydes from vicinal hydroxyls by sodium periodate oxidation, creating cyano-esters from the hydroxyls naturally present, etc.). The reaction between the electrophile and the nucleophile will form a bond that may or may not need further chemistry applied to it. For instance, reaction of an amine with the reducing end of a polysaccharide yields an imine that needs to be reduced with a hydride donor to create a stable bond, a reaction termed reductive amination. Reaction of an amine with a cyano-ester yields an isourea that also can be reduced with a hydride donor to form a stable bond. Reaction with a stronger nucleophile (e.g., hydroxyl amine, hydrazide, etc.) forms other intermediates (i.e., hydrazide reaction forms a hydrazone) that may or may not require reduction.

In an exemplary embodiment, the core is a silica particle or a particle comprising a silica coating (e.g., a paramagnetic particle comprising a silica coating, etc.). Surface modification of silica particles is commonly achieved by reaction with an alkoxysilane or halosilane. Alkoxysilanes will bind forming 1-3 Si—O—Si links to the surface in a condensation reaction with the surface silanol groups. The halosilanes will typically hydrolyze substituting the halide for alcohol group which can similarly undergo condensation forming 1-3 Si—O—Si links with surface silanol groups. In anhydrous conditions, halosilanes will react directly with surface silanol groups. A wide variety of alkoxysilanes/halosilanes are commercially available. Suitable alkoxysilanes/halosilanes include but are not limited to 3-aminopropyl triethoxysilane (APTS) and 3-mercaptopropyl trimethoxysilane (MPTS). APTS and MPTS allow for facile linker chemistry with other frequently used linking moieties such as n-hydroxysuccinide (NHS) functionalized molecules, isothiocynates, cyano-esters, malemides, etc. These linking moieties may be present on a compound of interest. For instance, cores functionalized with APTS may be reacted with CDAP-activated polysaccharides. Alternatively, these linking moieties may be used to attach further functional groups to the core. For instance, cores functionalized with APTS may be reacted with amine-reactive biotin conjugates or amine-reactive streptavidin conjugates to create a core derivative with biotin or streptavidin, respectfully.

In further embodiments, one or more compounds of interest may be stably attached to a core using the any of the chemistries described herein in a manner that creates multiple layers. For instance, a core functionalized with a reactive amine may be reacted with a compound of interest with a reducing chemistry to create an initial bond that is then reduced to form a stable bond, thereby creating a core with a first layer of a compound of interest (“the layered core”). A second layer comprising the same or different compound of interest may be produced by either using existing reactive groups present in the first layer or creating new reactive groups in the first layer, and then reacting a compound of interest with the appropriate chemistry to from a core layered with a first and then a second compound of interest. Alternative designs are also encompassed by the present disclosure. For instance, each layer may or may not differ in terms of the compounds of interest, the absolute amount of each compound, the ratio of compounds in a given layer, etc.

Those having ordinary skill in the art, in light of this specification, will realize that depending on the nature of the functional groups that are present on the surface of the beads and the nature of the functional groups that are present on the compound of interest (or derivative thereof), other types of interactions may occur via which compounds of interest can be stably attached to a core. Multiple types of chemistries may also be used. Choice of a suitable chemistry may also be influenced, in part, by a physical property of the compound of interest. For instance, certain chemistries are more amendable to compounds that are water soluble, or partially water soluble, whereas other chemistries are more amendable to compounds that are typically insoluble.

The amount of a compound of interest attached to a core can vary. For instance, the conjugation chemistry and the type of compound may affect the amount of compound attached. Generally, at least about 0.5 pg of a compound of interest is attached to a core. In some embodiments, the amount of the compound of interest attached to a core is about 0.5 pg to about 5 μg. In some embodiments, the amount of the compound of interest attached to a core is about 0.5 pg to about 1 μg. In some embodiments, the amount of the compound of interest attached to a core is about 1 pg to about 1 μg. In some embodiments, the amount of the compound of interest attached to a core is about 0.5 pg to about 0.5 μg. In some embodiments, the amount of the compound of interest attached to a core is about 1 pg to about 0.5 μg. In some embodiments, the amount of the compound of interest attached to a core is about 1 pg to about 0.1 μg. In some embodiments, the amount of the compound of interest attached to a core is about 0.5 pg to about 50 ng. In some embodiments, the amount of the compound of interest attached to a core is about 1 pg to about 50 ng. In some embodiments, the amount of the compound of interest attached to a core is about 1 pg to about 10 ng. In some embodiments, the amount of the compound of interest attached to a core is about 0.5 pg to about 5 ng. In some embodiments, the amount of the compound of interest attached to a core is about 1 pg to about 1 ng. In some embodiments, the amount of the compound of interest attached to a core is about 1 pg to about 500 pg. In some embodiments, the amount of the compound of interest attached to a core is about 0.5 pg to about 500 pg. In some embodiments, the amount of the compound of interest attached to a core is about 1 pg to about 100 pg. In some embodiments, the amount of the compound of interest attached to a core is about 0.5 pg to about 50 pg. In some embodiments, the amount of the compound of interest attached to a core is about 1 pg to about 50 pg.

In each of the above embodiments, the core further comprises a tag that facilitates recovery of particles from biological material obtained from a subject, following administration of the particles to the subject. Said tag may be incorporated into the core itself, attached to the exterior surface of the core, layered over the core as a coating, or any combination thereof. When attached to the exterior surface of the core, attachment may occur using the same or a different chemistry than used to attach compounds of interest. Suitable tags include metals, fluorescent compounds, quantum dots, biotin, peptides, and nucleic acids, among others. In some examples, the tag is a purification or affinity tags (e.g., CBP, FLAG-tag, GST, HA-tag, HBH, MBP, Myc, E-tag, NE-tag, S-tag, TAP, V5, AviTag, SBP, Strep-tag, polyhistidine, polyarginine, polyglutamine, thioredoxin-tag, etc.). In other examples, the tag is a metal oxide or other magnetic or paramagnetic material, typically incorporated into the core. As is known in the art, magnetic and paramagnetic particles may have a variety of different structures. For instance, magnetic particles may be distributed in a volume of a polymer matrix, magnetic particles may form a shell around a polymer core, magnetic particles may form a core that is surrounded by a polymer shell, or combinations thereof. See, for instance, Philippova et al., European Polymer Journal, 2011, 47: 542-559. Non-limiting examples of magnetic cores that may be used include Dynabeads® (Dynal AS, Oslo, Norway), MagMax™ beads (Applied Biosystems, Foster City, Calif.), BioMag® beads (Polysciences, Inc., Warrington, Pa.) BcMag™ beads (BioClone Inc., San Diego, Calif.), PureProteome™ magnetic beads (Millipore Corporation), or the like.

c) Optional Labels

Particles of the present disclosure may further comprise a label. One or more labels may be incorporated into a particle, attached to a particle, or attached to the compound of interest by methods known in the art. Preferably, addition of a label does not substantially alter the transit time of a particle through a subject's intestinal tract. Non-limiting examples of suitable labels include fluorescent compounds, quantum dots, biotin, polynucleotide sequences, radioisotopes and purification or affinity tags (e.g., CBP, FLAG-tag, GST, HA-tag, HBH, MBP, Myc, E-tag, NE-tag, S-tag, TAP, V5, AviTag, SBP, Strep-tag, polyhistidine, polyarginine, polyglutamine, thioredoxin-tag, etc.). Use of a label facilitates further separation of recovered particles for downstream analyses or imaging. As such, the label should be different than the tag described in Section I(b). For instance, if the tag is a first fluorochrome, the label should be a second fluorochrome. The method used to attach a label to a particle may be the same or different than the method used to attach a compound of interest to the particle.

d) Exemplary Embodiments

In one example, an artificial food particle comprises a core comprising a tag, one or more glycans, and an optional label. In some embodiments, a particle has a single glycan. In other embodiments, a particle has a combination of 2 or more glycans, a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, pea fiber, citrus peel, yellow mustard, soy cotyledon, orange fiber (coarse), orange fiber (fine), orange peel, tomato peel, inulin (low molecular weight), potato fiber, apple pectin, sugar beet fiber, oat hull fiber, acacia extract, inulin (high molecular weight), barley beta-glucan, barley bran, oat beta-glucan, apple fiber, rye bran, barley malted, wheat bran, wheat aleurone, maltodextrin (including but not limited to resistant maltodextrin), psyllium, cocoa, citrus fiber, tomato pomace, rice bran, chia seed, corn bran, soy fiber, sugar cane fiber, resistant starch 4. In each of the above embodiments, the glycan(s) are attached to the core either directly or indirectly, preferably by an irreversible interaction. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or directly or indirectly attached to the core or the glycan via the same method used with the glycan(s) or a different method.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, pea fiber, citrus peel, yellow mustard, soy cotyledon, orange fiber (coarse), orange fiber (fine), orange peel, tomato peel, inulin (low molecular weight), potato fiber, apple pectin, sugar beet fiber, oat hull fiber, acacia extract, inulin (high molecular weight), barley beta-glucan, barley bran, oat beta-glucan, apple fiber, rye bran, barley malted, wheat bran, wheat aleurone, maltodextrin (including but not limited to resistant maltodextrin), psyllium, cocoa, citrus fiber, tomato pomace, rice bran, chia seed, corn bran, soy fiber, sugar cane fiber, resistant starch 4. In each of the above embodiments, the glycan(s) are attached to the core via an avidin-biotin interaction, preferably a streptavidin-biotin interaction. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or the glycan via an avidin-biotin interaction (the same or different than used with the glycan(s)) or by other methods known in the art.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, pea fiber, citrus peel, yellow mustard, soy cotyledon, orange fiber (coarse), orange fiber (fine), orange peel, tomato peel, inulin (low molecular weight), potato fiber, apple pectin, sugar beet fiber, oat hull fiber, acacia extract, inulin (high molecular weight), barley beta-glucan, barley bran, oat beta-glucan, apple fiber, rye bran, barley malted, wheat bran, wheat aleurone, maltodextrin (including but not limited to resistant maltodextrin), psyllium, cocoa, citrus fiber, tomato pomace, rice bran, chia seed, corn bran, soy fiber, sugar cane fiber, resistant starch 4. In each of the above embodiments, the glycan(s) are derivatized to generate cyano-esters from the hydroxyls naturally present and the derivatized glycan(s) are attached to cores comprising amine functional groups on the surface. In still further embodiments, the cores are also functionalized with phosphonates. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or the glycan via the amine functional groups on the core's surface (using the same or different chemistry than used with the glycan(s)) or by other methods known in the art.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, pea fiber, citrus peel, yellow mustard, soy cotyledon, orange fiber (coarse), orange fiber (fine), orange peel, tomato peel, inulin (low molecular weight), potato fiber, apple pectin, sugar beet fiber, oat hull fiber, acacia extract, inulin (high molecular weight), barley beta-glucan, barley bran, oat beta-glucan, apple fiber, rye bran, barley malted, wheat bran, wheat aleurone, maltodextrin (including but not limited to resistant maltodextrin), psyllium, cocoa, citrus fiber, tomato pomace, rice bran, chia seed, corn bran, soy fiber, sugar cane fiber, resistant starch 4. In each of the above embodiments, the core is functionalized with APTS and the glycan(s) are CDAP-activated. In still further embodiments, the cores are also functionalized with phosphonates. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or the glycan via the amine functional groups on the core's surface (using the same or different chemistry than used with the glycan(s)) or by other methods known in the art.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, orange fiber (coarse), orange (fine), inulin, pea fiber, sugar beet fiber, soy cotyledon, yellow mustard bran, and barley bran. In each of the above embodiments, the glycan(s) are attached to the core either directly or indirectly, preferably by an irreversible interaction. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or directly or indirectly attached to the core or the glycan via the same method used with the glycan(s) or a different method.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, orange fiber (coarse), orange (fine), inulin, pea fiber, sugar beet fiber, soy cotyledon, yellow mustard bran, and barley bran. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or glycan via an avidin-biotin interaction (the same or different than used with the glycan(s)) or by other methods known in the art.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, orange fiber (coarse), orange (fine), inulin, pea fiber, sugar beet fiber, soy cotyledon, yellow mustard bran, and barley bran. In each of the above embodiments, In each of the above embodiments, the core is functionalized with APTS and the glycan(s) are CDAP-activated. In still further embodiments, the cores are also functionalized with phosphonates. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or the glycan via the amine functional groups on the core's surface (using the same or different chemistry than used with the glycan(s)) or by other methods known in the art.

In another example, an artificial food particle comprises a core comprising a tag, one or more glycans, and an optional label. In some embodiments, a particle has a single glycan. In other embodiments, a particle has a combination of 5 or more glycans, a combination of 10 or more glycan, or a combination of 20 or more glycans. In other embodiments, a particle has a combination of two to twenty glycans. In other embodiments, a particle has a combination of two to ten glycans. In any of the aforementioned embodiments, the glycan may be a polymer that is a homo- or heteropolymer consisting of two or more monosaccharides linked glycosidically. As such, the glycan is understood to not contain any modifications (e.g., the glycan is not a glycoconjugate of any kind). In still other embodiments, a particle has a combination of glycans obtained from a fiber preparation. In certain embodiments, the fiber preparation is selected from citrus pectin, orange fiber (coarse), orange (fine), inulin, pea fiber, sugar beet fiber, soy cotyledon, yellow mustard bran, and barley bran. In each of the above embodiments, the glycan(s) are derivatized to generate cyano-esters from the hydroxyls naturally present and the derivatized glycan(s) are attached to cores comprising amine functional groups on the surface. In still further embodiments, the cores are also functionalized with phosphonates. In some embodiments, the amount of the compound of interest attached to a core is about 0.5 pg to about 500 ng, or about 0.5 pg to about 50 ng, or about 0.5 pg to about 5 ng. In some embodiments, the amount of the compound of interest attached to a core is about 0.5 pg to about 500 pg, or about 0.5 pg to about 50 pg. In some embodiments, the amount of the compound of interest attached to a core is about 1 pg to about 1000 pg, or about 1 pg to about 100 pg, or about 1 pg to about 50 pg. When present, the label can be incorporated into the core, or attached to the core or the glycan via the amine functional groups on the core's surface (using the same or different chemistry than used with the glycan(s)) or by other methods known in the art.

In any of the aforementioned embodiments, the glycan polymer(s) may be a polymer that has been modified, whether naturally or otherwise; non-limiting examples of such modifications include acetylation, alkylation, esterification, etherification, oxidation, phosphorylation, selenization, sulfonation, or any other manipulation.

In any of the aforementioned embodiments, the particle may comprise one layer of glycans or more than one layer glycans. As described above, the glycans can be arranged in a variety of different patterns when multiple layers are present.

In another example, an artificial food particle comprises a core, at least one compound of interest, and a label, wherein the core is a paramagnetic particle comprising a silica coating. In some embodiments, a particle comprises one compound of interest. In other embodiments, a particle comprises a combination of 5 or more compounds of interest, a combination of 10 or more compounds of interest, or a combination of 20 or more compounds of interest. In other embodiments, a particle comprises a combination of two to twenty compounds of interest. In other embodiments, a particle comprises a combination of two to ten compounds of interest. In certain embodiments, one or more of the compounds of interest are a biomolecule. In some examples, each compound of interest is a glycan. In still further examples, the core is functionalized with an organosilane reagent, which is optionally APTS, and the glycan(s) are CDAP-activated, and the cores are optionally functionalized with phosphonates. In some embodiments, the amount of the compound of interest attached to the core is about 0.5 pg to about 500 ng, or about 0.5 pg to about 50 ng, or about 0.5 pg to about 5 ng. In some embodiments, the amount of the compound of interest attached to the core is about 0.5 pg to about 500 pg, or about 0.5 pg to about 50 pg. In some embodiments, the amount of the compound of interest attached to the core is about 1 pg to about 1000 pg, or about 1 pg to about 100 pg, or about 1 pg to about 50 pg. When present, the label can be incorporated into the core, or attached to the core or the glycan via the amine functional groups on the core's surface (using the same or different chemistry than used with the glycan(s)) or by other methods known in the art.

### II. Compositions

In an additional aspect, the present disclosure provides compositions comprising a plurality of artificial food particles. Suitable artificial food particles are described in Section I, the disclosures of which are incorporated into this section by reference. Compositions may comprise a plurality of particles that are compositionally identical or may comprise a plurality of particles of different types. Particles of different types differ in one more aspects including but not limited to the compounds of interest, particle design (e.g., compounds incorporated into a core, coating a core, or attached to a core), the type of core, the label (if present), and the chemistry used to stably attach a compound of interest and/or a label to a core.

In certain embodiments, the present disclosure provides a composition comprising a plurality of particles of more than one type, each type of particle comprising a unique compound of interest or combination of compounds of interest, and a unique label. In exemplary embodiments, all the particles have the same general design, meaning all the particles have the compound(s) of interest either incorporated into a core, or coating a core, or attached to a core. However, in embodiments where the compound(s) of interest are attached to a core, the type of core and the chemistry used to stably attach the compound of interest and/or the label to the core may vary between particle types.

In further embodiments, the present disclosure provides a composition comprising a plurality of particles of more than one type, each type of particle comprising a core, a compound of interest or combination of compounds of interest, and a unique label, wherein the compound(s) of interest and label are stably attached to the core. In various embodiments, the core may be the same between types of particles, may differ between particles, or a combination thereof. In each of the aforementioned embodiments, the chemistry used to stably attach the compound of interest and/or the label to the core may vary or be the same between particle types.

In still further embodiments, the present disclosure provides a composition comprising a plurality of particles of more than one type, each type of particle comprising a core, a glycan or combination of glycans, and a unique label, wherein the glycan(s) and label are stably attached to the core. In various embodiments, the core may be the same between types of particles, may differ between particles, or a combination thereof. In each of the aforementioned embodiments, the chemistry used to stably attach the glycan(s) and/or the label to the core may vary or be the same between particle types.

The number of particle types in a composition is not limited. For instance, compositions of the present disclosure may comprise 5 or fewer particle types, 10 or fewer particle types, 15 or fewer particle types, 20 or fewer particle types, 30 or fewer particle types 40 or fewer particle types 50 or fewer particle types, or more than 50 particle types.

The number of particles in each composition can vary. In embodiments comprising a plurality of particles of more than on type, compositions may contain an equal number of particles for each particle type. Alternatively, compositions may contain different numbers of particles for each particle type. In another alternative, compositions may contain a number of particles for each particle type such that the compounds of interest are provided in approximately the same amount.

Compositions of the present disclosure may be formulated for oral administration, and may further comprise inert excipients. Oral preparations may be enclosed in gelatin capsules or compressed into tablets. Oral preparations may also be administered as aqueous suspensions, elixirs, or syrups. For these, the composition may further comprise various sweetening, flavoring, coloring, emulsifying and/or suspending agents, as well as diluents such as water, ethanol, glycerin, and combinations thereof. Oral preparations may also be formulated to provide immediate release, time-released, pH-dependent release or enteric release of the particles.

Compositions of the present disclosure may be formulated as a liquid. Liquid preparations are formulated for oral administration, and may be aqueous or oily suspensions, emulsions, syrups, or elixirs. Such liquid formulations may further comprise various sweetening, flavoring, coloring, emulsifying, suspending agents, and/or preservatives, as well as diluents or nonaqueous vehicles. Suspending agent include, but are not limited to, sorbitol syrup, methyl cellulose, glucose/sugar syrup, gelatin, hydroxyethylcellulose, carboxymethyl cellulose, aluminum stearate gel, and hydrogenated edible fats. Emulsifying agents include, but are not limited to, lecithin, sorbitan monooleate, and acacia. Diluents include, but are not limited to, water, ethanol, glycerin, and combinations thereof. Nonaqueous vehicles include, but are not limited to, edible oils, almond oil, fractionated coconut oil, oily esters, propylene glycol, and ethyl alcohol.

Compositions of the present disclosure may also be formulated as a solid by methods known in the art. Solid formulations may be a tablet; a caplet; a pill; a powder such as a sterile packaged powder, a dispensable powder, and an effervescent powder; a capsule including both soft or hard gelatin capsules; a lozenge; a sachet; a sprinkle; a reconstitutable powder or shake; a troche; a pellet; a granule; a semisolid or a gel. Compositions formulated as a solid may be fast disintegrating. Compositions formulated as a solid may provide immediate release, sustained release, enteric release, time-delayed release, or combinations thereof.

### III. Measuring Gut Microbiota-Mediated Modifications

In an additional aspect, the present disclosure provides a method to measure modifications that occur to a compound of interest after oral administration to a subject. In one embodiment, the method comprises: (a) orally administering to a subject a composition of Section II, wherein structural information and/or amount of the particle-bound compound(s) of interest is known (the “input data”), (b) recovering particles from biological material obtained from the subject, and (c) identifying structural changes to the recovered particle-bound compound(s) of interest and/or measuring the amount of the recovered particle-bound compound(s) of interest (the “recovered data”) and determining the difference between the recovered data and the input data. In another embodiment, the method comprises: (a) admixing, ex vivo, a composition of Section II and a sample of the subject's gut microbiota, wherein structural information and/or amount of the particle-bound compound(s) of interest is known (the “input data”), (b) recovering particles from the admixture after a suitable amount of time (e.g., hours or days), and (c) identifying structural changes to the recovered particle-bound compound(s) of interest and/or measuring the amount of the recovered particle-bound compound(s) of interest (the “recovered data”) and determining the difference between the recovered data and the input data. In another embodiment, the method comprises: (a) admixing a composition of Section II to an in vitro culture of one or more gut microbial strains, wherein structural information and/or amount of the particle-bound compound(s) of interest is known (the “input data”), (b) recovering particles from the admixture after a suitable amount of time (e.g., hours or days), and (c) identifying structural changes to the recovered particle-bound compound(s) of interest and/or measuring the amount of the recovered particle-bound compound(s) of interest (the “recovered data”) and determining the difference between the recovered data and the input data. The modification may be cleavage, degradation (partial or complete), acetylation, alkylation, deamidation, deglycosylation, delipidation, esterification, etherification, glucuronidation, glycosylation, hydrolysis, lipidation, methylation, methylesterification, oxidation, phosphorylcholination, phosphorylation, proteolysis, reduction, ring opening, selenization, sulfation, sulfonation, or any other manipulation. Compositions may be orally administered by methods known in the art, which for the avoidance of doubt, includes but is not limited to buccal administration, sublabial administration, sublingual administration, and by gavage.

In certain embodiments, a composition of Section II is a composition comprising a plurality of particles of more than one type, each type of particle comprising a unique compound of interest or combination of compounds of interest, and a unique label. After administering said composition to a subject, the method comprises recovering the particles from biological material obtained from the subject and then separating the recovered particles by type; and for each type of particle, measuring the amount of the compound(s) of interest on the recovered particles (the “recovered amount”) and calculating the difference between the recovered amount and the input amount.

Preferred subjects are humans or nonhuman animals. In some embodiments, a subject is a human. In other embodiments, the subject is a non-human mammal, a bird, a fish, a reptile, or an amphibian. In various embodiments, the nonhuman animal may be a companion animal (e.g., dog, cat, etc.), a livestock animal (e.g., cow, pig, horse, sheep, goat, etc.), a zoological animal, or a research animal (e.g., a non-human primate, a rodent, etc.). In one example, the subject is a germ-free mouse. In another example, the subject is a germ-free mouse that was colonized with a consortium of bacterial strains. In a further example, the subject is a germ-free mouse that was colonized with intact uncultured microbiota from a human donor. In still a further example, the subject is a germ-free mouse that was colonized with intact uncultured microbiota from a human donor in need of a dietary intervention. Human subjects in need of a dietary intervention may be a subject that consumes a diet high in saturated fat and/or low in fruits and vegetables, a subject that is overweight or obese, a subject diagnosed with a disease including but not limited to type I diabetes, type II diabetes, cardiovascular disease, a neurological disease, a neurodegenerative disease, or an inflammatory disease.

When the subject has a gut microbiota, the modification(s) to the compound of interest are typically mediated, at least in part if not completely, by the subject's gut microbiota. As such, in embodiments where the subject has a gut microbiota, the present disclosure provides a method to measure gut microbiota-mediated modifications that occur to a compound of interest after oral administration to a subject. When a modification is solely dependent upon gut microorganisms (i.e., due to the functional activity of a gut microbiota), then the difference between the input data and the recovered data is the gut microbiota-dependent modification, which is a measure of the gut microbiota's functional activity. Germ-free animals can be used to evaluate the contribution of any microbiota-independent modifications, and this contribution (if present) can be removed from the final measurement.

The results from the aforementioned methods may be used to characterize the functional state of a subject's gut microbiota/microbiome, which may then be compared to an earlier measurement for the same subject or an average measurement for a suitable comparator (e.g., healthy subjects, subjects with a similar health/disease status, etc.). In this way, the methods may provide a personalized measure of in vivo microbiome activity and health characteristics that may aide in diagnosis of a disease, influence prognosis and/or guide medical treatment, enable personalized food design or nutrition guidance, or allow for other actions to improve the subject's health. For example, the aforementioned methods may be used to measure disease state biomarkers comprising microbiota activity and/or structural information regarding the microbiota/microbiome. As another example, the aforementioned methods may be used to measure the effect of a drug or other therapeutic intervention on microbiota function in order to improve dosing, efficacy and/or adherence. As another example, the aforementioned methods may be used to measure microbiota functional activity restoration following acute surgery or antibiotic administration in order to enable early identification and prevention of adverse events that often require readmission. The above uses are non-limiting, and are intended to only illustrate the scope uses encompassed by the present disclosure.

In various embodiments, the aforementioned methods may further comprise quantifying at least one additional aspect of the subject's gut microbiota and/or the subject's health before, after, or before and after administering a composition of Section II. Non-limiting examples of an additional aspect of the subject's gut microbiota that may be quantified include changes in the representation of bacterial taxa, genes encoding carbohydrate-active enzymes (CAZymes) and/or polysaccharide utilization loci (PULs), and/or genes encoding proteins and enzymes in various metabolic pathways, as well as changes in the abundance of proteins encoded by one or more bacterial PUL, abundance of CAZYmes, abundance of all Firmicutes, abundance of a subset of Firmicutes species, proportional representation of all Firmicutes, proportional representation of a subset Firmicutes species, abundance of all Bacteroides species, abundance of a subset of Bacteroides species, proportional representation of all Bacteroides species, proportional representation of a subset Bacteroides species, and microbial metabolites.

Biological material obtained from a subject administered the composition may be a blood sample or, more preferably, cecal or fecal matter. Biological material may be used immediately or may be frozen and stored indefinitely. A skilled artisan will appreciate that the amount of biological material needed may vary depending upon a variety of factors, including the amount of the composition administered, the type of tag and/or the type of label, as well as the amount of compound, label or tag per particle.

In one example of the aforementioned embodiments, a method to measure glycan degradation comprises (a) orally administering to a subject a composition comprising a plurality of particles of one type, the particles comprising a core, a glycan or combination of glycans, and a label, wherein the glycan(s) and label are stably attached to the core, and wherein the amount of particle-bound glycan is known (the “input data”); (b) recovering particles from biological material obtained from the subject; and (c) measuring the amount of particle-bound glycan for the recovered particles (the “recovered data”) and calculating the amount of glycan degraded, which is the difference between the input data and recovered data.

In another example, a method for measuring glycan degradation comprises (a) orally administering to a subject a composition comprising a plurality of particles of more than one type, each type of particle comprising a core, a glycan or combination of glycans, and a unique label, wherein the glycan(s) and label are stably attached to the core, and wherein the amount of bead-bound glycan per particle type is known (the “input data”); (b) recovering particles from biological material obtained from the subject and then separating the recovered particles by type; and (c) for each recovered particle type, measuring the amount of glycan per particle type (the “recovered data”) and calculating the amount of glycan degraded, which is the difference between the input data and recovered data. In various embodiments, the core may be the same between types of particles, may differ between types of particles, or a combination thereof. In each of the aforementioned embodiments, the chemistry used to stably attach the glycan(s) and/or the label to the core may vary or be the same between particle types. In certain examples of each of the aforementioned embodiments, one or more type of particle comprises a combination of glycans obtained from a fiber preparation.

In each of the above embodiments, particle-bound glycan may be measured by GC-MS after the glycans are release from the cores, as described in the Examples. Briefly, particle-bound glycans are released from the core (e.g., by acid hydrolysis) and the mass of each monosaccharide detected in a sample of each type of bead can be determined by GC-MS and this mass then divided by the final count of beads in each sample to produce a measurement of mass of recoverable monosaccharide per bead. Through routine experimentation, the types of monosaccharaides detected can be optimized. Other methods known in the art may also be used. For instance, other instrumentations such as LC-MS, HPLC, or HPAE-PAD may be used. Alternatively or in addition, any analytical method that quantifies monosaccharides may be used.

In each of the above embodiments, the input data may include structural information about the glycans, in addition to or as an alternative to the amount of particle-bound glycan per particle type. The Examples describe, for instance, methods to analyze carbohydrate linkage analysis. Without wishing to be bound by theory, potentially important information about the ability of an individual's gut microbiota to process specific linkages within a glycan may be missed by a monosaccharide analysis of particle-bound glycan. Methods are also known in the art to analyze other types of glycan modifications, including but not limited to amino-modification, acetylation, alkylation, esterification, etherification, methylation, methylesterification, oxidation, phosphorylcholination, phosphorylation, ring-opening, selenization, sulfation and sulfonation.

A skilled artisan will appreciate that degradation and/or modification of other compounds of interest (e.g., other biomolecules or drugs) may be also measured in view of the disclosures in Section II, the Examples, and methods known in the art to measure degradation or other structural changes to drugs, proteins, lipids, nucleic acids, etc.

### IV. Isolating Gut Microorganisms

In an additional aspect, the present disclosure provides a method to recruit gut microorganisms in vivo, and optionally isolate them. The method comprises: orally administering to a subject a composition of Section II, and optionally recovering particles from biological material obtained from the subject and isolating DNA from the recovered beads and then sequencing the DNA to identify the particular species of microbes that were bound to the recovered beads.

In some embodiments, recruiting gut microorganisms in vivo to a food particle may be used to create novel microenvironments in vivo. For instance, a food particle may comprise two or more types of glycans in order to recruit particular bacterial taxa with complementary functional activities. In another example, a food particle may comprise a biomolecule that a particular bacterial species metabolizes and a drug toxic to the bacterial species, in order to recruit the bacterial species to be in physical proximity to the drug.

In embodiments where the particles are recovered in order to isolate gut microorganisms, isolating gut microorganisms may be used to better understand or define the fiber degrading capacity a subject's gut microbiota. The “fiber degrading capacity” of a subject's gut microbiota is defined by its compositional state, specifically the absence, presence and abundance of primary and secondary consumers of dietary fiber. Microbes that are primary consumers initiate degradation of dietary fibers, while secondary consumers utilize glycans that are released by primary consumers. Without wishing to be bound by theory, stratification of particle-associated microbial communities may be seen with recovered particles. For instance, the most closely adherent microorganisms may include primary consumers, while more loosely adherent microorganisms may include secondary consumers. Alternatively, stratification may not be observed. By using different particles that have different compounds of interest, or compounds of interest arranged within the particle in varying manners, it is possible to evaluate how the availability of a compound (or access to a compound) affects the relationship between primary consumers, secondary consumers, or primary consumers and secondary consumers.

In certain embodiments, the method may further comprise an additional sorting step to enrich for microbe-bound beads. For instance, in step (b), the biological material (or a fraction thereof) may be treated with a DNA or protein stain prior to recovering the particles, and the recovered particles may be further sorted to select those recovered particles labeled with the stain. In an alternative approach, after recovering particles from biological material obtained from the subject, the recovered particles may be treated with a DNA or protein stain and the treated particles may be further sorted to select those recovered particles labeled with the stain. Non-limiting examples of suitable DNA and protein stains include Propidium iodide, DAPI, 7AAD, Syto DNA dyes (Invitrogen), LIVE/DEAD (Invitrogen). Alternatives to DNA stains may also be used. For instance, antibodies, aptamers, or other reagents may be used to specifically label microbial specific proteins, RNA, lipids, and/or carbohydrates.

### V. Measuring a Change in a Subject's Gut Microbiota

In an additional aspect, the present disclosure provides methods to measure one or more changes in a subject's gut microbiota. The change measured may be a change in the functional state and/or compositional state of the gut microbiota/microbiome. In one embodiment, the method comprises measuring at least one microbe-mediated modification at a first time and at a second time, and calculating the difference between the obtained values to measure the change in the subject's gut microbiota. Methods to measure microbe-mediated modification(s) are detailed in Section III and incorporated into this section by reference. In another embodiment, the method comprises isolating gut microorganisms at a first time and at a second time, and calculating the difference (either absolute or relative) between the isolated organisms to measure the change in the subject's gut microbiota and/or microbiome. Methods to isolate gut microorganisms are detailed in Section IV and incorporated into this section by reference. In each embodiment, the amount of time that elapses between the first and second measurement may vary. For instance, the amount of time may be hours, days, weeks, or even months.

In various embodiments, the aforementioned methods may be used to test the effect of a compound, a drug, a food, a food ingredient, a nutritional supplement (e.g., a fiber preparation, a prebiotic, a probiotic, a vitamin supplement, a mineral supplement, combinations thereof, etc.), an herbal remedy, a lifestyle modification, or a behavioral modification on the compositional and/or functional state of a subject's gut microbiota. For instance, the aforementioned methods may further comprise a step between the first and second measurement, or between isolation of gut microorganisms the first and second time, wherein the subject is administered a compound, a drug, a food, a food ingredient, a nutritional supplement, or an herbal remedy. Alternatively, or in addition, the method may further comprise a step between the first and second measurement, or between isolation of gut microorganisms the first and second time, wherein the subject engages in a lifestyle or behavioral modification. Non-limiting examples of lifestyle or behavior modifications include increased or decreased exercise, increased or decreased amounts of relaxation, increased or decreased caloric intake, increased or decreased fiber intake, increased or decreased fruit and/or vegetable consumption, increased or decreased fat consumption, increased or decreased alcohol consumption, or the like.

The first measurement or isolation is typically used to establish a baseline or starting condition. This may occur immediately prior to the lifestyle or behavioral modification, or administering the item to be tested, or at a reasonable time before as determined by one of skill in the art through routine experimentation. Similarly, the second measurement or isolation may occur immediately after the lifestyle or behavioral modification, or administering the item to be tested, or at a reasonable time before as determined by one of skill in the art through routine experimentation (e.g., hours, days, or weeks). In various embodiments, the lifestyle or behavioral modification or administration of the item to be tested may occur once or more than once between the first and second measurement/first and second isolation.

In one example, the present disclosure provides a method to test the effect of a food, a food ingredient, or a nutritional supplement on the functional state of a subject's gut microbiota, the method comprising (a) at a first time, measuring degradation of at least one biomolecule of interest according to the method of Section III, (b) administering an amount of a food, a food ingredient, or a nutritional supplement to the subject, (c) at a second time, after the administration of the food, repeating the measurement of step (a), and (d) calculating the difference between the values obtained from step (c) and step (a). In some embodiments, the food, food ingredient, or nutritional supplement is administered daily, and the second measurement occurs within 1, 2, 3, 4, 5, or 6 hours. In some embodiments, the food, food ingredient, or nutritional supplement is administered daily, and the second measurement occurs within 6, 7, 8, 9, 10, or 11 hours. In some embodiments, the food, food ingredient, or nutritional supplement is administered daily, and the second measurement occurs in about 1 to 12 hours or 12 to 24 hours. In some embodiments, the food, food ingredient, or nutritional supplement is administered daily, and the second measurement occurs about 1, 2, 3, 4, 5, or 6 days later. In some embodiments, the food, food ingredient, or nutritional supplement is administered daily, and the second measurement occurs about a week later. In each of the above embodiments, the food, food ingredient, or nutritional supplement may be administered multiple times a day, rather than once a day. Alternatively, the food, food ingredient, or nutritional supplement may be administered less frequently (e.g., every other day, once a week, etc.).

In one example, the present disclosure provides a method to test the effect of a lifestyle or behavioral modification on the functional state of a subject's gut microbiota, the method comprising (a) at a first time, measuring degradation of at least one biomolecule of interest according to the method of Section III, (b) performing a lifestyle or behavioral modification, (c) at a second time, after the lifestyle or behavioral modification, repeating the measurement of step (a), and (d) calculating the difference between the values obtained from step (c) and step (a). In some embodiments, the lifestyle or behavioral modification occurs daily, and the second measurement occurs within 1, 2, 3, 4, 5, or 6 hours. In some embodiments, the lifestyle or behavioral modification occurs daily, and the second measurement occurs within 6, 7, 8, 9, 10, or 11 hours. In some embodiments, the lifestyle or behavioral modification occurs daily, and the second measurement occurs in about 1 to 12 hours or 12 to 24 hours. In some embodiments, the lifestyle or behavioral modification occurs daily, and the second measurement occurs about 1, 2, 3, 4, 5, or 6 days later. In some embodiments, the lifestyle or behavioral modification occurs daily, and the second measurement occurs about a week later. In each of the above embodiments, the lifestyle or behavioral modification may occur multiple times a day, rather than once a day. Alternatively, the lifestyle or behavioral modification may occur less frequently (e.g., every other day, once a week, etc.).

In another example, the present disclosure provides a method to test the effect of the functional state of a subject's gut microbiota on a drug, the method comprising (a) at a first time, measuring degradation of the drug according to the method of Section III, wherein the drug is the compound of interest, (b) administering a pharmaceutical composition comprising the drug to the subject, (c) at a second time, after the administration of the pharmaceutical composition, repeating the measurement of step (a), and (d) calculating the difference between the values obtained from step (c) and step (a). In some embodiments, the pharmaceutical composition is administered daily, and the second measurement occurs within 1, 2, 3, 4, 5, or 6 hours. In some embodiments, the pharmaceutical composition is administered daily, and the second measurement occurs within 6, 7, 8, 9, 10, or 11 hours. In some embodiments, the pharmaceutical composition is administered daily, and the second measurement occurs in about 1 to 12 hours or 12 to 24 hours. In some embodiments, the pharmaceutical composition is administered daily, and the second measurement occurs about 1, 2, 3, 4, 5, or 6 days later. In some embodiments, the pharmaceutical composition is administered daily, and the second measurement occurs about a week later. In each of the above embodiments, the pharmaceutical composition may be administered multiple times a day, rather than once a day. Alternatively, the pharmaceutical composition may be administered less frequently (e.g., every other day, once a week, etc.).

### VI. Microbiota-Directed Foods

In another aspect, the present disclosure provides methods to develop and test microbiota-directed foods. A “microbiota-directed food,” as used herein, refers to a food that selectively promotes the representation and expressed beneficial functions of targeted human gut microbes.

For instance, the methods of Section III, Section IV, or Section V may be used to directly characterize how gut microorganisms with distinct, as well as overlapping, nutrient harvesting capacities respond to different food ingredients, or combinations of food ingredients, and use this information to develop a microbiota-directed food. As a non-limiting example, the methods of Section III, Section IV, or Section V may be used to test a plurality of biomolecules of the same type (e.g., arabinan) that have different molecular structures to identify bioactive component(s) to include in a microbiota-directed food (i.e., the structure(s) that are preferentially utilized by targeted gut microbiota). As another non-limiting example, the methods of Section III, Section IV, or Section V may be used to screen a food ingredient (e.g., pea fiber, fish oil, hydrolyzed whey protein isolate, etc.) provided by different suppliers to identify a source that maximizes the representation and/or expressed beneficial functions of targeted human gut microbes.

The methods of Section III, Section IV, or Section V may also be used to directly characterize how gut microorganisms with distinct, as well as overlapping, nutrient harvesting capacities respond to a potential microbiota-directed food and use this information to modify the composition of the microbiota-directed food to maximize the desired effect (e.g. maximizes the representation and/or expressed beneficial function(s) of targeted human gut microbes). As a non-limiting example, the methods of Section III, Section IV, or Section V may be used iteratively to test, refine/modify, retest, refine/modify, retest etc. a microbiota-directed food.

The methods of Section III, Section IV, or Section V may also be used to create a personalized microbiota-directed food for a given subject. As a non-limiting example, the methods of Section III, Section IV, or Section V may be used to directly characterize the compositional and/or functional state of a subject's gut microbiota and use this information to develop or select an appropriate microbiota-directed food to promotes the representation and expressed beneficial functions of targeted human gut microbes that will improve the health or well-being of that subject.

### EXAMPLES

The following examples illustrate various iterations of the invention and in some instances demonstrate preferred embodiments of the invention. It should be appreciated by those of skill in the art that the techniques disclosed in the examples that follow represent techniques discovered by the inventors to function well in the practice of the invention. Those of skill in the art should, however, in light of the present disclosure, appreciate that changes may be made in the specific embodiments that are disclosed and still obtain a like or similar result without departing from the spirit and scope of the invention. Therefore, all matter set forth or shown in the accompanying drawings is to be interpreted as illustrative and not in a limiting sense.

The references listed below are cited in the Examples that follow.
Adey, A., Morrison, H. G., Asan, Xun, X., Kitzman, J. O., Turner, E. H., Stackhouse, B., MacKenzie, A. P., Caruccio, N.C., Zhang, X., et al. (2010). Rapid, low-input, low-bias construction of shotgun fragment libraries by high-density in vitro transposition. Genome Biol 11, R₁₁₉.
Anderson, K. L., and Salyers, A. A. (1989) Biochemical-Evidence That Starch Breakdown by Bacteroides thetaiotaomicron Involves Outer-Membrane Starch-Binding Sites and Periplasmic Starch-Degrading Enzymes. J Bacteriol 171, 3192-3198.
Anumula, K. R., and Taylor, P. B. (1992) A Comprehensive Procedure for Preparation of Partially Methylated Alditol Acetates from Glycoprotein Carbohydrates. Anal Biochem 203, 101-108.
Bagenholm, V., Reddy, S. K., Bouraoui, H., Morrill, J., Kulcinskaja, E., Bahr, C. M., Aurelius, O., Rogers, T., Xiao, Y., Logan, D. T., Martens, E. C., Koropatkin, N. M., and Stalbrand, H. (2017) Galactomannan Catabolism Conferred by a Polysaccharide Utilization Locus of Bacteroides ovatus. J Biol Chem 292, 229-243.
Atmodjo, M. A., Hao, Z., and Mohnen, D. (2013). Evolving views of pectin biosynthesis. Annu Rev Plant Biol 64, 747-779.
Bagwe, R. P., Hilliard, L. R., and Tan, W. H. (2006) Surface modification of silica nanoparticles to reduce aggregation and nonspecific binding. Langmuir 22, 4357-4362.
Bates, D., Machler, M., Bolker, B. M., and Walker, S. C. (2015) Fitting Linear Mixed-Effects Models Using Ime4. J Stat Softw 67, 1-48.
Bielski, R., and Witczak, Z. (2013) Strategies for Coupling Molecular Units if Subsequent Decoupling Is Required. Chem Rev 113, 2205-2243.
Benjamini, Y., and Hochberg, Y. (1995) Controlling the False Discovery Rate—a Practical and Powerful Approach to Multiple Testing. J R Stat Soc B 57, 289-300.
Bokulich, N. A., Subramanian, S., Faith, J. J., Gevers, D., Gordon, J. I., Knight, R., Mills, D. A., and Caporaso, J. G. (2013). Quality-filtering vastly improves diversity estimates from Illumina amplicon sequencing. Nature Methods 10, 57-59.
Buffetto, F., Cornuault, V., Rydahl, M. G., Ropartz, D., Alvarado, C., Echasserieau, V., Le Gall, S., Bouchet, B., Tranquet, O., Verhertbruggen, Y., et al. (2015). The Deconstruction of Pectic Rhamnogalacturonan I Unmasks the Occurrence of a Novel Arabinogalactan Oligosaccharide Epitope. Plant Cell Physiol 56, 2181-2196.
Caffall, K. H., and Mohnen, D. (2009) The structure, function, and biosynthesis of plant cell wall pectic polysaccharides. Carbohyd Res 344, 1879-1900.
Carmody, R. N., Bisanz, J. E., Bowen, B. P., Maurice, C. F., Lyalina, S., Louie, K. B., Treen, D., Chadaideh, K. S., Maini Rekdal, V., Bess, E. N., Spanogiannopoulos, P., Ang, Q. Y., Bauer, K. C., Balon, T. W., Pollard, K. S., Northen, T. R., and Turnbaugh, P. J. (2019) Cooking shapes the structure and function of the gut microbiome. Nat Microbiol 4, 2052-2063.
Cartmell, A., McKee, L. S., Pena, M. J., Larsbrink, J., Brumer, H., Kaneko, S., Ichinose, H., Lewis, R. J., Vikso-Nielsen, A., Gilbert, H. J., and Marles-Wright, J. (2011) The Structure and Function of an Arabinan-specific alpha-1,2-Arabinofuranosidase Identified from Screening the Activities of Bacterial GH43 Glycoside Hydrolases. J Biol Chem 286, 15483-15495.
Clarkson, S. M., Giannone, R. J., Kridelbaugh, D. M., Elkins, J. G., Guss, A. M., and Michener, J. K. (2017). Construction and Optimization of a Heterologous Pathway for Protocatechuate Catabolism in Escherichia coli Enables Bioconversion of Model Aromatic Compounds. Applied and Environmental Microbiol 83, e01313-01317.
Desai, M. S., Seekatz, A. M., Koropatkin, N. M., Kamada, N., Hickey, C. A., Wolter, M., Pudlo, N. A., Kitamoto, S., Terrapon, N., Muller, A., et al. (2016). A Dietary Fiber-Deprived Gut Microbiota Degrades the Colonic Mucus Barrier and Enhances Pathogen Susceptibility. Cell 167, 1339-1353 e1321.
Doco, T., O'Neill, M. A., and Pellerin, P. (2001) Determination of the neutral and acidic glycosyl-residue compositions of plant polysaccharides by GC-EI-MS analysis of the trimethylsilyl methyl glycoside derivatives. Carbohyd Polym 46, 249-259.
Edgar, R. C. (2010). Search and clustering orders of magnitude faster than BLAST. Bioinformatics 26, 2460-2461.
Englyst, H. N., and Cummings, J. H. (1988). Improved Method for Measurement of Dietary Fiber as Non-Starch Polysaccharides in Plant Foods. Journal of the Association of Official Analytical Chemists 71, 808-814.
Faith, J. J., Ahern, P. P., Ridaura, V. K., Cheng, J., and Gordon, J. I. (2014). Identifying gut microbe-host phenotype relationships using combinatorial communities in gnotobiotic mice. Sci Transl Med 6, 220ra211.
Faith, J. J., Guruge, J. L., Charbonneau, M., Subramanian, S., Seedorf, H., Goodman, A. L., Clemente, J. C., Knight, R., Heath, A. C., Leibel, R. L., et al. (2013). The long-term stability of the human gut microbiota. Science 341, 1237439.
Filisetti-Cozzi, T. M., and Carpita, N.C. (1991). Measurement of uronic acids without interference from neutral sugars. Anal Biochem 197, 157-162.
Fragiadakis, G. K., Smits, S. A., Sonnenburg, E. D., Van Treuren, W., Reid, G., Knight, R., Manjurano, A., Changalucha, J., Dominguez-Bello, M. G., Leach, J., et al. (2018). Links between environment, diet, and the hunter-gatherer microbiome. Gut Microbes, 1-12.
Ghosh, T. S., Rampelli, S., Jeffery, I. B., Santoro, A., Neto, M., Capri, M., Giampieri, E., Jennings, A., Candela, M., Turroni, S., Zoetendal, E. G., Hermes, G. D. A., Elodie, C., Meunier, N., Brugere, C. M., Pujos-Guillot, E., Berendsen, A. M., De Groot, L., Feskins, E. J. M., Kaluza, J., Pietruszka, B., Bielak, M. J., Comte, B., Maijo-Ferre, M., Nicoletti, C., De Vos, W. M., Fairweather-Tait, S., Cassidy, A., Brigidi, P., Franceschi, C., and O'Toole, P. W. (2020) Mediterranean diet intervention alters the gut microbiome in older people reducing frailty and improving health status: the NU-AGE 1-year dietary intervention across five European countries. Gut Epub ahead of print: 23-03-2020. doi:10.1136/gutjnl-2019-319654
Glabe, C. G., Harty, P. K., and Rosen, S. D. (1983) Preparation and properties of fluorescent polysaccharides. Analytical Biochemistry 130, 287-294.
Glenwright, A. J., Pothula, K. R., Bhamidimarri, S. P., Chorev, D. S., Basle, A., Firbank, S. J., Zheng, H., Robinson, C. V., Winterhalter, M., Kleinekathofer, U., Bolam, D. N., et al. (2017). Structural basis for nutrient acquisition by dominant members of the human gut microbiota. Nature 541, 407-411.
Goodman, A. L., McNulty, N. P., Zhao, Y., Leip, D., Mitra, R. D., Lozupone, C. A., Knight, R., and Gordon, J. I. (2009). Identifying genetic determinants needed to establish a human gut symbiont in its habitat. Cell Host & Microbe 6, 279-289.
Goodman, A. L., Kallstrom, G., Faith, J. J., Reyes, A., Moore, A., Dantas, G., and Gordon, J. I. (2011) Extensive personal human gut microbiota culture collections characterized and manipulated in gnotobiotic mice. Proc Natl Acad Sci USA 108, 6252-6257.
Gualberto, D. G., Bergman, C. J., Kazemzadeh, M., and Weber, C. W. (1997) Effect of extrusion processing on the soluble and insoluble fiber, and phytic acid contents of cereal brans. Plant Food Hum Nutr 51, 187-198.
Hibberd, M. C., Wu, M., Rodionov, D. A., Li, X., Cheng, J., Griffin, N. W., Barratt, M. J., Giannone, R. J., Hettich, R. L., Osterman, A. L., et al. (2017). The effects of micronutrient deficiencies on bacterial species from the human gut microbiota. Sci Transl Med 9.
Hibbing, M. E., Fuqua, C., Parsek, M. R., and Peterson, S. B. (2010). Bacterial competition: surviving and thriving in the microbial jungle. Nature Reviews Microbiology 8, 15-25.
Johnson, A. J., Vangay, P., Al-Ghalith, G. A., Hillmann, B. M., Ward, T. L., Shields-Cutler, R. R., Kim, A. D., Shmagel, A. K., Syed, A. N., Personalized Microbiome Class, S., Walter, J., Menon, R., Koecher, K., and Knights, D. (2019) Daily Sampling Reveals Personalized Diet-Microbiome Associations in Humans. Cell Host Microbe 25, 789-802.
Koniev, O., and Wagner, A. (2015) Developments and recent advancements in the field of endogenous amino acid selective bond forming reactions for bioconjugation. Chem Soc Rev 44, 5495-5551.
Kotarski, S. F., and Salyers, A. A. (1984). Isolation and characterization of outer membranes of Bacteroides thetaiotaomicron grown on different carbohydrates. Journal of Bacteriology 158, 102-109.
Langmead, B., and Salzberg, S. L. (2012) Fast gapped-read alignment with Bowtie 2. Nat Methods 9, 357-359.
Law, C. W., Chen, Y., Shi, W., and Smyth, G. K. (2014). voom: Precision weights unlock linear model analysis tools for RNA-seq read counts. Genome Biol 15, R₂₉.
Lees, A., Nelson, B. L., and Mond, J. J. (1996) Activation of soluble polysaccharides with 1-cyano-4-dimethylaminopyridinium tetrafluoroborate for use in protein-polysaccharide conjugate vaccines and immunological reagents. Vaccine 14, 190-198.
Levigne, S., Thomas, M., Ralet, M. C., Quemener, B. C., and Thibault, J. F. (2002). Determination of the degrees of methylation and acetylation of pectins using a C18 column and internal standards. Food Hydrocolloids 16, 547-550.
Lloyd-Price, J., Mahurkar, A., Rahnavard, G., Crabtree, J., Orvis, J., Hall, A. B., Brady, A., Creasy, H. H., McCracken, C., Giglio, M. G., McDonald, D., Franzosa, E. A., Knight, R., White, O., and Huttenhower, C. (2017) Strains, functions and dynamics in the expanded Human Microbiome Project. Nature 550, 61-66.
Luis, A. S., Briggs, J., Zhang, X., Farnell, B., Ndeh, D., Labourel, A., Basle, A., Cartmell, A., Terrapon, N., Stott, K., et al. (2018). Dietary pectic glycans are degraded by coordinated enzyme pathways in human colonic Bacteroides. Nature Microbiol 3, 210-219.
Luo, W. J., Friedman, M. S., Shedden, K., Hankenson, K. D., and Woolf, P. J. (2009) GAGE: generally applicable gene set enrichment for pathway analysis. BMC Bioinformatics 10, 161.
Lynch, J. B., and Sonnenburg, J. L. (2012). Prioritization of a plant polysaccharide over a mucus carbohydrate is enforced by a Bacteroides hybrid two-component system. Mol Microbiol 85, 478491.
Ma, Z. Q., Dasari, S., Chambers, M. C., Litton, M. D., Sobecki, S. M., Zimmerman, L. J., Halvey, P. J., Schilling, B., Drake, P. M., Gibson, B. W., et al. (2009). IDPicker 2.0: Improved protein assembly with high discrimination peptide identification filtering. J Proteome Res 8, 3872-3881.
Martens, E. C., Lowe, E. C., Chiang, H., Pudlo, N. A., Wu, M., McNulty, N. P., Abbott, D. W., Henrissat, B., Gilbert, H. J., Bolam, D. N., et al. (2011). Recognition and degradation of plant cell wall polysaccharides by two human gut symbionts. PLoS Biology 9, e1001221.
Masuko, T., Minami, A., Iwasaki, N., Majima, T., Nishimura, S. I., and Lee, Y. C. (2005) Carbohydrate analysis by a phenol-sulfuric acid method in microplate format. Anal Biochem 339, 69-72.
McDonald, D., Price, M. N., Goodrich, J., Nawrocki, E. P., DeSantis, T. Z., Probst, A., Andersen, G. L., Knight, R., and Hugenholtz, P. (2012). An improved Greengenes taxonomy with explicit ranks for ecological and evolutionary analyses of bacteria and archaea. ISME J 6, 610-618.
McNulty, N. P., Yatsunenko, T., Hsiao, A., Faith, J. J., Muegge, B. D., Goodman, A. L., Henrissat, B., Oozeer, R., Cools-Portier, S., Gobert, G., Chervaux, C., Knights, D., Lozupone, C. A., Knight, R., Duncan, A. E., Bain, J. R., Muehlbauer, M. J., Newgard, C. B., Heath, A. C., and Gordon, J. I. (2011) The Impact of a Consortium of Fermented Milk Strains on the Gut Microbiome of Gnotobiotic Mice and Monozygotic Twins. Science Translational Medicine 3, 106ra106.
McNulty, N. P., Wu, M., Erickson, A. R., Pan, C., Erickson, B. K., Martens, E. C., Pudlo, N. A., Muegge, B. D., Henrissat, B., Hettich, R. L., et al. (2013). Effects of diet on resource utilization by a model human gut microbiota containing Bacteroides cellulosilyticus WH2, a symbiont with an extensive glycobiome. PLoS Biology 11, e1001637.
Menni, C., Jackson, M. A., Pallister, T., Steves, C. J., Spector, T. D., and Valdes, A. M. (2017). Gut microbiome diversity and high-fibre intake are related to lower long-term weight gain. Int J Obes (Lond) 41, 1099-1105.
Nicholson, J. K., Holmes, E., Kinross, J., Burcelin, R., Gibson, G., Jia, W., and Pettersson, S. (2012) Host-gut microbiota metabolic interactions. Science 336, 1262-1267.
Patnode, M. L., Beller, Z. W., Han, N. D., Cheng, J. Y., Peters, S. L., Terrapon, N., Henrissat, B., Le Gall, S., Saulnier, L., Hayashi, D. K., Meynier, A., Vinoy, S., Giannone, R. J., Hettich, R. L., and Gordon, J. I. (2019) Interspecies Competition Impacts Targeted Manipulation of Human Gut Bacteria by Fiber-Derived Glycans. Cell 179, 59-73.
Pattathil, S., Avci, U., Miller, J. S., and Hahn, M. G. (2012) Immunological approaches to plant cell wall and biomass characterization: Glycome Profiling. Methods Mol Biol 908, 61-72.
Pettolino, F. A., Walsh, C., Fincher, G. B., and Bacic, A. (2012). Determining the polysaccharide composition of plant cell walls. Nat Protoc 7, 1590-1607.
Porter, N. T., and Martens, E. C. (2017). The critical roles of polysaccharides in gut microbial ecology and physiology. Annu Rev Microbiol 71, 349-369.
Raman, A. S., Gehrig, J. L., Venkatesh, S., Chang, H. W., Hibberd, M. C., Subramanian, S., Kang, G., Bessong, P. O., Lima, A. A., Kosek, M. N., Petri, W. A., Rodionov, D. A., Arzamasov, A. A., Leyn, S. A., Osterman, A. L., Huq, S., Mostafa, I., Islam, M., Mahfuz, M., Haque, R., Ahmed, T., Barratt, M. J., and Gordon, J. I. (2019) A sparse covarying unit that describes healthy and impaired human gut microbiota development. Science 365, eaau4735.
Ridaura, V. K., Faith, J. J., Rey, F. E., Cheng, J., Duncan, A. E., Kau, A. L., Griffin, N. W., Lombard, V., Henrissat, B., Bain, J. R., et al. (2013). Gut microbiota from twins discordant for obesity modulate metabolism in mice. Science 341, 1241214.
Ritchie, M. E., Phipson, B., Wu, D., Hu, Y. F., Law, C. W., Shi, W., and Smyth, G. K. (2015) limma powers differential expression analyses for RNA-sequencing and microarray studies. Nucleic Acids Research 43, e47.
Rogowski, A., Briggs, J. A., Mortimer, J. C., Tryfona, T., Terrapon, N., Lowe, E. C., Basle, A., Morland, C., Day, A. M., Zheng, H., et al. (2015). Glycan complexity dictates microbial resource allocation in the large intestine. Nature Commun 6, 7481.
Scalbert, A., Brennan, L., Manach, C., Andres-Lacueva, C., Dragsted, L. O., Draper, J., Rappaport, S. M., van der Hooft, J. J., and Wishart, D. S. (2014) The food metabolome: a window over dietary exposure. Am J Clin Nutr 99, 1286-1308.
Schwalm, N. D., 3rd, Townsend, G. E., 2nd, and Groisman, E. A. (2016). Multiple Signals Govern Utilization of a Polysaccharide in the Gut Bacterium Bacteroides thetaiotaomicron. MBio 7.
Shafer, D. E., Toll, B., Schuman, R. F., Nelson, B. L., Mond, J. J., and Lees, A. (2000) Activation of soluble polysaccharides with 1-cyano-4-dimethylaminopyridinium tetrafluoroborate (CDAP) for use in protein-polysaccharide conjugate vaccines and immunological reagents. II. Selective crosslinking of proteins to CDAP-activated polysaccharides. Vaccine 18, 1273-1281.
Shahidi, F., Ho, C.-T., and Chuyen, N. v. (1998) Process-induced chemical changes in food, Plenum Press, New York.
Shepherd, E. S., DeLoache, W. C., Pruss, K. M., Whitaker, W. R., and Sonnenburg, J. L. (2018). An exclusive metabolic niche enables strain engraftment in the gut microbiota. Nature 557, 434-438.
Smyth, G. K. (2004). Linear models and empirical bayes methods for assessing differential expression in microarray experiments. Stat Appl Genet Mol Biol 3, Article3.
Sonnenburg, E. D., Smits, S. A., Tikhonov, M., Higginbottom, S. K., Wingreen, N. S., and Sonnenburg, J. L. (2016). Diet-induced extinctions in the gut microbiota compound over generations. Nature 529, 212-215.
Soto-Cantu, E., Cueto, R., Koch, J., and Russo, P. S. (2012) Synthesis and Rapid Characterization of Amine-Functionalized Silica. Langmuir 28, 5562-5569.
Stammler, F., Glasner, J., Hiergeist, A., Holler, E., Weber, D., Oefner, P. J., Gessner, A., and Spang, R. (2016) Adjusting microbiome profiles for differences in microbial load by spike-in bacteria. Microbiome 4, e28.
Tabb, D. L., Fernando, C. G., and Chambers, M. C. (2007). MyriMatch: highly accurate tandem mass spectral peptide identification by multivariate hypergeometric analysis. J Proteome Res 6, 654-661.
Tauzin, A. S., Laville, E., Xiao, Y., Nouaille, S., Le Bourgeois, P., Heux, S., Portais, J. C., Monsan, P., Martens, E. C., Potocki-Veronese, G., et al. (2016). Functional characterization of a gene locus from an uncultured gut Bacteroides conferring xylo-oligosaccharides utilization to Escherichia coli. Mol Microbiol 102, 579-592.
Terrapon, N., Lombard, V., Drula, E., Lapebie, P., Al-Masaudi, S., Gilbert, H. J., and Henrissat, B. (2018). PULDB: the expanded database of Polysaccharide Utilization Loci. Nucleic Acids Res 46, D677-D683.
Thibault, J. F. (1979). Automatisation du dosage des substances pectiques par la méthode au métahydroxydiphényle. Lebensml Wiss Technol 12, 247-251.
Ting, L., Cowley, M. J., Hoon, S. L., Guilhaus, M., Raftery, M. J., and Cavicchioli, R. (2009). Normalization and statistical analysis of quantitative proteomics data generated by metabolic labeling. Mol Cell Proteomics 8, 2227-2242.
Tuncil, Y. E., Xiao, Y., Porter, N. T., Reuhs, B. L., Martens, E. C., and Hamaker, B. R. (2017) Reciprocal Prioritization to Dietary Glycans by Gut Bacteria in a Competitive Environment Promotes Stable Coexistence. Mbio 8, e01068.
Wehrens, R., Weingart, G., and Mattivi, F. (2014) metaMS: An open-source pipeline for GC-MS-based untargeted metabolomics. J Chromatogr B 966, 109-116.
Wolf, A. R., Wesener, D. A., Cheng, J. Y., Houston-Ludlam, A. N., Beller, Z. W., Hibberd, M. C., Giannone, R. J., Peters, S. L., Hettich, R. L., Leyn, S. A., Rodionov, D. A., Osterman, A. L., and Gordon, J. I. (2019) Bioremediation of a Common Product of Food Processing by a Human Gut Bacterium. Cell Host Microbe 26, 463-477.
Wu, M., McNulty, N. P., Rodionov, D. A., Khoroshkin, M. S., Griffin, N. W., Cheng, J., Latreille, P., Kerstetter, R. A., Terrapon, N., Henrissat, B., et al. (2015). Genetic determinants of in vivo fitness and diet responsiveness in multiple human gut Bacteroides. Science 350, aac5992.
Zeevi, D., Korem, T., Zmora, N., Israeli, D., Rothschild, D., Weinberger, A., Ben-Yacov, O., Lador, D., Avnit-Sagi, T., Lotan-Pompan, M., et al. (2015). Personalized Nutrition by Prediction of Glycemic Responses. Cell 163, 1079-1094.
Zhao, L., Zhang, F., Ding, X., Wu, G., Lam, Y. Y., Wang, X., Fu, H., Xue, X., Lu, C., Ma, J., et al. (2018). Gut bacteria selectively promoted by dietary fibers alleviate type 2 diabetes. Science 359, 1151-1156.

### Example 1—Glycan-Coated Paramagnetic Beads

A food-grade, pea fiber preparation was purchased from a commercial supplier. The compositional analysis of the pea fiber preparation is found in Table B. Wheat Arabinoxylan and Icelandic Moss Lichenan were purchased from Megazyme (P-WAXYL, P-LICHN) and yeast alpha-mannan was purchased from Sigma-Aldrich (M7504). Polysaccharides were solubilized in water (at a concentration of 5 mg/mL for pea fiber and 20 mg/mL for arabinoxylan and lichenan), sonicated and heated to 100° C. for 1 minute, then centrifuged at 24,000×g for 10 minutes to remove debris. TFPA-PEG3-biotin (Thermo Scientific), dissolved in DMSO (10 mg/mL) was added to the polysaccharide solution at a ratio of 1:5 (v/v). The sample was subjected to UV irradiation for 10 minutes (UV-B 306 nm, 7844 mJ total), and then diluted 1:4 to facilitate desalting on 7 kD Zeba spin columns (Thermo Scientific).

Biotinylated polysaccharide was mixed with one of several biotinylated fluorophores (PF-505, PF-510LSS, PF-633, PF-415; all at a concentration of 50 ng/mL; all obtained from Promokine). A 500 μL aliquot of this preparation was incubated with 10⁷ paramagnetic streptavidin-coated silica beads (LSKMAGT, Millipore Sigma) for 24 hours at room temperature. Beads were washed by centrifugation three times with 1 mL HNTB buffer (10 mM HEPES, 150 mM NaCl, 0.05% Tween-20, 0.1% BSA) followed by addition of 5 μg/mL streptavidin (Jackson Immunoresearch) in HNTB (30 min incubation at room temperature). Beads were washed as before and then incubated with 250 μL of the biotinylated polysaccharide preparation. The washing, streptavidin, and polysaccharide incubation steps were repeated three times.

Bead preparations were assessed using an Aria III cell sorter (BD Biosciences) to confirm adequate labeling. Beads were incubated with 70% ethanol for 1 minute in a biosafety cabinet, then washed three times with 1 mL sterile HNTB using a magnetic stand. The different bead types were combined, diluted, and aliquoted to 10⁷ beads per 650 μL HNTB in sterile Eppendorf microcentrifuge tubes. The number of beads in each aliquot was counted using an Aria III cell sorter and CountBright fluorescent microspheres (BD Bioscience).

Bead preparations were analyzed by GC-MS to quantify the amount of carbohydrate bound. Beads were sorted back into their polysaccharide types based on fluorescence using an Aria III sorter (average sort purity, 96%). Sorted samples were centrifuged (500×g for 5 minutes) to pellet beads and the beads were transferred to a 96-well plate. All bead samples were incubated with 1% SDS/6M Urea/HNTB for 10 minutes at room temperature to remove exogenous components, washed three times with 200 μL HNTB using a magnetic plate rack, and then stored overnight at 4° C. prior to monosaccharide analysis. The number and purity of beads in each sorted sample was determined by taking an aliquot for analysis on the Aria III cell sorter. Equal numbers of beads from each sample were transferred to a new 96-well plate and the supernatant was removed with a magnetic plate rack. For acid hydrolysis, 200 μL of 2M trifluoroacetic acid and 250 ng/mL myo-inositol-D6 (CDN Isotopes; spike-in control) were added to each well, and the entire volume was transferred to 300 μL glass vials (ThermoFisher; catalog number C4008-632C). Another aliquot was taken to verify the final number of beads in each sample. Monosaccharide standards were included in separate wells and subjected to the hydrolysis protocol in parallel with the other samples. Vials were crimped with Teflon-lined silicone caps (ThermoFisher) and incubated at 100° C. with rocking for 2 h. Vials were then cooled, spun to pellet beads, and their caps were removed. A 180 μL aliquot of the supernatant was collected and transferred to new 300 μL glass vials. Samples were dried in a SpeedVac for 4 hours, methoximated in 20 μL O-methoxyamine (15 mg/mL pyridine) for 15 h at 37° C., followed by trimethylsilylation in 20 μL MSTFA/TMCS [N-Methyl-N-trimethylsilyltrifluoroacetamide/2,2,2-trifluoro-N-methyl-N-(trimethylsilyl)-acetamide, chlorotrimethylsilane] (ThermoFisher) for 1 h at 70° C. One half volume of heptane (20 μL) was added before loading the samples for injection onto a 7890B gas chromatography system coupled to a 5977B MS detector (Agilent). The mass of each monosaccharide detected in each sample of sorted beads was determined using monosaccharide standard curves. This mass was then divided by the final count of beads in each sample to produce a measurement of mass of recoverable monosaccharide per bead.

TABLE 1
Monosaccharide analysis of wheat arabinoxylan
beads and pea fiber beads

| | | Mean (pg/bead) | sd |
|---|---|---|---|
| Xylose | Arabinoxylan beads | 0.17 | 0.12 |
| | Pea Fiber beads | 0.06 | 0.07 |
| | Uncoated beads | 0.01 | 0.01 |
| Arabinose | Arabinoxylan beads | 0.54 | 0.25 |
| | Pea Fiber beads | 0.2 | 0.06 |
| | Uncoated beads | 0.06 | 0.02 |
| Mannose | Arabinoxylan beads | 0.02 | 0.02 |
| | Pea Fiber beads | 0.04 | 0.02 |
| | Uncoated beads | 0.06 | 0.03 |
| Galactose | Arabinoxylan beads | 0.02 | 0.01 |
| | Pea Fiber beads | 0.05 | 0.03 |
| | Uncoated beads | 0 | 0.01 |
| Glucose | Arabinoxylan beads | 0.02 | 0.04 |
| | Pea Fiber beads | 0.01 | 0.02 |
| | Uncoated beads | 0.01 | 0.01 |

### Example 2—Glycan-Coated Paramagnetic Beads

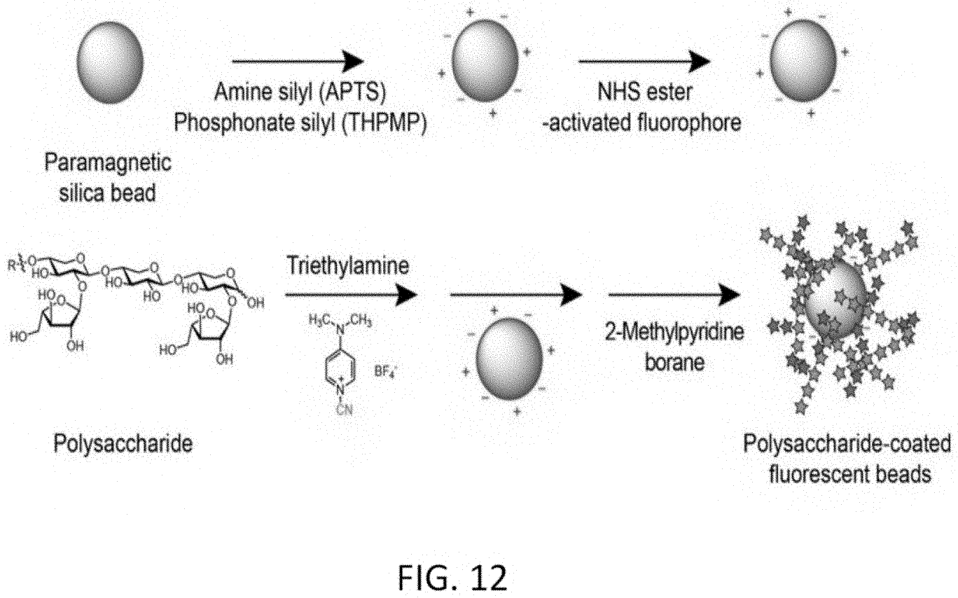

This example describes an alternative method used to attach polysaccharides to paramagnetic glass beads. To covalently immobilize polysaccharides onto paramagnetic glass beads for use as biosensors of gut microbiota biochemical function, a bead with unique chemical functionality was developed. Amine functional groups were added to the bead surface as a chemical handle because of their nucleophilic nature at neutral pH and their utility in multiple bioconjugation reactions (Koniev et al., 2015). It was hypothesized that the amine functional group could be used for two critical functions: 1) addition of a fluorophore for the multiplexed analysis of multiple bead types within a single animal or subject, and 2) the covalent immobilization of an activated polysaccharide (FIG. 12).

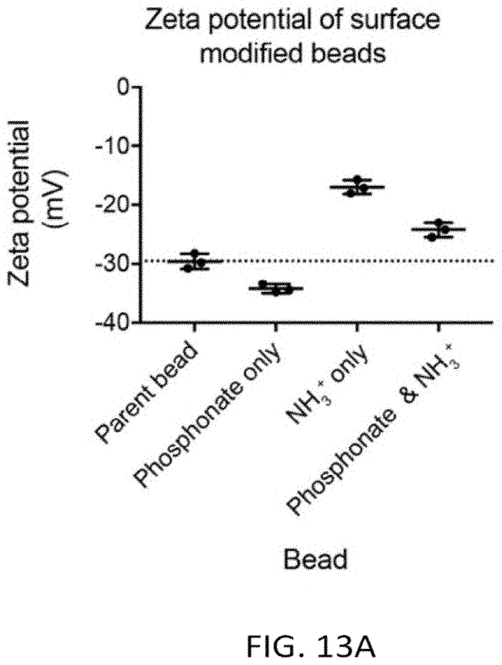

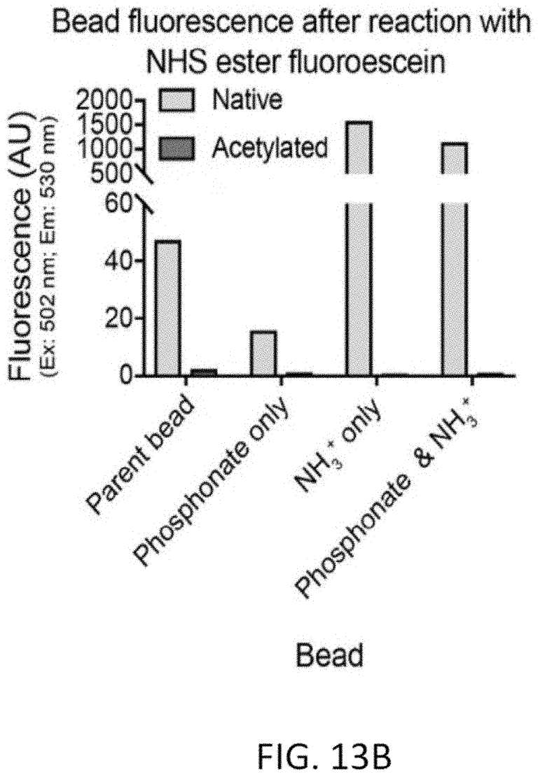

To install amines on the bead surface, the activated amine-silyl reagent (3-aminopropyl)triethoxysilane (APTS) was reacted with bead in the presence of water. Under the same reaction conditions, a zwitterionic surface could be generated with 3-(trihydroxysilyl)propyl methylphosphonate (THPMP) to an APTS containing reaction. The additional phosphonate functionality was important to reduce nonspecific binding to the bead surface (Bagwe et al., 2006). The zeta potential of surface modified paramagnetic silica beads was used to monitor the addition of both amine and phosphonate functional groups onto the bead surface (FIG. 13A).

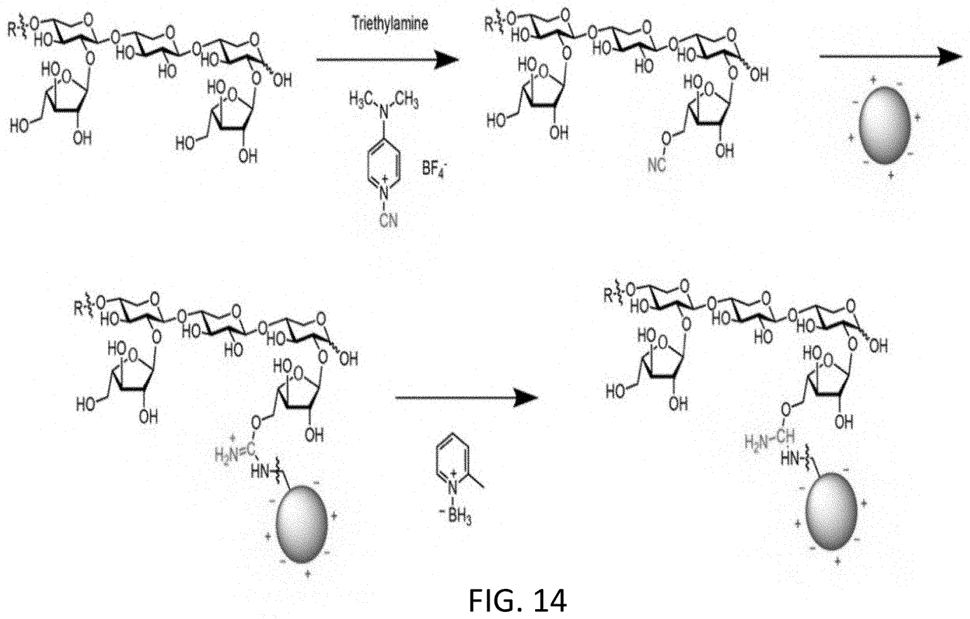

N-Hydroxysuccinim ide ester (NHS)-activated fluorophores were covalently bound to the bead surface to facilitate the multiplexed analysis of multiple bead types within a single animal. With fluorescent amine-phosphonate paramagnetic glass beads in hand, we next sought to covalently immobilize polysaccharides of interest of the bead surface. Strategies for bioconjugation with polysaccharides are lacking compared to proteins, peptide, and nucleic acids due to the limited chemical functionality naturally occurring within polysaccharides. We chose to activate polysaccharides using a cyano (CN—) donor to generate a cyano-ester. Suitable cyano-donors include, but are not limited to, cyanogen bromide (CNBr) (Glabe et al., 1983) and the organic nitrile donor 1-cyano-4-dimethylaminopyridinium tetrafluoroborate (CDAP) (Lees et al., 1996). Both donors have been used for the generation of affinity matrixes on agarose beads and the synthesis of polysaccharide-conjugate vaccines; specifically, CDAP activation and conjugation was used for the development of the pneumococcal-conjugate vaccines (Lees et al., 1996). We chose CDAP because of its solubility in DMSO and the fact that it is less pH sensitive and less toxic than CNBr. CDAP was dissolved in DMSO and added to a solution of polysaccharide in the presence of catalytic triethylamine. CDAP nonspecifically generates cyano-ester electrophiles from the hydroxyls naturally present within a polysaccharide (FIG. 14). After activation, fluorescent amine-phosphonate beads were added. The solution was allowed to react overnight. Reaction of bead surface amine and the cyano-ester group of the activated polysaccharide yields a liable isourea bond that is reduced to a stable covalent bond with the addition of a hydride donor. We chose 2-methylpyridine borane although harsher donors such as sodium borohydride or sodium cyanoborohydride will also work. Immobilization of polysaccharide on the bead surface and reduction of the isourea bond has little to no effect on bead fluorescence.

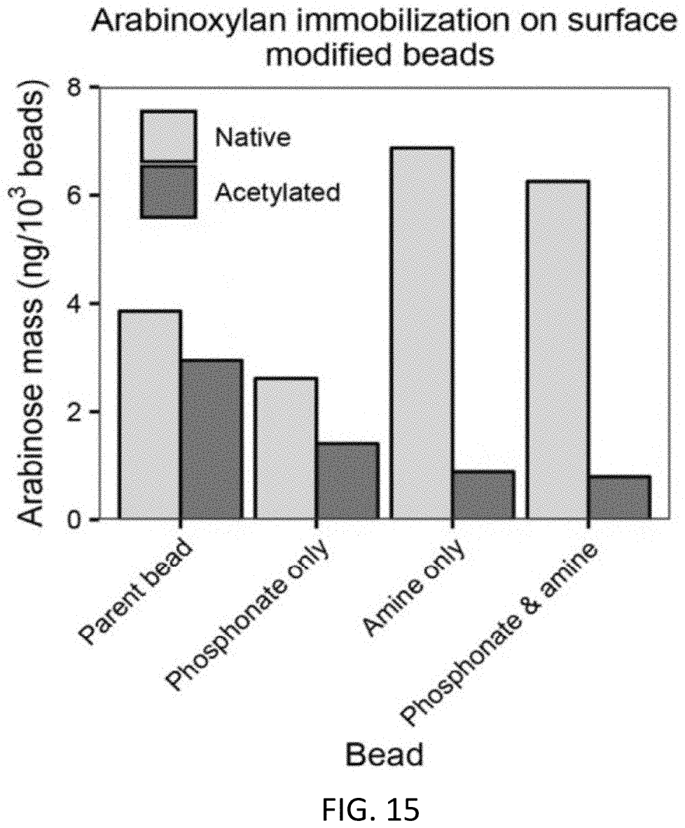

Polysaccharide immobilization on the bead surface was quantified via acid hydrolysis of surface-immobilized polysaccharide and quantification of the liberated monosaccharides using gas chromatography mass spectrometry (GC-MS). Polysaccharide was hydrolyzed using 2 M trifluoroacetic acid and liberated monosaccharides were quantified as silylated methoxyamine-reduced monosaccharides using free monosaccharides as standards. Beads were enumerated with flow cytometry and an equal number of each bead type were assayed in parallel. Beads lacking surface amines, or beads reacted with polysaccharides not activated with CDAP, lacked surface-immobilized polysaccharide (FIG. 15). Typical bead yields are 5-25 pg of immobilized polysaccharide per bead.

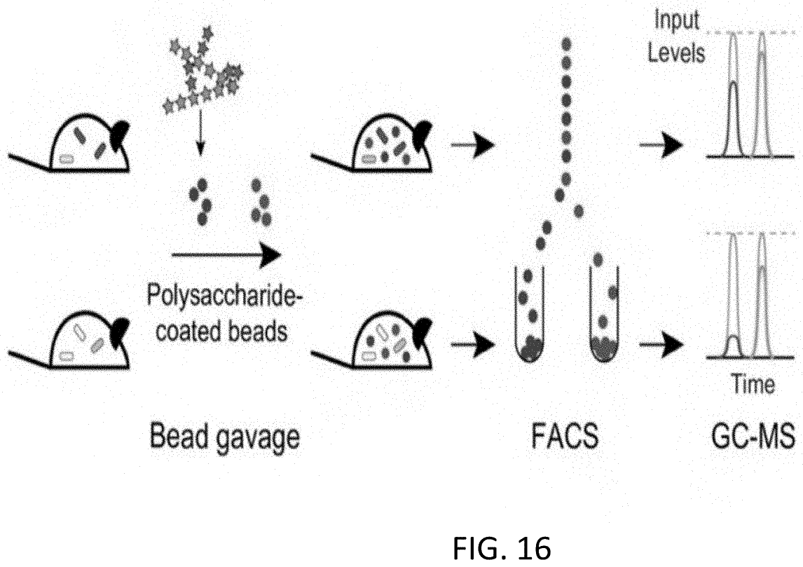

Multiple types of polysaccharide-coated beads labeled with distinct fluorophores were pooled and gavaged into gnotobiotic mouse models as biosensors of gut community biochemical function. Polysaccharide degradation was measured as a function of 1) community composition, and 2) diet. Pooled beads were gavaged into germ-free mice 4 hours prior to animals were euthanized; beads were subsequently isolated from the mouse cecum based on their density and magnetic properties. Polysaccharide degradation was quantified as the amount of polysaccharide remaining covalently bound to the bead after passage through the gut and recovery from the cecum (FIG. 16).

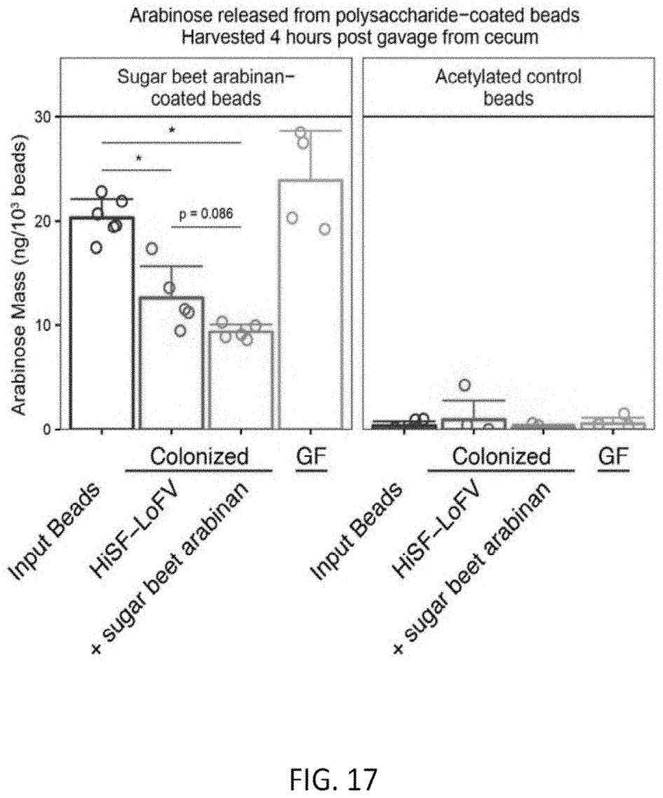

The ability of a microbiota to degrade a commercially available preparation of sugar beet arabinan (Megazyme; cat. no.: P-ARAB) was determined by comparing amine phosphonate beads coated with the carbohydrate to control beads whose surface amines were acetylated. Sugar beet arabinan is a polymer containing the monosaccharides arabinose, galactose, rhamnose, and galacturonic acid. Neutral monosaccharides were quantified after hydrolysis of bead-bound polysaccharide. Arabinose liberated during acid hydrolysis of sugar beet arabinan-coated beads was used as a marker of arabinan degradation. Comparison of input beads to beads passed through germ-free animals demonstrates that sugar beet arabinan is not digested by host enzymes during passage through a mouse (FIG. 17). However, beads gavaged into colonized mice exhibited reduced levels of arabinan remaining on the surface, and the levels of degradation changed as a function of mouse diet. The microbiota of mice fed a diet high in saturated fat and low in fruits and vegetables (HiSF-LoFV) or mice fed a HiSF-LoFV diet supplemented with 100 mg/mouse/day sugar beet arabinan degraded a significant amount of sugar beet arbainan when compared to input beads that were not gavaged into mice colonized with a defined 14-member consortium composed of human gut microbiota that had been cultured and their genomes sequenced (Table 2) (Ridaura et al., 2013; Wu et al., 2015). Additionally, colonized mice fed HiSF-LoFV diet supplemented sugar beet arabinan showed increased degradation capacity as compared to colonized mice fed the unsupplemented HiSF-LoFV diet (p=0.086; pairwise Welch's t-test). These results demonstrate that 1) the defined model human microbiota was required for sugar beet arabinan degradation and 2) dietary supplementation with sugar beet arabinan changed the functional capacity of the microbiota to degrade this glycan.

TABLE 2
Bacterial strains comprising the model
defined human gut community.

| Bacteria | Strain | Citation |
|---|---|---|
| Bacteroides ovatus | ATCC 8483 | (Wu et al., 2015) |
| | INSeq | |
| Bacteroides cellulosilyticus | WH2 INSeq | (Wu et al., 2015) |
| Bacteroides thetaiotaomicron | ATCC 7330 | (Wu et al., 2015) |
| | INSeq | |
| Bacteroides thetaiotaomicron | VPI-5482 | (Wu et al., 2015) |
| | INSeq | |
| Bacteroides vulgatus | ATCC 8482 | (Wu et al., 2015) |
| | INSeq | |
| Bacteroides caccae | TSDC17.2 | (Ridaura et al., 2013) |
| Bacteroides finegoldii | TSDC17.2 | (Ridaura et al., 2013) |
| Bacteroides massiliensis | TSDC17.2 | (Ridaura et al., 2013) |
| Collinsella aerofaciens | TSDC17.2 | (Ridaura et al., 2013) |
| Escherichia coli | TSDC17.2 | (Ridaura et al., 2013) |
| Odoribacter splanchnicus | TSDC17.2 | (Ridaura et al., 2013) |
| Parabacteroides distasonis | TSDC17.2 | (Ridaura et al., 2013) |
| Ruminococcaceae sp. | TSDC17.2 | (Ridaura et al., 2013) |
| Subdoligranulum variabile | TSDC17.2 | (Ridaura et al., 2013) |

Further details are provided below for the materials and methods used in the above experiments.

Synthesis of amine phosphonate beads: To a solution of microscopic (10 μm) paramagnetic silica beads (Millipore Sigma; Cat no: LSKMAGN01) in water, equal molar amounts of (3-aminopropyl)triethoxysilane (APTS) (Sigma Aldrich) and 3-(trihydroxysilyl)propyl methylphosphonate (THPMP) (Sigma Aldrich) were added (Bagwe et al., 2006; Soto-Cantu et al., 2012). The reaction was allowed to proceed for 5 hours at 50° C. with shaking. The reaction was terminated with repeated washing of beads with water using a magnet.

Zeta potential measurement: Zeta potential was measured to track modification of the bead surface. Zeta potential measurements were obtained on a Malvern ZEN3600 using disposable Malvern zeta potential cuvettes. Measurements were obtained with the default settings of the instrument, using the refractive index of SiO₂ as the material, and water as the dispersant. Beads were resuspended to a concentration of 5×10⁵/mL in 10 mM (4-(2-hydroxyethyl)-1-piperazineethanesulfonic acid) (HEPES; pH 7.2) and analyzed in triplicate. Zeta potential of starting beads and beads monofunctionalized with APTS or THPMP were used as standards.

Fluorophore labeling of amine phosphonate beads: Fluorophores were covalently bound to the bead surface to facilitate the multiplexed analysis of multiple bead types within a single animal. N-Hydroxysuccinimide ester (NHS)-activated fluorophores were dissolved in dimethyl sulfoxide (DMSO) at 1 mM. Resuspended fluorophore was diluted into a solution of 20 mM HEPES (pH 7.2) and 50 mM NaCl to a final concentration of 100 nM and incubated with amine phosphonate beads for 50 minutes at 22° C. Beads were washed repeatedly with water to terminate the reaction. The extent of fluorophore labeling was assessed on each bead type using flow cytometry. The concentration of fluorophore used was the lowest at which the bead populations could be reliably and easily distinguished via flow cytometry. Fluorophores and their sources: Alexa Fluor 488 NHS ester (Life Technologies; cat. no.: A20000), Promofluor 415 NHS ester (PromoKine; cat. no.: PK-PF415-1-01), Promofluor 633P NHS ester (PromoKine; cat. no.: PK-PF633P-1-01), and Promofluor 510-LSS NHS ester (PromoKine; cat. no.: PK-PF510LSS-1-01).

Amine phosphonate bead acetylation: Acetylation of bead surface amines was used to confirm the specific linkage of both fluorophore and polysaccharides to the bead surface. Acetylated beads were also used as an empty bead control when gavaged into mice. Bead surface amines were acetylated using acetic anhydride under anhydrous conditions. Amine phosphonate beads were washed repeatedly with multiple solvents with the goal of resuspending the beads in anhydrous methanol; beads were washed in water, then methanol, then anhydrous methanol. Pyridine (0.5 volume equivalents) was then added as a base followed by acetic anhydride (0.5 volume equivalents). The reaction was allowed to proceed for 3 hours at 22° C. and then quenched with repeated washing with water. The described acetylation conditions had no effect on the fluorescence of any of the four fluorophores tested.

Polysaccharide conjugation to amine phosphonate beads: Polysaccharides were dissolved at 3-10 mg/mL in 50 mM HEPES (pH 8) with heat and sonication. To a solution of polysaccharide (5 mg/mL) containing trimethylamine (0.5 equivalent), 1-cyano-4-dimethylaminopyridinium tetrafluoroborate (CDAP; Sigma Aldrich; 1 eq.) dissolved in DMSO was added. The optimal concentration of CDAP was found to be 0.2 mg of CDAP per mg of polysaccharide. The polysaccharide/CDAP solution was mixed for 5 minutes at 22° C. to allow for polysaccharide activation. Amine phosphonate beads resuspended in 50 mM HEPES (pH 8) were added to the activated polysaccharide solution and the reaction was allowed to proceed for 15 hours at 22° C. Any aggregated beads were resuspended with light sonication. The resulting isourea linkage between the bead and polysaccharide was reduced by addition of 2-picoline borane dissolved in DMSO (10% wt:wt) and incubation for 40 minutes at 40° C. The reaction was terminated with repeated washing in water and then 20 mM HEPES (pH 7.2) 50 mM NaCl. The described reaction conditions for polysaccharide conjugation or reduction had little or no effect on the fluorescence of any of the four fluorophores tested.

Bead counting: The absolute number of beads in a solution was determined with flow cytometry using CountBright Absolute Counting Beads (ThermoFisher Scientific; cat. no.: C36950) according to the manufacturer's suggested protocol.

Bead pooling and gavage into gnotobiotic mice: Pools of equal number of each bead type were prepared from fluorophore-labeled polysaccharide-coated amine phosphonate beads. The required number of a given bead type was sterilized with 70% ethanol for 10 minutes before washing with sterile water and 20 mM HEPES (pH 7.2), 50 mM NaCl, 0.01% bovine serum albumin, and 0.01% Tween-20. The different bead types were then pooled into a single mixture.

Pooled bead mixtures (10-15×10⁶ beads) were gavaged into gnotobiotic mice 4-6 hours prior to sacrifice. Beads were harvested from cecal contents using bead density and magnetism. Beads were sorted back into the original bead type using fluorescence-activated cell sorting (FACS; BD FACSAria III).

Quantitation of polysaccharide degradation: Polysaccharide degradation was determined by quantifying the amount of monosaccharide hydrolyzed from bead-bound polysaccharide after bead passage through a mouse. To do so, an equal number of beads were placed in crimp-top glass vials and hydrolyzed using 2 M trifluoroacetic acid for 2 hours at 95° C. The solution was reduced to dryness under reduced pressure. Liberated monosaccharides were reduced with methoxyamine (15 mg/mL in pyridine) for 15 hours at 37° C. Hydroxyl groups were silylated using N-Methyl-N-trimethylsilyltrifluoroacetamide (MSTFA) 1% 2,2,2-Trifluoro-N-methyl-N-(trimethylsilyl)-acetamide, chlorotrimethylsilane (TCMS) (ThermoFisher Scientific; Cat. no.: TS-48915) for 1 hour at 60° C. Samples were diluted with heptane and analyzed by GC-MS on Agilent 7890A gas chromatography system, coupled with a 5975C mass spectrometer detector (Agilent). Monosaccharide composition and quantitation were determined using chemical standards simultaneously derivatized.

### Example 3—Layered Glycan Beads

As described in Example 1, several layers of a single glycan were applied to a bead by serial incubation of the beads (obtained from the manufacturer with streptavidin covalently bound) with biotin-glycan, then streptavidin, then biotin-glycan, then streptavidin, then biotin-glycan. This is possible since streptavidin has four biotin binding sites, allowing it to link the previous layer of biotin-glycan to a new layer of biotin-glycan. This method may can be modified to create a bead with layers of different glycans, or alternating layers of glycans, by using multiple types of biotin-glycan (e.g., biotin-glycan 1, biotin-glycan 2, biotin, etc.).

As described in Example 2, glycans were conjugated to amine phosphonate beads by first activing the glycans with CDAP. Multi-layered beads can also be prepared by the CDAP method because a diamine can serve the same linking function between previous and new layers, since it has two amine groups.

The procedures above have been performed with alternating arabinoxylan and mannan layers. Other chemistries may also be used.

### Example 4—In Vivo Screen for Fiber Preparations that Target Specific Human Gut Microbes

In the present study, we describe an in vivo approach for identifying fibers and their bioactive components that selectively increase the fitness of a group of human gut Bacteroides, and the different mechanisms these organisms deploy when encountering these nutrient resources and one another. The bacterial targets for fiber-based manipulation originated from our previous study of twins stably discordant for obesity (Ridaura et al., 2013). Fecal microbiota from these twin pairs transmitted discordant adiposity and metabolic dysfunction phenotypes to recipient germ-free mice. Co-housing mice shortly after they received microbial communities from lean (Ln) or obese (Ob) co-twins prevented recipients of the Ob donor microbiota from developing obesity and associated metabolic abnormalities. Analysis of their gut communities revealed that invasion of Bacteroides species from Ln into Ob microbiota, notably B. thetaiotaomicron, B. vulgatus, B. caccae, and B. cellulosilyticus, correlated with protection from the increased adiposity and metabolic phenotypes that developed in co-housed Ob-Ob controls. Invasion was diet-dependent, occurring when animals consumed a human diet designed to represent the lower tertile of consumption of saturated fats and upper tertile of consumption of fruits and vegetables (high in fiber) in the USA, but not when they consumed a diet representing the upper tertile of saturated fat and lower tertile of fruit and vegetable consumption (Ridaura et al., 2013). Here we identify dietary fiber preparations and constituent bioactive components that increase the fitness of these targeted Bacteroides (B. thetaiotaomicron, B. vulgatus, B. caccae, and/or B. cellulosilyticus) in vivo in the high saturated fatty acid-low fruits and vegetables (HiSF-LoFV) diet context. To do so, we first colonized germ-free mice with a defined consortium of sequenced bacterial strains cultured from a Ln donor in an obesity-discordant twin pair. Mice were fed 144 different diets generated by supplementing the HiSF-LoFV formulation with 34 different food-grade fiber preparations in different combinations at different concentrations. Armed with a consortium that contained targeted Bacteroides species, each in the form of a library of tens of thousands of transposon (Tn) mutant strains, and employing high resolution mass spectrometry, we subsequently characterized the effects of monotonous feeding of selected fiber preparations on the community's expressed proteome and on the fitness of Tn mutants. By identifying polysaccharide processing genes whose expression was increased and that functioned as key fitness determinants, we inferred which components of the fiber preparations were bioactive. Time series proteomic analyses of the complete community and derivatives lacking one or more Bacteroides, revealed nutrient harvesting strategies resulting in, as well as alleviating interspecies competition for fiber components. Finally, administering artificial food particles coated with dietary polysaccharides to gnotobiotic mice with deliberately varied community membership further established the contributions of individual Bacteroides species to glycan processing in vivo.

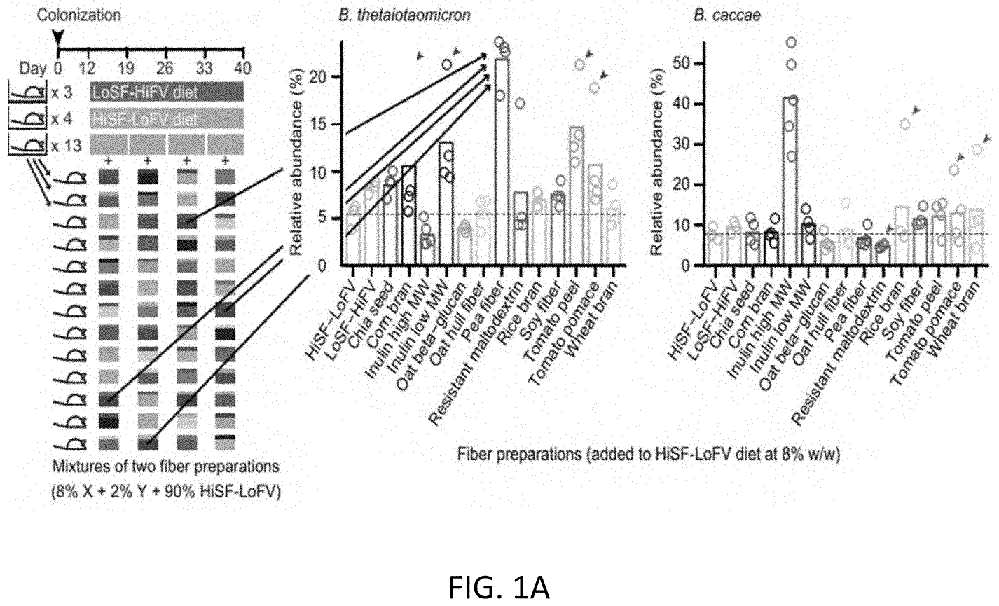

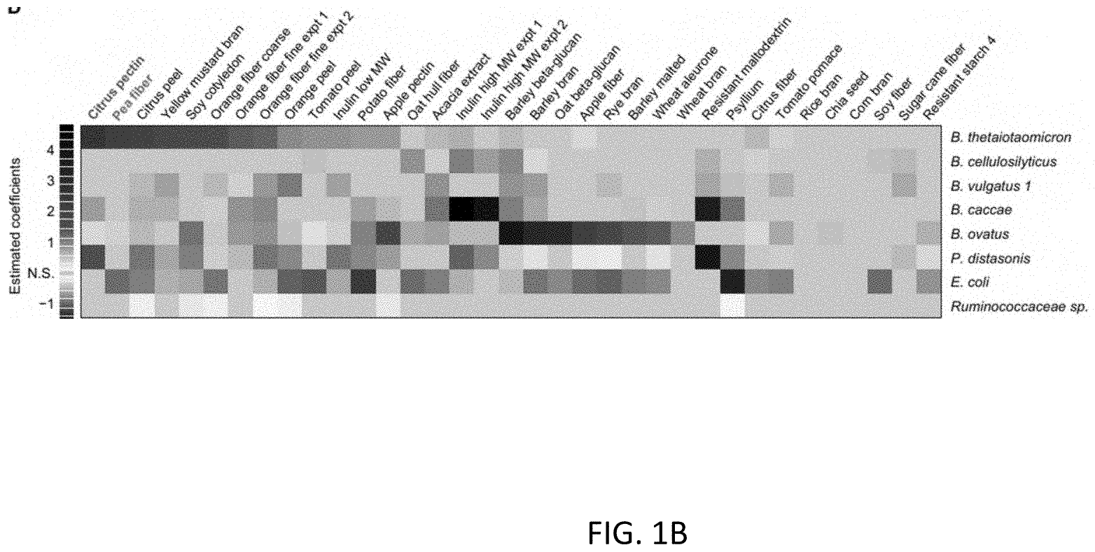

A schematic of the experimental design for screening 34 food grade fibers is shown in FIG. 1A. In total, three separate experiments were performed to complete an analysis of the effects of these fiber preparations on community structure. These fibers were obtained from diverse plant sources including fruits, vegetables, legumes, oilseeds, and cereals. Ten to 13 different fibers were tested per experiment (Table 3). Each mouse was colonized with a 20-member consortium of sequenced bacterial strains cultured from a single Ln co-twin donor. Each animal received a different fiber-supplemented diet each week for a total of four weeks. Each of the 144 unique diets tested contained one fiber type present at a concentration of 8% (w/w) and another fiber type at 2%. These two concentrations were systematically paired (Methods) to maximize the number of fiber preparations tested (FIG. 1A). Moreover, fiber types were presented in varying orders during the diet oscillation, mitigating potential hysteresis effects. Control groups were monotonously fed the unsupplemented HiSF-LoFV or LoSF-HiFV diet.

TABLE 3
Food-grade dietary fiber preparations
(A) Experiment details

| | Screening | | Screening |
|---|---|---|---|
| Fiber preparation | experiment used | Fiber preparation | experiment used |
| Citrus pectin | 3 | Oat beta-glucan | 2 |
| Pea fiber | 2 | Apple fiber | 1 |
| Citrus peel | 3 | Rye bran | 1 |
| Yellow mustard | 3 | Barley malted | 1 |
| Soy cotyledon | 3 | Wheat aleurone | 1 |
| Orange fiber (Coarse) | 1 | Wheat bran | 2 |
| Orange fiber (Fine) | 1 and 3 | Resistant | 2 |
| | | maltodextrin | |
| Orange peel | 3 | Psyllium | 3 |
| Tomato peel | 2 | Cocoa | 3 |
| Inulin, LMW | 2 | Citrus fiber | 3 |
| Potato Fiber | 3 | Tomato pomace | 2 |
| Apple pectin | 1 | Rice bran | 2 |
| Oat hull fiber | 2 | Chia seed | 2 |
| Acacia extract | 1 | Corn bran | 2 |
| Inulin, HMW | 2 and 3 | Soy fiber | 2 |
| Barley beta-glucan | 1 | Sugar cane fiber | 3 |
| Barley bran | 1 | Resistant starch 4 | 3 |

(B) Compositional analysis

| | % | % | % | HMW | LMW | % | % | % | % | % |
|---|---|---|---|---|---|---|---|---|---|---|
| | TDF | IDF | SDF | DF | DF | Prot | Fat | Carb | Moisture | Ash |
| Citrus | 78.9 | 1.4 | 75.5 | 76.9 | 2 | 3.34 | 0.56 | 86.82 | 7.97 | 1.31 |
| pectin* | | | | | | | | | | |
| Pea fiber* | 67.2 | 61.36 | 4.94 | 66.3 | 0.8 | 9.49 | 0.93 | 79.75 | 7.37 | 2.46 |
| Citrus peel | 70.9 | 47.7 | 23.2 | 70.9 | 0.6 | 4.44 | 2.31 | 83.16 | 6.85 | 3.24 |
| Yellow | 41.8 | 40.7 | 0.47 | 40.8 | 1 | 25.34 | 10.68 | 50.86 | 8.12 | 5 |
| mustard | | | | | | | | | | |
| Soy | 62.9 | 54 | 7.5 | 61.5 | 1.4 | 24.49 | 1.48 | 60.78 | 8.41 | 4.84 |
| cotyledon | | | | | | | | | | |
| Orange | 68.5 | 33.2 | 29.5 | 68.5 | 0.6 | 7.47 | 2.16 | 80.92 | 5.69 | 1.96 |
| fiber | | | | | | | | | | |
| (Coarse)* | | | | | | | | | | |
| Orange | 68 | 28.2 | 28.1 | 66.8 | 1.1 | 9.92 | 4.13 | 78.39 | 4.74 | 1.17 |
| fiber (Fine) | | | | | | | | | | |
| Orange | 60.1 | 42.9 | 17.2 | 60.1 | 0.6 | 6.19 | 4.03 | 79.49 | 7.36 | 2.93 |
| peel | | | | | | | | | | |
| Tomato | 79.1 | 68.22 | 10.88 | 79.1 | 0.6 | 8.07 | 4.42 | 79.23 | 5.57 | 2.71 |
| peel | | | | | | | | | | |
| Inulin, | 98.5 | <0.5 | 98.5 | 86 | 12.5 | 0.4 | 1.18 | 95.14 | 3.2 | 0.08 |
| LMW | | | | | | | | | | |
| Potato | 65.5 | 53.9 | 9.9 | 63.8 | 1.7 | 7.28 | 1.48 | 79.14 | 9.41 | 2.69 |
| Fiber | | | | | | | | | | |
| Apple | 60 | 0.47 | 58.65 | 59.3 | 0.7 | 12.04 | 0.98 | 70.61 | 10.76 | 5.61 |
| pectin | | | | | | | | | | |
| Oat hull | 95.7 | 92.86 | 2.84 | 95.7 | 0.6 | 0.35 | 0.15 | 94.3 | 3.91 | 1.29 |
| fiber | | | | | | | | | | |
| Acacia | 72.4 | 0.47 | 72.4 | 72.4 | 0.6 | 0.79 | 0.65 | 84.11 | 9.89 | 4.56 |
| extract | | | | | | | | | | |
| Inulin, | 90.9 | ND | ND | 59.5 | 31.3 | 0.28 | 3.71 | 91.44 | 4.28 | 0.29 |
| HMW* | | | | | | | | | | |
| Barley | 84.6 | 0.47 | 74.4 | 81.6 | 3 | 3.08 | 1.56 | 88.45 | 5.85 | 1.06 |
| beta- | | | | | | | | | | |
| glucan | | | | | | | | | | |
| Barley | 46 | 11.1 | 20.8 | 45.2 | 0.9 | 18.72 | 4.13 | 69.28 | 5.69 | 1.96 |
| bran* | | | | | | | | | | |
| Oat beta- | 46.6 | 25.6 | 20.3 | 45.5 | 1.1 | 21.64 | 4.98 | 65.45 | 4.07 | 3.86 |
| glucan | | | | | | | | | | |
| Apple fiber | 73.3 | 57.25 | 7.01 | 73.3 | 0.6 | 9.78 | 1.57 | 81.77 | 4.98 | 1.9 |
| Rye bran | 45.5 | 32.7 | 0.47 | 41.5 | 4 | 13.58 | 4.8 | 70.01 | 6.48 | 5.13 |
| Barley | 42.2 | 39.5 | 0.47 | 41.1 | 1.1 | 16.89 | 10.53 | 63.52 | 6.15 | 2.91 |
| malted | | | | | | | | | | |
| Wheat | 43.7 | 39.89 | 0.47 | 42.3 | 1.5 | 13.64 | 9.05 | 63.55 | 7.14 | 6.62 |
| aleurone | | | | | | | | | | |
| Wheat | 30.2 | 24.54 | 3.46 | 28 | 2.2 | 14.06 | 5.08 | 67.12 | 9.7 | 4.04 |
| bran | | | | | | | | | | |
| Resistant | 72.3 | 0.47 | 1.8 | 1.8 | 70.5 | 0.71 | 0.08 | 95.52 | 3.77 | 0.04 |
| maltodextrin | | | | | | | | | | |
| Psyllium | 95.6 | 87.8 | 3.6 | 91.4 | 4.2 | 1.63 | 0.74 | 88.08 | 6.98 | 2.57 |
| Cocoa | 31.6 | 21.5 | 9.3 | 30.8 | 0.9 | 27.81 | 12.61 | 50.29 | 2.67 | 6.62 |
| Citrus fiber | 91 | 85.3 | 4.7 | 91 | 0.6 | 0.61 | 1.23 | 90.07 | 3.51 | 4.58 |
| Tomato | 56.7 | 49.1 | 7.6 | 56.7 | 0.6 | 15.63 | 14.37 | 62.26 | 4.76 | 2.98 |
| pomace | | | | | | | | | | |
| Rice bran | 23.5 | 22.19 | 0.61 | 22.8 | 0.7 | 15.13 | 21.62 | 49.88 | 5.21 | 8.16 |
| Chia seed | 40.8 | 39.17 | 1.63 | 40.8 | 0.6 | 22.07 | 36.91 | 30.67 | 5.62 | 4.73 |
| Corn bran | 76.8 | 72.34 | 4.46 | 76.8 | 0.6 | 4.97 | 4.08 | 83.9 | 6.09 | 0.96 |
| Soy fiber | 93.8 | 89.29 | 3.11 | 92.4 | TBD | 1.58 | 1.05 | 89.97 | 4.88 | 2.52 |
| Sugar | 95.6 | 90.6 | 5 | 95.6 | 0.6 | 0.12 | 0.15 | 93.36 | 6.11 | 0.38 |
| cane fiber | | | | | | | | | | |
| Resistant | 90.7 | 70.3 | 20.4 | 90.7 | 0.6 | 0.12 | 0.08 | 86.48 | 11.72 | 1.8 |
| starch 4 | | | | | | | | | | |

Abbreviations:
dietary fiber (DF),
total dietary fiber (TDF),
insoluble dietary fiber (IDF),
soluble dietary fiber (SDF),
high molecular weight (HMW),
low molecular weight (LMW),
protein (Prot),
carbohydrate (Carb),
not determined (ND)
*See Tables B-G for monosaccharide analysis and glycosyl linkage analysis

TABLE 4
Monosaccharide analysis of HiSF-LoFV diet

| | F1 (390 ug) | | F2 (490 ug) | | F3 (480 ug) | |
|---|---|---|---|---|---|---|
| Glycosyl | Mass | | Mass | | Mass | |
| residue | (mg) | Mol % | (mg) | Mol % | (mg) | Mol % |
| Arabinose (Ara) | 3.1 | 29.6 | 2 | 3.4 | 7.7 | 12.8 |
| Rhamnose (Rha) | 0.1 | 0.4 | 0.1 | 0.1 | 0.7 | 1 |
| Fucose (Fuc) | n.d. | — | n.d. | — | 0.1 | 0.1 |
| Xylose (Xyl) | 3.4 | 32.9 | 3.9 | 6.7 | 14.4 | 24 |
| Galacturonic | 0.1 | 0.6 | 0.2 | 0.3 | 2.4 | 3.1 |
| acid (GalA) | | | | | | |
| Mannose (Man) | 1.8 | 14.1 | 6 | 8.6 | 13.9 | 19.4 |
| Galactose (Gal) | 0.9 | 7.2 | 0.7 | 1.1 | 4.9 | 6.8 |
| Glucose (Glc) | 1.9 | 15.2 | 55.8 | 79.8 | 23.5 | 32.7 |
| Sum = | 11.2 | | 68.7 | | 67.5 | |

TABLE 5
Glycosyl linkage analysis of HiSF-LoFV diet

| | | % detected linkage | | |
|---|---|---|---|---|
| | Deduced Linkage | F1 | F2 | F3 |
| Arabinose | (t-Araf) | 19.7 | 5.2 | 3.9 |
| | (2-Araf) | 1.4 | 0.3 | 1.9 |
| | (3-Araf) | 0.7 | 0.2 | 0.8 |
| | (4-Arap or 5-Araf) | 2.4 | 0.5 | 1.6 |
| Xylose | (t-Xyl) | 0.9 | 0.4 | 2.4 |
| | (4-Xyl) | 17.8 | 8.4 | 9.1 |
| | (2-Xyl) | 1.8 | 0.7 | 2.3 |
| | (2,4-Xyl) | 0.7 | 0.8 | 0.4 |
| | (3,4-Xyl) | 5.9 | 2 | 2.1 |
| | (2,3,4-Xyl) | 6.6 | — | — |
| Fucose | (t-Fuc) | — | — | 0.3 |
| Galactose | (t-Gal) | 1.3 | 0.5 | 2.4 |
| | (3-Gal) | 0.9 | — | — |
| | (2-Gal) | — | — | 0.6 |
| | (4-Gal) | 2.6 | 0.9 | 4.8 |
| | (6-Gal) | 0.4 | — | 0.3 |
| | (3,6-Gal) | 4.6 | 1.2 | 0.4 |
| Mannose | (t-Man) | 5.2 | 5.4 | 6.3 |
| | (2-Man) | 2.9 | 1.5 | 1.5 |
| | (3-Man) | 0.9 | 0.3 | 0.2 |
| | (4-Man) | 1.4 | 1.4 | 13 |
| | (2,4-Man) | 0.2 | — | — |
| | (4,6-Man) | — | — | 1 |
| | (3,6-Man) | 1.2 | — | 0.5 |
| | (2,6-Man) | 1.1 | 0.6 | 0.9 |
| Glucose | (t-Glc) | 2.9 | 4.6 | 2.4 |
| | (3-Glc) | 4.8 | 1.1 | 1.5 |
| | (6-Glc) | 0.8 | 0.7 | 0.6 |
| | (4-Glc) | 10 | 58 | 29.9 |
| | (3,4-Glc) | 0.5 | 1.2 | 0.3 |
| | (2,4-Glc) | 0.3 | 0.5 | 0.5 |
| | (4,6-Glc) | — | 3.6 | 7.8 |

We analyzed the relative abundance of each member of the defined community at two time points at the end of each diet treatment by collecting fecal samples and performing 16S rRNA gene sequencing. Binning the data according to the fiber preparation present at 8% concentration revealed potent and specific effects on distinct taxa (FIG. 1A). To analyze the independent effects of the two fiber preparations administered during each diet treatment, we generated a linear mixed-effects model for each bacterial taxon using the data from the last two days of consumption of each diet. The coefficient estimates in these models describe the slope of the predicted dose response curve for each fiber preparation's effect on each community member (Tables 6A, 7A, 8A). Twenty-one fiber preparations had significant estimated coefficients of >1 (with a coefficient of 1 indicating a 1% increase in the relative abundance of a bacterial species for every 1% increase in the concentration of the fiber preparation added to the HiSF-LoFV diet) (FIG. 1B). Large coefficients were observed in the B. thetaiotaomicron models for citrus pectin (2.6) and pea fiber (2.1). The B. ovatus models revealed pronounced effects of barley beta-glucan (3.9) and barley bran (3.1). Estimated coefficients for high molecular weight inulin (4.5, B. caccae model), resistant maltodextrin (3.8, P. distasonis model), and psyllium (3.4, E. coli model) were notable with 8% fiber administration driving the relative abundance of these community members from 10-20% to nearly 50%. Two of the fiber preparations tested (rice bran and corn bran) either had no detectable effect on the abundance of community members or produced estimated coefficients <0.5. High molecular weight inulin and an orange fiber preparation were tested across two separate experiments; the results established that the effects on the relative abundances of community members were reproducible (coefficients were highly correlated between these independent experiments, R²=0.96; Tables 6A, 7A, 8A). The even distributions of residuals around the fitted values in the models indicated that there were no pronounced threshold or saturation effects of these fiber preparations at the concentrations tested. For bacterial species that exhibited notable responses to fiber (at least one coefficient >1), the average R² value of the models was 0.82. We repeated our analyses using DNA yield from each fecal sample to estimate the absolute abundance of each organism as a function of fiber preparation. The estimated coefficients obtained from these two measures were highly correlated (R²=0.88) (Tables 6B, 7B, 8B). Together, results obtained from this screen illustrate the specificity of the effects of different types of dietary fiber on community configuration.

TABLE 6
Screening Experiment 1

| | | | | | | | | | | | |
|---|---|---|---|---|---|---|---|---|---|---|---|
| Taxonomy | OTU no. | 1 | 2 | 3 | 4 | 5 | 6 | 7 | 8 | 9 | 10 |

(A) Estimated Coefficients from linear
mixed effect models generated using relative abundance

| | | | | | | | | | | | |
|---|---|---|---|---|---|---|---|---|---|---|---|
| Bacteroides | 848236 | 0.31 | 0.83 | 1.33 | 1.62 | — | −0.48 | — | — | — | 0.61 |
| thetaiotaomicron | | | | | | | | | | | |
| Bacteroides | 539126 | — | — | — | — | −0.3 | −0.8 | — | — | — | −0.37 |
| cellulosilyticus | | | | | | | | | | | |
| Bacteroides | 850870 | — | — | 0.42 | 0.61 | −0.7 | −0.71 | — | — | −0.49 | 0.89 |
| vulgatus | | | | | | | | | | | |
| Bacteroides caccae | 579112 | — | −0.5 | −0.73 | −0.35 | −0.63 | −0.88 | −0.4 | −0.33 | — | −0.94 |
| Bacteroides ovatus | 844958 | 2.13 | 1.83 | 0.84 | — | 3.12 | 3.89 | 1.41 | 1.32 | 1.78 | 0.81 |
| Parabacteroides | 846317 | 0.24 | −0.65 | −0.45 | −0.37 | −0.22 | −0.34 | — | −0.23 | −0.15 | — |
| distasonis | | | | | | | | | | | |
| Escherichia coli | 1111717 | −1 | — | — | −0.9 | −0.95 | −0.48 | −0.84 | −0.8 | −1.05 | −0.84 |
| Ruminococcaceae | 360801 | — | 0.2 | — | 0.14 | — | — | — | — | — | — |
| sp. | | | | | | | | | | | |
| Subdoligranulum | 364609 | −0.34 | −0.29 | — | — | — | −0.2 | — | — | — | — |
| variabile | | | | | | | | | | | |
| Collinsella | 1110606 | −0.18 | −0.16 | −0.19 | −0.16 | −0.15 | −0.09 | −0.14 | −0.12 | −0.12 | −0.13 |
| aerofaciens | | | | | | | | | | | |
| Bacteroides | 840832 | | | | | | | | | | |
| massiliensis | | | | | | | | | | | |
| Odoribacter | 210303 | −0.04 | −0.04 | −0.02 | −0.02 | −0.03 | −0.05 | −0.03 | −0.02 | −0.04 | −0.04 |
| splanchnicus | | | | | | | | | | | |
| Bacteroides | de novo | 0.03 | 0.04 | 0.05 | 0.03 | — | — | — | — | 0.02 | — |
| finegoldii | OTU | | | | | | | | | | |
| Peptococcus niger | 1135793 | −0.35 | −0.21 | −0.25 | −0.27 | −0.23 | −0.34 | −0.15 | −0.14 | −0.23 | — |
| Dorea longicatena | de novo | −0.47 | −0.66 | −0.59 | −0.57 | — | 0.31 | — | — | — | −0.32 |
| | OTU | | | | | | | | | | |

(B) Estimated Coefficients from linear mixed effect
models generated using DNA-scaled abundance.

| | | | | | | | | | | | |
|---|---|---|---|---|---|---|---|---|---|---|---|
| Bacteroides | 848236 | — | 1.15 | 1.64 | 1.54 | — | — | — | — | — | — |
| thetaiotaomicron | | | | | | | | | | | |
| Bacteroides | 539126 | — | — | — | — | — | — | — | — | — | −0.55 |
| cellulosilyticus | | | | | | | | | | | |
| Bacteroides | 850870 | — | — | 0.78 | 0.63 | — | — | — | — | — | — |
| vulgatus | | | | | | | | | | | |
| Bacteroides caccae | 579112 | — | — | −0.45 | — | — | −0.55 | — | — | — | −0.9 |
| Bacteroides ovatus | 844958 | 1.54 | 2.05 | 1.35 | — | 3.72 | 4.9 | 0.97 | 1.06 | 1.64 | — |
| Parabacteroides | 846317 | — | −0.4 | — | — | — | — | — | — | — | −0.37 |
| distasonis | | | | | | | | | | | |
| Escherichia coli | 1111717 | −0.84 | — | — | −0.55 | −0.42 | — | −0.62 | −0.63 | −0.72 | −1 |
| Ruminococcaceae | 360801 | — | 0.24 | — | 0.14 | — | — | — | — | — | — |
| sp. | | | | | | | | | | | |
| Subdoligranulum | 364609 | −0.28 | — | 0.26 | — | — | — | — | — | — | −0.27 |
| variabile | | | | | | | | | | | |
| Collinsella | 1110606 | −0.16 | −0.11 | −0.12 | −0.12 | −0.09 | — | −0.13 | −0.09 | −0.09 | −0.15 |
| aerofaciens | | | | | | | | | | | |
| Bacteroides | 840832 | | | | | | | | | | |
| massiliensis | | | | | | | | | | | |
| Odoribacter | 210303 | −0.03 | — | — | — | — | −0.03 | −0.02 | — | −0.03 | −0.05 |
| splanchnicus | | | | | | | | | | | |
| Bacteroides | de novo | 0.02 | 0.04 | 0.07 | 0.03 | 0.02 | — | — | — | 0.02 | — |
| finegoldii | OTU | | | | | | | | | | |
| Peptococcus niger | 1135793 | −0.29 | — | — | −0.18 | −0.1 | −0.19 | −0.13 | −0.12 | −0.15 | −0.19 |
| Dorea longicatena | de novo | −0.47 | −0.46 | −0.32 | −0.38 | — | 0.83 | — | — | — | −0.51 |
| | OTU | | | | | | | | | | |

1 - apple fiber,
2- apple pectin,
3 orange fiber fine,
4- orange fiber course,
5 barley bran,
5- barley beta glucan,
7- barley malted,
8- wheat aleurone,
9- rye bran,
10- acacia extract
“—” indicates estimate was not statistically significant (ANOVA, P < 0.05)
blank cells indicate that the organism was not detected above the 0.05% relative abundance cut-off in the experiment

TABLE 7
Screening Experiment 2
(A) Estimated Coefficients from linear mixed effect
models generated using relative abundance

| Taxonomy | OTU no. | 1 | 2 | 3 | 4 | 5 | 6 | 7 | 8 | 9 | 10 | 11 | 12 | 13 |
|---|---|---|---|---|---|---|---|---|---|---|---|---|---|---|
| Bacteroides | 848236 | 0.87 | — | — | 0.89 | — | — | — | — | — | — | 2.09 | — | — |
| thetaiotaomicron | | | | | | | | | | | | | | |
| Bacteroides | 539126 | — | −0.69 | − | 0.47 | — | — | — | −0.63 | — | 0.83 | — | — | 0.51 |
| cellulosilyticus | | | | | | | | | | | | | | |
| Bacteroides | 850870 | 0.9 | — | — | — | — | — | — | — | — | — | — | — | — |
| vulgatus | | | | | | | | | | | | | | |
| Bacteroides | 579112 | — | 4.54 | — | — | — | — | — | — | — | — | — | — | — |
| caccae | | | | | | | | | | | | | | |
| Bacteroides | 844958 | 0.35 | −0.55 | — | — | — | 0.52 | 0.91 | — | 2.99 | 0.68 | 0.34 | — | — |
| ovatus | | | | | | | | | | | | | | |
| Parabacteroides | 846317 | −1.06 | −0.95 | — | — | — | — | — | 3.75 | — | — | — | — | — |
| distasonis | | | | | | | | | | | | | | |
| Escherichia coli | 1111717 | — | — | −0.92 | −1.16 | — | — | — | — | −0.89 | −1.03 | −1.09 | −0.85 | −1.11 |
| Ruminococcaceae | 360801 | −0.03 | — | 0.03 | 0.09 | — | — | — | — | — | — | — | — | — |
| sp. | | | | | | | | | | | | | | |
| Subdoligranulum | 364609 | −0.28 | −0.4 | — | — | — | — | — | −0.26 | — | — | −0.33 | — | — |
| variabile | | | | | | | | | | | | | | |
| Collinsella | 1110606 | — | −0.3 | −0.32 | −0.33 | — | −0.27 | — | −0.34 | — | — | −0.34 | — | −0.3 |
| aerofaciens | | | | | | | | | | | | | | |
| Bacteroides | 840832 | −0.07 | −0.08 | −0.09 | −0.08 | −0.06 | — | −0.09 | −0.09 | −0.09 | — | −0.1 | — | −0.09 |
| massiliensis | | | | | | | | | | | | | | |
| Odoribacter | 210303 | — | −0.04 | — | — | — | — | — | −0.05 | — | −0.04 | −0.04 | — | — |
| splanchnicus | | | | | | | | | | | | | | |
| Bacteroides | de novo | | | | | | | | | | | | | |
| finegoldii | OTU | | | | | | | | | | | | | |
| Peptococcus | 1135793 | −0.21 | −0.19 | −0.18 | −0.18 | — | — | — | −0.27 | — | −0.18 | −0.28 | −0.21 | — |
| niger | | | | | | | | | | | | | | |

(B) Estimated Coefficients from linear mixed effect
models generated using DNA-scaled abundance.

| | | Screening experiment 2 | | | | | | | | | | | | |
|---|---|---|---|---|---|---|---|---|---|---|---|---|---|---|
| Taxonomy | OTU no. | 1 | 2 | 3 | 4 | 5 | 6 | 7 | 8 | 9 | 10 | 11 | 12 | 13 |
| Bacteroides | 848236 | 0.73 | — | — | — | — | — | — | — | — | — | 1.24 | − | — |
| thetaiotaomicron | | | | | | | | | | | | | | |
| Bacteroides | 539126 | — | −0.42 | — | — | — | — | — | −0.36 | — | — | — | — | — |
| cellulosilyticus | | | | | | | | | | | | | | |
| Bacteroides | 850870 | 0.67 | — | — | — | — | — | — | — | — | — | — | — | — |
| vulgatus | | | | | | | | | | | | | | |
| Bacteroides | 579112 | — | 1.96 | — | — | — | — | — | — | — | — | — | — | — |
| caccae | | | | | | | | | | | | | | |
| Bacteroides | 844958 | 0.39 | −0.36 | — | — | — | — | 0.5 | — | 2.01 | — | 0.27 | — | — |
| ovatus | | | | | | | | | | | | | | |
| Parabacteroides | 846317 | −0.55 | −0.53 | — | — | — | — | — | 1.72 | — | — | — | — | — |
| distasonis | | | | | | | | | | | | | | |
| Escherichia coli | 1111717 | 0.59 | −0.57 | −0.69 | −0.86 | −0.91 | — | — | −0.52 | — | −0.93 | −0.57 | −0.71 | −0.87 |
| Ruminococcaceae | 360801 | −0.02 | — | — | 0.04 | — | — | — | — | — | — | — | — | — |
| sp. | | | | | | | | | | | | | | |
| Subdoligranulum | 364609 | — | −0.22 | — | −0.14 | −0.19 | — | — | −0.17 | — | −0.18 | −0.16 | — | −0.17 |
| variabile | | | | | | | | | | | | | | |
| Collinsella | 1110606 | — | −0.19 | −0.25 | −0.23 | −0.26 | −0.23 | — | −0.22 | — | −0.18 | −0.2 | −0.2 | −0.27 |
| aerofaciens | | | | | | | | | | | | | | |
| Bacteroides | 840832 | −0.04 | −0.06 | −0.06 | −0.05 | −0.05 | −0.04 | −0.05 | −0.06 | −0.06 | −0.04 | −0.06 | −0.04 | −0.06 |
| massiliensis | | | | | | | | | | | | | | |
| Odoribacter | 210303 | — | −0.03 | — | — | — | — | — | −0.03 | — | −0.03 | −0.02 | — | −0.02 |
| splanchnicus | | | | | | | | | | | | | | |
| Bacteroides | de novo | | | | | | | | | | | | | |
| finegoldii | OTU | | | | | | | | | | | | | |
| Peptococcus | 1135793 | −0.11 | −0.13 | −0.14 | −0.13 | −0.15 | — | — | −0.17 | — | −0.15 | −0.16 | −0.15 | −0.14 |
| niger | | | | | | | | | | | | | | |

1, inulin LMW,
2, inulin HMW,
3- tomato pomace,
4- tomato peel,
5- rice bran,
6- chia see,
7- wheat bran,
8- resistant maltodextrin,
9- oat beta glucan,
10- oat hull fiber,
11- pea fiber,
12- corn bran
“—” indicates estimate was not statistically significant (ANOVA, P < 0.05)
blank cells indicate that the organism was not detected above the 0.05% relative abundance cut-off in the experiment

TABLE 8
Screening Experiment 3
(A) Estimated Coefficients from linear mixed effect
models generated using relative abundance

| | | Screening experiment 3 | | | | | | | | | | | |
|---|---|---|---|---|---|---|---|---|---|---|---|---|---|
| Taxonomy | OTU no. | 1 | 2 | 3 | 4 | 5 | 6 | 7 | 8 | 9 | 10 | 11 | 12 |
| Bacteroides | 848236 | 2 | — | — | 1 | — | 1.72 | 0.4 | 1.67 | 1.31 | −0.52 | 2.55 | 0.87 |
| thetaiotaomicron | | | | | | | | | | | | | |
| Bacteroides | 539126 | — | 0.57 | — | — | — | — | — | — | — | −0.88 | — | — |
| cellulosilyticus | | | | | | | | | | | | | |
| Bacteroides | 850870 | 0.6 | 0.73 | — | 1.09 | 0.55 | 0.81 | 0.65 | — | 0.82 | — | — | — |
| vulgatus | | | | | | | | | | | | | |
| Bacteroides | 579112 | −0.54 | — | — | — | −0.91 | −0.57 | — | — | −0.78 | 4.85 | −0.67 | 0.79 |
| caccae | | | | | | | | | | | | | |
| Bacteroides | 844958 | 0.59 | — | 0.64 | 0.52 | — | — | 0.72 | 1.17 | 0.93 | −0.46 | 0.34 | 1.05 |
| ovatus | | | | | | | | | | | | | |
| Parabacteroides | 846317 | −0.95 | −0.47 | −0.32 | −0.8 | −0.78 | −0.63 | −0.38 | −0.88 | −0.94 | −1.02 | −1.15 | −0.8 |
| distasonis | | | | | | | | | | | | | |
| Escherichia coli | 1111717 | −0.85 | — | −0.71 | −1.03 | 3.43 | −0.56 | −0.84 | −0.59 | −0.56 | −0.55 | — | −1.33 |
| Ruminococcaceae | 360801 | 0.17 | — | — | 0.13 | −0.08 | — | — | 0.21 | 0.07 | — | 0.45 | — |
| sp. | | | | | | | | | | | | | |
| Subdoligranulum | 364609 | −0.39 | −0.29 | — | — | −0.79 | −0.45 | — | — | −0.35 | −0.65 | −0.66 | −0.28 |
| variabile | | | | | | | | | | | | | |
| Collinsella | 1110606 | −0.26 | — | — | −0.25 | −0.3 | — | — | — | −0.25 | — | −0.26 | — |
| aerofaciens | | | | | | | | | | | | | |
| Bacteroides | 840832 | −0.11 | −0.06 | — | −0.1 | −0.11 | −0.06 | −0.09 | −0.12 | −0.1 | −0.1 | −0.11 | −0.1 |
| massiliensis | | | | | | | | | | | | | |
| Odoribacter | 210303 | −0.04 | −0.04 | −0.02 | −0.03 | −0.07 | — | −0.04 | −0.04 | — | −0.05 | −0.04 | −0.02 |
| splanchnicus | | | | | | | | | | | | | |
| Bacteroides | de novo | 0.05 | — | — | 0.04 | — | 0.06 | 0.04 | 0.07 | 0.07 | — | 0.06 | 0.07 |
| finegoldii | OTU | | | | | | | | | | | | |
| Peptococcus niger | 1135793 | −0.42 | −0.34 | −0.37 | −0.41 | −0.58 | −0.38 | −0.24 | −0.53 | −0.37 | −0.5 | −0.49 | −0.48 |

1- citrus peel, 2- sugar cane fiber, 3- resistant starch 4, 4- orange peel, 5- psyllium, 6- yellow mustard bran, 7- citrus fiber, 8- soy
cotyledon, 9- orange fiber fine, 10- inulin HMW, 11- citrus pectin, 12- potato fiber
“—” indicates estimate was not statistically significant (ANOVA, P < 0.05)
blank cells indicate that the organism was not detected above the 0.05% relative abundance cut-off in the experiment

(B) Estimated Coefficients from linear mixed effect
models generated using DNA-scaled abundance.

| Taxonomy | OTU no. | 1 | 2 | 3 | 4 | 5 | 6 | 7 | 8 | 9 | 10 | 11 | 12 | 13 |
|---|---|---|---|---|---|---|---|---|---|---|---|---|---|---|
| Bacteroides | 848236 | 2.02 | — | — | 1.21 | − | 1.52 | — | 2.47 | 1.39 | −0.57 | 3.22 | 0.73 | 2.02 |
| thetaiotaomicron | | | | | | | | | | | | | | |
| Bacteroides | 539126 | — | — | — | — | −0.47 | — | −0.52 | — | — | −0.83 | 0.49 | — | — |
| cellulosilyticus | | | | | | | | | | | | | | |
| Bacteroides | 850870 | 0.62 | — | — | 1.26 | — | 0.64 | — | — | 0.91 | — | — | — | 0.62 |
| vulgatus | | | | | | | | | | | | | | |
| Bacteroides | 579112 | — | — | — | — | −0.92 | −0.51 | −0.51 | — | −0.57 | 4.22 | — | 0.76 | — |
| caccae | | | | | | | | | | | | | | |
| Bacteroides | 844958 | 0.67 | — | — | 0.66 | — | — | — | 1.76 | 1.01 | −0.48 | 0.65 | 0.94 | 0.67 |
| ovatus | | | | | | | | | | | | | | |
| Parabacteroides | 846317 | −0.76 | −0.6 | −0.36 | −0.64 | −0.82 | −0.54 | −0.67 | −0.51 | −0.73 | −0.9 | −0.89 | −0.65 | −0.76 |
| distasonis | | | | | | | | | | | | | | |
| Escherichia coli | 1111717 | −0.69 | −0.75 | −0.73 | −0.74 | 1.24 | — | −1.16 | — | — | — | — | −0.98 | −0.69 |
| Ruminococcaceae | 360801 | 0.17 | — | — | 0.15 | −0.1 | — | — | 0.28 | 0.08 | — | 0.53 | — | 0.17 |
| sp. | | | | | | | | | | | | | | |
| Subdoligranulum | 364609 | −0.25 | −0.34 | — | — | −0.7 | −0.37 | −0.32 | — | — | −0.56 | −0.46 | — | −0.25 |
| variabile | | | | | | | | | | | | | | |
| Collinsella | 1110606 | −0.21 | — | — | −0.2 | −0.29 | — | −0.19 | — | −0.2 | — | — | — | −0.21 |
| aerofaciens | | | | | | | | | | | | | | |
| Bacteroides | 840832 | −0.09 | −0.06 | — | −0.09 | −0.09 | — | −0.09 | −0.1 | −0.09 | −0.09 | −0.1 | −0.09 | −0.09 |
| massiliensis | | | | | | | | | | | | | | |
| Odoribacter | 210303 | −0.03 | −0.05 | −0.02 | −0.02 | −0.07 | — | −0.05 | — | — | −0.04 | — | — | −0.03 |
| splanchnicus | | | | | | | | | | | | | | |
| Bacteroides | de novo | 0.04 | — | — | 0.05 | — | 0.05 | — | 0.09 | 0.07 | — | 0.08 | 0.07 | 0.04 |
| finegoldii | OTU | | | | | | | | | | | | | |
| Peptococcus niger | 1135793 | −0.32 | −0.35 | −0.34 | −0.33 | −0.52 | −0.32 | −0.36 | −0.38 | −0.27 | −0.43 | −0.34 | −0.4 | −0.32 |

1, inulin LMW, 2, inulin HMW, 3- tomato pomace, 4- tomato peel, 5- rice bran, 6- chia see, 7- wheat bran,
8- resistant maltodextrin, 9- oat beta glucan, 10- oat hull fiber, 11- pea fiber, 12- corn bran
“—” indicates estimate was not statistically significant (ANOVA, P < 0.05)
blank cells indicate that the organism was not detected above the 0.05% relative abundance cut-off in the experiment

### Example 5: Proteomics and Forward Genetics Identify Bioactive Polysaccharides in Fiber Preparations

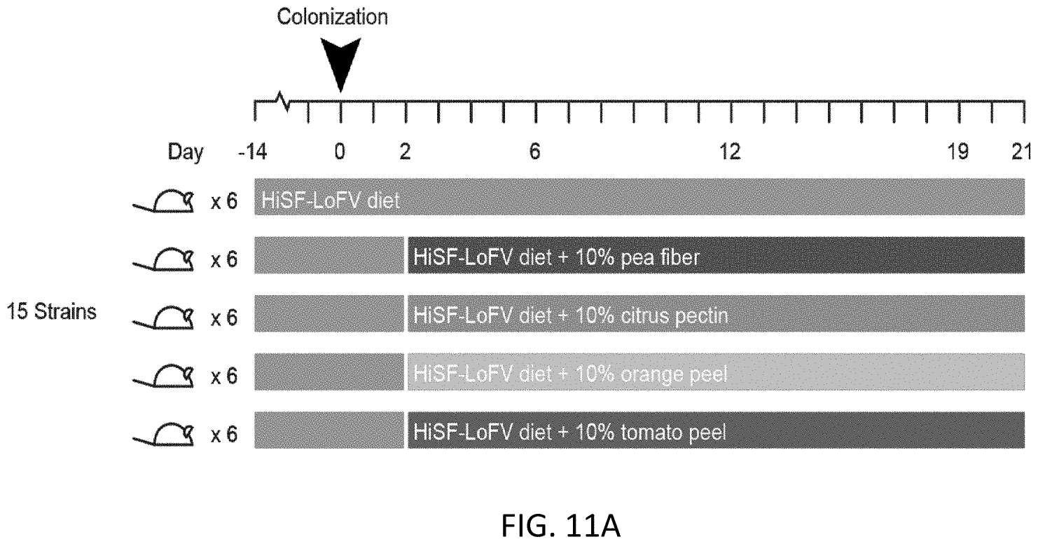

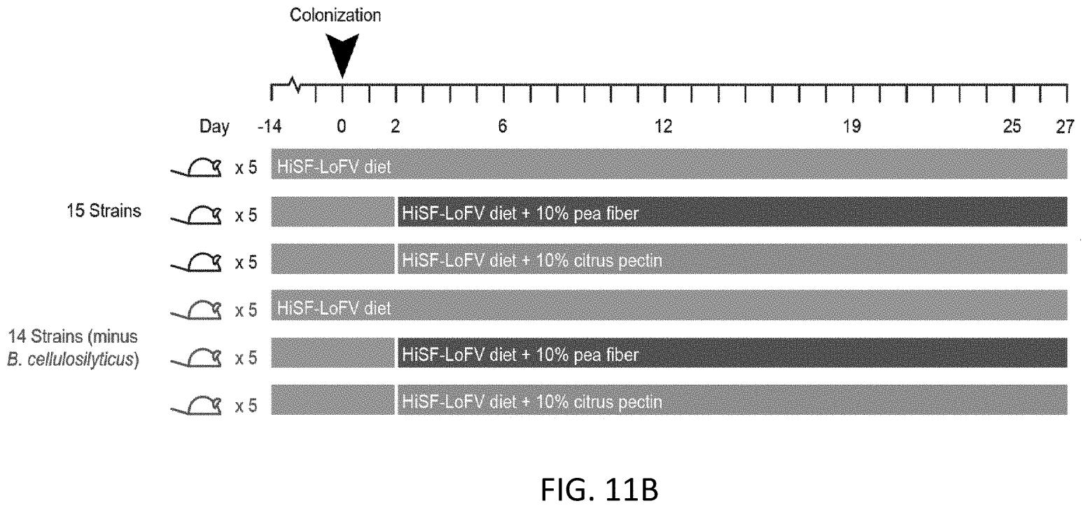

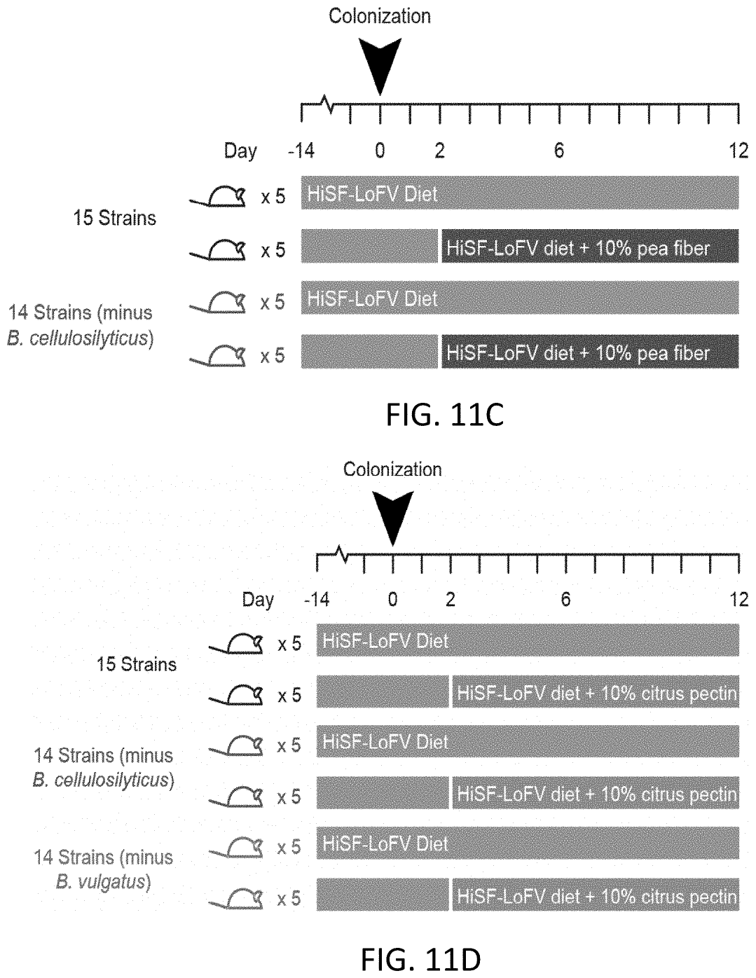

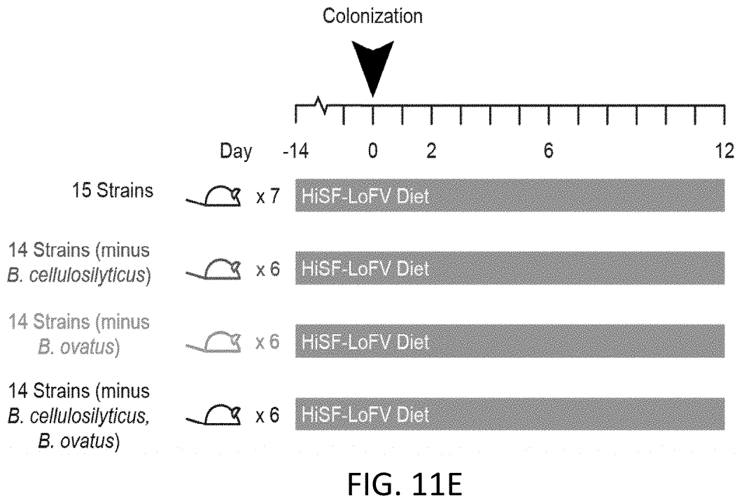

Several possible mechanisms could account for the increase of a target Bacteroides in response to fiber administration, including indirect effects involving other species. Therefore, we sought to determine which polysaccharides in the fiber preparations caused the target species to expand and whether they acted directly on those species by serving as nutrient sources for their growth. To do so, we simultaneously quantified community-wide protein expression and assessed the contributions of proteins to bacterial fitness using a forward genetic screen. The screen was based on genome-wide transposon (Tn) mutagenesis and a method known as multi-taxon INsertion Sequencing (INSeq), which allows simultaneous analysis of Tn mutant libraries generated from different Bacteroides species in the same recipient gnotobiotic mouse. We employed five INSeq libraries constructed using type strains corresponding to four Bacteroides species present in the Ln co-twin donor culture collection. The quality and performance of these libraries had been characterized previously in vitro and in vivo (30,300-167,000 isogenic Tn mutants/library; single site of Tn insertion/strain; 11-26 Tn insertions/gene; 71-92% genes covered/genome; (Hibberd et al., 2017; Wu et al., 2015)). Additionally, we simplified the community used in these experiments by omitting six strains from the original 20 member consortium that were not robust colonizers in the HiSF-LoFV diet context (Faith et al., 2014; Ridaura et al., 2013). All mice were colonized with the resulting 15-member community while consuming the base (unsupplemented) HiSF-LoFV diet. Animals were divided into five groups (n=6 animals/group) and were either continued on the base HiSF-LoFV diet or, two days after gavage, switched to the HiSF-LoFV diet supplemented with one of the fibers identified in the screen. We tested pea fiber, citrus pectin, orange peel, and tomato peel, each at a concentration of 10% (w/w), based on their ability to increase the representation of one or more of the targeted Bacteroides (FIG. 1B). All diets were administered ad libitum and given monotonously for the duration of the experiment (FIG. 11). DNA isolated from fecal samples was subjected to short read shotgun DNA sequencing (COmmunity PROfiling by Sequencing, COPRO-Seq; (Hibberd et al., 2017; McNulty et al., 2013) to quantify the representation of each community member as a function of fiber treatment, including the combined abundance of all INSeq mutants for a given species. Our previous studies had established that in aggregate, a population of INSeq mutants behaves similarly to the corresponding wild-type parental strain (Hibberd et al., 2017; Wu et al., 2015).

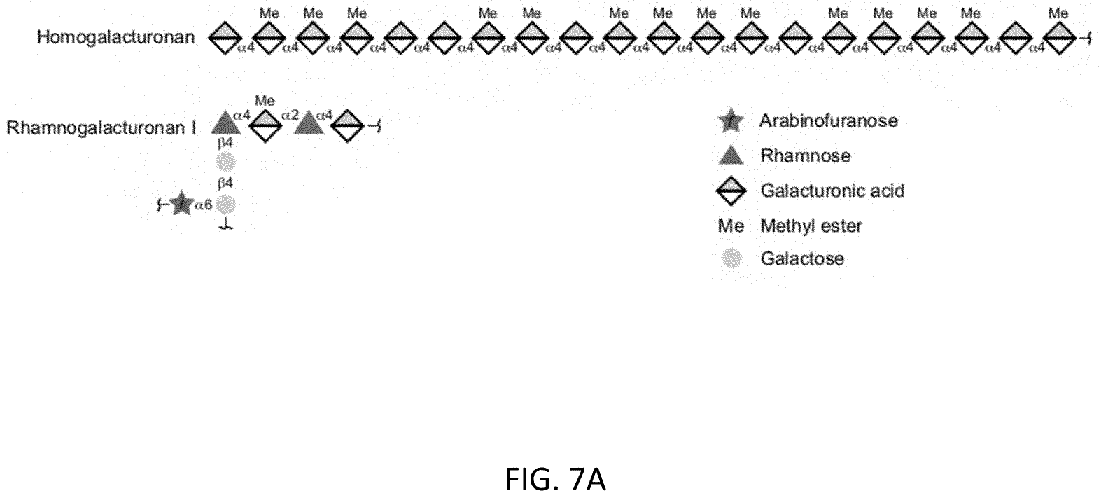

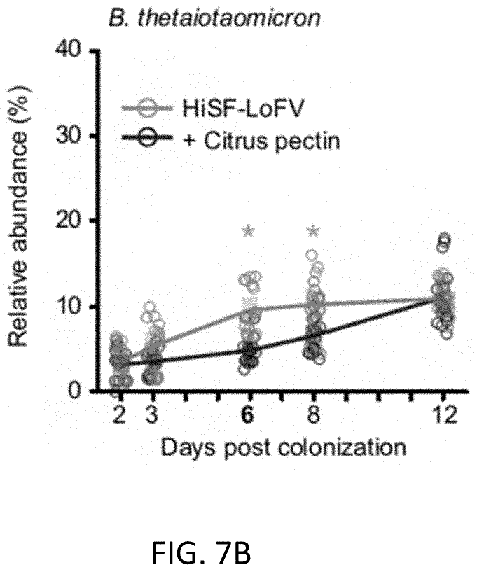

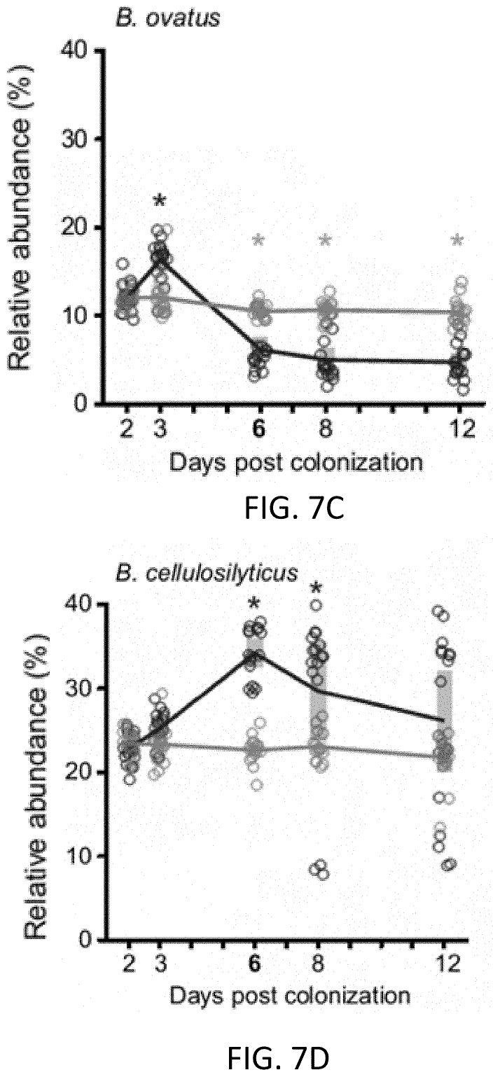

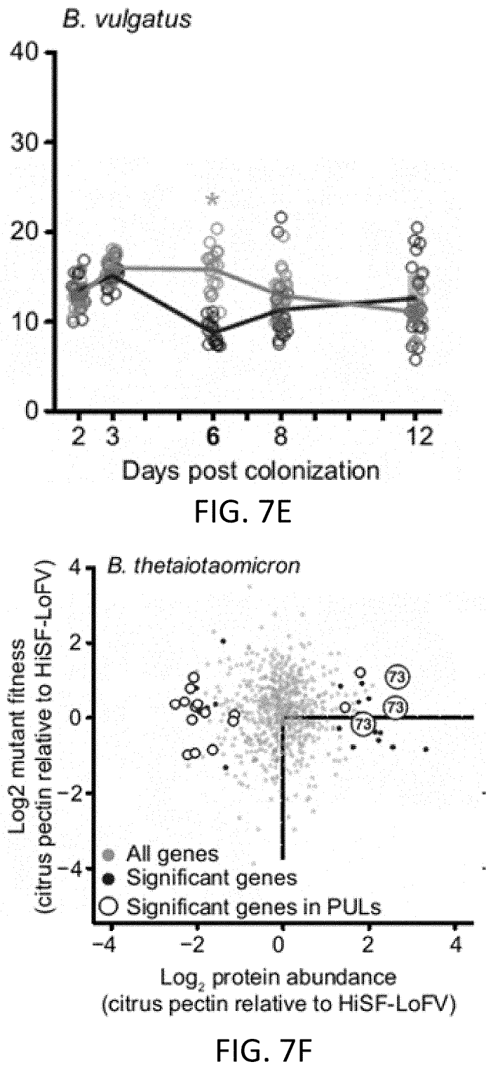

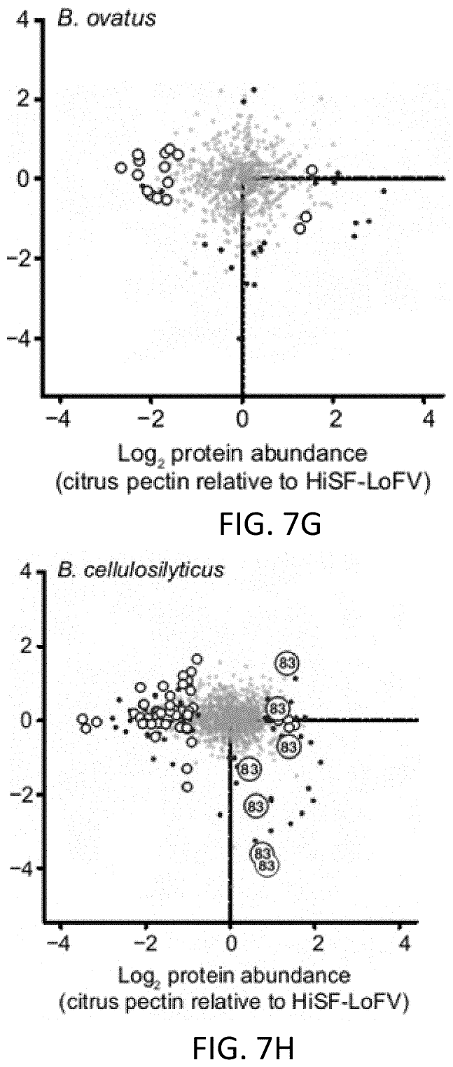

Consistent with results obtained from seven days of fiber administration in the screening experiments, we observed a statistically significant expansion of B. thetaiotaomicron VPI-5482 in mice consuming pea fiber (ANOVA, P<0.05; FIG. 2B). Also in accordance with observations made in the screen, the relative abundance of B. ovatus ATCC-8483 was significantly greater in the pea fiber-treated group (FIG. 2C), while B. cellulosilyticus WH2 and B. vulgatus ATCC-8482 did not exhibit significant changes during this time period (FIG. 2D and FIG. 2E). Citrus pectin induced significant expansion of three species (B. cellulosilyticus, Bacteroides finegoldii, and a member of the Ruminococcaceae) that was distinct from the set affected by pea fiber (FIG. 7D). Although the fiber screen predicted an increase in the abundance of B. thetaiotaomicron in response to citrus pectin, this was not observed during monotonous feeding until later in the time course, indicating a difference between the strains employed or the effect of different community context (FIG. 7B). Orange peel significantly increased the representation of B. vulgatus, but otherwise had a minimal effect on community structure. Tomato peel did not significantly increase any members of this community, which may indicate the strain-dependency of a given species' response to a certain fiber when the effect size of a given fiber preparation is low. Since both pea fiber and citrus pectin had pronounced effects on distinct sets of taxa, we selected these preparations for more detailed functional studies of their utilization by community members.

Structural analyses of lead fibers—We used permethylation and gas-chromatography-mass spectrometry to analyze the monosaccharide composition and glycosidic linkages of polysaccharides present in pea fiber and citrus pectin. After accounting for starch (typically degraded and absorbed by the host) and cellulose (not metabolized by the target Bacteroides; (McNulty et al., 2013)), the most abundant polysaccharide in pea fiber was arabinan, consisting of a linear 1,5-linked arabinose backbone with arabinose residues as side chains at position 2 or 3 (FIG. 2A, Table D). Linear xylan (4-linked xylose), homogalacturonan (4-linked galacturonic acid) and rhamnogalacturonan I (2- and 2,4-linked rhamnose) were also detected as structural features of the polysaccharides in pea fiber. Homogalacturonan with a high degree of methyl esterification was the main structural component of citrus pectin (88.6% galacturonic acid), with arabinan, 1,4-linked galactan and RGI present as minor components (FIG. 7A, Table E).

High-resolution proteomic analysis of community gene expression—The results of these biochemical analyses raised the possibility that metabolism of arabinan in pea fiber and methylated homogalacturonan in citrus pectin were involved in the responses of target Bacteroides. To test this hypothesis, we turned to high-resolution shotgun proteomic analysis, focusing on fecal samples obtained on day 6 of the monotonous feeding experiment. After considering only peptides that uniquely mapped to a single seed protein, 11,493 proteins were advanced to quantitative analysis (summed abundances; 59% from community members, 36% from mouse and 2% from diet; see Methods). We calculated a z-score for each expressed protein from each bacterial species using the abundances of all proteins assigned to that individual species in a given sample. This allowed us to determine changes in the abundance of each protein irrespective of changes in the abundance of that species in the community. In the case of the Bacteroides species represented by INSeq libraries, we considered the measured abundance of a given protein to reflect the summed contributions of all the mutant strains of that species (thus representing the level of expression we would expect from a corresponding wild-type strain). Linear models were constructed using limma (Smyth, 2004; Ting et al., 2009) and significant effects were identified between bacterial protein abundances and supplementation of the control diet with pea fiber and citrus pectin (245 and 450 proteins, respectively; |fold-change|>log 2(1.2), P<0.05, FDR corrected). Bacteroides contain multiple polysaccharide utilization loci (PULs) in their genomes. PULs provide a fitness advantage by endowing a species with the ability to sense, import, and process complex glycans using their encoded carbohydrate-responsive transcription factors, SusC/SusD-like transporters, and carbohydrate active enzymes (CAZymes) (Glenwright et al., 2017; Kotarski and Salyers, 1984; Martens et al., 2011; McNulty et al., 2013; Shepherd et al., 2018). Eighty-five of the proteins whose levels were significantly altered by pea fiber and 134 that were significantly affected by citrus pectin were encoded by PULs (Terrapon et al., 2018).

Ranking proteins by the pea-fiber induced increase in their abundance disclosed that in B. thetaiotaomicron, 6 of the top 10 were encoded by PULs 7, 73, and 75. PUL7 is known to be involved in arabinan metabolism (Lynch and Sonnenburg, 2012; Schwalm et al., 2016), and encodes characterized and predicted arabinofuranosidases in glycoside hydrolase (GH) family 43, GH51, and GH146. PUL75 carries out the degradation of rhamnogalacturonan I (RGI) (Luis et al., 2018), but its expression is also triggered by exposure to purified arabinan in vitro (Martens et al., 2011). PUL73 processes homogalacturonan (Luis et al., 2018) and encodes CAZymes that cleave linked galacturonic acid residues and remove methyl and acetyl esters from galacturonic acid [polysaccharide lyase (PL)1, GH105, GH28, CE8, CE12 family members]. B. ovatus proteins encoded by predicted RGI-processing PULs (PUL97) (Luis et al., 2018) were among the most increased by pea fiber administration. Supplementation of the HiSF-LoFV diet with citrus pectin resulted in increased abundance of proteins encoded by a B. cellulosilyticus PUL that is induced by homogalacturonan in vitro (PUL83). In addition, citrus pectin induced expression of proteins in several B. finegoldii PULs (PUL34, 35, 42, and 43) that encode galacturonan-processing enzymes (GH28, GH105, GH106, PL11 subfamily 1, CE8 and CE12). This latter finding correlates with the organism's citrus pectin-driven expansion.

Combining proteomic and INSeq analyses—As noted above, we colonized mice with INSeq libraries and then fed them the base HiSF-LoFV diet for two days before switching the experimental groups to fiber-supplemented diets. We measured the abundances of Tn mutant strains, and calculated log ratios between fecal samples collected on experimental day 6 (posttreatment) and day 2 (pre-treatment); results were compared to the reference HiSF-LoFV treatment arm to focus on genes that had significant fitness effects in the context of these fibers (P<0.05, FDR corrected; see Methods; 223 genes, 24% in PULs. Genes exhibiting a significant positive fold-change in protein abundance and negative effect on fitness when mutated appear in the bottom right quadrant of the orthogonal protein-fitness plots shown in FIG. 2F-FIG. 2I.

Genes in PULs were ranked by the magnitude of pea-fiber-dependent increases in the abundances their protein products and decreases in strain fitness when they were disrupted by a Tn insertion. The results revealed genes in three PULs (PUL7 in B. thetaiotaomicron, PUL5 in B. cellulosilyticus, and PUL27 in B. vulgatus; FIG. 2F, FIG. 2H, and FIG. 2I) that were affected by pea fiber. These three PULs are homologous as judged by a BLASTp comparison of their encoded proteins against the genomes of other community members (FIG. 2J). Genes in a highly-conserved arabinose utilization operon, present within the B. thetaiotaomicron and B. cellulosilyticus PULs, but at a site distant from PUL27 in B. vulgatus, had the greatest effect on B. vulgatus fitness of any genes represented in the mutant library (FIG. 2I). We subsequently compared the genomes of five strains of B. thetaiotaomicron, and found that PUL7 was highly conserved with the exception of a single gene of unknown function (BT_0352) that was present in two of the strains (FIG. 27). PUL27 in B. vulgatus was also well conserved across 6 strains with the exception of some variability in the gene lengths of the hybrid two-component system and SusC-like transporter.

The increased fitness cost of mutations in B. ovatus RGI-processing PUL97, but not the B. thetaiotaomicron RGI-processing PUL75, indicated that these species utilize different carbohydrates in the pea fiber-supplemented diet (RGI and arabinan, respectively; FIG. 2G). In contrast, the overlapping reliance on arabinan degradation pathways in B. thetaiotaomicron, B. vulgatus, and B. cellulosilyticus raised the possibility that these species were engaged in competition with one another for arabinan in pea fiber.

A parallel analysis of mice monotonously fed citrus pectin revealed that five genes encoded by galacturonan-processing PUL83 in B. cellulosilyticus were among the most abundantly expressed and most important for fitness compared to the base diet condition (FIG. 7H). B. vulgatus did not expand with citrus pectin supplementation (FIG. 7E), nevertheless, it contained galacturonan-processing PULs (PUL5/6, PUL31, and PUL42/43) with genes involved in hexuronate metabolism whose protein products increased in abundance and, when mutated, conveyed decreased fitness when exposed to this fiber preparation (FIG. 7I). Consistent with increased reliance on citrus pectin, the abundance of B. vulgatus proteins involved in starch utilization (PUL38) was decreased in the presence of this fiber.

Together, our proteomic and INSeq datasets revealed the microbial genes required during fiber-driven expansion, highlighted the polysaccharides that contributed to the fitness effects of these fibers and provided evidence for functional overlap in the nutrient harvesting strategies of B. cellulosilyticus and B. vulgatus, in two distinct fiber conditions. The dominance of B. cellulosilyticus in diverse diet contexts led us to ask whether (and how) this species directly competes with other community members for polysaccharides.

### Example 6—Interspecies Competition Controls the Outcomes of Fiber-Based Microbiota Manipulation

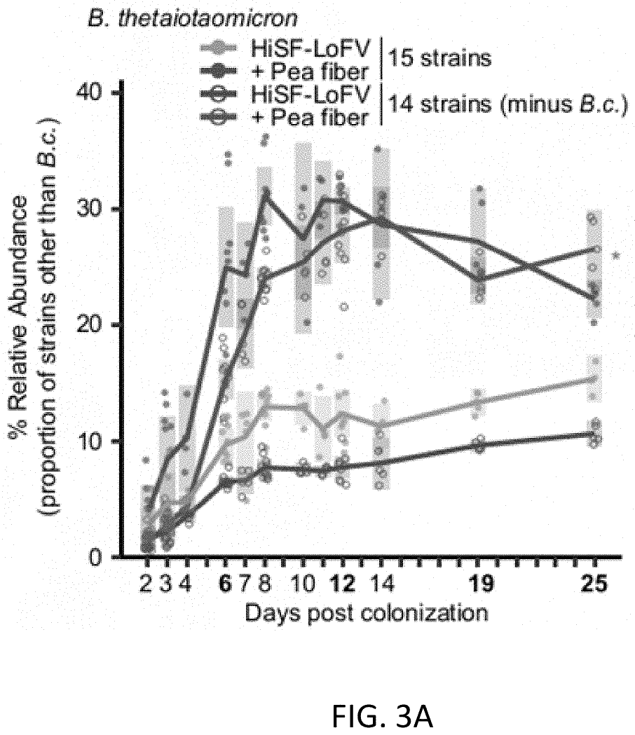

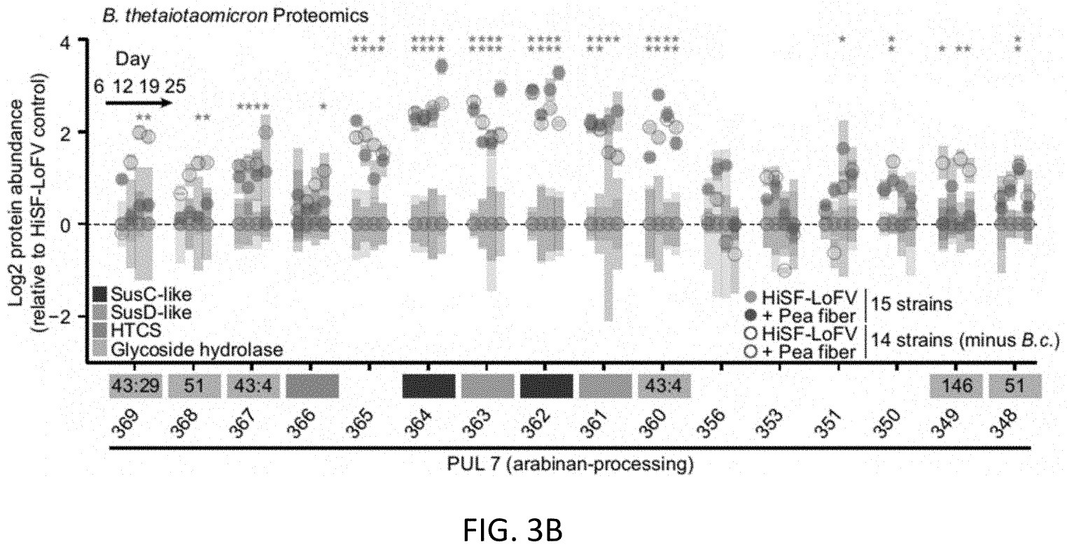

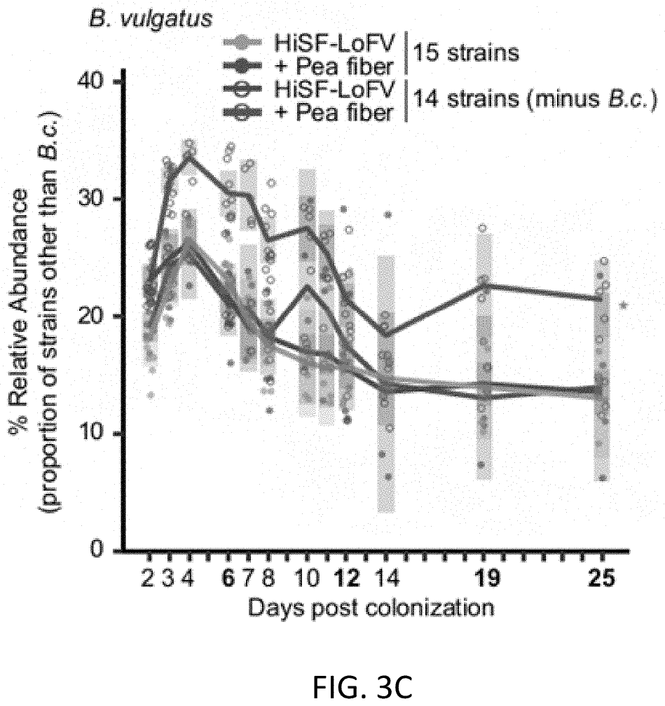

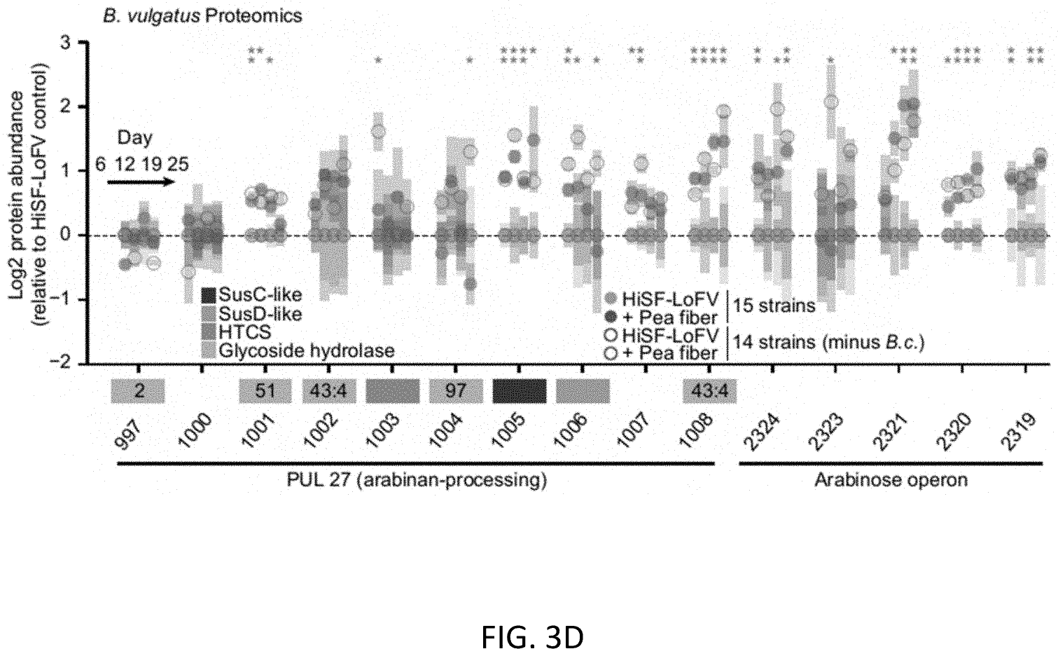

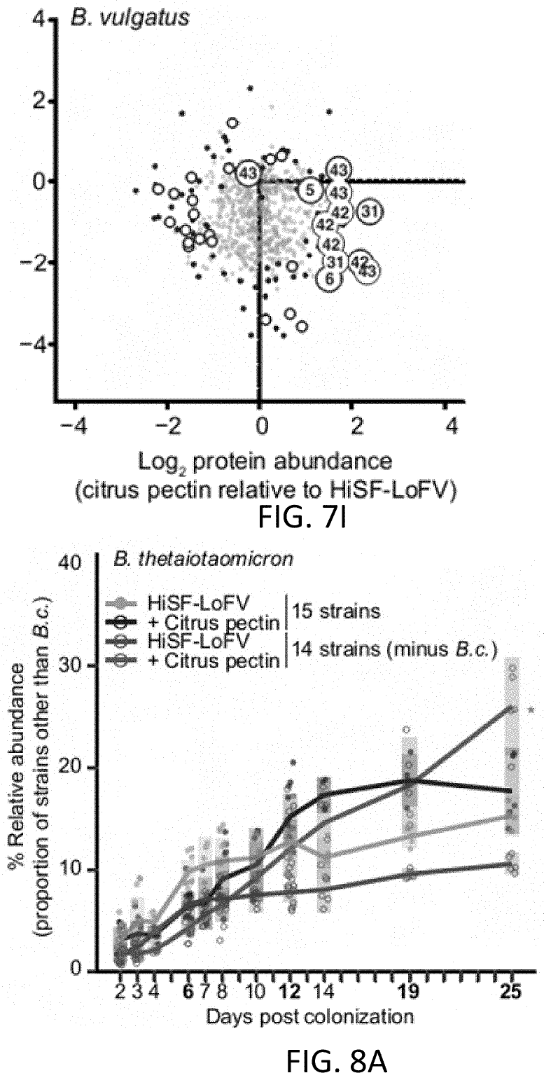

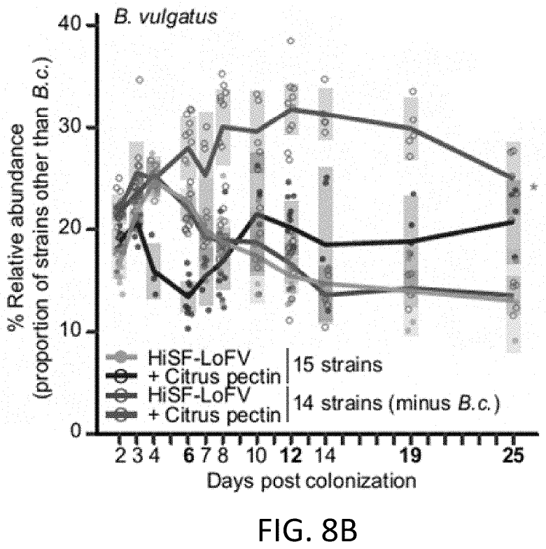

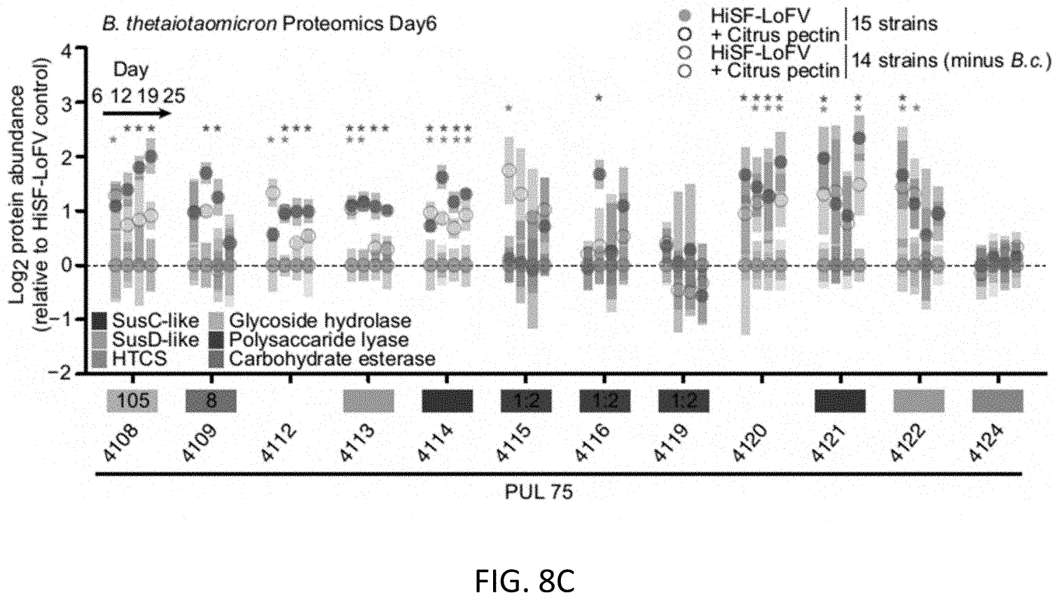

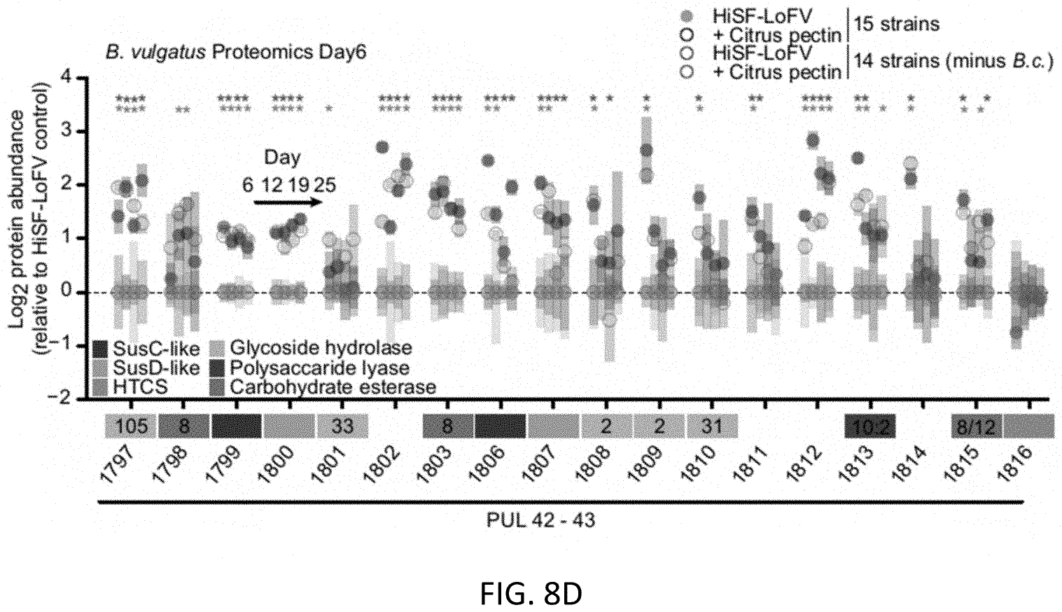

We performed a direct test for interactions between B. cellulosilyticus and other species by comparing the defined 15-member community, to the derivative 14-member community lacking B. cellulosilyticus. Using an experimental design that mimicked the monotonous feeding study described above, groups of germ-free mice were colonized with these two communities and fed the HiSF-LoFV diet with or without 10% (w/w) pea fiber or citrus pectin. COPRO-Seq analysis was used to determine the abundance of each strain as a proportion of all strains other than B. cellulosilyticus, thereby controlling for the compositional effect of removing this species. Defined this way, the abundance of B. thetaiotaomicron did not increase upon omission of B. cellulosilyticus in the presence of pea fiber, suggesting minimal competition between these two species for arabinan (FIG. 3A. Proteomic analysis of fecal samples collected on experimental days 6, 12, 19, and 25 demonstrated that the proteins in B. thetaiotaomicron PUL7 whose abundances were increased by pea fiber in the complete community context, were not further increased in the absence of B. cellulosilyticus (FIG. 3B. B. vulgatus was the only species that expanded with pea fiber administration in the absence of B. cellulosilyticus (P<0.05, ANOVA, FDR corrected; FIG. 3C). Proteomic analysis of serially collected fecal samples disclosed that the abundances of proteins encoded by B. vulgatus PUL27, as well as its arabinose operon, were persistently increased during exposure to pea fiber, regardless of whether B. cellulosilyticus was included in the community (FIG. 3D). Citrus pectin provided a second example of fiber-driven expansion of B. vulgatus in the absence of B. cellulosilyticus (FIG. 8B). Expression of proteins encoded by B. vulgatus' galacturonan-processing PULs 5, 6, 31, 42, and 43, were also induced by citrus pectin, irrespective of B. cellulosilyticus (FIG. 8C and FIG. 8D). Together, our findings demonstrate a negative interaction between B. vulgatus and B. cellulosilyticus and suggest that the greater abundance of B. vulgatus when B. cellulosilyticus is absent occurs because the persistent competition between these organisms for arabinan in pea fiber and homogalacturonan in citrus pectin is relieved.

### Example 7—Artificial Food Particles as Biosensors of Community Glycan Degradative Activities

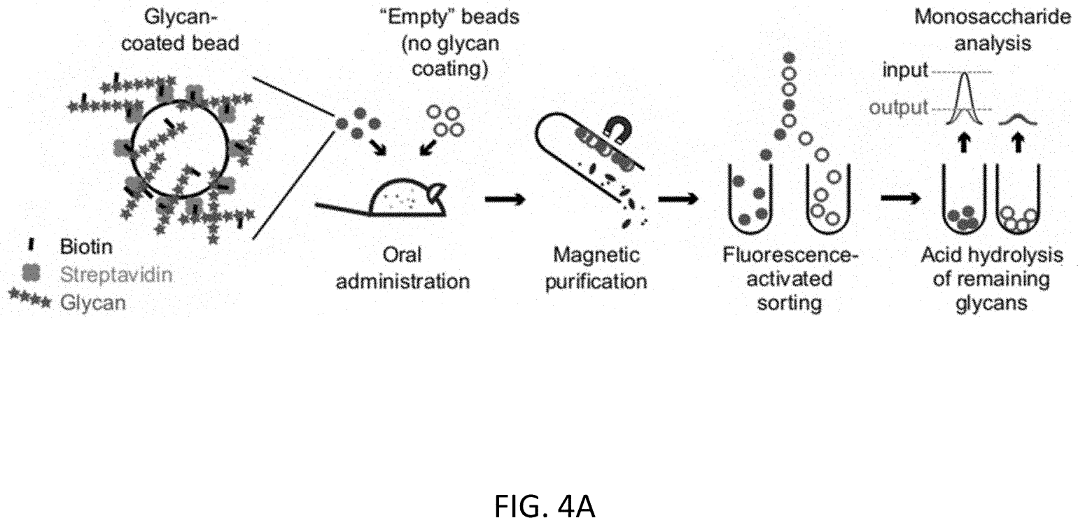

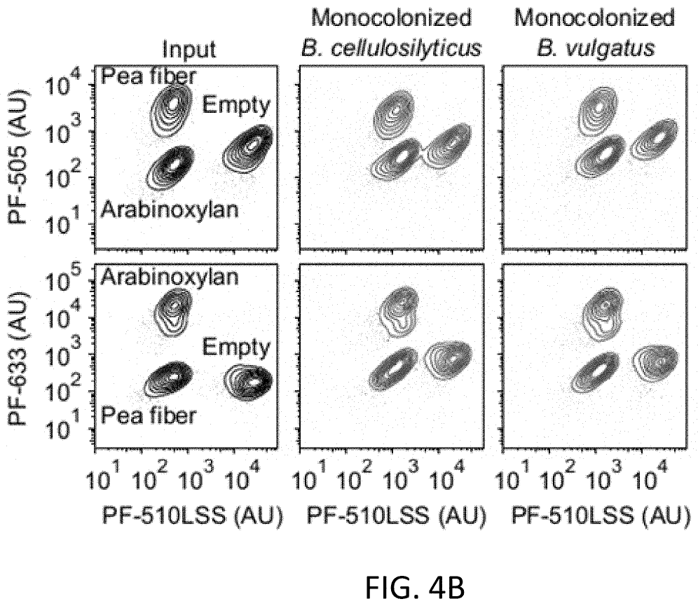

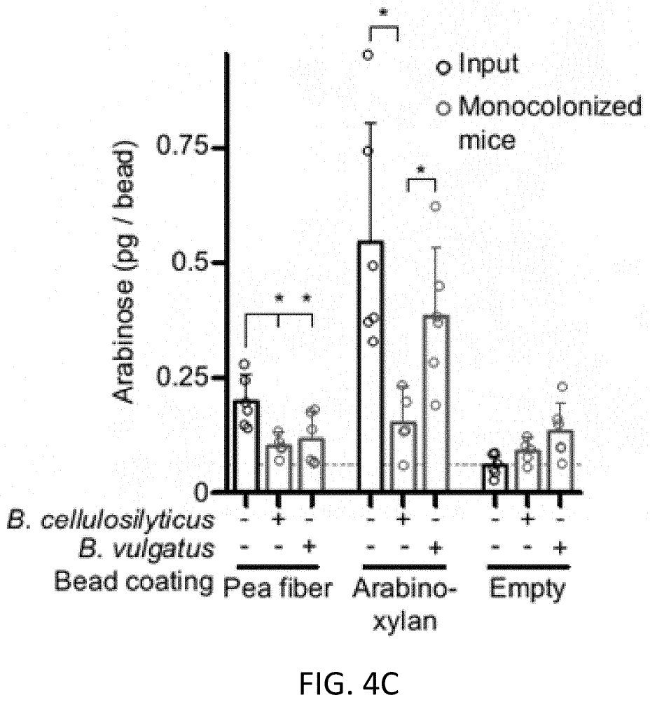

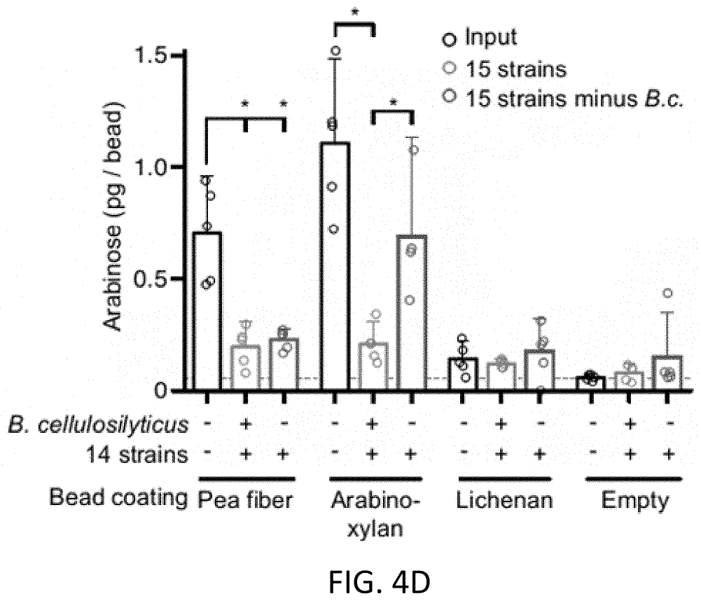

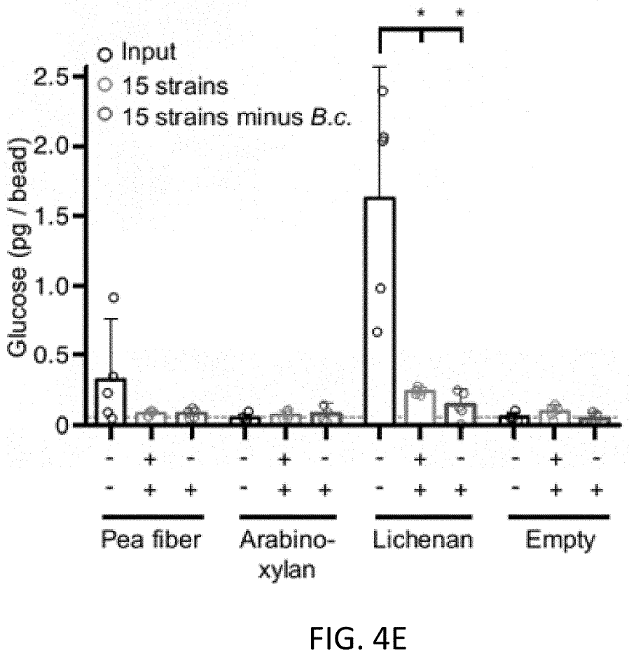

To directly test the capacity of competing Bacteroides to process the same nutrient substrate in vivo, a bead-based glycan degradation assay was developed (FIG. 4A). Two polysaccharides of interest were selected: (i) a soluble, starch-depleted fraction of pea fiber polysaccharides composed predominantly of arabinose (83% of monosaccharides) with little xylose (4%), and (ii) wheat arabinoxylan (38% arabinose/62% xylose). The latter was used as a control given its established ability to support growth (in vitro) of B. cellulosilyticus (McNulty et al., 2013) but not B. vulgatus (Tauzin et al., 2016). These polysaccharides were biotinylated and each product was attached to a distinct population of microscopic (20 μm diameter) streptavidin-coated paramagnetic glass beads, generating carbohydrate-coated artificial ‘food particles’ that could be recovered from mouse intestinal contents using a magnetic field. Each population of beads was also labeled with a distinct biotinylated fluorophore so that several types of polysaccharide-beads could be pooled, administered at the same time to the same mouse, recovered from the gut lumen or feces and then sorted into their original groups using a flow cytometer (FIG. 4B). ‘Empty’ beads that had not been incubated with polysaccharides, but were labeled with a unique biotinylated fluorophore, served as negative controls. The sorted beads were subjected to acid hydrolysis and the hydrolysis products were assayed by gas chromatography-mass spectrometry (GC-MS) to quantify the levels of bead-bound carbohydrate present before and after transit through the mouse gut. Alternative methods to quantify the levels of bead-bound carbohydrate present before and after administration can also be used.

Germ-free mice were colonized with either B. cellulosilyticus or B. vulgatus alone and fed a HiSF-LoFV diet supplemented with 10% (w/w) pea fiber. Seven days after colonization, all mice were gavaged with an equal mixture of the three bead types (5×10⁶ of each type/animal, n=5-6 animals). Mice were euthanized 4 h later, beads were recovered from their cecum and colon, and the mass of monosaccharides on the different purified bead types was quantified. The fluorescent signal present on all bead types persisted after intestinal transit, confirming that the biotin-streptavidin interactions were stable under these conditions (FIG. 4B). Pea fiber-beads recovered from both groups of mice had significantly reduced arabinose [26.1±3.4% (mean±SD) and 29.1±0.7% of levels in input beads, respectively]. In contrast, levels of arabinose were only significantly decreased on arabinoxylan-coated beads recovered from mice colonized with B. cellulosilyticus (FIG. 4C; Table 9).

A follow-up experiment of identical design was performed except that animals fed HiSF-LoFV supplemented with pea fiber were gavaged 12 days rather than seven days after colonization with a collection of four rather than three types of beads. These beads were either empty (no glycan bound) or coated with (i) the soluble, starch-depleted fraction of pea fiber, or wheat arabinoxylan, or lichenan from Icelandic moss, a control glycan low in arabinose (81% glucose/8% mannose/6% galactose/2% arabinose). Beads were recovered, purified by flow cytometry and analyzed using GC-MS. The degradation of bead-bound pea fiber and arabinoxylan was similar to that observed on day 7.

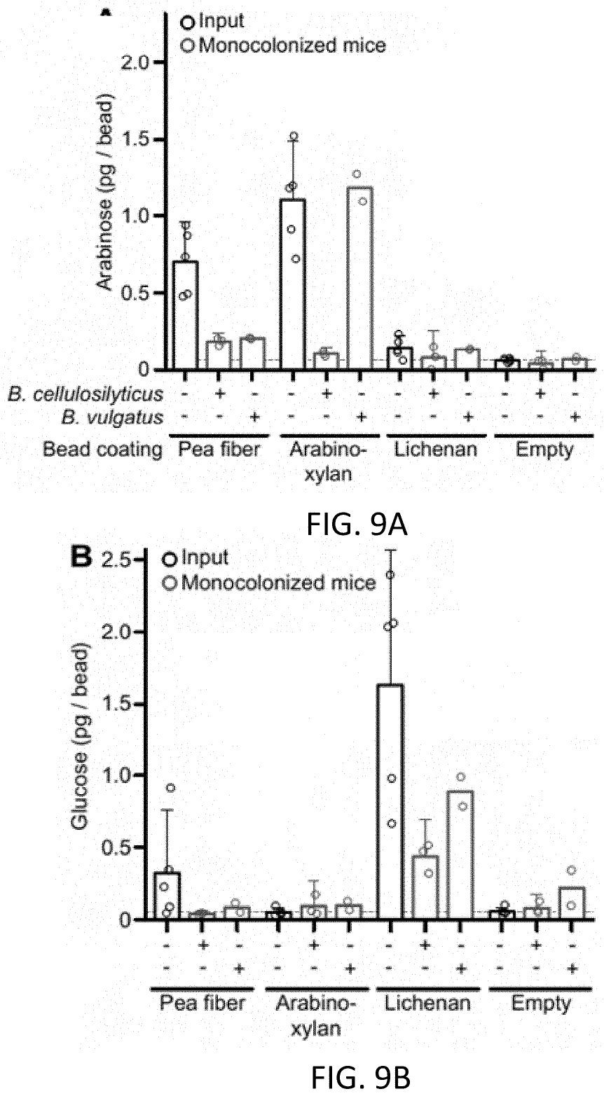

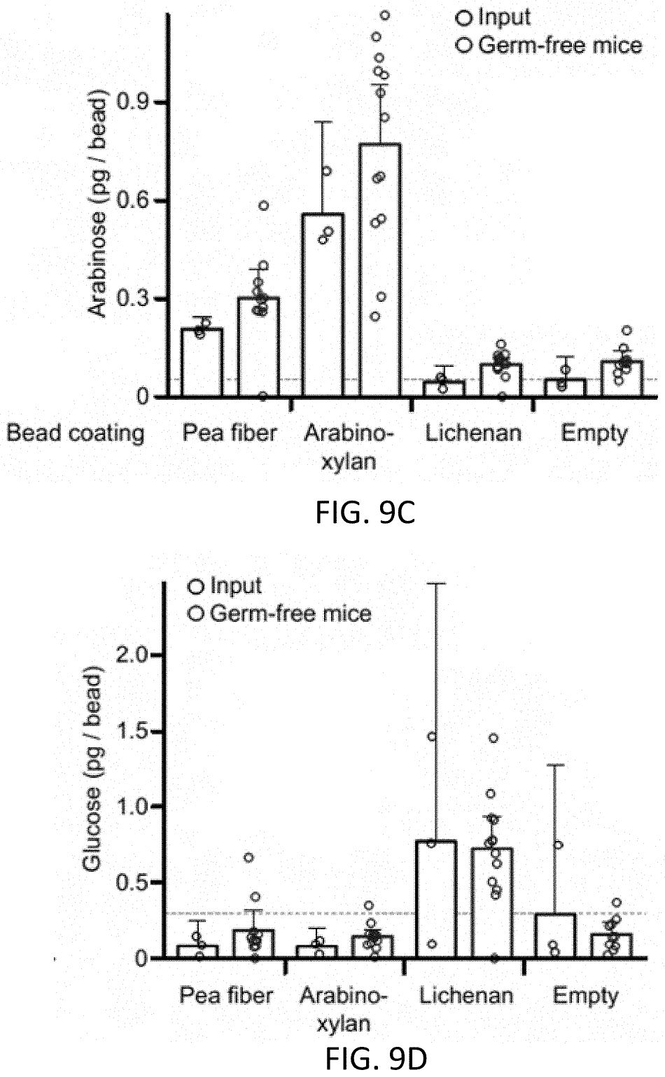

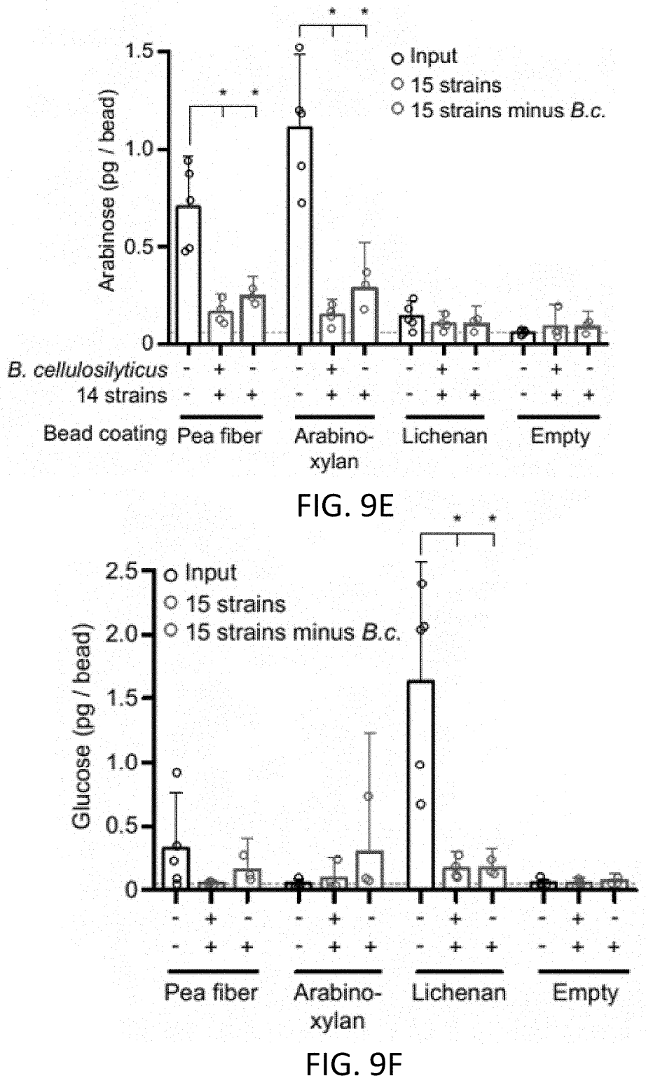

To control for microbe-independent polysaccharide degradation, germ-free mice were given a gavage of arabinoxylan-coated, pea-fiber coated, lichenan-coated, and empty beads (n=13 animals). We collected all fecal samples produced during an 8 h period (from 4 to 12 hours after gavage). Assays of the arabinoxylan-, pea fiber-, and lichenan-coated beads purified from fecal samples obtained from each germ-free animal revealed no significant degradation of these polysaccharides after passage through their intestines (FIG. 9C and FIG. 9D; Tables 9 and 10). Together, these results provide a direct, in vivo demonstration of the overlapping capacities of competing Bacteroides species to degrade arabinan present in pea fiber.

Given the observation that several species can metabolize pea fiber arabinan in vivo, whether the absence of B. cellulosilyticus would compromise the efficiency with which the community carried out this function was assessed. Mice consuming the unsupplemented HiSF-LoFV diet were given pea fiber-coated, arabinoxylan-coated, lichenan-coated, and empty beads 12 days after colonization with (i) the 15-member consortium or (ii) the derivative 14-member community lacking B. cellulosilyticus. Analysis of beads recovered from the cecal and colonic contents of these mice disclosed that the level of pea fiber degradation was not affected by the absence of B. cellulosilyticus (FIG. 4D). In a separate group of mice fed a pea-fiber supplemented HiSF-LoFV diet, degradation of bead-bound pea-fiber was also the same regardless of the presence of B. cellulosilyticus (FIG. 9E and FIG. 9F). Thus, consistent with our detection of multiple species exploiting pea fiber arabinan as a nutrient source (FIG. 2 and FIG. 3), the community can compensate for loss of this metabolic function provided by B. cellulosilyticus.

TABLE 9

| | | | | B. vulgatus | | B. cellulosilyticus | |
|---|---|---|---|---|---|---|---|
| | | Input | | HiSF-LoFV | | HiSF-LoFV | |
| | | Mean | | Mean | | Mean | |
| Monosaccharide | | (pg/bead) | sd | (pg/bead) | sd | (pg/bead) | sd |
| Xy | Arabinoxylan beads | 0.17 | 0.12 | 0.11 | 0.12 | 0.05 | 0.05 |
| | Pea Fiber beads | 0.06 | 0.07 | 0.01 | 0.01 | 0.01 | 0.02 |
| | Uncoated beads | 0.01 | 0.01 | 0.01 | 0.01 | 0.02 | 0.03 |
| Ara | Arabinoxylan beads | 0.54 | 0.25 | 0.38 | 0.15 | 0.15 | 0.07 |
| | Pea Fiber beads | 0.2 | 0.06 | 0.12 | 0.06 | 0.1 | 0.02 |
| | Uncoated beads | 0.06 | 0.02 | 0.13 | 0.06 | 0.09 | 0.02 |
| Man | Arabinoxylan beads | 0.02 | 0.02 | 0.04 | 0.03 | 0.05 | 0.03 |
| | Pea Fiber beads | 0.04 | 0.02 | 0.06 | 0.04 | 0.06 | 0.04 |
| | Uncoated beads | 0.06 | 0.03 | 0.14 | 0.07 | 0.1 | 0.06 |
| Gal | Arabinoxylan beads | 0.02 | 0.01 | 0.06 | 0.05 | 0.02 | 0.01 |
| | Pea Fiber beads | 0.05 | 0.03 | 0.07 | 0.05 | 0.05 | 0.02 |
| | Uncoated beads | 0 | 0.01 | 0.05 | 0.03 | 0.04 | 0.2 |
| Glc | Arabinoxylan beads | 0.02 | 0.04 | 0 | 0.01 | 0.01 | 0.01 |
| | Pea Fiber beads | 0.01 | 0.02 | 0 | 0.01 | 0 | 0 |
| | Uncoated beads | 0.01 | 0.01 | 0 | 0.01 | 0.01 | 0.01 |

Abbreviations:
xylose (Xyl),
arabinose (Ara),
mannose (Man),
galactose (Gal),
glucose (Glc)

TABLE 10A

| | | Mean (sd) pg/bead | | | | | | | | | |
|---|---|---|---|---|---|---|---|---|---|---|---|
| | BEAD TYPE | Input | | A | | B | | C | | D | |
| Xyl | Arabinoxylan | 2.1 | (0.55) | 0.44 | (0.21) | 0.85 | (0.24) | 0.23 | (0.18) | 0.36 | (0.11) |
| | Pea Fiber | 0.2 | (0.29) | 0.09 | (0.07) | 0.06 | (0.03) | 0.03 | (0.02) | 0.08 | (0.04) |
| | Lichenan | 0.06 | (0.02) | 0.06 | (0.05) | 0.11 | (0.09) | 0.04 | (0.02) | 0.08 | (0.04) |
| | Uncoated | 0.07 | (0.02) | 0.21 | (0.37) | 0.07 | (0.07) | 0.1 | (0.14) | 0.43 | (0.52) |
| Ara | Arabinoxylan | 1.11 | (0.31) | 0.21 | (0.08) | 0.69 | (0.28) | 0.15 | (0.05) | 0.28 | (0.1) |
| | Pea Fiber | 0.7 | (0.21) | 0.2 | (0.09) | 0.23 | (0.04) | 0.16 | (0.06) | 0.24 | (0.04) |
| | Lichenan | 0.14 | (0.07) | 0.12 | (0.02) | 0.17 | (0.12) | 0.11 | (0.04) | 0.1 | (0.04) |
| | Uncoated | 0.06 | (0.01) | 0.08 | (0.03) | 0.15 | (0.16) | 0.09 | (0.07) | 0.09 | (0.03) |
| Man | Arabinoxylan | 0 | (0.01) | 0.02 | (0.01) | 0.02 | (0.01) | 0.02 | (0.01) | 0.02 | (0.01) |
| | Pea Fiber | 0.05 | (0.04) | 0.04 | (0.01) | 0.09 | (0.04) | 0.02 | (0.01) | 0.03 | (0.01) |
| | Lichenan | 0.12 | (0.05) | 0.14 | (0.06) | 0.17 | (0.13) | 0.09 | (0.03) | 0.07 | (0.03) |
| | Uncoated | 0 | (0.01) | 0.04 | (0.01) | 0.04 | (0.02) | 0.02 | (0.01) | 0.03 | (0.01) |
| Gal | Arabinoxylan | 0.02 | (0.01) | 0.09 | (0.02) | 0.11 | (0.06) | 0.09 | (0.02) | 0.07 | (0.01) |
| | Pea Fiber | 0.22 | (0.29) | 0.21 | (0.04) | 0.35 | (0.14) | 0.13 | (0.04) | 0.18 | (0.05) |
| | Lichenan | 0.23 | (0.1) | 0.2 | (0.14) | 0.44 | (0.29) | 0.21 | (0.1) | 0.29 | (0.09) |
| | Uncoated | 0.02 | (0.01) | 0.21 | (0.08) | 0.27 | (0.13) | 0.12 | (0.03) | 0.11 | (0.04) |
| Glc | Arabinoxylan | 9.15 | (7.95) | 11.53 | (7.18) | 14.21 | (11.64) | 8 | (3.43) | 23.27 | (17.41) |
| | Pea Fiber | 38.2 | (33.13) | 12.81 | (3.85) | 22.32 | (8.36) | 6.91 | (1.14) | 20.48 | (10.25) |
| | Lichenan | 193.16 | (71.35) | 23.41 | (4.76) | 37.74 | (26.01) | 24.89 | (8.33) | 19.62 | (7.81) |
| | Uncoated | 8.41 | (4.65) | 11.3 | (5.51) | 14.49 | (10.38) | 7.12 | (2.65) | 11.68 | (1.3) |

A = 15-member, HiSF-LoFV;
B = 14-member (No B.c.), HiSF-LoFV;
C = 15-member HiSF-LoFV+ Pea Fiber;
D = 14-member (No B.c.), HiSF-LoFV+ Pea Fiber
Abbreviations:
xylose (Xyl),
arabinose (Ara),
mannose (Man),
galactose (Gal),
glucose (Glc)

TABLE 10B

| | | Mean (sd) pg/bead | | | |
|---|---|---|---|---|---|
| | BEAD TYPE | E | | F | |
| Xyl | Arabinoxylan | 0.22 | (0.18) | 1.46 | (0.24) |
| | Pea Fiber | 0.14 | (0.15) | 0.06 | (0.01) |
| | Lichenan | 0.04 | (0.02) | 0.14 | (0.09) |
| | Uncoated | 0.16 | (0.04) | 0.1 | (0.04) |
| Ara | Arabinoxylan | 0.1 | (0.02) | 1.19 | (0.12) |
| | Pea Fiber | 0.18 | (0.02) | 0.2 | (0.01) |
| | Lichenan | 0.08 | (0.08) | 0.14 | (0.01) |
| | Uncoated | 0.04 | (0.03) | 0.07 | (0.01) |
| Man | Arabinoxylan | 0.03 | (0.03) | 0.01 | (0.01) |
| | Pea Fiber | 0.03 | (0.02) | 0.02 | (0.01) |
| | Lichenan | 0.1 | (0.04) | 0.1 | (0.02) |
| | Uncoated | 0.06 | (0.03) | 0.02 | (0.01) |
| Gal | Arabinoxylan | 0.15 | (0.14) | 0.1 | (0.02) |
| | Pea Fiber | 0.25 | (0.12) | 0.22 | (0.02) |
| | Lichenan | 0.36 | (0.15) | 0.46 | (0.18 |
| | Uncoated | 0.27 | (0.13) | 0.2 | (0.06) |
| Glc | Arabinoxylan | 7.13 | (5.46) | 8.39 | (0.81) |
| | Pea Fiber | 8.35 | (3.84) | 8.34 | (2.2) |
| | Lichenan | 23.52 | (3.84) | 69.59 | (15.85) |
| | Uncoated | 14.47 | (2.24) | 17.82 | (5.76) |

E = B. cellulosilyticus, HiSF-LoFV+ Pea Fiber;
F = B. vulgatus, HiSF-LoFV+ Pea Fiber
Abbreviations:
xylose (Xyl),
arabinose (Ara),
mannose (Man),
galactose (Gal),
glucose (Glc)

TABLE 11

| | | Input | | Germ-free HiSF-LoFV | |
|---|---|---|---|---|---|
| | | Mean | | Mean | |
| Monosaccharide | | (pg/bead) | sd | (pg/bead) | sd |
| Xyl | Arabinoxylan beads | 1.18 | 0.16 | 1.35 | 0.41 |
| | Pea Fiber beads | 0.11 | 0.08 | 0.22 | 0.26 |
| | Lichenan beads | 0.16 | 0.22 | 0.14 | 0.08 |
| | Uncoated beads | 0.11 | 0.03 | 0.18 | 0.06 |
| Ara | Arabinoxylan beads | 0.56 | 0.11 | 0.77 | 0.3 |
| | Pea Fiber beads | 0.2 | 0.02 | 0.3 | 0.14 |
| | Lichenan beads | 0.04 | 0.02 | 0.1 | 0.04 |
| | Uncoated beads | 0.05 | 0.03 | 0.11 | 0.04 |
| Man | Arabinoxylan beads | 0.01 | 0.01 | 0.05 | 0.05 |
| | Pea Fiber beads | 0.03 | 0.02 | 0.05 | 0.03 |
| | Lichenan beads | 0.12 | 0.07 | 0.23 | 0.14 |
| | Uncoated beads | 0.02 | 0.01 | 0.03 | 0.01 |
| Gal | Arabinoxylan beads | 0.03 | 0.01 | 0.2 | 0.07 |
| | Pea Fiber beads | 0.06 | 0.03 | 0.37 | 0.14 |
| | Lichenan beads | 0.2 | 0.1 | 0.59 | 0.23 |
| | Uncoated beads | 0.07 | 0.08 | 0.26 | 0.11 |
| Glc | Arabinoxylan beads | 13.72 | 3.3 | 13.78 | 5.2 |
| | Pea Fiber beads | 7.27 | 4.32 | 25.47 | 22.97 |
| | Lichenan beads | 79.39 | 40.38 | 92.09 | 57.16 |
| | Uncoated beads | 22.58 | 25 | 22.24 | 19.15 |

Abbreviations:
xylose (Xyl),
arabinose (Ara),
mannose (Man),
galactose (Gal),
glucose (Glc)

TABLE 12

| | | Mean (sd) pg/bead | | | | | | | | | |
|---|---|---|---|---|---|---|---|---|---|---|---|
| | BEAD TYPE | Input | | A | | B | | C | | D | |
| Xyl | Arabinoxylan | 0.15 | (0.09) | 0.1 | (0.02) | 0.13 | (0.07) | 0.22 | (0.33) | 0.11 | (0.07) |
| | Mannan | 0.38 | (0.16) | 0.31 | (0.07) | 0.23 | (0.17) | 0.26 | (0.12) | 0.32 | (0.25) |
| | Uncoated | 0.05 | (0.05) | 0.08 | (0.04) | 0.44 | (0.66) | 0.09 | (0.05) | 0.08 | (0.01) |
| | Arabinoxylan (spike- | 0.1 | (0.03) | 0.17 | (0.21) | 0.43 | (0.75) | 0.17 | (0.14) | 0.09 | (0.05) |
| | in control) | | | | | | | | | | |
| Ara | Arabinoxylan | 9.02 | (2.84) | 3.07 | (0.68) | 3.73 | (1.57) | 4.41 | (4.08) | 8.45 | (3.53) |
| | Mannan | 1.09 | (2.46) | 0.09 | (0.05) | 0.04 | (0.02) | 0.07 | (0.06) | 0.1 | (0.05) |
| | Uncoated | 0.29 | (0.42) | 0.1 | (0.04) | 0.06 | (0.03) | 0.1 | (0.06) | 0.24 | (0.1) |
| | Arabinoxylan (spike- | 7.44 | (3.09) | 8.61 | (4.43) | 8.02 | (2.38) | 10.52 | (1.95) | 8.67 | (6.21) |
| | in control) | | | | | | | | | | |
| Man | Arabinoxylan | 7.15 | (2.24) | 2.07 | (0.49) | 3.61 | (1.86) | 2.83 | (2.48) | 6.43 | (2.87) |
| | Mannan | 1.18 | (1.93) | 0.45 | (0.39) | 0.27 | (0.16) | 0.55 | (0.18) | 0.34 | (0.19) |
| | Uncoated | 0.26 | (0.4) | 0.1 | (0.05) | 0.12 | (0.07) | 0.1 | (0.02) | 0.17 | (0.02) |
| | Arabinoxylan (spike- | 5.82 | (2.39) | 5.46 | (2.11) | 7.06 | (2.31) | 6.16 | (1.72) | 5.78 | (3.89) |
| | in control) | | | | | | | | | | |
| Gal | Arabinoxylan | 0.17 | (0.1) | 0.12 | (0.02) | 0.16 | (0.05) | 0.17 | (0.1) | 0.15 | (0.07) |
| | Mannan | 0.23 | (0.29) | 0.11 | (0.1) | 0.06 | (0.05) | 0.1 | (0.06) | 0.08 | (0.06) |
| | Uncoated | 0.02 | (0.01) | 0.06 | (0.02) | 0.06 | (0.03) | 0.08 | (0.02) | 0.07 | (0.02) |
| | Arabinoxylan (spike- | 0.14 | (0.04) | 0.17 | (0.09) | 0.14 | (0.02) | 0.8 | (0.05) | 0.12 | (0.08) |
| | in control) | | | | | | | | | | |
| Glc | Arabinoxylan | 0.06 | (0.03) | 0.03 | (0.03) | 0.05 | (0.02) | 0.06 | (0.09) | 0.05 | (0.04) |
| | Mannan | 1.08 | (0.49) | 1.09 | (0.53) | 0.85 | (0.83) | 0.87 | (0.6) | 1.15 | (0.8) |
| | Uncoated | 0.02 | (0.02) | 0.04 | (0.03) | 0.05 | (0.04) | 0.04 | (0.03) | 0.07 | (0.06) |
| | Arabinoxylan (spike- | 0.04 | (0.02) | 0.03 | (0.02) | 0.04 | (0.03) | 0.02 | (0.02) | 0.03 | (0.03) |
| | in control) | | | | | | | | | | |

A = 15-member, HiSF-LoFV;
B = 14-member (No B.c.), HiSF-LoFV;
C = 14-member (No B.o.), HiSFmBO;
D = 13-member (No B.c., No B.o.), HiSF-LoFVmBO
Abbreviations:
xylose (Xyl),
arabinose (Ara),
mannose (Man),
galactose (Gal),
glucose (Glc)

### Example 8—Acclimation to the Presence of a Potential Competitor Alleviates Resource Conflict

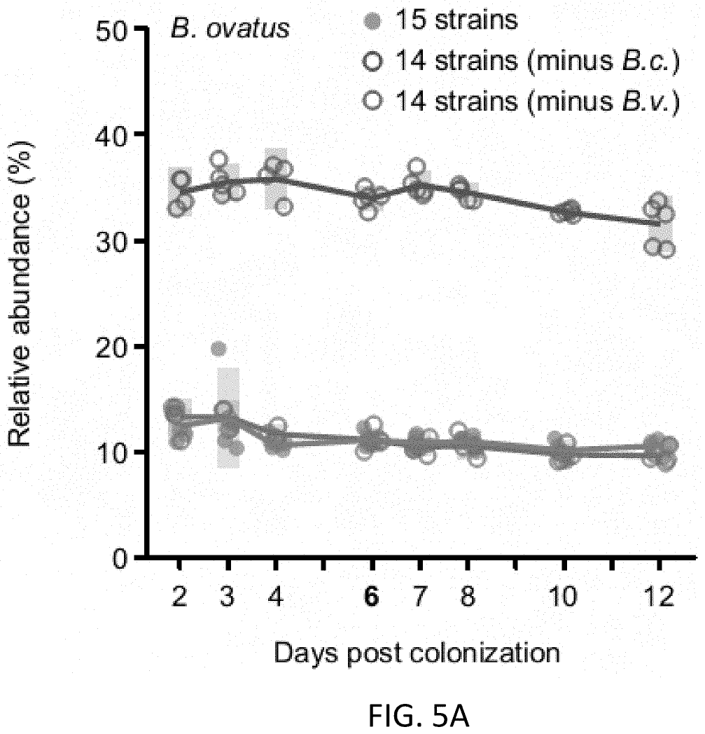

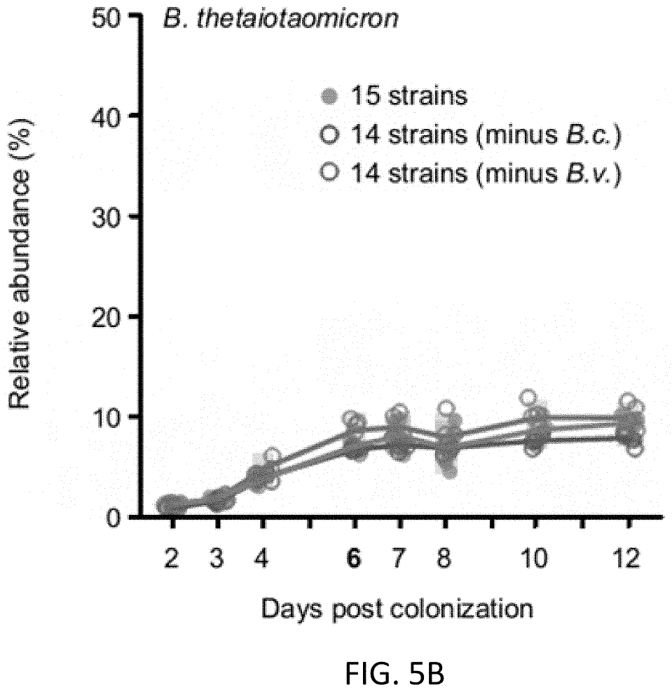

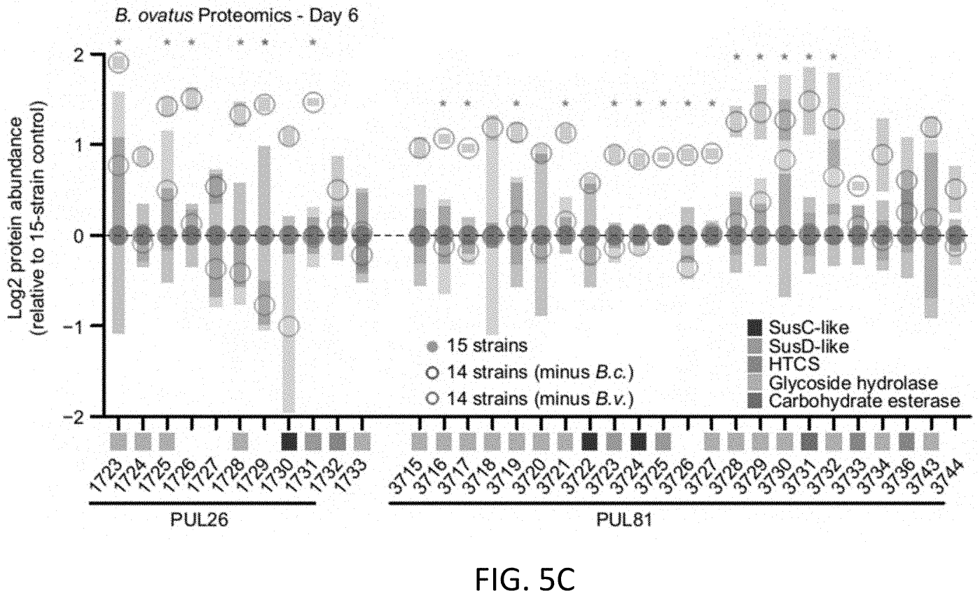

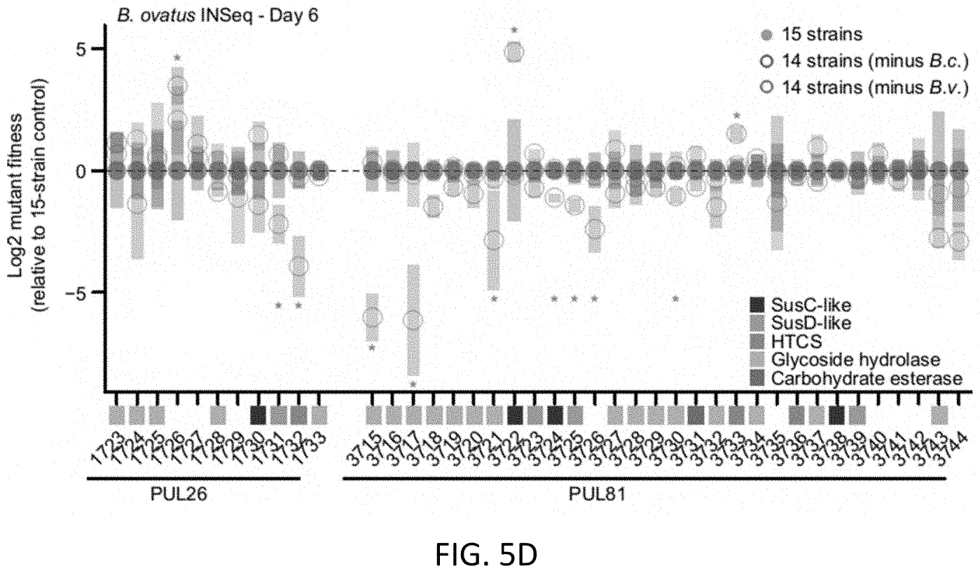

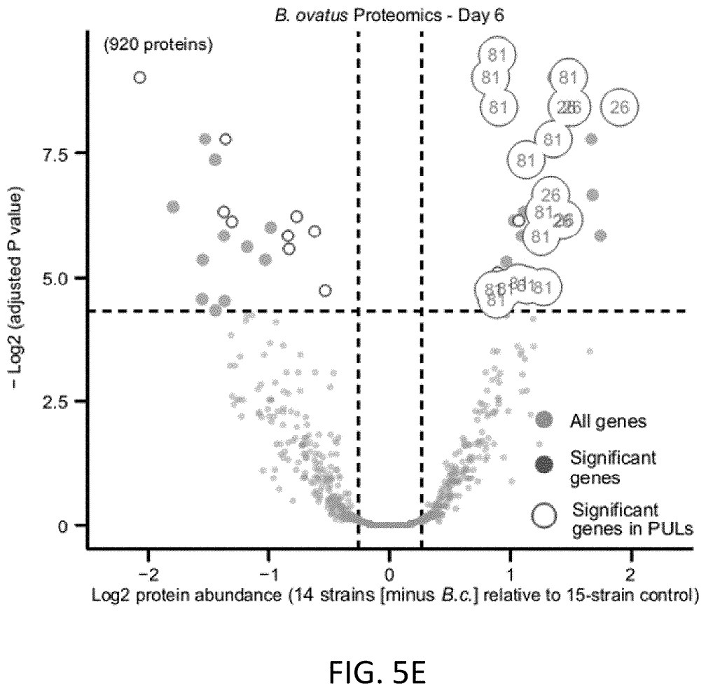

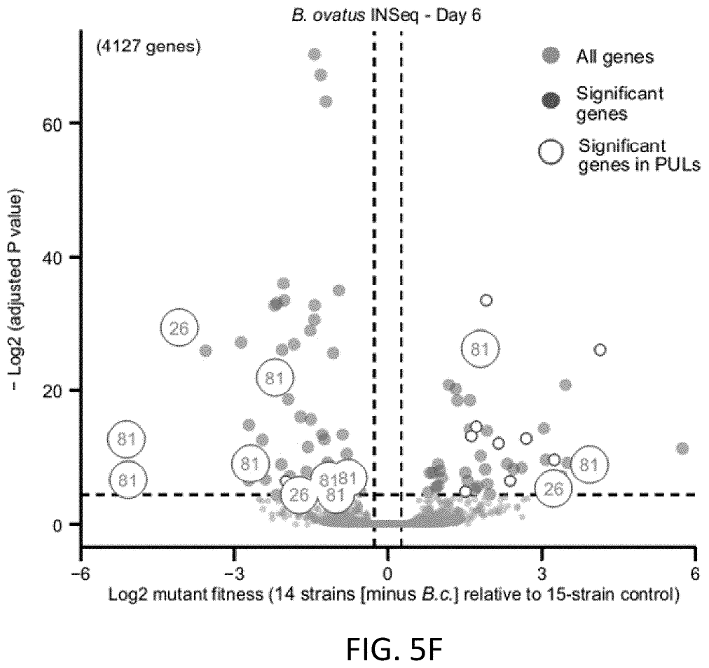

The in vivo bead-based glycan degradation assays revealed that in contrast to arabinan, the capacity of the community to process arabinoxylan was not rescued by other species in the absence of B. cellulosilyticus (FIG. 4D; Tables 9-12). This was unexpected, given that B. cellulosilyticus omission resulted in a significant increase in the relative abundance of B. ovatus (FIG. 5), which encodes PULs capable of arabinoxylan breakdown (Martens et al., 2011; Rogowski et al., 2015). We examined whether these results could arise from a type of interspecies relationship between B. cellulosilyticus and B. ovatus distinct from that observed between B. cellulosilyticus and B. vulgatus.

As discussed above, the abundances of B. vulgatus proteins involved in pea fiber or citrus pectin degradation were unchanged upon removal of its competitor B. cellulosilyticus. In contrast, B. ovatus exhibited metabolic flexibility, with proteins encoded by two arabinoxylan-processing PULs (PUL26 and PUL81) predominating among those whose abundances were increased when B. cellulosilyticus was absent versus present (FIG. 5C and FIG. 5D). This effect was apparent regardless of whether mice were fed the pea fiber-supplemented, citrus pectin-supplemented, or control unsupplemented HiSF-LoFV diets, consistent with the presence of arabinoxylan in the HiSF-LoFV diet. When we analyzed the contributions of genes to the fitness of B. ovatus (by calculating the changes in the abundance of Tn mutant strains from day 2 to day 6), those in these two arabinoxylan PULs were the most affected by omission of B. cellulosilyticus (FIG. 5D and FIG. 5F). This result indicates that B. ovatus exhibits a marked decrease in its reliance on arabinoxylan in the full 15-member community context. Examining another group of mice that received a 14-member community lacking B. vulgatus revealed that its absence did not induce changes in B. ovatus at the level of its relative abundance, the abundances of proteins encoded by its PULs involved in arabinoxylan processing or by other PULs, or in the fitness cost associated with mutations in its arabinoxylan-processing PULs or in other PULs (FIG. 5A and FIG. 5C, and FIG. 5D).

Monosaccharide and linkage analysis verified that arabinoxylan was present in the HiSF-LoFV diet; this conclusion was based on finding abundant 4-linked xylose with branching 4,3-linked xylose, and terminal arabinose (Tables 4-5). We also detected small amounts of 3-linked glucose (indicative of hemicellulose beta-glucans), galacturonic acid and rhamnose. The presence of these structures in the base HiSF-LoFV diet are consistent with the observed increase in abundance of proteins in B. ovatus PULs shown or predicted to process beta-glucan, rhamnogalacturonan, and host glycan when B. cellulosilyticus is present (FIG. 28).

Based on these results, we reasoned that metabolic flexibility allows B. ovatus to acclimate to the presence of B. cellulosilyticus by shifting its nutrient harvesting strategies, de-emphasizing arabinoxylan degradation, thus mitigating competition between the two species. To test this notion further, we performed an experiment omitting B. cellulosilyticus, B. ovatus, or both species from the 15-member consortium introduced into mice. Animals were fed the base HiSF-LoFV diet for 12 days and fecal samples were collected as in previous experiments. Confirming our earlier results, COPRO-Seq revealed that the abundance of B. ovatus was increased in the absence of B. cellulosilyticus (FIG. 6B. Proteomics analysis of fecal samples obtained on day 6 of this experiment also revealed an increase in the abundance of 16 proteins encoded by arabinoxylan-processing PULs 26 and 81 in B. ovatus when B. cellulosilyticus was removed (FIG. 6D). In contrast, the abundance of B. cellulosilyticus as a proportion of the remaining strains did not increase (FIG.), with just one protein specified by each of its arabinoxylan-processing PULs in B. cellulosilyticus (PULs 86 and 87) significantly increasing in abundance when B. ovatus was absent (FIG. 6E). These results, combined with the observation that arabinoxylan-processing genes are important for fitness of B. ovatus only when B. cellulosilyticus is absent (FIG. 5E), indicate that the metabolic flexibility of B. ovatus mitigates competition between two species with the capacity to process the same dietary fiber resource.

We sought to directly measure the functional outcome of metabolic flexibility in B. ovatus and establish that this species degraded arabinoxylan in the community lacking B. cellulosilyticus. Therefore, arabinoxylan-beads, as well as empty and yeast alpha-mannan coated control beads, were administered to the four groups of mice described above, with all mice consuming the base HiSF-LoFV diet. In the absence of B. cellulosilyticus, significant degradation of arabinoxylan was still detected (FIG. 6F), consistent with our previous observations (Tables 9-12). Omission of B. ovatus was also associated with persistent degradation (FIG. 6F), as expected based on the expression of arabinoxylan PULs by B. cellulosilyticus. However, arabinoxylan-coated beads recovered from mice lacking B. ovatus and B. cellulosilyticus were indistinguishable from input beads (FIG. 6F). In addition, omission of both B. cellulosilyticus and B. ovatus did not produce significant increases in the proportions of the remaining strains relative to one another, suggesting that these other species were unable to take advantage of the available arabinoxylan resources in the diet. None of the community contexts examined produced significant decreases in bead-bound mannan, controlling for non-specific polysaccharide degradation (FIG. 6G). As an additional ‘spike-in’ control, we added arabinoxylan beads to cecal and fecal samples obtained from all groups of mice immediately after they were euthanized and recovered and processed them in parallel with the orally administered beads. The preservation of carbohydrate on spike-in beads established that B. cellulosilyticus/B. ovatus-dependent degradation occurred during intestinal transit and not sample processing (FIG. 6F).

Together, these experiments show that, in contrast to the persistent competition for arabinan and homogalacturonan exhibited by B. vulgatus, B. ovatus avoids competition for arabinoxylan via acclimation to the presence of its potential competitor, B. cellulosilyticus. This conclusion is based on several observations; (i) the HiSF-LoFV diet contains arabinoxylan polysaccharides, which can be metabolized by both species in question, (ii) omission of B. ovatus did not cause detectable expansion of B. cellulosilyticus, (iii) proteins encoded by B. ovatus arabinoxylan PULs were significantly increased when B. cellulosilyticus was absent, (iv) genes in B. ovatus arabinoxylan PULs were more important for fitness when B. cellulosilyticus was absent, and (v) B. ovatus was responsible for the residual arabinoxylan degradation that took place in the absence of B. cellulosilyticus.

### Example 9—Discussion for Examples 4-8

Together, Examples 4-8 show that, in contrast to the persistent competition for arabinan and homogalacturonan exhibited by B. vulgatus, B. ovatus avoids competition via acclimation to the presence of its potential competitor, B. cellulosilyticus. This conclusion is based on the observations that (i) omission of B. ovatus did not cause detectable expansion of B. cellulosilyticus, (ii) proteins encoded by B. ovatus arabinoxylan PULs were significantly increased when B. cellulosilyticus was absent, (iii) genes in B. ovatus arabinoxylan PULs were significantly more important for fitness when B. cellulosilyticus was absent, and (iv) B. ovatus was responsible for the residual arabinoxylan degradation that took place in the absence of B. cellulosilyticus.

Combining (i) high resolution proteomics, (ii) forward genetic screens for fitness determinants, (iii) a collection of glycan-coated artificial food particles, and (iv) deliberate manipulations of community membership in gnotobiotic mice fed ‘representative’ high-fat, low-fiber USA diet led to the direct characterization of how human gut Bacteroides with distinct, as well as overlapping, nutrient harvesting capacities respond to different food-grade fibers. Our approach allowed us to identify bioactive components in compositionally complex fibers that impact specific members of the microbiota. Obtaining this type of information can inform food manufacturing practices by directing efforts to seek sources of and enrich for these active components; e.g., through judicious selection of cultivars of a given food staple, food processing methods or an existing waste stream from food manufacturing to mine for these components.

Deliberately manipulating membership of a consortium of cultured, sequenced human-donor derived microbes prior to their introduction into gnotobiotic mice fed a human diet, with or without fiber supplementation, provides an opportunity to determine whether and how organisms compete and what mechanisms they use to avoid competition. Simultaneous harvest of a particular dietary resource by two species is theoretically possible whenever they both contain a genetic apparatus sufficient for metabolism of that resource. We provide evidence that competition for particular glycans in fiber preparations is realized in such a model community, since glycan-degrading genes were expressed and required for fitness in both species, and negative interactions were observed in strain omission experiments. These omission experiments disclosed distinct relationships between B. vulgatus, B. ovatus and B. cellulosilyticus; namely, the ability of B. ovatus to acclimate to the presence of a competitor (B. cellulosilyticus) as opposed to the persistent competition between B. vulgatus and B. cellulosilyticus for the same resource. A healthy human gut microbiota has great strain-level diversity. Determining which strains representing a given species to select as a lead candidate probiotic agent, or for incorporation into synbiotic (prebiotic plus probiotic) formulations, is a central challenge for those seeking to develop next generation microbiota-directed therapeutics. Identifying organisms with metabolic flexibility, as opposed to those that are more prone to competing with other community members, could contribute to understanding how certain strains are capable of coexisting with the residents of diverse human gut communities.

Particles present in foods prior to consumption, or generated by physical and biochemical/enzymatic processing of foods during their transit through the gut, provide community members with opportunities to attach to their surfaces, and harvest surface-exposed nutrient resources. The ability of organisms to adhere to such particles, the carrying capacity of particles (size relative to nutrient content), and the physical partitioning their component nutrients can be envisioned as affecting competition, conflict avoidance, and cooperation. The ability of a given gut microbial community to degrade different fiber components was quantified in our studies using artificial food particles composed of fluorescently labeled, paramagnetic microscopic beads coated with different polysaccharides. This approach provides an additional dimension for characterizing the functional properties of a microbial community, and has a number of advantages. First, the measurement of polysaccharides coupled to magnetic beads is not confounded by the presence in the gut of structurally similar (or even identical) dietary or microbial polysaccharides. Second, this technology, when applied to gnotobiotic mice, permits simultaneous testing of multiple glycans in the same animal, allowing a direct comparison of the degradative capabilities of different assemblages of human gut microbes in vivo. For example, we were able to demonstrate non-redundant arabinoxylan degradation carried out by B. cellulosilyticus in this community, despite the presence of another arabinoxylan degrader, B. ovatus. Third, applied directly to humans, these diagnostic biosensors' could be used to quantify functional differences between their gut microbiota, and physical associations between carbohydrates and strains of interest, as a function of host health status, nutritional status/interventions, or other perturbations. As such, results obtained with these biosensors could facilitate ongoing efforts to use machine learning algorithms that integrate a variety of parameters, including biomarkers of host physiologic state and features of the microbiota, to develop more personalized nutritional recommendations (Zeevi et al., 2015). Lastly, this technology could be used to advance food science. The bead coating strategy employed was successful with over 30 commercially available polysaccharide preparations and the assay has been extended to measure the degradation of other biomolecules, including proteins. Particles carrying components of food that have been subjected to different processing methods, or particles bearing combinations of nutrients designed to attract different sets of primary (and secondary) microbial consumers could also be employed in preclinical models to develop and test food prototypes optimized for processing by the microbiota representative of different targeted human consumer populations.

### Example 10—Methods for Examples 4-8

Gnotobiotic mice—All experiments involving mice were carried out in accordance with protocols approved by the Animal Studies Committee of Washington University in St. Louis. For screening different fiber preparations, germ-free male C57BL/6J mice (10-16 weeks-old) were singly housed in cages located within flexible plastic isolators. Cages contained paper houses for environmental enrichment. Animals were maintained on a strict light cycle (lights on at 0600 h, off at 1900 h). Mice were fed a LoSF-HiFV diet for five days prior to colonization. After colonization, the community was allowed to stabilize on the LoSF-HiFV diet for an additional five days. One group of control mice remained on this diet for the rest of the experiment and a second control group was switched to the HiSF-LoFV diet for the rest of the experiment.

Mice in the experimental group first received an introductory diet containing equal parts of all fiber preparations employed in a given screen (totaling 10% of the diet by weight), and then received a series of diets containing different fiber preparations as described in FIG. 1A. A 10 g aliquot of a given diet/fiber mixture was hydrated with 5 mL sterile water in a gnotobiotic isolator; the resulting paste was pressed into a feeding dish and placed on the cage floor. Food levels were monitored nightly, and a freshly hydrated aliquot of that diet was supplied every two days (preventing levels from dropping below roughly one third of the original volume). Bedding (Aspen Woodchips; Northeastern Products) was replaced after each 7-day diet period to prevent any spilled food from being consumed during the next diet exposure. Fresh fecal samples were collected from each animal within seconds of being produced on days 1, 3, 6, and 7 of every diet period, and placed in liquid nitrogen within 45 min. Pre-colonization fecal samples were collected to verify the germ-free status of mice.

For monotonous feeding experiments, mice were fed the control HiSF-LoFV diet in its pelleted form for two weeks prior to colonization. Two days after colonization, mice were switched to paste diets containing 10% of the powdered fiber preparation mixed into the base diet (or the base diet in paste form without added fiber) for the remainder of the experiment. As noted above, these diets were delivered in freshly hydrated aliquots every two days. Fecal samples, including those obtained prior to colonization, were collected on the days indicated in FIG. 11.

Defined microbial communities—The screening experiments used cultured, sequenced bacterial strains obtained from a fecal sample that had been collected from a lean co-twin in an obesity-discordant twin-pair [Twin Pair 1 in (Ridaura et al., 2013); also known as F60T2 in (Faith et al., 2013)]. Isolates were grown to stationary phase in TYGS medium (Goodman et al., 2009) in an anaerobic chamber (atmosphere; 75% N2, 20% CO2, 5% H2). Equivalent numbers of organisms were pooled (based on OD600 measurements). The pool was divided into aliquots that were frozen in TYGS/15% glycerol, and maintained at −80° C. until use. On experimental day 0, aliquots were thawed, the outer surface of their tubes were sterilized with Clidox (Pharmacal) and the tubes were introduced into gnotobiotic isolators. The bacterial consortium was administered through a plastic tipped oral gavage needle (total volume, 400 μL per mouse). Based on inconsistent colonization observed in screening experiment 1, one isolate (Enterococcus fecalis; average relative abundance, 2.1%) was not included in screening experiments 2 and 3.

Model communities containing INSeq libraries—Ten strains selected from the human donor-derived community described above were colony purified, and each frozen in 15% glycerol and TYGS medium. Recoverable CFUs/mL were quantified by plating on brain-heart-infusion (BHI) blood agar. The identity of strains was verified by sequencing full-length 16S rRNA amplicons. On the day of gavage, stocks of these strains were thawed in an anaerobic chamber and mixed together along with each of five multi-taxon INSeq libraries (B. thetaiotaomicron VPI-5482, B. thetaiotaomicron 7330, B. cellulosilyticus WH2, B. vulgatus ATCC-8482, B. ovatus ATCC-8483) whose generation and characterization have been described in earlier publications (Hibberd et al., 2017; Wu et al., 2015). An aliquot of this mixture was administered by oral gavage to germ-free mice housed in gnotobiotic isolators (2×10⁶ CFUs of each donor organism plus an OD600 0.5 of each INSeq library per mouse recipient; total gavage volume, 400 μL). For B. cellulosilyticus, B. vulgatus, B. ovatus, or B. cellulosilyticus and B. ovatus omission experiments, gavage mixtures were prepared in parallel without these organisms. The absence of one or both of these strains was verified by COPRO-Seq analysis of both the gavage mixture and fecal samples collected throughout the experiment from recipient mice.

Fiber-rich food ingredient mixtures—HiSF-LoFV and LoSF-HiFV diets were produced using human foods, selected based on consumption patterns from the National Health and Nutrition Examination Survey (NHANES) database (Ridaura et al., 2013). Diets were milled to powder (D90 particle size, 980 □m), and mixed with pairs of powdered fiber preparations [one preparation at 8% (w/w) and the other preparation at 2% (w/w)]. Fiber content was defined for each preparation [Association of Official Agricultural Chemists (AOAC) 2009.01], as was protein, fat, total carbohydrate, ash, and water content [protein AOAC 920.123; fat AOAC 933.05; ash AOAC 935.42; moisture AOAC 926.08; total carbohydrate (100−(Protein+Fat+Ash+Moisture)]. The powdered mixtures were sealed in containers and sterilized by gamma irradiation (20-50 kilogreys, Steris, Mentor, OH). Sterility was confirmed by culturing the diet under aerobic and anaerobic conditions (atmosphere, 75% N2, 20% CO2, 5% H₂) at 37° C. in TYG medium, and by feeding the diets to germ-free mice followed by COPRO-Seq analysis of their fecal DNA.

Monosaccharide and linkage analysis of fiber preparations—Uronic acid (as GalA) was measured using the m-hydroxybiphenyl method (Thibault, 1979). Sodium tetraborate was used to distinguish GlcA and GalA (Filisetti-Cozzi and Carpita, 1991). The degree of methylation of galacturonic acid (pectins) in the sample was estimated as previously described (Levigne et al., 2002). Samples were hydrolyzed with 1M H₂SO₄ for 2 h at 100° C. and individual neutral sugars were analyzed as their alditol acetate derivatives (Englyst and Cummings, 1988) by gas chromatography. To fully release glucose from cellulose, a pre-hydrolysis step was carried out by incubation in 72% H₂SO₄ for 30 minutes at 25° C. prior to the hydrolysis step. Linkage analysis was performed after carboxyl reduction of uronic acid with NaBD4/NaBH4 according to a previously published procedure (Pettolino et al., 2012) with minor modifications (this procedure allows galactose, galacturonic acid and methylesterified galacturonic acid to be distinguished). Methylation of carboxyl-reduced samples was performed as described in (Buffetto et al., 2015).

Polysaccharides from the HiSF-LoFV diet were isolated by sequential alkaline extractions (Pattathil et. al., 2012). Briefly, lipids were removed from a sample of powdered HiSF-LoFV by sequential incubation in 80% ethanol, 100% ethanol, and acetone. The dried precipitate was suspended in 1M KOH containing 0.5% (w/w) NaBH4 and stirred overnight. The solution was neutralized and the supernatant was collected by centrifugation (this material is referred to as fraction 1 (F1)). The insoluble material was suspended in 1M KOH/0.5% (w/w) NaBH4 overnight, and the supernatant was collected (referred to as F2). The insoluble material was suspended in 4M KOH/0.5% (w/w) NaBH4 overnight and the supernatant was collected (referred to as F3). Each fraction was dialyzed (SnakeSkin 3.5K MWCO, Thermo Scientific) in water, lyophilized, and then treated for 4 hours at 37° C. with amyloglucosidase (36 units/mg) and alpha-amylase (100 units/mg; both enzymes from Megazyme). Enzymes were inactivated by boiling and samples were dialyzed and lyophilized. Measurement of the dry mass of each fraction before and digestion revealed that the total starch content of the base HiSF-LoFV diet was 22% (w/w) (note a comparable analysis the pea fiber yielded a value of 3.6%, meaning that HiSF-LoFV diet supplemented with 10% pea fiber contains a total starch content of 20% by weight).

HiSF-LoFV diet polysaccharides were analyzed by the Center for Complex Carbohydrate Research at the University of Georgia in Athens. Glycosyl composition analysis was performed by combined GC-MS of the per-O-trimethylsilyl (TMS) derivatives of the monosaccharide methyl glycosides produced from the sample by acidic methanolysis (Santander et al., 2013). Briefly, samples (300-500 μg) were heated with methanolic HCl in a sealed screw-top glass test tube for 17 h at 80° C. After cooling and removal of the solvent under a stream of nitrogen, samples were derivatized with Tri-Sil® (Pierce) at 80° C. for 30 min. GC-MS analysis of the TMS methyl glycosides was performed on an Agilent 7890A GC interfaced to a 5975C mass selective detector (MSD), using a Supelco Equity-1 fused silica capillary column (30 m×0.25 mm ID).

Glycosyl linkage analysis of HiSF-LoFV diet polysaccharides was performed as previously described with slight modification (Heiss et. al., 2009). Samples were permethylated, depolymerized, reduced and acetylated, and the resulting partially methylated alditol acetates (PMAAs) were analyzed by GC-MS. About 1 mg of the sample was used for linkage analysis. The sample was suspended in 200 μL of dimethyl sulfoxide and left to stir for 1 day. Permethylation of the sample was affected by two rounds of treatment with sodium hydroxide (15 minutes) and methyl iodide (45 minutes). The permethylated material was hydrolyzed using 2 M TFA (2 hours in sealed tube at 121° C.), reduced with NaBD4, and acetylated using acetic anhydride/TFA. The resulting PMAAs were analyzed on an Agilent 7890A GC interfaced to a 5975C MSD (electron impact ionization mode); separation was performed on a 30 m Supelco SP-2331 bonded phase fused silica capillary column.

V4-16S rRNA gene sequencing—DNA was isolated from fecal samples by first bead-beating the sample with 0.15 mm-diameter zirconium oxide beads and a 5 mm-diameter steel ball in 2× buffer A (200 mM NaCl, 200 mM Tris, 20 mM EDTA), followed by extraction in phenol:chloroform:isoamyl alcohol, and further purification (QiaQuick 96 purification kit; Qiagen, Valencia, Calif.). PCR amplification of the V4 region of bacterial 16S rRNA genes was performed as described (Bokulich et al., 2013). Amplicons with sample-specific barcodes were pooled for multiplex sequencing using an Illumina MiSeq instrument. Reads were demultiplexed and rarefied to 5000 reads per sample. Reads sharing 99% nucleotide sequence identity [99% ID operational taxonomic units (OTUs)], that mapped to a reference OTU in the GreenGenes 16S rRNA gene database (McDonald et al., 2012) were assigned to that OTU. The 16S rRNA gene could not be amplified in multiple fecal DNA samples from mice fed 8% cocoa fiber. A small subset of reads (<5%) representing additional V4-16S rDNA amplicon sequences produced from colony-purified stocks of Bacteroides ovatus, Parabacteroides distasonis, Dorea longicatena, and Collinsella aerofaciens were omitted from our analyses of fecal DNA samples. Streptococcus thermophilus, an organism heavily used in cheese processing, was also omitted based on its detection in DNA isolated from samples of the sterile HiSF-LoFV diet.

COPRO-Seq analyses of bacterial species abundances—Libraries were prepared from fecal DNA using sonication and addition of paired-end barcoded adaptors (McNulty et al., 2013) or by tagmentation using the Nextera DNA Library Prep Kit (Illumina) and combinations of custom barcoded primers (Adey et al., 2010). Libraries were sequenced using an Illumina NextSeq instrument [1,011,017±314,473 reads/sample (mean±SD) across experiments]. Reads were mapped to bacterial genomes with previously published custom Perl scripts (see below) adapted to use Bowtie II for genome alignments (Hibberd et al., 2017); samples represented by less than 150,000 uniquely mapped reads were omitted from the analysis.

Community-wide quantitative proteomics—Lysates were prepared from fecal samples by bead beating in SDS buffer (4% SDS, 100 mM Tris-HCl, 10 mM dithiothreitol, pH 8.0) using 0.15 mm diameter zirconium oxide beads, followed by centrifugation at 21,000×g for 10 minutes. Pre-cleared protein lysates were further denatured by incubation at 85° C. for 10 minutes, and adjusted to 30 mM iodoacetamide to alkylate reduced cysteines. After incubation in the dark for 20 minutes at room temperature, protein was isolated by chloroform-methanol extraction. Protein pellets were then washed with methanol, air dried, and re-solubilized in 4% sodium deoxycholate (SDC) in 100 mM ammonium bicarbonate (ABC) buffer, pH 8.0. Protein concentrations were measured using the BCA (bicinchoninic acid) assay (Pierce). Protein samples (250 □g) were then transferred to a 10 kDa MWCO spin filter (Vivaspin 500, Sartorius), concentrated, rinsed with ABC buffer, and digested in situ with sequencing-grade trypsin (Clarkson et al., 2017). The tryptic peptide solution was then passed through the spin-filter membrane, adjusted to 1% formic acid to precipitate the remaining SDC, and the precipitate removed from the peptide solution with water-saturated ethyl acetate. Peptide samples were concentrated using a SpeedVac, measured by BCA assay and analyzed by automated 2D LC-MS/MS using a Vanquish UHPLC with autosampler plumbed directly in-line with a Q Exactive Plus mass spectrometer (Thermo Scientific) outfitted with a 100 μm ID triphasic back column [RP—SCX-RP; reversed-phase (5 μm Kinetex C18) and strong-cation exchange (5 μm Luna SCX) chromatographic resins; Phenomenex] coupled to an in-house pulled, 75 μm ID nanospray emitter packed with 30 cm Kinetex C18 resin. For each sample, 12 μg of peptides were autoloaded, desalted, separated and analyzed across four successive salt cuts of ammonium acetate (35, 50, 100 and 500 mM), each followed by a 105-minute organic gradient. Eluting peptides were measured and sequenced by data-dependent acquisition on the Q Exactive Plus (Clarkson et al., 2017).

MS/MS spectra were searched with MyriMatch v.2.2 (Tabb et al., 2007) against a proteome database derived from the genomes of the strains in the defined model community concatenated with major dietary protein sequences, common protein contaminants, and reversed entries to estimate false-discovery rates (FDR). Since the relative abundance of B. thetaiotaomicron 7330 was low on day 6 [0.05%±0.041% (mean±SD) for all groups], we chose to analyze all peptides that mapped to the B. thetaiotaomicron VPI-5482 proteome, regardless of whether they also mapped to B. thetaiotaomicron 7330. Peptide spectrum matches (PSM) were required to be fully tryptic with any number of missed cleavages, and contain a static modification of 57.0214 Da on cysteine and a dynamic modification of 15.9949 Da on methionine. PSMs were filtered using IDPicker v.3.0 (Ma et al., 2009) with an experiment-wide FDR <1% at the peptide-level. Peptide intensities were assessed by chromatographic area-under-the-curve (label-free quantification option in IDPicker). To remove cases of extreme sequence redundancy, the community meta-proteome was clustered at 100% sequence identity post-database search [UCLUST; (Edgar, 2010)] and peptide intensities were summed to their respective protein groups/seeds to estimate overall protein abundance. Proteins were included in the analysis only if they were detected in more than 3 biological replicates in at least one experimental group. Missing values were imputed to simulate the limit of detection of the mass spectrometer, using mean minus 2.2× standard deviation with a width of 0.3× standard deviation. Four additional imputed distributions produced results that were in general agreement with this approach in terms of fold-abundance change induced by fiber treatment and statistical significance.

Multi-taxon INSeq—Multi-taxon INSeq allows simultaneous analysis of multiple mutant libraries in the same recipient gnotobiotic mouse owing to the fact that the mariner Tn vector contains Mmel sites at each end plus taxon-specific barcodes. Mmel digestion cleaves genomic DNA at a site 20-21 bp distal to the restriction enzyme's recognition site so that the site of Tn insertion and the relative abundance of each Tn mutant can be defined in given diet/community contexts by sequencing the flanking genomic sequence and taxon-specific barcode (Wu et al., 2015). Purified fecal DNA was processed as described previously (Wu et al., 2015). DNA was digested with Mmel and the products were ligated to sample-specific barcoded adaptors. Sequencing was performed on an Illumina HiSeq 2500 instrument, with a custom indexing primer providing the strain-specific barcode for the insertion. Analysis of mutant strain frequencies was carried out using custom software. Log ratios of the abundances of Tn mutant strains on experimental days 6 and 2 (corresponding to the period of fiber treatment compared to just prior to fiber exposure) were calculated for each mouse.

PUL nomenclature and homology—All PUL assignments were made based on “new assembly” genomes present in the CAZy PUL database_(www.cazy.org/PULDB) (Terrapon et al., 2018). All boundaries of PULs were algorithmically defined (listed as ‘predicted PUL’ in PULDB). The algorithmically defined boundaries of B. thetaiotaomicron PUL7 were extended to include the adjacent arabinose operon based on previously published experimental datasets (Schwalm et al., 2016). A cluster of three or more adjacent CAZymes was defined as a ‘polysaccharide utilization complement’. Homology between genes in PULs was determined using a reciprocal BLASTp approach with an E-value threshold of 1×10⁻⁹, querying each protein product contained within a CAZy-annotated PUL against reference genomes from other species in the community.

Generation of glycan-coated magnetic beads—Wheat Arabinoxylan and Icelandic Moss Lichenan were purchased from Megazyme (P-WAXYL, P-LICHN) and yeast alpha-mannan was purchased from Sigma-Aldrich (M7504). Polysaccharides were solubilized in water (at a concentration of 5 mg/mL for pea fiber and 20 mg/mL for arabinoxylan and lichenan), sonicated and heated to 100° C. for 1 minute, then centrifuged at 24,000×g for 10 minutes to remove debris. TFPA-PEG3-biotin (Thermo Scientific), dissolved in DMSO (10 mg/mL) was added to the polysaccharide solution at a ratio of 1:5 (v/v). The sample was subjected to UV irradiation for 10 minutes (UV-B 306 nm, 7844 mJ total), and then diluted 1:4 to facilitate desalting on 7 kD Zeba spin columns (Thermo Scientific).

Biotinylated polysaccharide was mixed with one of several biotinylated fluorophores (PF-505, PF-510LSS, PF-633, PF-415; all at a concentration of 50 ng/mL; all obtained from Promokine). A 500 μL aliquot of this preparation was incubated with 10⁷ paramagnetic streptavidin-coated silica beads (LSKMAGT, Millipore Sigma) for 24 hours at room temperature. Beads were washed by centrifugation three times with 1 mL HNTB buffer (10 mM HEPES, 150 mM NaCl, 0.05% Tween-20, 0.1% BSA) followed by addition of 5 μg/mL streptavidin (Jackson Immunoresearch) in HNTB (30 min incubation at room temperature). Beads were washed as before and then incubated with 250 μL of the biotinylated polysaccharide preparation. The washing, streptavidin, and polysaccharide incubation steps were repeated three times. Bead preparations were assessed using an Aria III cell sorter (BD Biosciences) to confirm adequate labeling, and then analyzed by GC-MS (see below) to quantify the amount of carbohydrate bound.

Administration and recovery of beads—Beads were incubated with 70% ethanol for 1 minute in a biosafety cabinet, then washed three times with 1 mL sterile HNTB using a magnetic stand. The different bead types were combined, diluted, and aliquoted to 10⁷ beads per 650 μL HNTB insterile Eppendorf microcentrifuge tubes. The number of beads in each aliquot was counted using an Aria III cell sorter and CountBright fluorescent microspheres (BD Bioscience). Tubes containing beads were introduced into gnotobiotic isolators and the beads were administered by oral gavage (600 μL per mouse). Separate aliquots of control beads, used to establish input carbohydrate content were stored in the dark at 37° C. until collection of experimental beads from mouse fecal or cecal samples had been completed.

For germ-free mouse experiments, animals were fed the HiSF-LoFV diet for two weeks and then gavaged with beads; all fecal pellets were collected during the 4- to 12-hour interval that followed gavage. During this time period, bedding was removed and mice were placed on grated cage bottoms (with access to food and water); cage bottoms were placed just above a 0.5 cm deep layer of sterile water on the floor of the cage, to prevent pellets from drying. For colonized animals, cecal and colonic contents were collected four hours after administration of beads at the time of euthanasia. Recovered samples were immediately placed in sterile water on ice.

Fecal, cecal, and input samples were vortexed and filtered through nylon mesh (100 μm pore-diameter). The resulting suspension of luminal contents was layered over sterile Percoll Plus (GE Health Care) and centrifuged for 5 minutes at 500×g. Beads were collected from underneath the Percoll layer and washed four times using a magnetic stand, each time with 1 mL fresh HNTB. Recovered beads were counted by flow cytometry as before, filtered through nylon mesh (40 μm pore diameter, BD Biosciences) and stored at 4° C. overnight. Beads were sorted back into their polysaccharide types based on fluorescence using an Aria III sorter (average sort purity, 96%). Sorted samples were centrifuged (500×g for 5 minutes) to pellet beads and the beads were transferred to a 96-well plate. All bead samples were incubated with 1% SDS/6M Urea/HNTB for 10 minutes at room temperature to remove exogenous components, washed three times with 200 μL HNTB using a magnetic plate rack, and then stored overnight at 4° C. prior to monosaccharide analysis.

Analysis of bead-bound glycan by GC-MS—The number and purity of beads in each sorted sample was determined by taking an aliquot for analysis on the Aria III cell sorter. Equal numbers of beads from each sample were transferred to a new 96-well plate and the supernatant was removed with a magnetic plate rack. For acid hydrolysis, 200 μL of 2M trifluoroacetic acid and 250 ng/mL myo-inositol-D6 (CDN Isotopes; spike-in control) were added to each well, and the entire volume was transferred to 300 μL glass vials (ThermoFisher; catalog number C4008-632C). Another aliquot was taken to verify the final number of beads in each sample. Monosaccharide standards were included in separate wells and subjected to the hydrolysis protocol in parallel with the other samples. Vials were crimped with Teflon-lined silicone caps (ThermoFisher) and incubated at 100° C. with rocking for 2 h. Vials were then cooled, spun to pellet beads, and their caps were removed. A 180 μL aliquot of the supernatant was collected and transferred to new 300 μL glass vials. Samples were dried in a SpeedVac for 4 hours, methoximated in 20 μL O-methoxyamine (15 mg/mL pyridine) for 15 h at 37° C., followed by trimethylsilylation in 20 μL MSTFA/TMCS [N-Methyl-N-trimethylsilyltrifluoroacetamide/2,2,2-trifluoro-N-methyl-N-(trimethylsilyl)-acetamide, chlorotrimethylsilane] (ThermoFisher) for 1 h at 70° C. One half volume of heptane (20 μL) was added before loading the samples for injection onto a 7890B gas chromatography system coupled to a 5977B MS detector (Agilent). The mass of each monosaccharide detected in each sample of sorted beads was determined using monosaccharide standard curves. This mass was then divided by the final count of beads in each sample to produce a measurement of mass of recoverable monosaccharide per bead.

Quantification and Statistical Analysis—Using data from days 6 and 7 of each diet treatment, a mixed effects model was generated in the R programming environment for each species in each of three fiber screening experiments. The relative abundance of that species in feces (or the relative abundance scaled by fecal DNA yield) was used as the dependent variable, and the concentration of administered fiber (10 to 13 fibers tested per experiment), as well as experimental day were used as independent variables. Mixed effects models incorporated terms to describe repeated measures of individual mice. In rare cases where B. cellulosilyticus failed to colonize (5 of 60 mice), the animals were not considered biological replicates since they harbored a distinct microbiota; they were omitted from the models. ANOVA (with Satterthwaite approximation for degrees of freedom) was performed to evaluate the significance of individual terms in models (FDR corrected P value cutoff of 0.01). Models were evaluated based on conditional R² values (incorporating random factors) and plots of the residuals and Cook's distance (no samples were excluded based on these assessments).

For COPRO-Seq analyses, differences between groups were assessed using mixed-effect models with time as a categorical variable, including day 2 as a pre-treatment time point. For omission experiments, the abundance of each strain as a proportion of all other strains except the omitted strain or strains was used for statistical tests. Significant terms in models were identified using ANOVA (FDR corrected P value cutoff of 0.05). Mann-Whitney U test was used for analyses of individual time-points of interest.

For quantitative proteomics, significant differences in protein abundance were determined using limma (Ting et al., 2009). For multi-taxon INSeq analyses, mutant strain abundances were analyzed using limma-voom (Law et al., 2014) after quantile normalization. The general linear model framework in limma-voom allowed us to perform moderated t-tests to determine the statistical significance (P<0.05, FDR corrected) of differences in fitness in the context of the control versus fiber-supplemented diets. A Mann-Whitney U test was used to calculate significant differences in monosaccharide abundance between bead samples. All tests were two-tailed.

Data and Software Availability—Datasets of V4-16S rRNA sequences in raw format prior to post-processing and data analysis, plus COPRO-Seq and INSeq datasets have been deposited at the European Nucleotide Archive under study accession PRJEB26564. All LC-MS/MS proteomic data have been deposited into the MassIVE data repository under accession numbers MSV000082287 (MassIVE) and PXD009535 (ProteomeXchange). INSeq software: github.com/mengwu1002/Multi-taxon_analysis_pipeline. COPRO-Seq software: github.com/nmcnulty/COPRO-Seq.

### Example 11—Adhesion Assays with Polysaccharide-Coated Beads and Gut Microbes

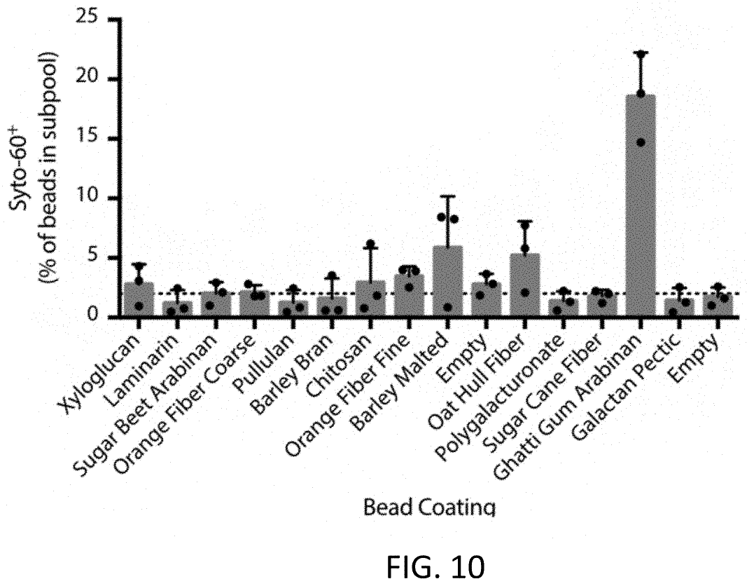

Beads were coated with one of 14 different glycans, as described in Example 1. The glycans are shown along the x-axis of FIG. 10. Mouse cecal contents were collected and all bacteria present were labeled with a fluorescent DNA stain (Syto-60). Aliquots of this bacterial mixture were incubated with beads. Beads were then assayed for fluorescence on a flow cytometer. Positive fluorescence indicates bound fluorescent bacteria. The extent of fluorescence is measured relative to control beads that are incubated with fluorescent dye, but not bacteria. Beads with no glycan coating (“Empty”) established the level of non-specific binding by bacteria.

These results demonstrated that microbes from the mouse cecum bind to particular plant polysaccharides (Arabinan from Ghatti Gum). Three technical replicates are shown with standard deviation.

This approach can be extended to fecal samples obtained from humans. It could also be extended to encompass the oral administration of beads to mice, humans, or other animals, with the addition of DNA sequencing of recovered beads to identify the particular species of microbes that bind to the beads in vivo.

### Example 12—Bioactive Glycan

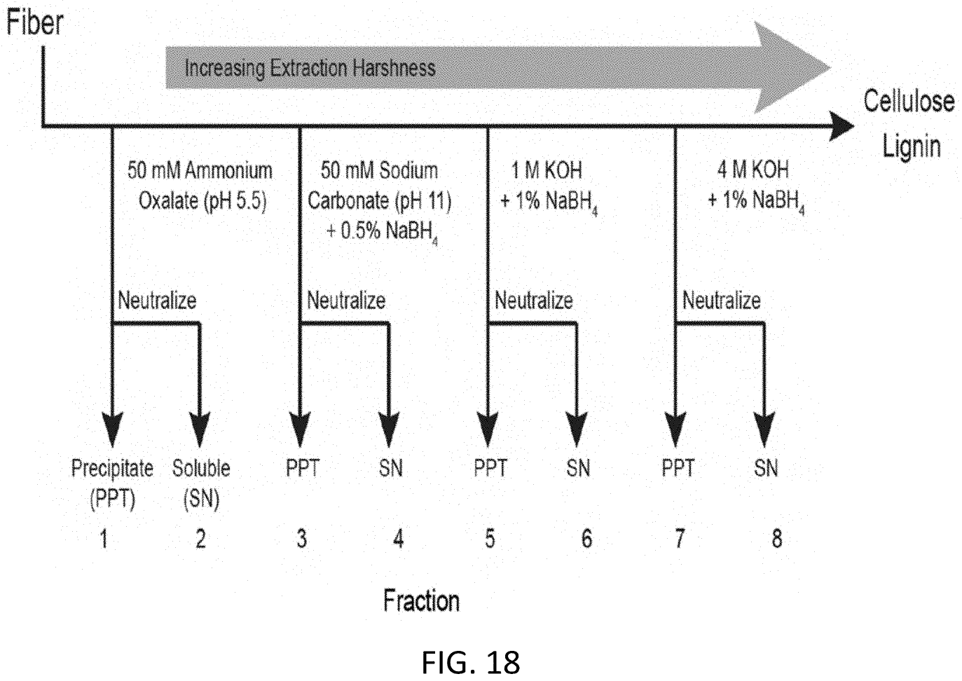

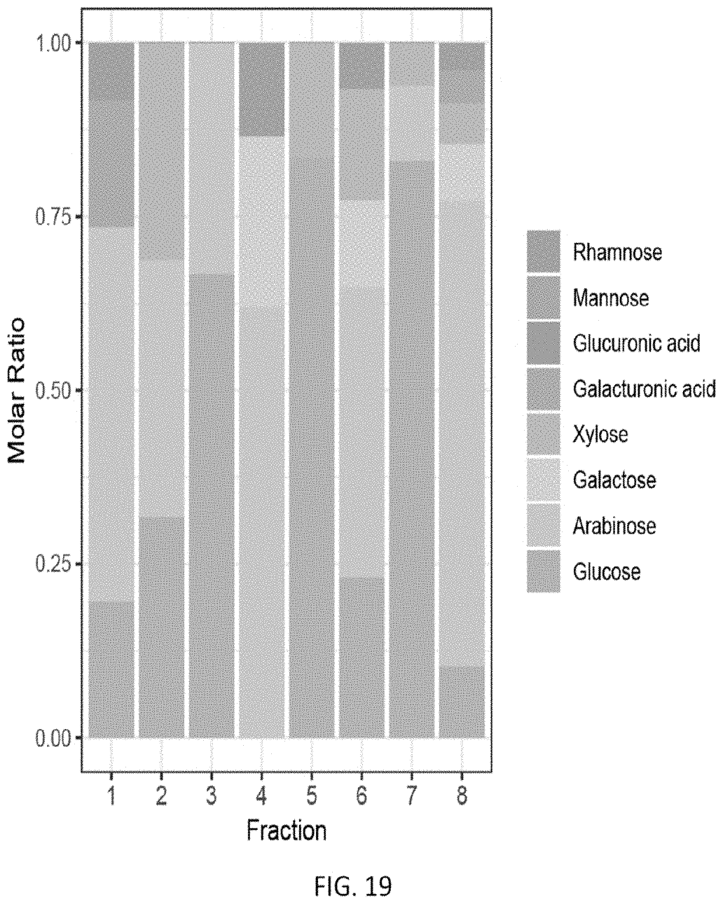

This example describes experiments to determine if there was a bioactive component of the pea fiber preparation used in Examples 2-6 that was responsible for increasing the representation of targeted Bacteroides represented in a model human gut community installed in gnotobiotic mice. The pea fiber preparation was subjected to extraction under increasingly harsh conditions with aqueous solutions to differentially solubilize constituents (Pattathil et al.) (FIG. 18). In total, 8 fractions were isolated and characterized for protein content (BCA assay), total carbohydrate content (phenol-sulfuric acid assay (Masuko et al.), and molecular size (high performance liquid chromatography-size exclusion chromatography with an evaporative light scattering detector). The monosaccharide composition of each fraction was determined (polysaccharide methanolysis followed by gas chromatography mass spectrometry (GC-MS; (Doco et al.)) (FIG. 19). Carbohydrate linkages were determined as partially methylated alditol acetates (PMAA) (Doares et al.).

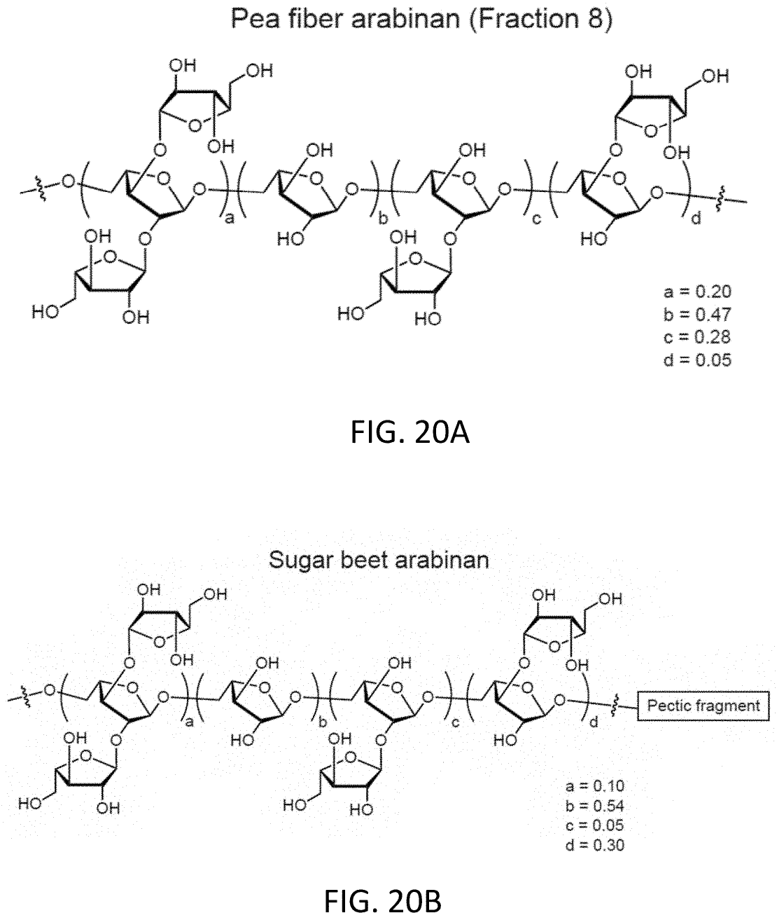

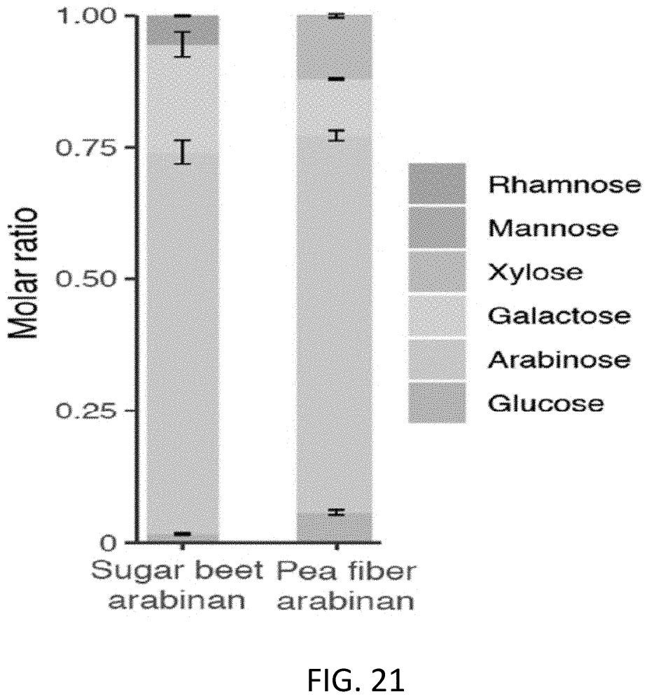

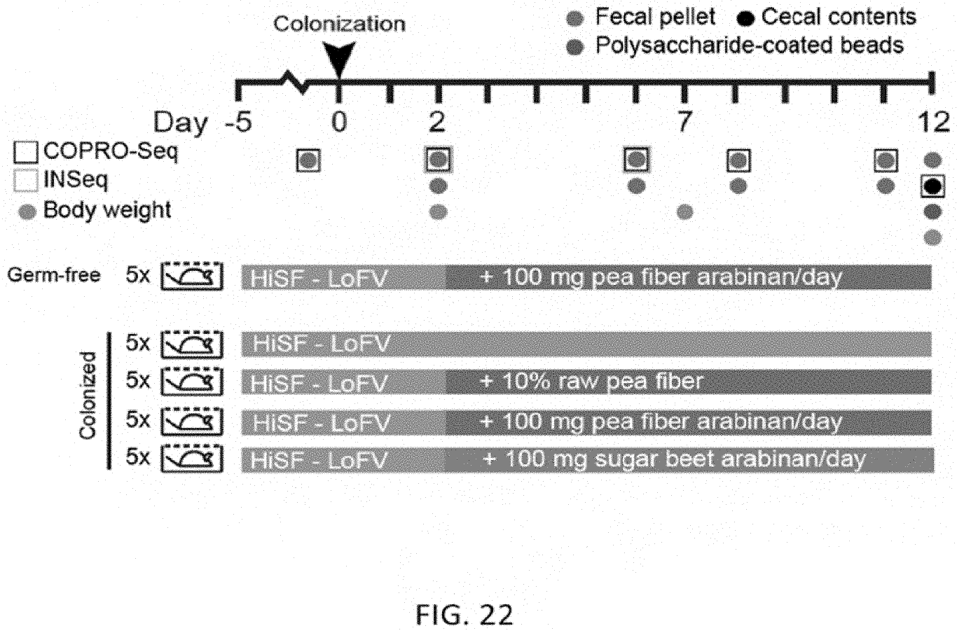

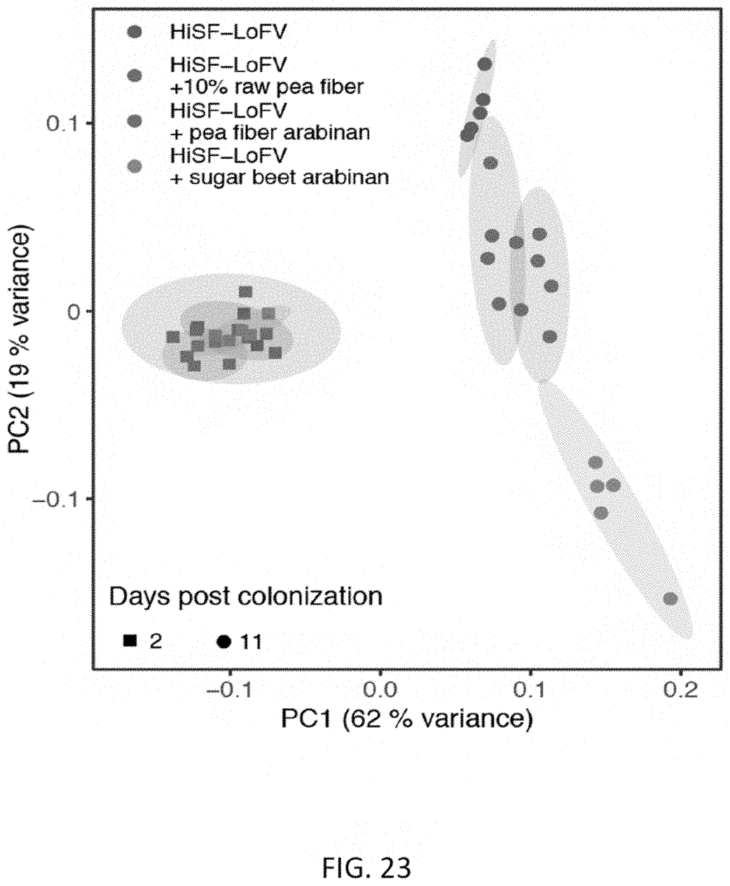

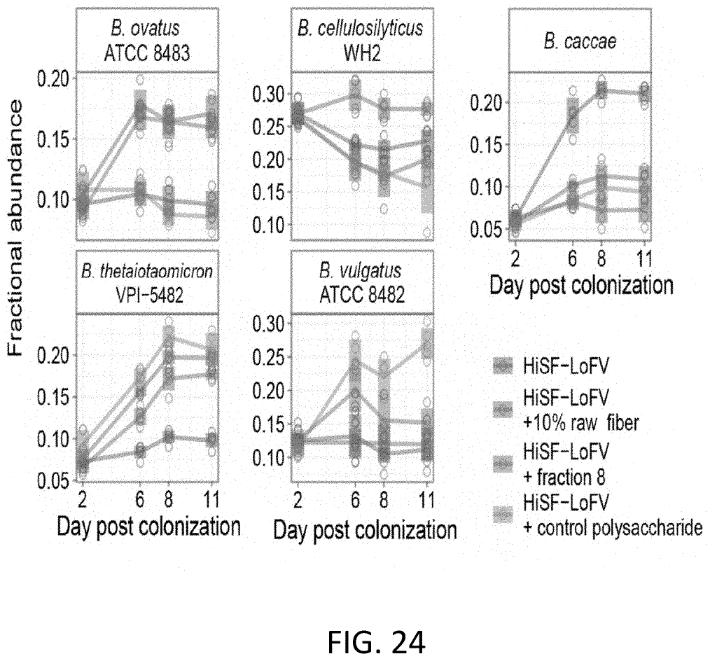

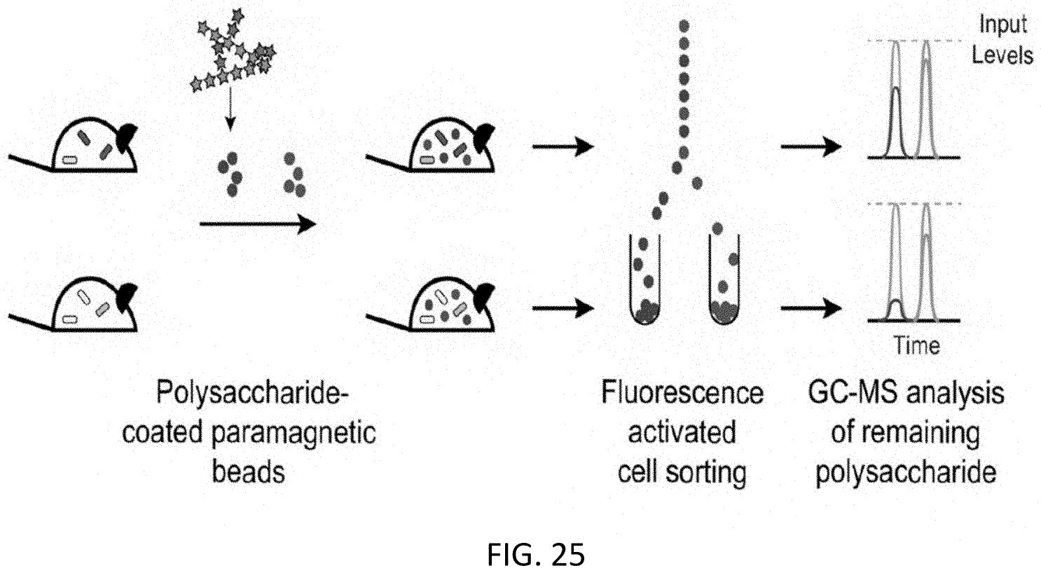

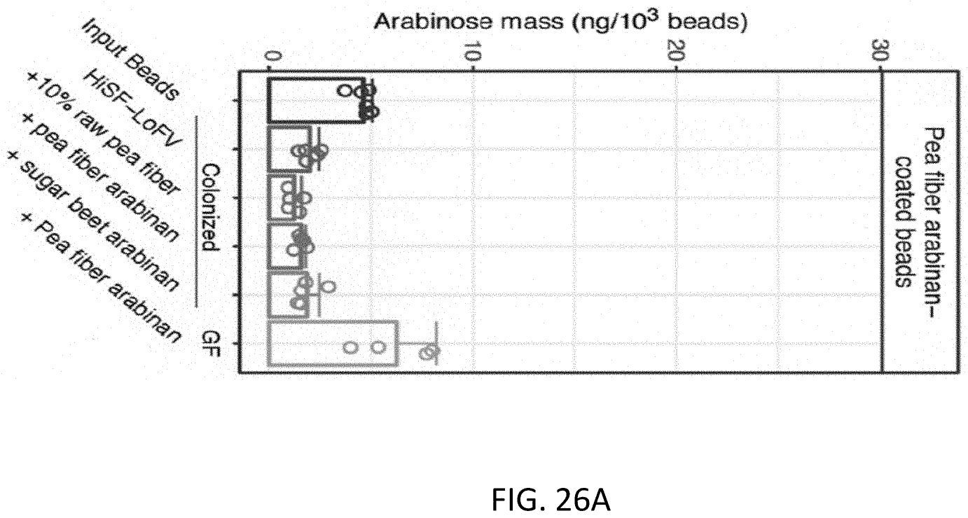

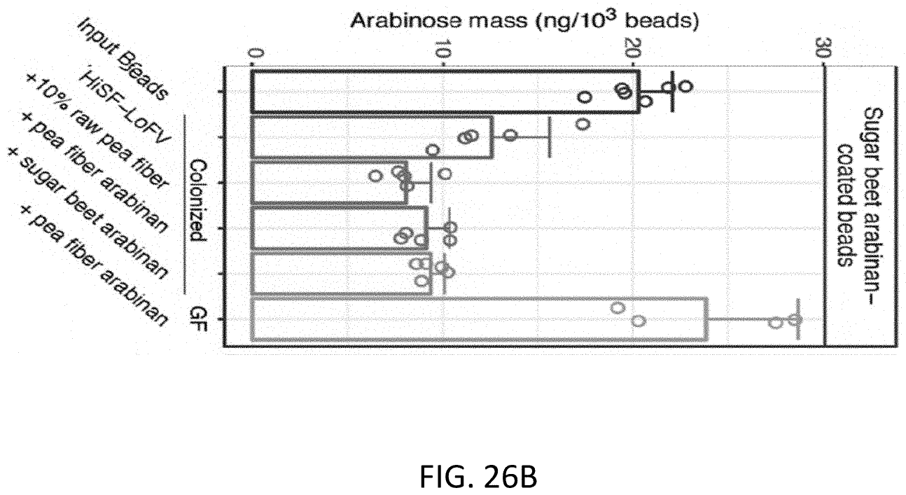

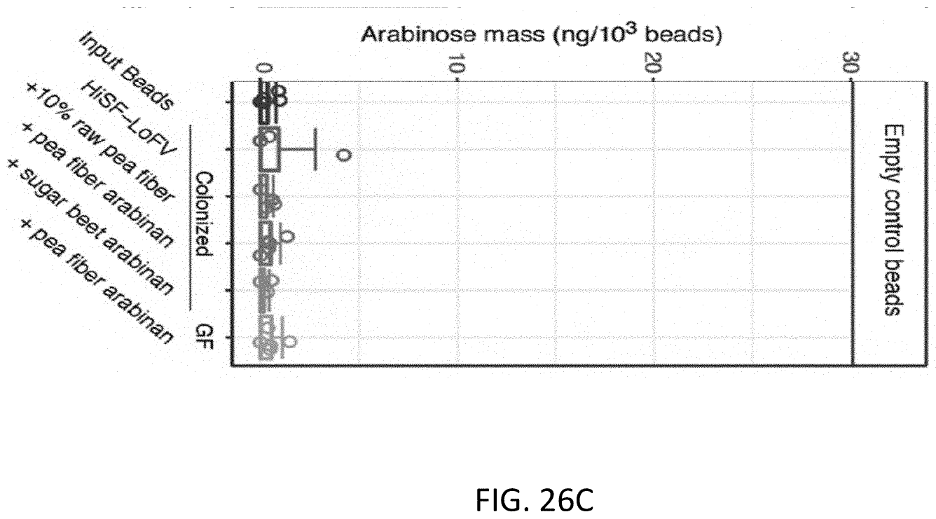

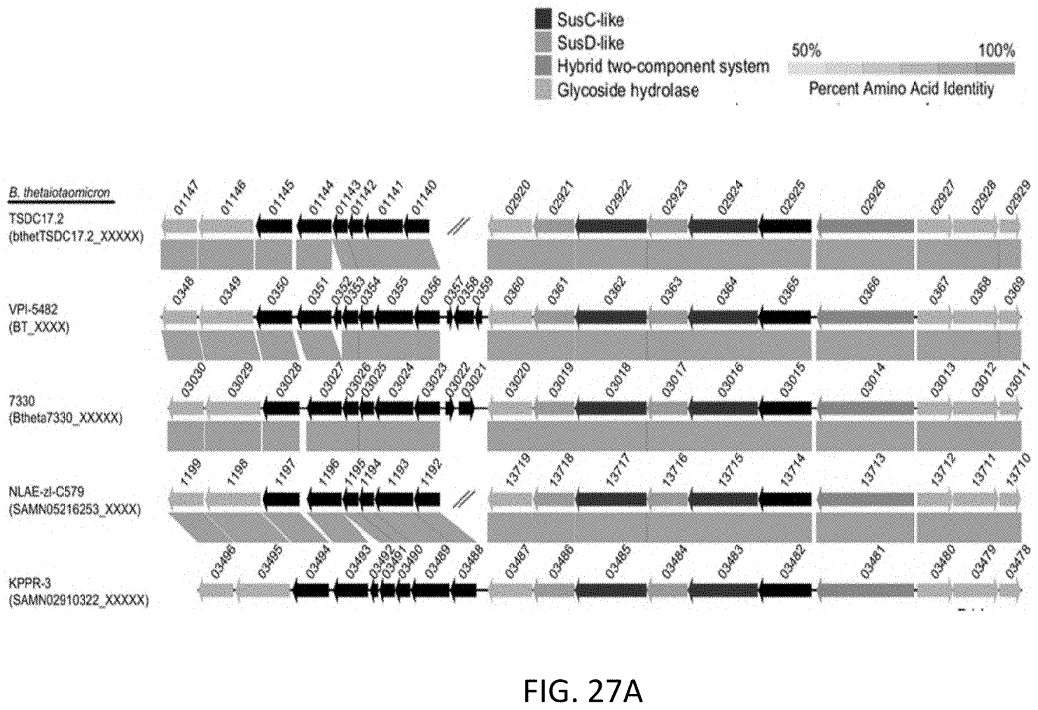

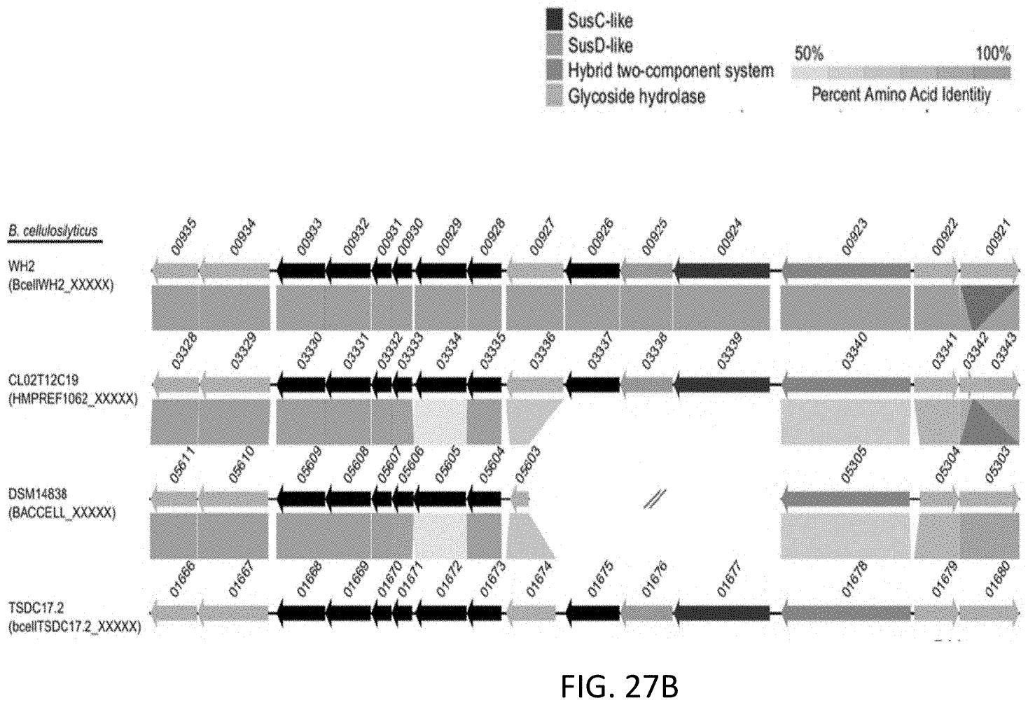

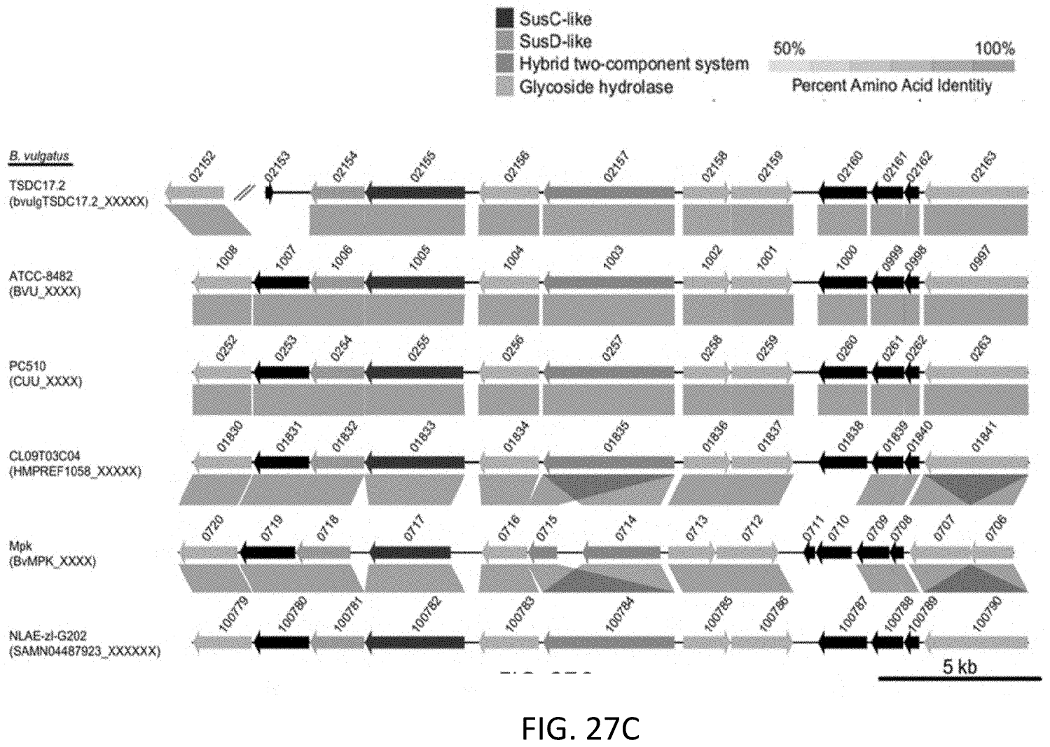

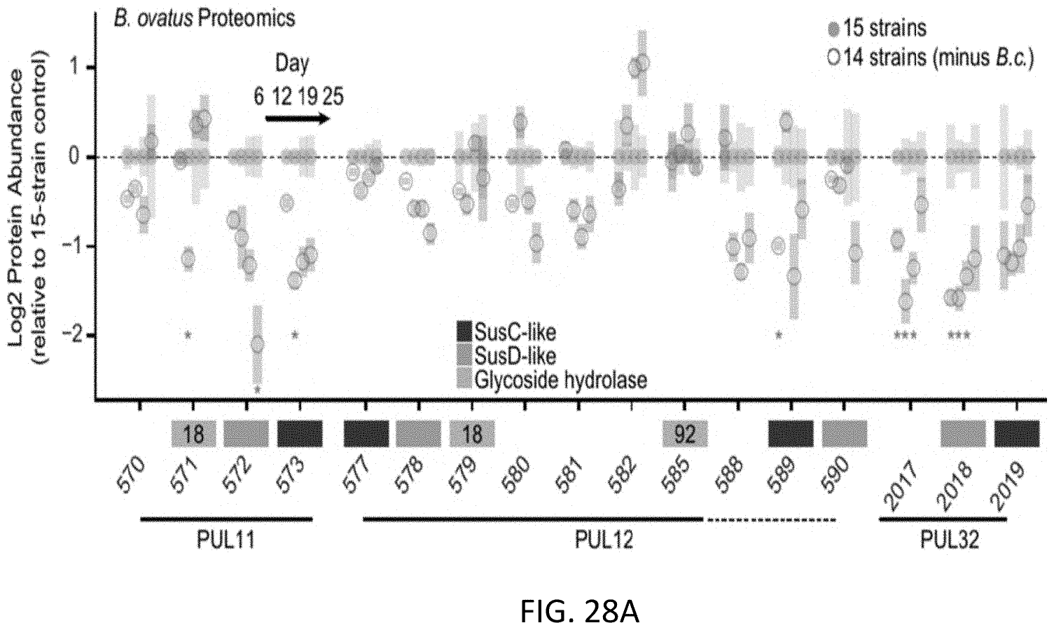

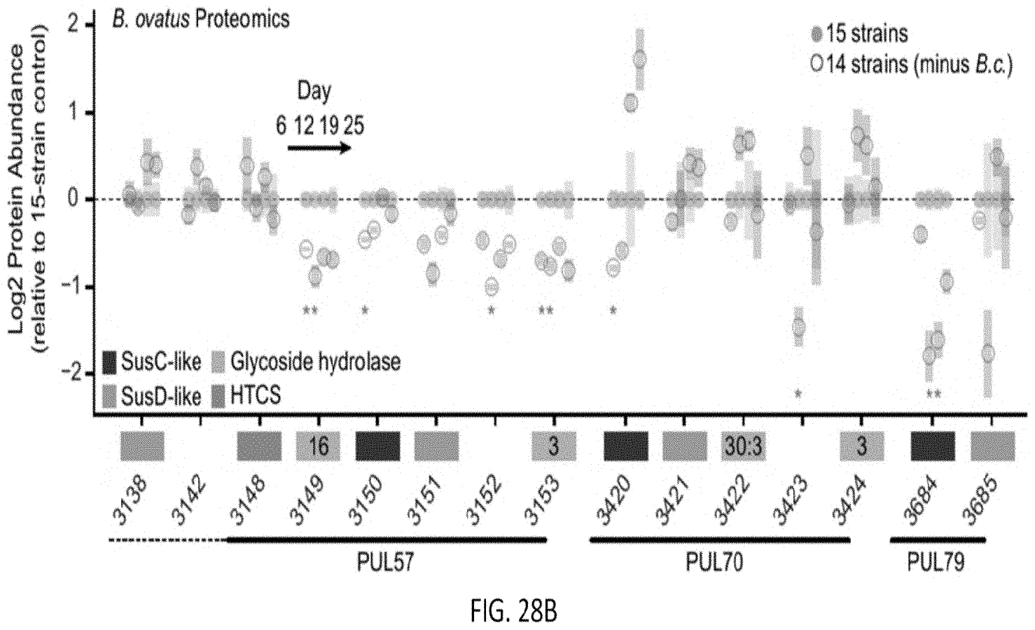

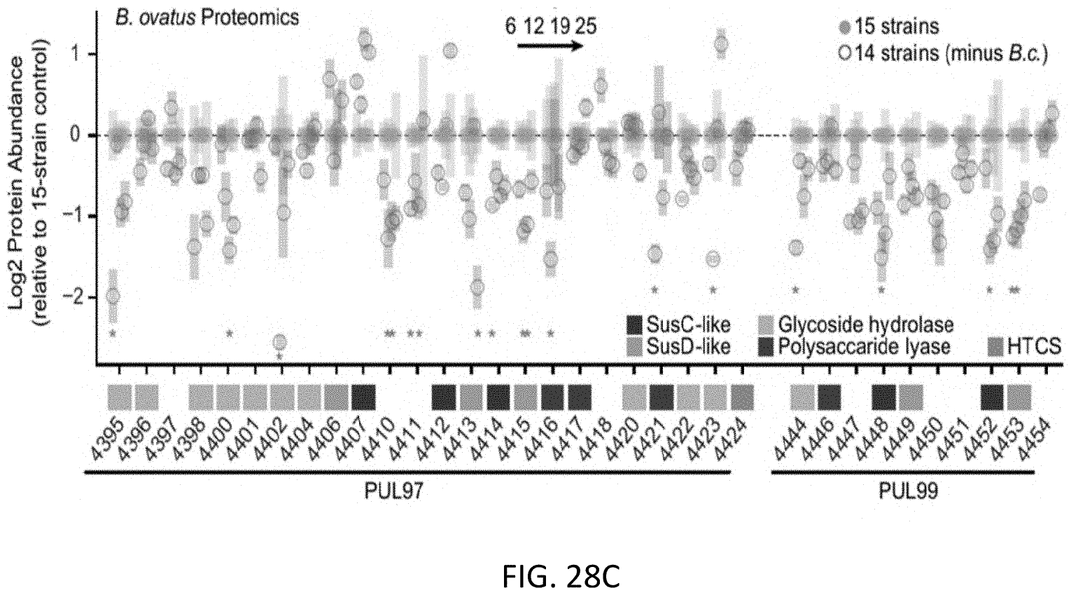

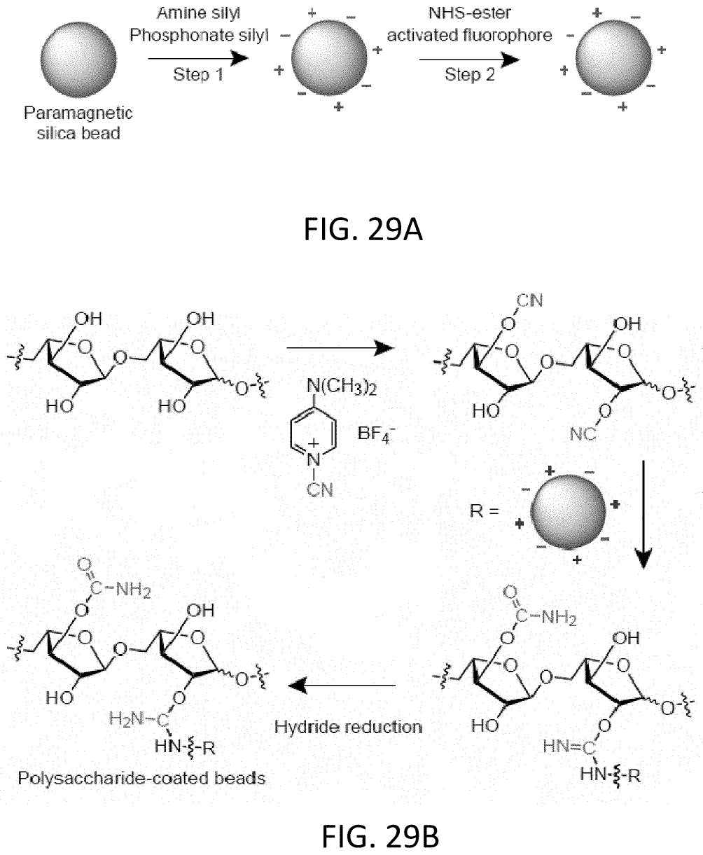

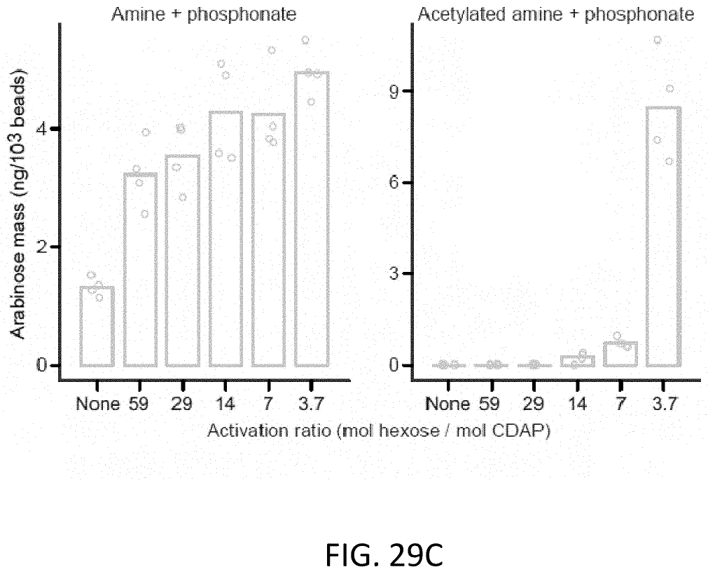

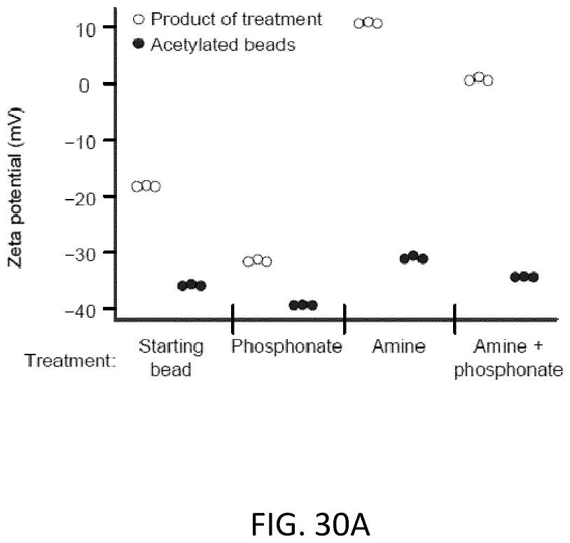

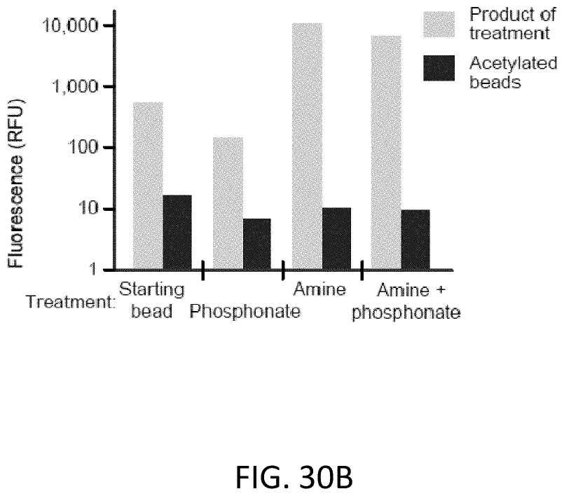

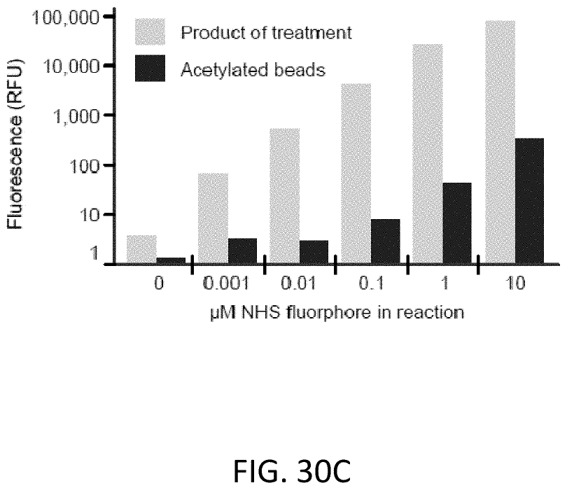

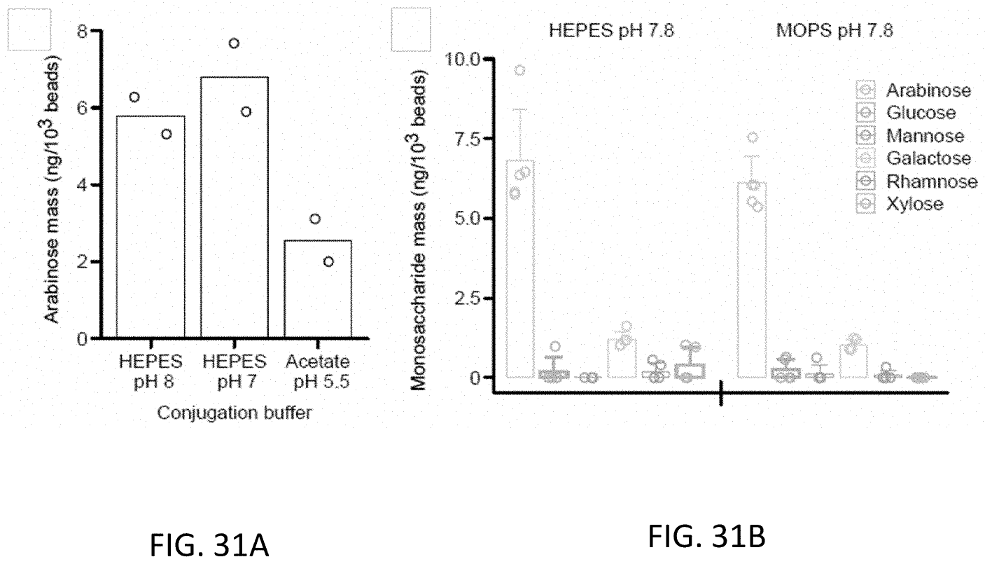

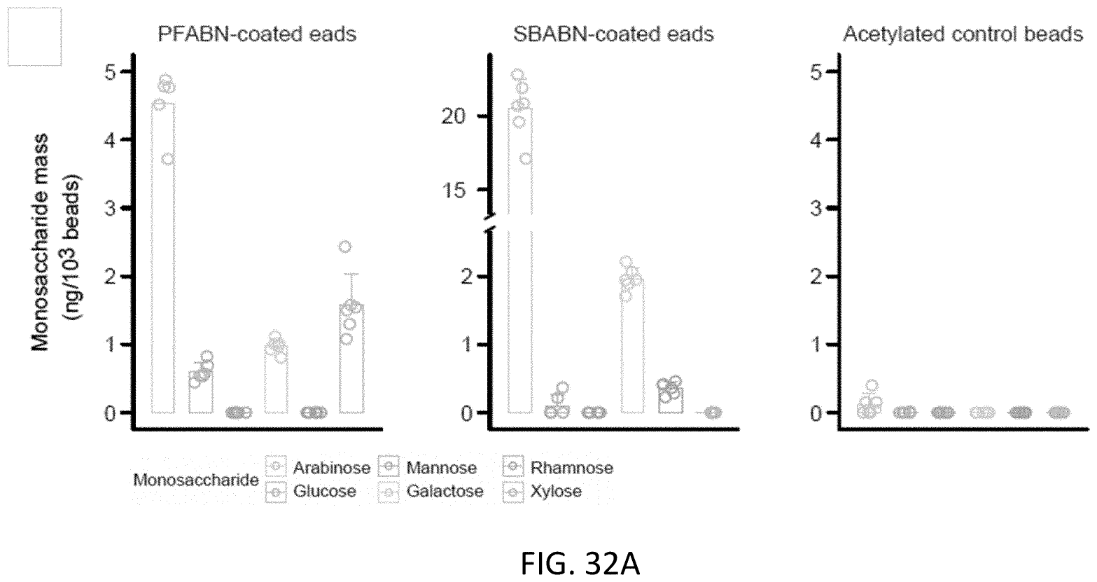

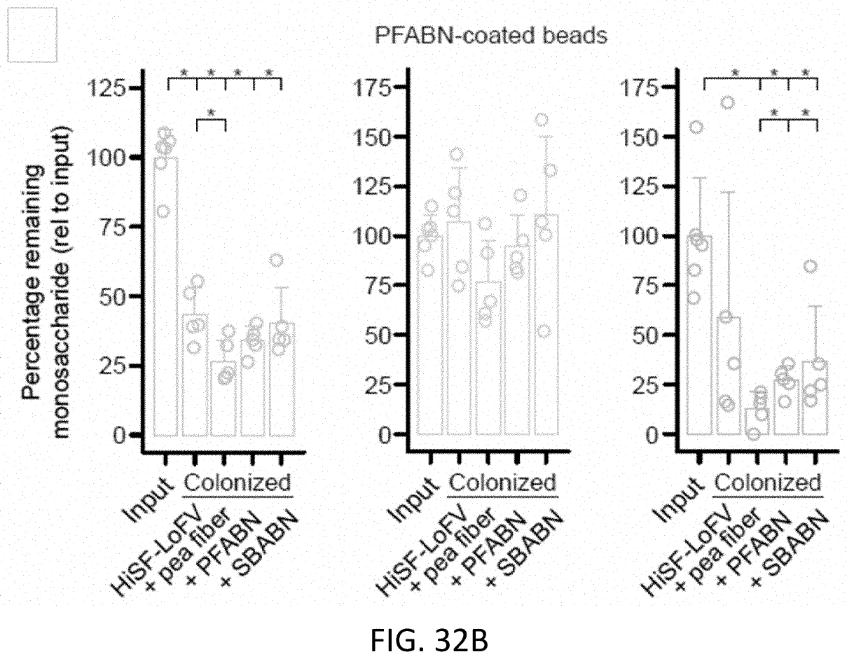

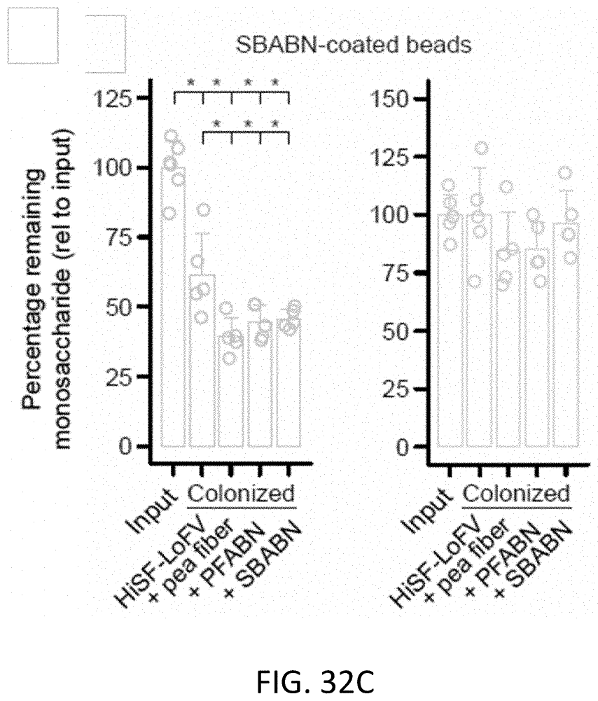

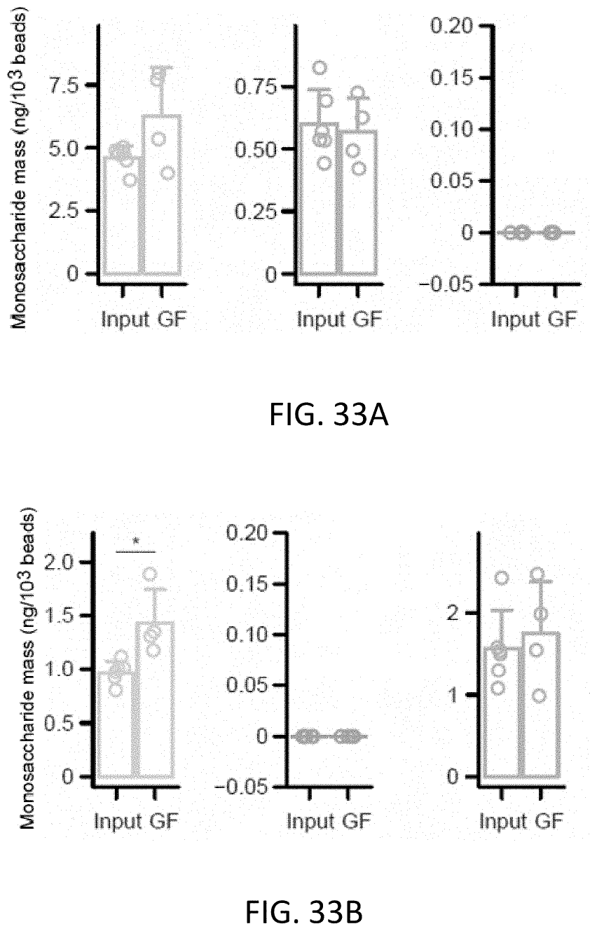

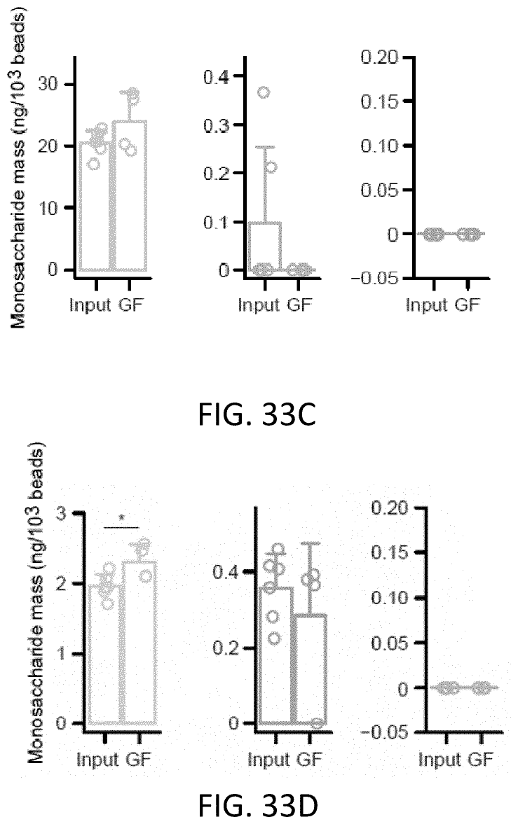

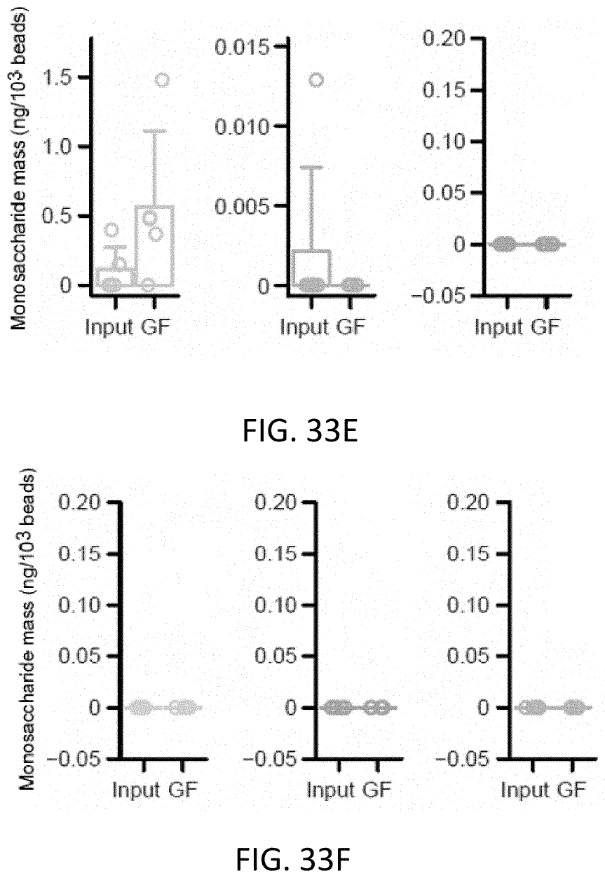

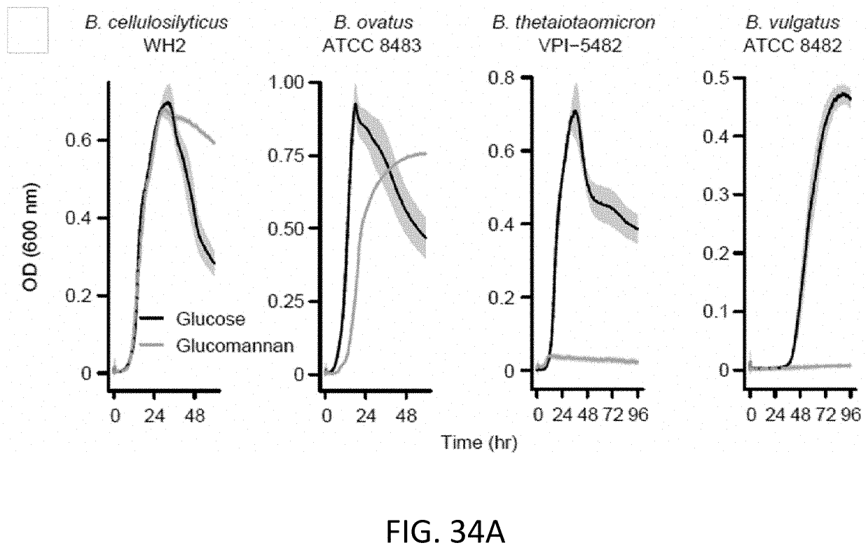

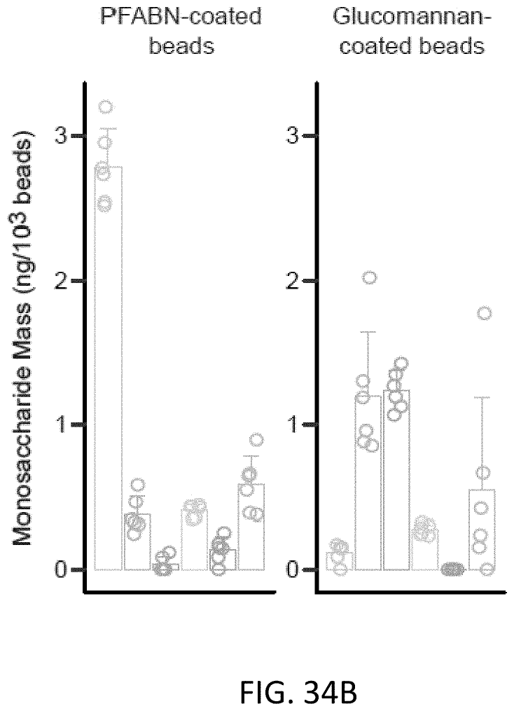

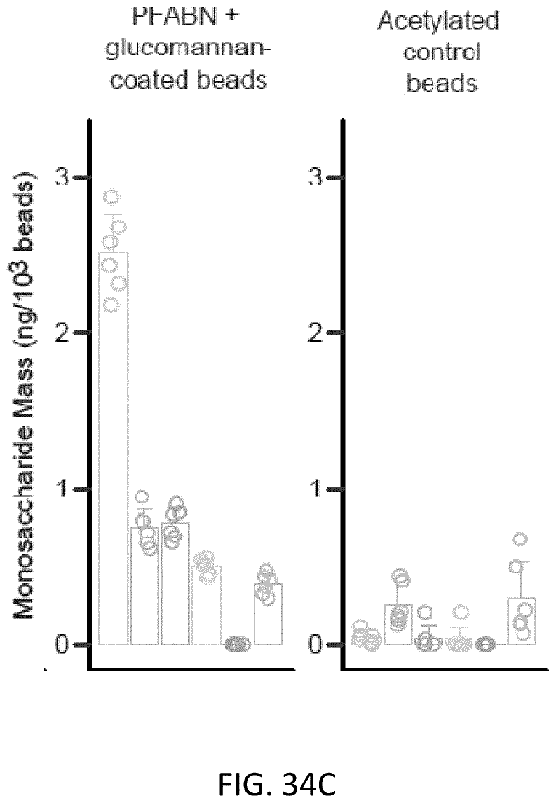

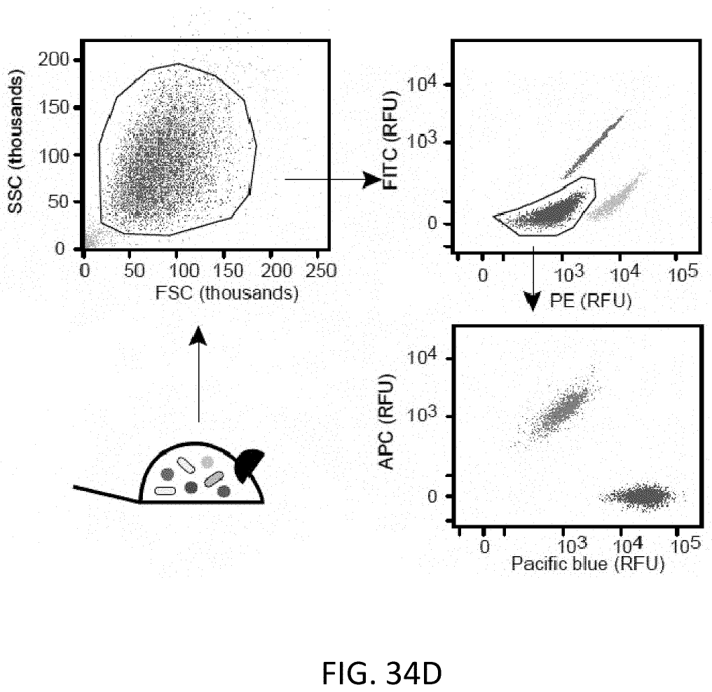

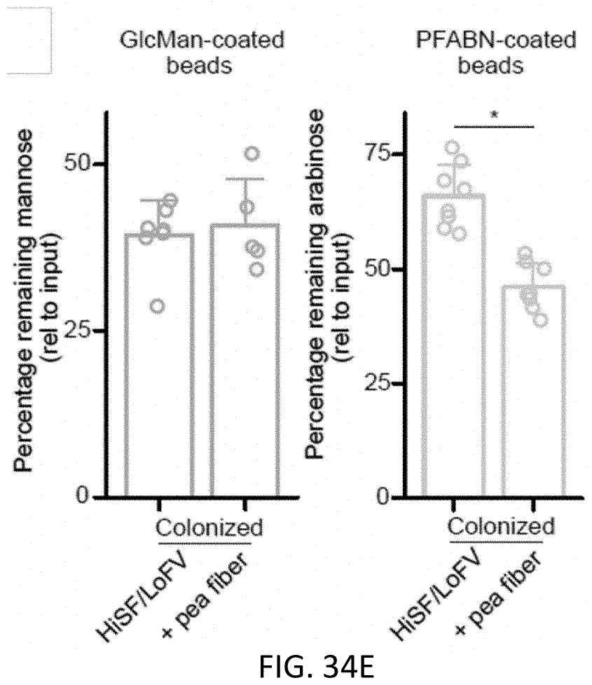

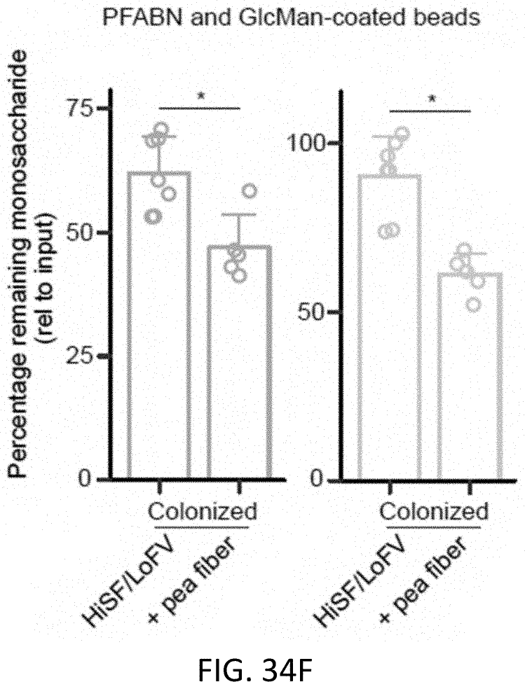

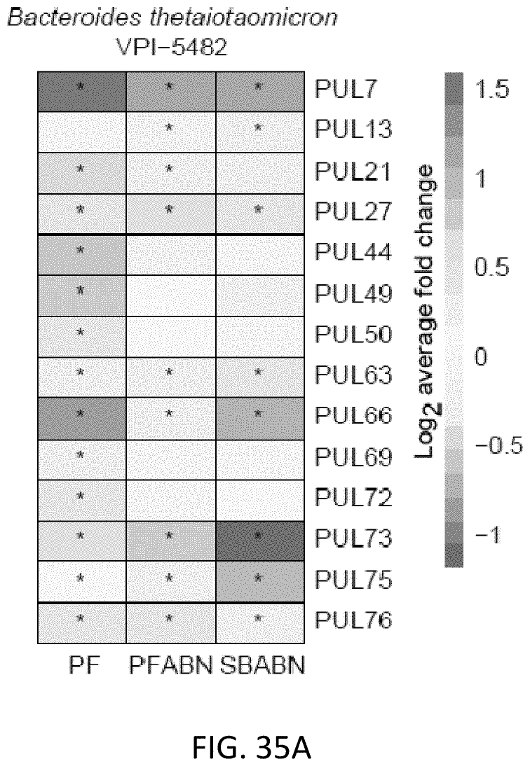

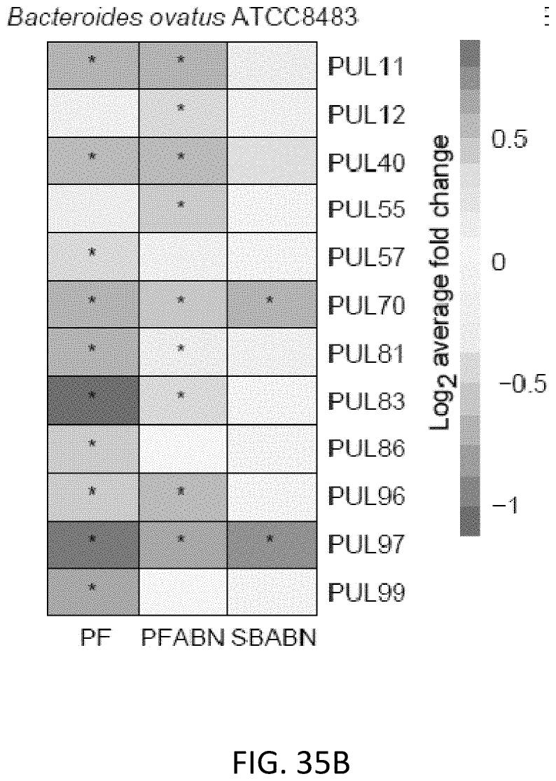

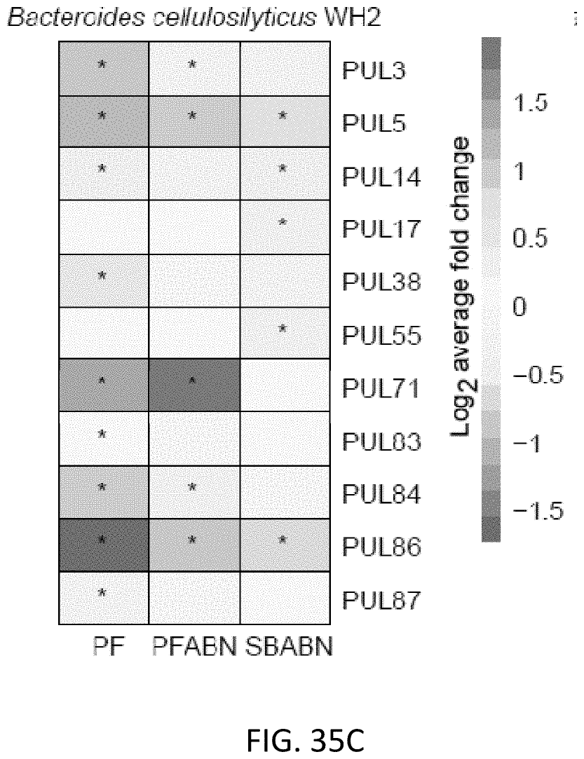

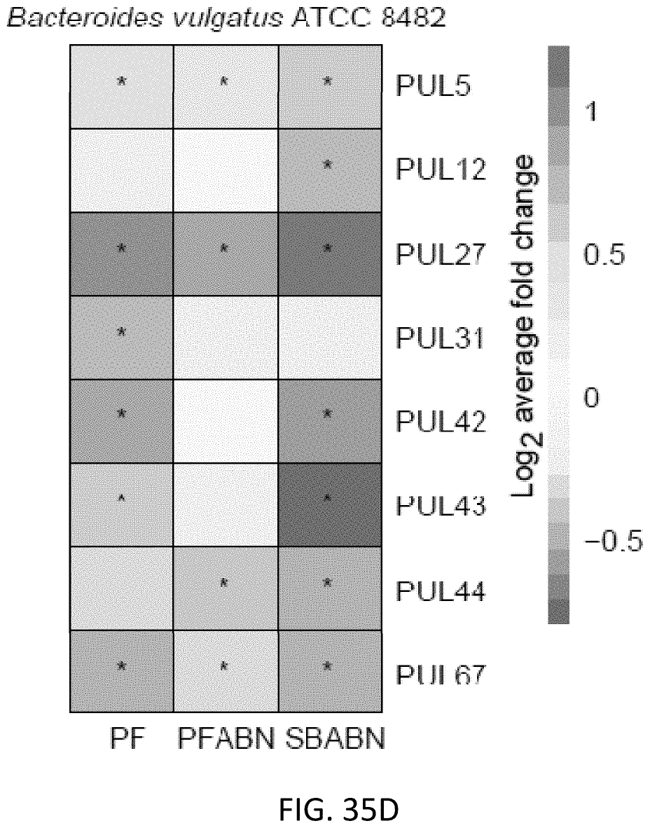

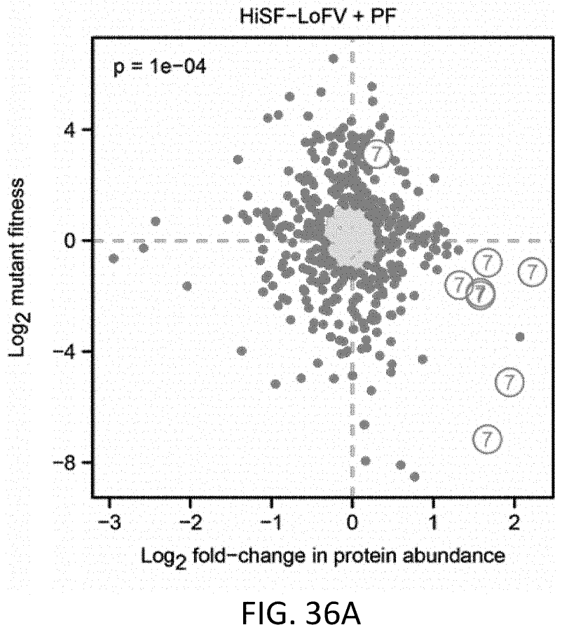

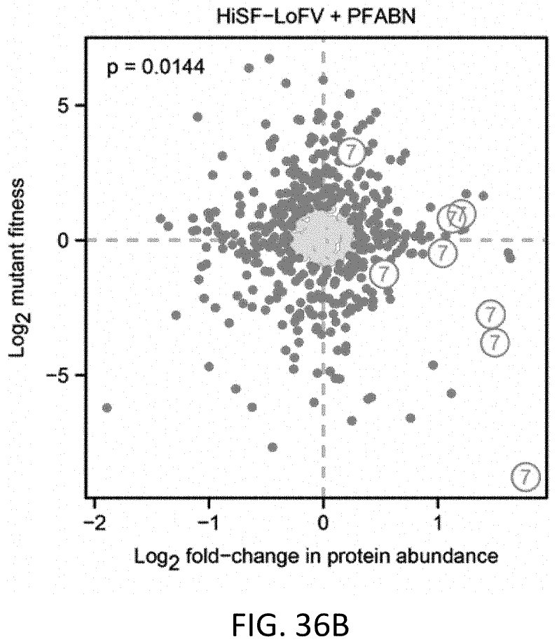

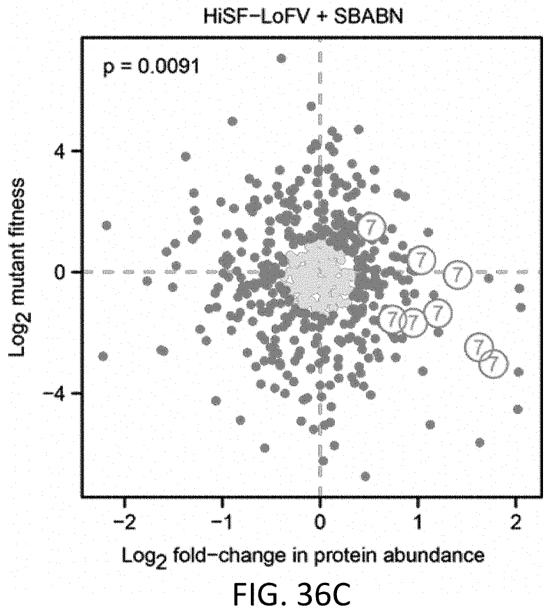

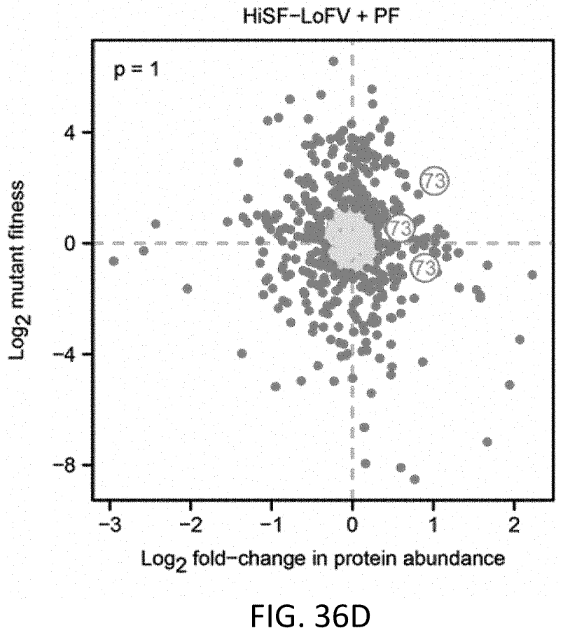

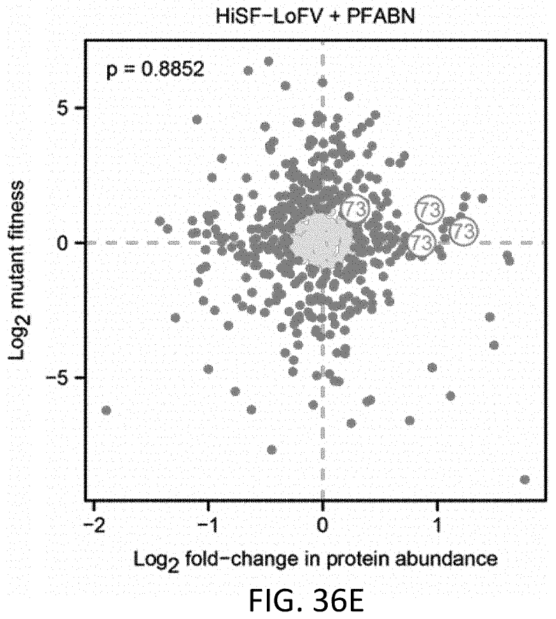

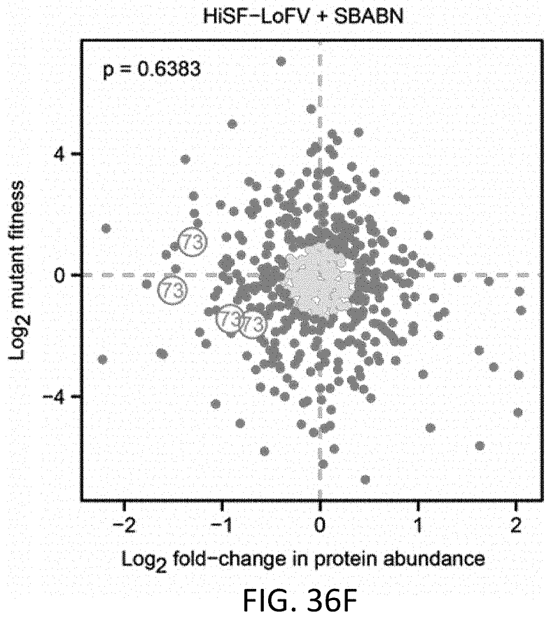

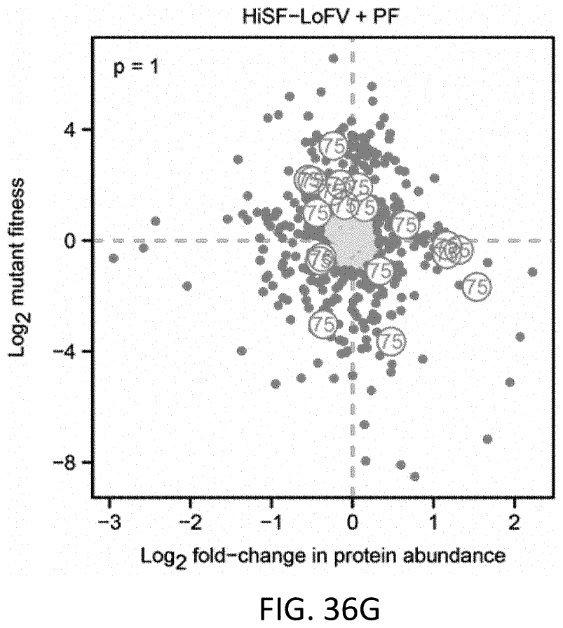

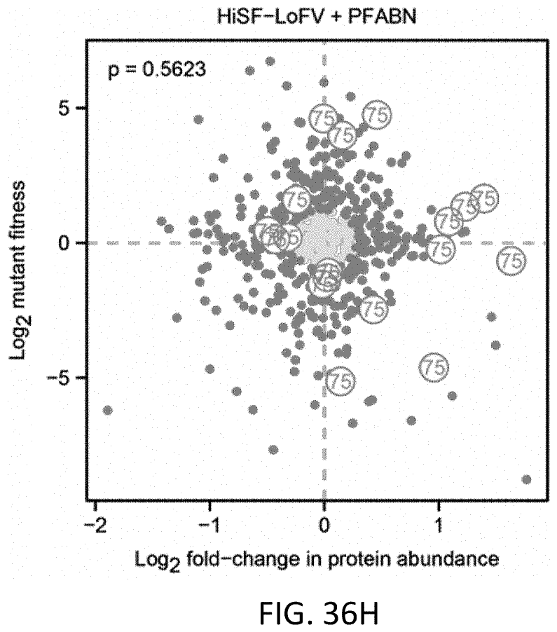

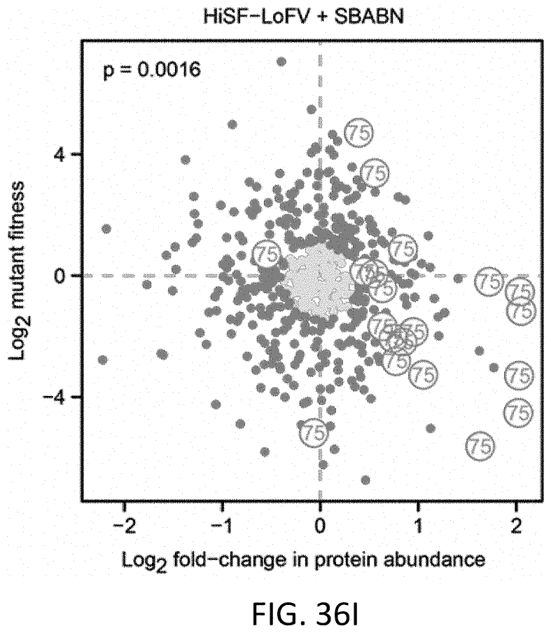

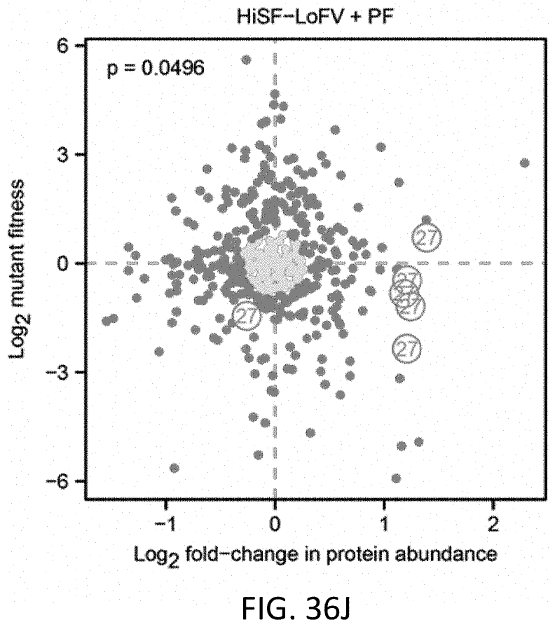

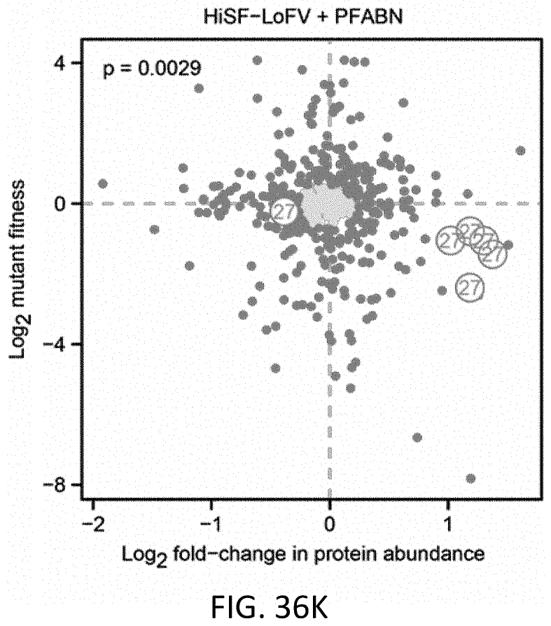

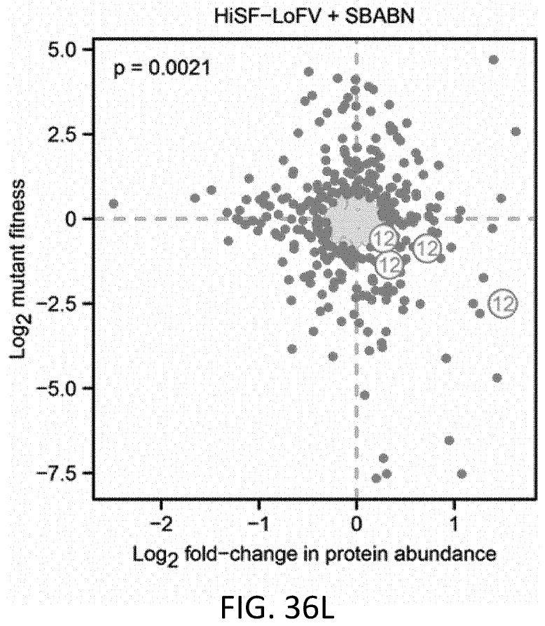

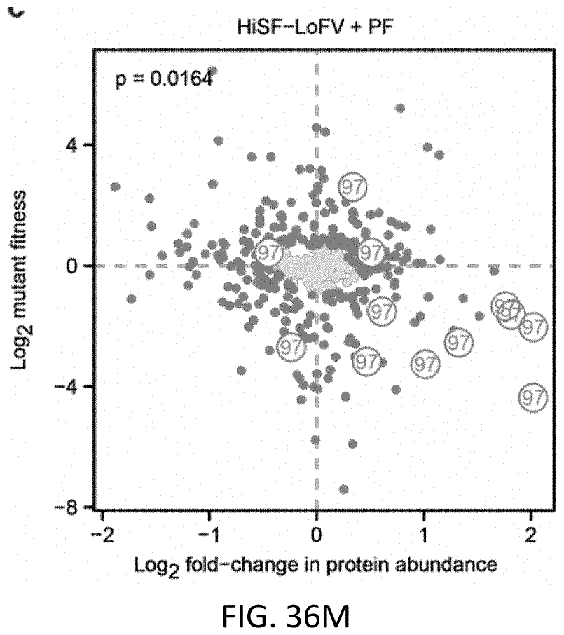

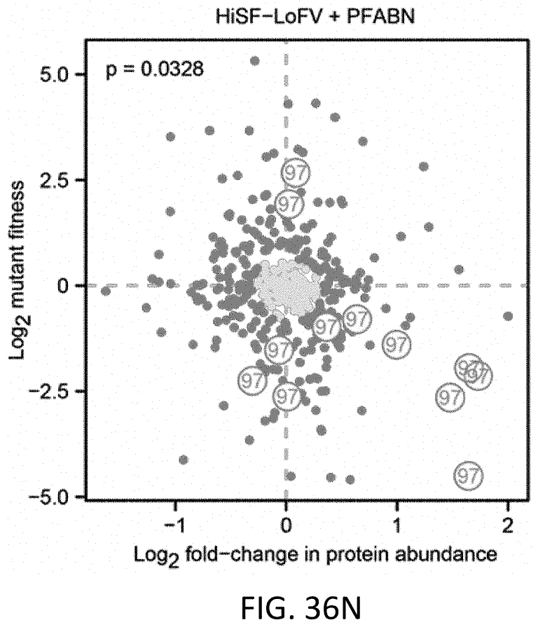

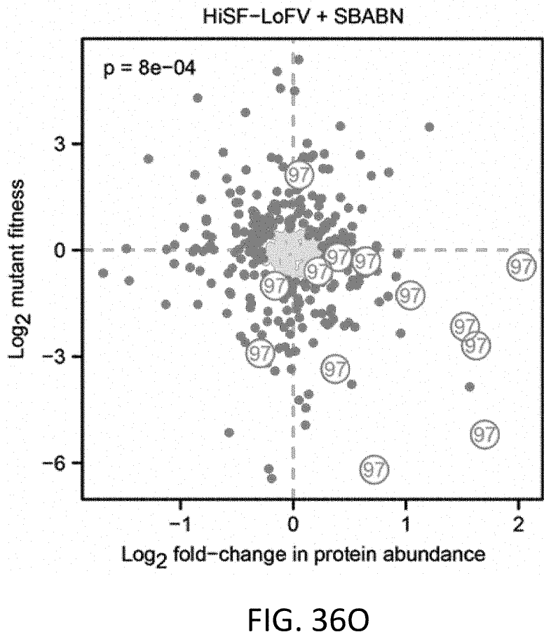

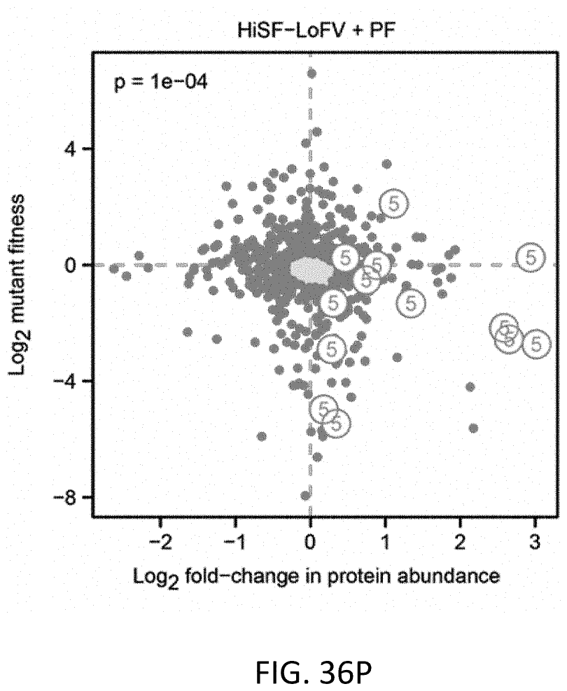

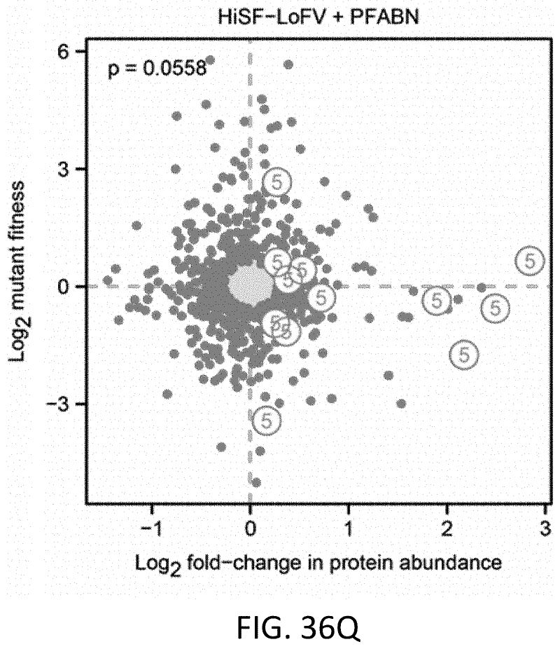

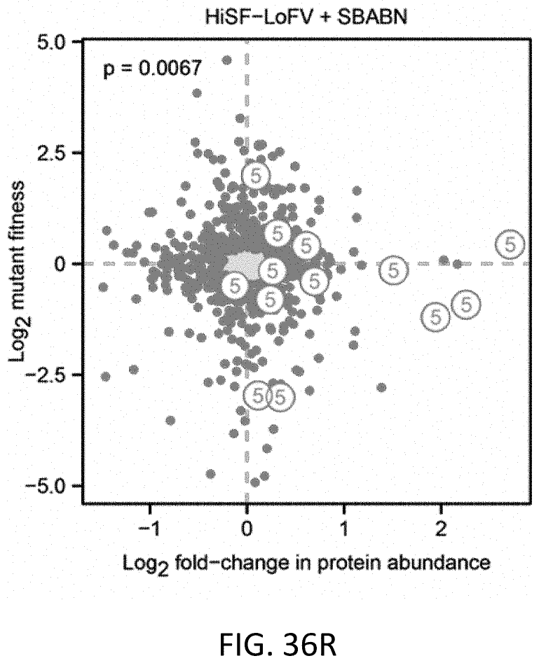

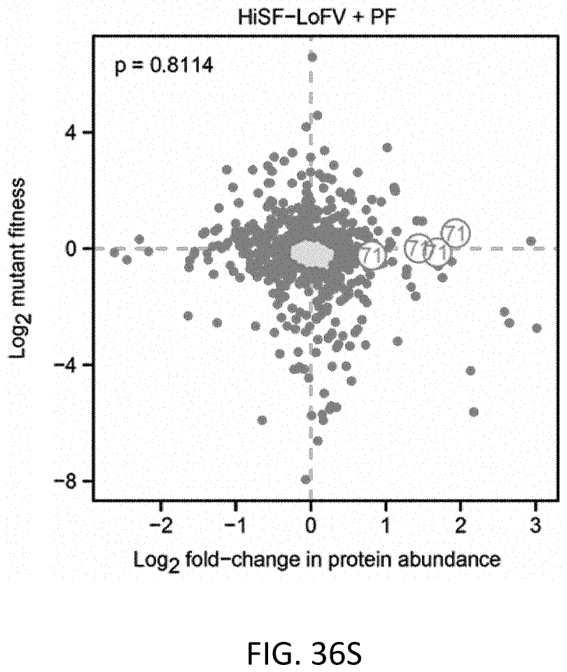

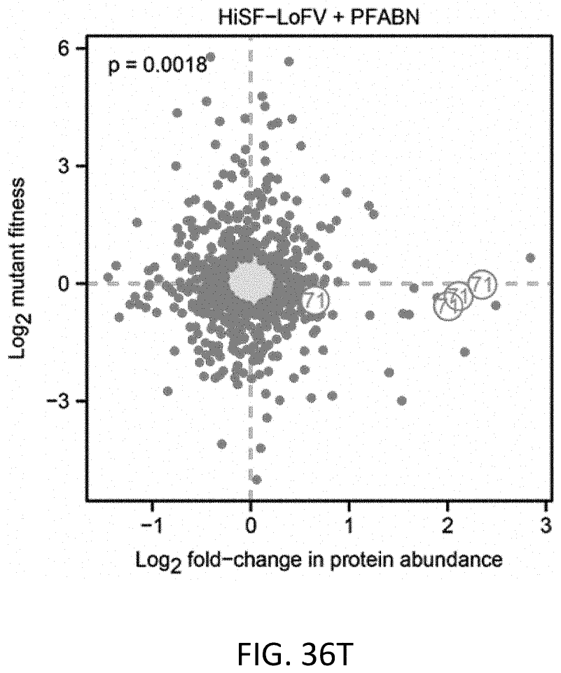

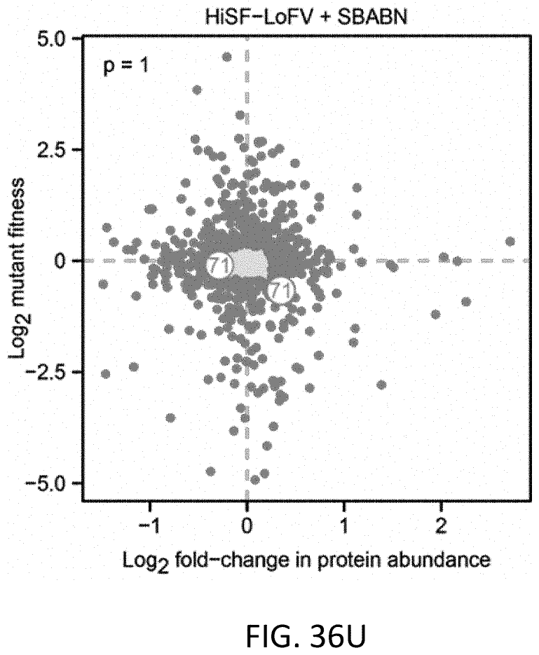

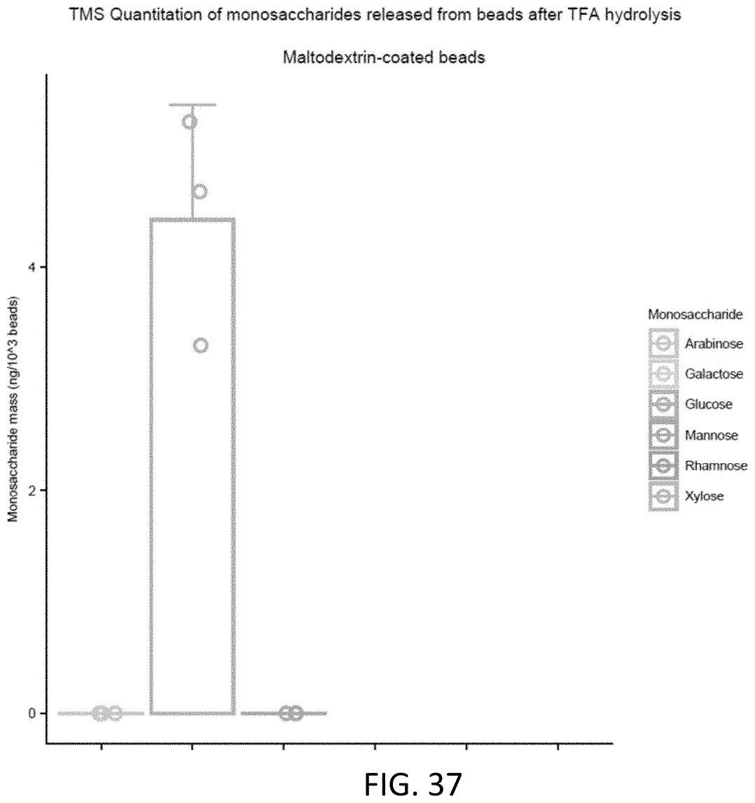

Fraction 8, obtained using the harshest conditions (4 M KOH for 24 hours at 22° C.) and containing high relative content of arabinose and galactose, was selected for further evaluation. Based on its monosaccharide composition and the results obtained from PMAA linkage analysis (Tables 13, 14), it appears that (i) fraction 8 is largely composed of arabinan that is predominately branched at the 2—, or doubly branched at the 2- and 3-positions of a linear α1-5 L-arabinofuranose backbone (FIG. 20) and (ii) the arabinan is covalently attached to small pectic fragments containing galacturonic acid, galactose, and rhamnose. The structure of the pea fiber arabinan is more highly branched and sterically encumbered than the more commonly observed arabinan structure, exemplified by commercially available sugar beet arabinan which is branched almost exclusively at the 3-position (Megazyme; cat. no.: P-ARAB) (Tables 13, 14). In addition to arabinan, fraction 8 contains lesser amounts of two additional plant polysaccharides that are not covalently bound to the arabinan: a small amount of xylan (linear β1-4 xylose) and a small amount of starch (α1-4 glucose).

The method for pea fiber arabinan isolation was scaled up using a procedure similar to what was employed in the initial fractionation to supply sufficient quantities for studies in gnotobiotic mice (yield 22%±2% wt:wt) (FIG. 2I). Briefly, 50 grams of the pea fiber preparation was first treated with 1 M KOH+0.5 wt. % sodium borohydride at room temperature for 24 hours to dissolve starch, proteins, free oligosaccharides and other smaller compounds. The mixtures were then centrifuged at 3,900 g for 20 minutes. The pellets were collected and resuspended in 4 M KOH+0.5 wt. % sodium borohydride and stirred at room temperature for 24 hours. The mixture was centrifuged at 3,900 g for 20 minutes again. The supernatant containing the targeted polysaccharides was then neutralized with 4 M acetic in cold bath. The extracted polysaccharides were then precipitated after adding ethanol to the mixture at the ratio of 3.75:1 and cooled down to −20° C. The precipitated polysaccharides were then collected by centrifuging the mixtures at 3,900 g at 4° C. for 20 minutes. The collected pellets were then crushed and washed in 80% ethanol at 4° C. to remove organics such as polyphenols. The latter step was repeated three times. The final pellets were then dried under dry nitrogen overnight to yield “Fraction 8”.

Next Fraction 8 (150 mg) was solubilized in 50 mM sodium malate (pH 6)+2 mM calcium chloride (30 mL) via incubation in a 95° C. water bath and sonication to yield a 5 mg/mL solution. To this, 3.5 mg of amyloglucoside (Megazyme; cat. no.: E-AMGFR) and 1.25 mg of alpha-amylase (Megazyme, cat. no.:E-PANAA) were added as 3 mg/mL stock solutions in 50 mM sodium malate (pH 6)+2 mM calcium chloride. Starch was digested via incubation at 37° C. for 4 hours. The digestion was terminated via enzyme denaturation by incubation at 90° C. for 30 min. The glucose product resulting from starch digestion was removed with extensive dialysis against ddH20 using 3.5 kDa molecular weight cut off Snakeskin dialysis tubing (ThermoFisher, cat. no,: 88244). The sample was dried via lyophilization to yield enzymatically destarched Fraction 8. Monosaccharide analysis and glycosyl linkage analysis was performed as described above (Table 16 and Table 17). The enzymatically destarched Fraction 8 was then used in the following animal experiment.

Four groups of adult C57BL/6J male mice fed the HiSF-LoFV diet were colonized with a defined community comprising 14 cultured, sequenced human gut bacterial strains (Ridaura et al.) (n=5 mice/arm; Table 15, FIG. 22). Two days after colonization, mice in three experimental groups were switched to the HiSF-LoFV diet supplemented with (i) 10% (wt:wt) the pea fiber preparation (calculated consumption 16.6 g/kg mouse weight/day), (ii) 100 mg/mouse/day enzymatically destarched Fraction 8 (3.3 g/kg/day), or (iii) 100 mg/mouse/day sugar beet arabinan (3.3 g/kg/day). A fourth control arm received the unsupplemented HiSF-LoFV diet.

Mice were given ad libitum access to the diets for 10 days at which point all animals were gavaged with polysaccharide-coated paramagnetic fluorescent beads. Animals were sacrificed 4 hours after gavage of the beads. Bacterial community composition was assessed via short read shotgun sequencing (COPRO-Seq) of DNA purified from serially-collected fecal samples and from cecal contents harvested at the conclusion of the experiment (McNulty et al.).

Principal components analysis of the relative abundances of community members in fecal samples collected on day 11 post-colonization revealed that all 3 experimental diets produced microbial community configurations that were distinct from those in mice consuming the control unsupplemented HiSF-LoFV diet (FIG. 23). Of note the microbial communities of mice supplemented with enzymatically destarched Fraction 8 were compositionally similar to that of mice whose diets were supplemented with the pea fiber preparation from which it was derived, but distinct from those consuming the sugar beet arabinan-supplemented HiSF-LoFV diet.

A time series analysis of the effects of the different glycans on the representation of community members in the fecal microbiota of mice belonging to the four treatment groups is presented in FIG. 24. Supplementation with both enzymatically destarched Fraction 8 and the pea fiber preparation supplementation both enhanced the fitness (relative abundance) of B. ovatus ATCC 8483 and B. thetaiotaomicron VPI-5482 compared to the unsupplemented HiSF-LoFV diet. In general, the responses of all Bacteroides to the pea fiber preparation and enzymatically destarched Fraction 8 were similar (as judged by their relative abundances), the one exception being B. cellulosilyticus WH2, which achieved a higher representation in the community in the presence of raw pea fiber. In contrast, sugar beet arabinan differed from both raw pea fiber and pea fiber arabinan in increasing the fractional abundance of B. vulgatus ATCC 8482 while having no significant effect on B. ovatus. Collectively, these results reveal that enzymatically destarched Fraction 8 is able to recapitulate the majority of the effects on community composition of the pea fiber preparation from which it was derived, and also highlight the structural specificity of responses by different Bacteroides species to arabinan prepared from different plant sources.

We took advantage of the fact that the gene content of the community was known and performed mass spectrometry-based fecal meta-proteomic analysis to define the responses of community members to the different glycan preparations. Bacteroides sp. possess multiple polysaccharide utilization loci (PULs); a shared feature of PULs is an adjacent pair of susC and susD homologs responsible for binding extracellular polysaccharide fragments and importing them into the periplasm. PUL genes adjacent to these susC/susD homologs encode various carbohydrate active enzymes (CAZymes) involved in polysaccharide depolymerization (Anderson and Salyers, 1989; Terrapon et al. 2018). Expression of PUL genes is regulated in ways that allow the bacteria to acquire nutrients within the highly competitive environment of the gut. FIG. 35 summarizes the results of our analysis of PUL gene expression from the two independent experiments (total of 10-11 mice/treatment arm). Based on geneset enrichment analysis (Luo et al., 2009), we identified 11, 14, 12, and 8 PULs that we deemed ‘responsive’ to at least one of the diet supplements in B. cellulosilyticus WH2, B. thetaiotaomicron VPI-5482, B. ovatus ATCC 8483, and B. vulgatus ATCC 8482, respectively (adjusted p value <0.05, unpaired one-sample Z-test, FDR-corrected).

Additionally, multi-taxon insertion site sequencing (INSeq) of the five strains represented as Tn mutant libraries was used to identify genes with significant contributions to bacterial fitness in each diet context (Wu and Gordon et al., 2015). Fitness was calculated as (i) the log 2 ratio of the number of sequencing reads originating from the site of insertion of the Tn in the organism in fecal communities sampled on dpg 6 versus dpg2, relative to (ii) the same ratio calculated in mice monotonously fed the unsupplemented HiSF-LoFV diet. A negative score indicates that a gene is important for fitness. The score of each gene was parametrized using linear models generated with limma (Richie and Smythe, 2015) to identify those whose effects on fitness were significantly different compared to when the unsupplemented HiSF-LoFV diet was being consumed. The results disclosed that the fitness scores of 332, 195, and 75 genes were significantly altered during diet supplementation with pea fiber, PFABN, or SBABN, respectively (adjusted p value <0.05, FDR-corrected).

Plots of fitness score versus change in protein abundance were subsequently generated for all genes in these Bacteroides (FIG. 36). High protein expression and low mutant fitness are represented in the right lower quadrant of these graphs. A chi-squared test was used to assess overrepresentation of genes from a given PUL in this quadrant. Genes within a PUL of interest that fell within an ellipse of the interquartile range of both measurements were omitted from the calculation; all genes other than the tested PUL represented the null. Using these criteria, B. thetaiotaomicron VPI-5482 PUL7 (FIG. 36A-C) was identified as having a significant effect on fitness during pea fiber, PFABN and SBABN supplementation (p<0.05, chi-squared test, FDR-corrected), but not during SBABN supplementation (p=0.11). PUL7 contains multiple GH43 and 51 family enzymes with reported arabinofuranosidase activity; its expression is induced during in vitro growth on arabinan (Martens et al., 2011; Cartmell et al., 2011) and in vivo with pea fiber supplementation (Patnode et al., 2019). In contrast, PUL75 (FIG. 36G-I) had a significant effect on fitness during SBABN but not during pea fiber or PFABN supplementation (p-value <0.005, 1 and 0.56, respectively; chi-squared test, FDR-corrected). PUL75 encodes multiple enzymes for rhamnogalacturonan I (RGI) backbone depolymerization and degradation of other pectic polysaccharides (Luis et al., 2018; Martens et al., 2011).

B. vulgatus ATCC 8482 provided another example of PULs that target arabinan but function as supplement source-specific fitness determinants. PUL27 and PUL12 contain genes belonging to GH43 GH51 and GH146 families that have specificity for L-arabinofuranosyl structures found in arabinan (Luis et al, 2018). Expression of PUL27 is responsive to all three supplements (FIG. 35) but it only significantly affects fitness in the context of unfractionated pea fiber and PFABN supplementation (p<0.05, chi-squared test, FDR-corrected) (FIG. 36J-K). In contrast, PUL12 only functions as a responsive fitness determinant during SBABN supplementation (FIG. 36L) (p<0.05, chi-squared test, FDR-corrected). Finally, PUL97 in B. ovatus ATCC 8483 (FIG. 35) functions as a fitness PUL with all three supplements (p<0.05, chi-squared test, FDR-corrected): it is the only fitness PUL we identified in this strain (FIG. 36M-O). Together, these community configurational and functional responses to diet supplementation provide evidence that PFABN is a key bioactive component of pea fiber utilized by B. thetaiotaomicron, B. vulgatus, B. cellulosilyticus and B. ovatus. However, these results do not directly establish that it is consumed. To produce such evidence, we developed a bead-based method for quantifying polysaccharide metabolism within the intestinal tracts of colonized gnotobiotic mice.

We next sought to quantify how the in vivo degradative capacity of each individual mouse's microbiota changed with dietary fiber supplementation. To do so, we employed microscopic paramagnetic silica beads (average diameter=10 μm) with covalently bound glycans from enzymatically destarched Fraction 8 or purified sugar beet arabinan. Each bead type could be distinguished based on its distinct covalently linked fluorophore. Empty control beads contained no bound glycan. Beads were pooled and gavaged into mice colonized with the defined community and fed either the unsupplemented HiSF-LoFV, or the HiSF-LoFV supplemented with the pea fiber preparation, enzymatically destarched Fraction 8, or the purified sugar beet arabinan. A separate group of animals that were maintained as germ-free fed enzymatically destarched Fraction 8 supplemented HiSF-LoFV served as controls (n=5 mice/treatment group)

Animals from all groups were euthanized 4 hours after gavage of the bead mixture. Beads were then separated from cecal contents based on their density and magnetism, and each bead type was purified using fluorescence activated cell sorting (FACS) (FIG. 25). To compare the in vivo degradative capacities of each diet-exposed microbiota, recovered sorted beads were subjected to acid hydrolysis to release all residual bead-bound polysaccharide as free monosaccharides which were then quantified using GC-MS.

Comparison of germ-free controls to animals containing the defined consortium of human gut bacteria established that removal of arabinan from the different bead types was colonization-dependent. Moreover, no arabinose was detected in the empty beads that were administered to germ-free or colonized animals (FIG. 26). When colonized mice were fed the HiSF-LoFV diet supplemented with the pea fiber preparation, arabinose removal from beads with bound Fraction 8 glycans or sugar beet arabinan was significantly (p=0.018 and 0.025, respectively; unpaired t-test) enhanced compared to mice consuming the unsupplemented diet (FIG. 26). These results indicate that the pea fiber preparation has the capacity to change the functional configuration of the defined community to a state of enhanced capacity to process arabinan-containing polysaccharides. Mice fed the HiSF-LoFV diet supplemented with either enzymatically destarched Fraction 8 or sugar beet arabinan demonstrated a trend toward enhanced arabinose removal in both bead contexts compared to that in observed in mice fed the unsupplemented HiSF-LoFV diet (FIG. 26). These results might suggest that the purified (‘free’) forms of arabinan prepared from pea fiber (fraction 8), or sugar beet arabinan, compete with bead-bound arabinan for degradation/consumption by members of the community more effectively than the structurally bound, compositionally more complex pea fiber preparation, i.e., this more complex form requires additional processing by CAZymes before they are available to arabinan consumers represented in the model human gut microbiota.

TABLE 13
Percent fractional abundance of each detected linkage in the purified
sugar beet and pea fiber arabinan (fraction 8) preparations.

| | % Fractional abundance | |
|---|---|---|
| | Sugar beet | |
| Residue | arabinan | Fraction 8 |
| Terminal Rhamnopyranosyl residue (t-Rha) | | 0.2 |
| Terminal Arabinofuranosyl residue (t-Araf) | 21.3 | 20.5 |
| Terminal Fucopyranosyl residue (t-Fuc) | — | 0.7 |
| Terminal Arabinopyranosyl residue (t-Ara) | — | — |
| Terminal Xylopyranosyl residue (t-Xyl) | — | 3.8 |
| 2 linked Rhamnopyranosyl residue (2-Rha) | 0.8 | 0.2 |
| 2 linked Arabinofuranosyl residue (2-Araf) | 0.6 | 0.3 |
| Terminal Glucuronic Acid residue (t-GlcA) | 0.7 | |
| Terminal Glucopyranosyl residue (t-Glc) | — | 0.8 |
| 3 linked Arabinofuranosyl residue (3-Araf) | 0.7 | 0.1 |
| Terminal Galactopyranosyl residue (t-Gal) | 2.9 | 2.9 |
| 4 linked Arabinopyranosyl residue or 5 | 29.3 | 20.7 |
| linked Arabinofuranosyl residue | | |
| (4-Arap or 5-Araf) | | |
| 4 linked Xylopyranosyl residue (4-Xyl) | — | 3.8 |
| 2 linked Xylopyranosyl residue (2-Xyl) | — | 1.5 |
| 2,4 linked Rhamnopyranosyl residue (2,4-Rha) | 1.7 | 1.0 |
| 2 linked Glucopyranosyl residue (2-Glc) | 0.3 | |
| 3 linked Galactopyranosyl residue (3-Gal) | 1.5 | 1.5 |
| 2 linked Galactopyranosyl residue (2-Gal) | — | 0.7 |
| 3,4 linked Arabinopyranosyl residue or | 24.5 | 2.3 |
| 3,5 linked Arabinofuranosyl residue | | |
| (3,4-Arap or 3,5-Araf) | | |
| 4 linked Galactopyranosyl residue (4-Gal) | 6.0 | 3.1 |
| 4 linked Galacturonic Acid residue (4-Gal A) | 0.4 | |
| 4 linked Glucopyranosyl residue (4-Glc) | — | 19.1^{a} |
| 6 linked Galactopyranosyl residue (6-Gal) | 1.5 | — |
| 2,4 linked Arabinopyranosyl residue or | 1.7 | 6.0^{a} |
| 2,5 linked Arabinofuranosyl residue | | |
| (2,4-Arap or 2,5-Araf) | | |
| 2,3,4 linked Arabinopyranosyl residue or | 4.2 | 7.8 |
| 2,3,5 linked Arabinofuranosyl residue | | |
| (2,3,4-Arap or 2,3,5-Araf) | | |
| 3,4 linked Glucopyranosyl residue (3,4-Glc) | — | — |
| 2,4 linked Glucopyranosyl residue (2,4-Glc) | — | — |
| 3,6 linked Galactopyranosyl residue (3,6-Gal) | 1.7 | |
| 4,6 linked Glucopyranosyl residue (4,6-Glc) | — | 3.1 |

^{a}These 2 peaks overlapped; percentages were estimated based on MS fragmentation

TABLE 14
Percent fractional abundance of each detected arabinose
linkage relative to the total arabinose linkages
in purified sugar beet and pea fiber arabinan.

| | % Fractional abundance | |
|---|---|---|
| | Sugar beet | |
| Residue | arabinan | Fraction 8 |
| Terminal Arabinofuranosyl residue (t-Araf) | 25.9 | 35.5 |
| 2 linked Arabinofuranosyl residue (2-Araf) | 0.7 | 0.5 |
| 3 linked Arabinofuranosyl residue (3-Araf) | 0.9 | 0.2 |
| 4 linked Arabinopyranosyl residue or | 35.6 | 25.9 |
| 5 linked Arabinofuranosyl residue (4-Arap or | | |
| 5-Araf) | | |
| 3,4 linked Arabinopyranosyl residue or | 29.8 | 4.0 |
| 3,5 linked Arabinofuranosyl residue (3,4- | | |
| Arap or 3,5-Araf) | | |
| 2,4 linked Arabinopyranosyl residue or | 2.1 | 10.4^{a} |
| 2,5 linked Arabinofuranosyl residue (2,4- | | |
| Arap or 2,5-Araf) | | |
| 2,3,4 linked Arabinopyranosyl residue or | 5.1 | 13.5 |
| 2,3,5 linked Arabinofuranosyl residue | | |
| (2,3,4-Arap or 2,3,5-Araf) | | |

^{a}Peak overlapped with another peak; percentage estimated based on MS fragmentation

TABLE 15
Bacterial strains comprising the model
defined human gut community.

| Bacteria | Strain | Citation |
|---|---|---|
| Bacteroides ovatus | ATCC 8483 INSeq | Ridaura et al. |
| Bacteroides cellulosilyticus | WH2 INSeq | Ridaura et al. |
| Bacteroides thetaiotaomicron | ATCC 7330 INSeq | Ridaura et al. |
| Bacteroides thetaiotaomicron | VPI-5482 INSeq | Ridaura et al. |
| Bacteroides vulgatus | ATCC 8482 INSeq | Ridaura et al. |
| Bacteroides caccae | TSDC17.2 | Wu et al. |
| Bacteroides finegoldii | TSDC17.2 | Wu et al. |
| Bacteroides massiliensis | TSDC17.2 | Wu et al. |
| Collinsella aerofaciens | TSDC17.2 | Wu et al. |
| Escherichia coli | TSDC17.2 | Wu et al. |
| Odoribacter splanchnicus | TSDC17.2 | Wu et al. |
| Parabacteroides distasonis | TSDC17.2 | Wu et al. |
| Ruminococcaceae sp. | TSDC17.2 | Wu et al. |
| Subdoligranulum variabile | TSDC17.2 | Wu et al. |

TABLE 16
Percent fractional abundance of linkages in
the enzymatically destarched Fraction 8

| | | Area % of Detected linkage | |
|---|---|---|---|
| | | Pea fiber | |
| | | arabinan | Sugar beet |
| | Glycosl linkage | (fraction 8) | arabinan |
| Arabinose | t-Ara(f) | 19.21 | 21.99 |
| | t-Arap(p) | 0.13 | 0.2 |
| | 3-Ara(f) | 0.34 | 1.39 |
| | 4-Ara(p)/5-Ara(f) | 21.59 | 24.29 |
| | 3,4-Ara(p)/3,5-Ara(f) | 2.19 | 13.57 |
| | 2,4-Ara(p)/2,5Ara(f) | 12.96 | 2.47 |
| | 2,3,4-Ara(p)/2,3,5-Ara(f) | 9.36 | 4.49 |
| | Sum total arabinose | 65.78 | 68.4 |
| Galactose | t-Gal(p) | 2.91 | 3.44 |
| | 3-Gal(p) | 1.89 | 1.47 |
| | 2-Gal(p) | 0.65 | 0 |
| | 4-Gal(p) | 7.16 | 14.05 |
| | 6-Gal(p) | 0.34 | 1.8 |
| | 4,6-Gal(p) | 0.54 | 0.36 |
| | 3,6-Gal(p) | 0.28 | 2.02 |
| | 3,4,6-Gal(p) | 0.02 | 0.15 |
| | 2,3,6-Gal(p) | 0 | 0.05 |
| | Sum total galactose | 13.79 | 23.34 |
| Xylose | t-Xyl(P) | 2.63 | 0 |
| | 4-Xyl(p) | 6.47 | 0 |
| | 3,4-Xyl(p) | 0.9 | 0.4 |
| | 2,3,4-Xyl(p) | 0 | 0.02 |
| | Sum total xylose | 10 | 0.42 |
| Rhamnose | t-Rha(p) | 0.15 | 0.44 |
| | 2-Rha(p) | 1.29 | 2.62 |
| | 3-Rha(p) | 0.1 | 0.48 |
| | 2,3-Rha(p) | 0 | 0.07 |
| | 2,4-Rha(p) | 2.69 | 3.53 |
| | 2,3,4-Rha(p) | 0.33 | 0.29 |
| | Sum total rhamnose | 4.56 | 7.43 |
| Glucose | t-Glc(p) | 0.16 | 0 |
| | 4-Glc(p) | 0.07 | 0.14 |
| | 2,4-Glc(p) | 0.22 | 0.19 |
| | 4,6-Glc(p) | 4.34 | 0.01 |
| | Sum total glucose | 4.79 | 0.34 |
| Mannose | t-Man(p) | 0.36 | 0 |
| | 3,6-Man(p) | 0.03 | 0 |
| | 2,6-Man(p) | 0.05 | 0 |
| | Sum total mannose | 0.44 | 0 |
| Other | t-Fuc(p) | 0.46 | 0.04 |
| | 3′-Api(f) | 0.17 | 0.02 |

TABLE 17
Fractional abundance of arabinose monosaccharides. Abundance
is relative to total arabinose content. Data was generated
from enzymatically destarched fraction #8 as partially
methylated alditol acetate via GC-MS analysis which was
supported by the Chemical Sciences, Geosciences and Biosciences
Division, Office of Basic Energy Sciences, U.S. Department
of Energy grant (DE-SC0015662) to DOE - Center for Plant
and Microbial Complex Carbohydrates at the Complex Carbohydrate
Research Center.

| | % fractional abundance of |
|---|---|
| | arabinose monosaccharides |
| Monosaccharide | (relative to total arabinose) |
| t-Ara(f) | 29.20% |
| t-Ara(p) | 0.20% |
| 3-Ara(f) | 0.51% |
| 4-Ara(p)/5-Ara(f) | 32.83% |
| 3,4-Ara(p)/3,5-Ara(f) | 3.33% |
| 2,4-Ara(p)/2,5Ara(f) | 19.70% |
| 2,3,4-Ara(p)/2,3,5-Ara(f) | 14.23% |
| Total | 100.00% |

### Example 13

Introduction: Increasing effort is being directed to deciphering how components of diets consumed by various human populations impact the composition and expressed functional features of their gut microbial communities (e.g., Johnson et al., 2019; Ghosh et al., 2020). A hoped-for benefit from obtaining this knowledge is to gain new insights about how food ingredients, and their biotransformation by the microbiota, are linked to various aspects of human physiology, and new ways to both define and improve nutritional status. However, there are many formidable challenges. The gut microbiota is complex, dynamic and exhibits considerable intra- and interpersonal variation in its configurations (Lloyd-Price et al., 2017). The chemical compositions of food staples are being catalogued at ever deepening levels of detail using higher through-put analytical methods, such as mass spectrometry. Even as this knowledge is being acquired, the nature of the ‘bioactive’ components recognized by members of the microbiota, and the pathways through which these chemical entities are metabolized by community members to influence their functions and those of the host remain poorly defined. Furthermore, much needs to be learned about the effects of current methods of food processing on the representation of these bioactives (Wolf et al., 2019; Carmody et al., 2019), and the mechanisms that determine whether and how microbes compete and/or cooperate for these food components (Patnode et al., 2019).

Dietary plant fibers epitomize these challenges and opportunities. Fibers are complex mixtures of biomolecules whose composition varies depending upon their source, their method of initial recovery, and the food processing technologies used to incorporate them into food products that have satisfactory organoleptic properties (texture, taste, smell) (Caffall and Mohnen, 2009). The vast majority of studies testing the biological effects of fibers have been performed with preparations whose biochemical features are largely uncharacterized. Fiber components include but are not limited to polysaccharides, proteins, fatty acids, polyphenols and other plant-derived small molecules (Nicolson et al., 2012; Scalbert et al., 2014). Separating and/or purifying component glycans from crude fiber mixtures can be very challenging; even if separation is achieved, painstaking analysis of features such as glycosidic linkages is required to define their structures (Pettolino et al., 2012). Knowing that a given microbiota member has a suitable complement of genes for acquiring and processing a given glycan structure does not necessarily predict whether that organism will be a consumer in vivo. Other factors need to be considered. For example, an individual's microbiota may harbor a number of organisms with the capacity to compete or cooperate with one another for utilization of a given type of glycan. A given dietary fiber typically contains a multiplicity of glycans. The physical-chemical structure of a fiber (e.g., its size, surface properties/nutrient composition) in a given region of the gut could influence which set of microbes attach to its surface, how its associated microbes prioritize consumption of its component glycans and how/whether particle-associated microbes can share products of glycan metabolism with one another.

The examples illustrate an approach for addressing some of these questions using pea fiber as an example. Pea fiber was selected based on results obtained from a recently published screen we conducted of 34 types of food-grade plant fibers obtained from various sources, including the waste streams of food manufacturing (Patnode et al., 2019). The screen was conducted in gnotobiotic mice colonized with a defined consortium of cultured sequenced human gut bacterial strains, including several saccharolytic Bacteroides species. Mice were fed a low fiber diet formulated to represent the upper tertile of saturated fat consumption and lower tertile of fruits and vegetable consumption by individuals living in the USA, as reported in the NHANES database. Supplementation of this diet with fiber from the seed coat of the pea, Pisum sativum, produced a significant increase in the abundance of Bacteroides thetaiotaomicron (Patnode et al., 2019). An arabinan-enriched fraction from raw pea fiber was purified and its structure defined (Example 12—Fraction 8, referred to in this example as PFABN). Forward genetic and proteomic analyses were used to compare its biological effects, versus those of unfractionated pea fiber and an arabanin from sugar beet with distinct glycosidic linkages, on members of a defined bacterial consortium containing human gut Bacteroides that was established in gnotobiotic mice (Example 12). A generalizable method for covalently attaching different glycans to microscopic paramagnetic glass beads with different covalently bound fluorophores was described (Example 12). Introduction of these ‘Microbiota Functional Activity Biosensors’ (MFABs) into gnotobiotic mice fed the HiSF-LoFV diet with or without glycan supplementation followed by their recovery from the gut allowed us to directly compare the capacity of these glycans to be metabolized by this community (Example 12 and this example). Co-localizing pea fiber arabinan with another type of polysaccharide not found in the diet (glucomannan) on an MFAB surface enhanced the efficiency of microbial community metabolism of bead-associated glucomannan when animals were given pea-fiber supplemented HiSF-LoFV diet (this example). Collectively, these findings illustrate how knowledge of the bioactive components of fibers, and the capacity to directly measure microbiota function with MFABs, could provide new approaches for designing ‘next generation’ prebiotics and foods that are more accessible to, and have a greater impact on, the gut microbiota (and by extension, the host).

Covalent linkage of various fluorescent labels and glycans to paramagnetic MFABs—To quantify PFABN and SBABN utilization as a function of diet, a versatile way to covalently link polysaccharides to recoverable, paramagnetic, microscopic glass beads that could function as biosensors of their degradation was sought. For covalent polysaccharide immobilization on a bead surface, a cyano-transfer reaction employed in the synthesis of polysaccharide-conjugate vaccines was adapted (Lees et al., 1996; Shafer et al., 2000).

FIG. 29A and FIG. 29B outline the procedure for generating fluorescently labeled, polysaccharide-coated beads. First, the surfaces of 10 μm-diameter glass beads were sialyated by reaction with an amine- and/or phosphonate-organosilane (step 1 in the Figure). This approach provided us with control over the stoichiometry and properties of surface functional groups (amine and phosphonate) to be used for further derivatization with a fluorophore and ligand immobilization. We found that coating with a 1:1 mol ratio of (2-aminopropyl)triethoxysilane (APTS) and 3-(trihydroxysilyl)propyl methylphosphonate (THPMP) to install both amine and phosphonate functional groups on the bead surface provided a nucleophilic handle and decreased nonspecific ligand binding and bead aggregation (Bagwe et al., 2006). Surface sialyation was monitored by measuring the Zeta potential of beads (FIG. 30A). Amine acetylation with acetic anhydride was used to quantify amine functional groups on the surface of each bead preparation (FIG. 30). Second, we attached unique fluorogenic tags directly to the bead surface so that multiple bead types with different immobilized polysaccharides could be analyzed simultaneously within a given gnotobiotic animal. To do so, surface-modified beads were reacted with an N-hydroxysuccinimide (NHS) ester-activated fluorophore (step 2 in FIG. 29A). Fluorophore coupling was specific to beads with surface amines (FIG. 30B, FIG. 30C). Bead fluorescence could be modulated over four orders of magnitude simply by titration of the reactant fluorophore (FIG. 30C). Low levels of fluorophore immobilization on beads not coated with APTS, or on acetylated beads likely reflects incomplete acetylation with acetic anhydride. Third, polysaccharide was activated by reaction with 1-cyano-4-dimethylaminopyridinium tetrafluoroborate (CDAP) to generate an electrophilic cyanate-ester intermediate (FIG. 29B); activated polysaccharide reacts with amines on the surface of the amine plus phosphonate bead.

Using SBABN as a test case, we found that a 1:7 mol ratio of CDAP to its calculated moles of hexose (assuming for the purpose of a generalizable calculation, that the polysaccharide is only composed of hexose), resulted in consistent and specific SBABN immobilization without ligand over-activation (manifested by aggregation and carbamoylation of hydroxyl groups) (FIG. 29C). Immobilization was dependent upon the presence of surface amines (FIG. 29C). Levels of conjugation ranged from 2-20 ng of arabinose per 1000 beads (FIG. 29C, FIG. 31A). Conjugation proceeded as expected based on the pKₐ of the bead amine: pH 7.5-7.8 yielded maximal immobilization (high pH results in cyanate ester hydrolysis while low pH favors amine protonation) (FIG. 31A). Conjugation efficiency was not significantly different when several different buffer solutes were tested (FIG. 31B). A low and inconsistent level of polysaccharide could be conjugated onto a bead surface in the absence of CDAP (FIG. 29C), likely through reductive amination of the polysaccharide reducing end.

Quantifying polysaccharide degradation with MFABs in gnotobiotic mice—PFABN and SBABN were immobilized onto amine plus phosphonate-derivatized beads. Beads acetylated with acetic anhydride after fluorophore labeling were used as controls (FIG. 32A). Each of these three bead types contained a unique fluorophore. The three bead types were pooled and the mixture was introduced by oral gavage into four groups of mice 10 days after they received the 14-member consortium: one group of recipient animals had been fed the unsupplemented HiSF-LoFV diet while the other groups had received HiSF-LoFV containing unfractionated pea fiber, PFABN or SBABN (n=5 animals/group). Germ-free mice fed HiSF-LoFV supplemented with PFABN served as controls (n=5). The bead mixtures were harvested using a magnet from the cecums of animals four hours after their introduction by oral gavage; the individual bead types were then purified by fluorescence-activated cell sorting (FACS). Polysaccharide degradation was quantified by gas-chromatography-mass spectrometry (GC-MS) of neutral monosaccharides released after acid hydrolysis of the purified beads. Results were referenced to the masses of monosaccharides released from aliquots of each input bead type (i.e., the same bead preparation but never introduced into mice).

The quantities of neutral monosaccharides liberated by acid hydrolysis from the surfaces of beads recovered from the cecums of germ-free mice were not significantly different from the amounts liberated from the input bead preparations with one exception—a slight, albeit statistically significant, increase in galactose (FIG. 33; p<0.05, Mann-Whitney U test). This result established the stability and utility of cyanate-ester coupled MFABs for studying polysaccharide utilization within the mouse gut, and the recalcitrance of both PFABN and SBABN to host digestive enzymes.

In contrast to germ-free controls, the masses of arabinan was significantly decreased when PFABN- or SBABN-coated beads were recovered from colonized mice fed the unsupplemented HiSF-LoFV diet (FIG. 32B, FIG. 32C; p<0.05, Mann-Whitney U test). Compared to the base HiSF-LoFV diet, supplementation with unfractionated pea fiber induced a community configuration associated with significantly increased capacity to degrade both PFABN and SBABN as judged by the amount of arabinose remaining on recovered beads (FIG. 32B, FIG. 32C; p<0.05, Mann-Whitney U test). Utilization of arabinose from either PFABN- or SBABN-beads was not significantly different between the two types when the HiSF-LoFV diet was supplemented with either of these isolated arabinan preparations, demonstrating functional equivalence in the capacity of each community to utilize either arabinan (see FIG. 32B, FIG. 32C and Table 19). Results from cecal and fecal samples were comparable.

Beads coated in PFABN revealed that xylan (xylose monosaccharide remaining on PFABN beads) was more efficiently processed by the microbiota in all three supplemented diet contexts (FIG. 32B; p<0.05, Mann-Whitney U test). Our group previously explored the importance of xylan utilization from the base HiSF-LoFV diet (Patnode et al., 2019). In contrast to xylan, the galactan fragments present in both arabinan preparations were not utilized under any of the diet conditions tested (FIG. 32B, FIG. 32C, Table 19). This result suggests that arabinan-responsive PULs do not efficiently degrade galactan fragments, or that PUL induction and β(1-4) galactan utilization in vivo has lower priority compared to the available arabinan (Tuncil et al., 2017).

Co-localization of distinct glycans on the same bead: As noted in the Introduction, plant-derived dietary fibers have complex physical-chemical properties manifest in part by their mixtures of different glycan structures and by their varying shapes and surface properties. Fiber particles are impacted by (i) methods, such as extrusion, that are commonly used to incorporate fibers into food products so that these products have acceptable organoleptic properties (Gualberto et al., 1997; Shahidi et al., 1998), and (ii) the mechanical forces and digestive enzymes (both host and microbial) that are encountered as food passes through the gastrointestinal tract. We reasoned that the MFAB platform could provide a way of testing whether deliberately co-localizing distinct polysaccharides would result in their synergistic utilization by microbial community members.

To explore this notion, we turned to glucomannan, a hemicellulosic linear 13(1-4) polysaccharide composed of D-mannose and D-glucose. We found that among the pea fiber-responsive Bacteroides identified above, only B. ovatus and B. cellulosilyticus were able to grow in minimal medium containing glucomannan as the sole carbon source (FIG. 34A). Both organisms have PULs known to be induced by glucomannan in vitro (PUL 28 in B. cellulosilyticus; PULs 52 and 80 in B. ovatus); each of these PULs encodes at least one GH26 enzyme with β-mannosidase activity (Martens et al., 2011; Bagenholm et al., 2017). Multiple genes in the glucomannan-responsive PUL28 of B. cellulosilyticus were consistently expressed, but not at significantly different levels, when mice were fed the HiSF-LoFV and pea-fiber supplemented HiSF-LoFV diets. Only two B. ovatus genes from its glucomannan-responsive PUL52 were expressed, albeit at the very limit of detection, under both diet conditions, and none from its PUL80. None of the in vitro glucomannan-responsive PULs in B. ovatus or B. cellulosilyticus exhibited significant changes in their expression during diet supplementation with pea fiber (FIG. 35). Neither B. thetaiotaomicron VPI-5482 nor B. vulgatus ATCC 8482, which fail to grow on glucomannan as the sole carbon source, contain GH26, GH2, or GH130 genes with known or predicted β-mannosidase activities that were induced during pea fiber supplementation [among the two organisms, only B. thetaiotaomicron BT_0458 (GH2) and BT 1033 (GH130) were present under either diet conditions, and only at the very threshold of detection].

Based on these considerations, we hypothesized that supplementing the diet with pea fiber would induce expression of PULs in community members so that they could readily utilize bead-associated PFABN; moreover, those community members that could utilize PFABN and express β-mannosidases would be able to more efficiently access/metabolize glucomannan positioned on the same bead. To test this hypothesis, we synthesized beads coated with PFABN alone, glucomannan alone, or both glycans together, as well as control acetylated beads that lack a bound polysaccharide (FIG. 34B and FIG. 34C). These four bead types, each labeled with a distinct fluorophore, were simultaneously introduced into two groups of mice colonized with the 14-member community described in Example 12—one group was fed the unsupplemented HiSF-LoFV diet while the other group received a pea fiber supplemented diet (n=7-8 mice/group). Beads were recovered from their cecums 4 hours after gavage; the different bead-types were isolated using FACS (FIG. 34D) and subjected to acid hydrolysis and neutral monosaccharide analysis by GC-MS. We used the amount of mannose remaining on the bead as a proxy of glucomannan degradation because it represents the bulk of monosaccharide present in glucomannan and is absent in PFABN. The results revealed that glucomannan on beads coated with glucomannan alone was degraded to a similar extent in mice receiving the unsupplemented or pea fiber-supplemented HiSF-LoFV diets (p=0.87, Mann-Whitney U test) (FIG. 34E, Table 19). However, when presented with PFABN on the same bead, significantly more glucomannan was degraded by the microbiota of mice receiving the pea fiber supplemented diet as compared to the unsupplemented diet (p<0.05, Mann-Whitney U test) (FIG. 34E). The amount of arabinose remaining on beads coated with PFABN and glucomannan, and PFABN alone, was also significantly reduced (degradation increased) with pea fiber supplementation (FIG. 34F, Table 19). These results show that deliberate physical co-localization can result in synergistic utilization of polysaccharides during fiber supplementation (p<0.05, linear model; diet supplement by bead type interaction term). This finding, and the approach used to obtain these results, have implications for food science and prebiotic/synbiotic discovery efforts.

Discussion—The bead-based Microbiota Functional Activity Biosensors (MFAB) described in this report represent a platform technology for measuring biochemical activities expressed by a microbial community. Installing specific functional groups on the surfaces of microscopic paramagnetic glass beads using commercially available organosilane reagents creates a biorthogonal ‘handle’ for covalent attachment of ligands. This approach represents an alternative to a procedure we described recently, where bifunctional biotinylated ligands are generated prior to immobilization on glass beads coated with streptavidin (Patnode et al., 2019). By immobilizing ligand directly on the bead surface, MFABs possess considerably more sites for ligand attachment than do streptavidin beads. Higher ligand attachment density enables higher levels of ligand loading, which increases the dynamic range of a functional activity readout.

Crude dietary fibers contain various polysaccharides intercalated within a dense cellulose-lignin matrix. The chemistry for covalent attachment employed with MFABs not only allows for dense ligand presentation, but also enables multiple ligands to be simultaneously immobilized to create ‘hybrid’ beads that can be used to model the effects of physical co-localization of different fiber components on microbial utilization. In principle, a wide range of different glycan combinations with varying stoichiometries can be explored owing to the fact that different hybrid bead types, each with its own fluorophore, can be created and tested simultaneously in vitro and in vivo (the latter using defined communities or intact uncultured microbial communities).

The identification of bioactive components of fibers and their combination with other prebiotic glycans offers an approach for creating formulations with enhanced capacity to alter the expressed properties of targeted members of a microbial community. Extrapolating, producing such combinations could provide a way of realizing the health benefits of fiber-containing foods but at lower amounts of total fiber. This last feature would help food scientists surmount the challenge of dealing with the unsatisfactory organoleptic properties commonly encountered with high fiber content food formulations.

The approach we describe in this report for ligand immobilization does not require the synthesis of bifunctional ligands (or fluorophores); instead, custom functional groups can be incorporated into the probe through modification of the organosilane donor molecule. As such, the MFAB platform provides an opportunity to develop chemistries for nondestructively releasing ligands for analysis (Bielski et al., 2013). For example, characterization of microbial utilization of polysaccharides needs to move beyond relatively ‘simple’ GC-MS measurements of monosaccharides released from the surface of recovered beads to readouts of glycan structures recovered from the bead surface (prior to and after exposure to microbes). This information would provide a more informed view of functional properties (saccharolytic activities) expressed by a microbial community as a function of the donor and diet, as well as greater insights about structure/activity relationships of existing or new candidate prebiotic and synbiotic formulations.

### Example 14—Methods for Example 12 and 13

Purification of pea fiber arabinan (PFABN): Fractionation of pea fiber—Raw pea fiber was fractionated using serial extractions with aqueous buffers of increasing harshness (Pattathil et al., 2012). Pea fiber (Rattenmaier; Cat. No.: Pea Fiber EF 100) (5 g) was defatted by stirring at 23° C. for two hours in 60 mL of 80% (vol:vol) ethanol. Fiber was pelleted by centrifugation (3,500×g, 5 minutes) and the supernatant was removed. Neat ethanol was added to the pelleted fiber and the solution was mixed for two minutes. Fiber was centrifuged (3,500×g, 5 minutes) and the supernatant was removed. Neat acetone was added to the pelleted fiber, the solution was mixed for two minutes, centrifuged (3,500×g, 10 minutes), and the supernatant was removed. The resulting ‘defatted’ pea fiber was dried in a chemical hood overnight. Defatted pea fiber was subsequently resuspended in 200 mL of 50 mM ammonium oxalate (pH=5.7) and stirred at 23° C. for 20 hours. The suspension was centrifuged (7,000×g, 15 minutes), the supernatant was collected, concentrated [Amicon Stirred Cell concentrator (Millipore Sigma; Cat. No.: UFSC20001) with a 3 kDa molecular weight cut-off ultrafiltration disk (Millipore Sigma; Cat. No.: PLBC06210)] and then dialyzed extensively against water [3.5 KDa molecular weight cut-off dialysis tubing (Thermo Scientific; Cat. No.; 88244) or 3.5 KDa molecular weight cut-off Slide-A-Lyzer dialysis cassettes (Thermo Scientific)]. The precipitate from the dialysis was recovered by centrifugation (15,000×g, 15 minutes). The precipitate and soluble material from the dialysis, representing fractions one and two, respectively, were dried with lyophilization.

The pellet from the ammonium oxalate extraction was washed with 200 mL of water, centrifuged (4,000×g, 15 minutes), and the supernatant was discarded. The pellet was resuspended in 200 mL of 50 mM sodium carbonate (pH=10) containing 0.5% (wt:wt) sodium borohydride and stirred at 23° C. for 20 hours. The suspension was centrifuged (6,000×g, 15 minutes) and the supernatant was collected. Borohydride was quenched by slowly adding glacial acetic acid. A stringy precipitate began to form as the pH decreased. The suspension was concentrated (as above); the insoluble and soluble portions of the resulting concentrated carbonate suspension were separated with centrifugation (15,000×g, 15 minutes), yielding fractions three and four, respectively. Fractions were dialyzed and dried with lyophilization.

The pellet from the carbonate extraction was washed with water before resuspension in 200 mL of 1 M potassium hydroxide containing 1% wt:wt sodium borohydride and stirring for 20 hours at 23° C. The suspension was centrifuged (6,000×g, 15 min) and the supernatant was removed. Five drops of 1-octanol were added to prevent foaming during borohydride quenching. A light precipitate began to form in the solution as the pH decreased. The suspension was concentrated; the insoluble and soluble portions of the concentrated 1 M hydroxide extract were separated with centrifugation (15,000×g, 15 minutes), yielding fractions five and six, respectively. Fractions were dialyzed and dried with lyophilization.

The pellet from the 1 M hydroxide extraction was washed with water before resuspension in 200 mL of 4 M potassium hydroxide containing 1% wt:wt sodium borohydride. The mixture was stirred at 23° C. for 20 hours. The suspension was then centrifuged (6,000×g, 15 min) and the supernatant was removed. 1-Octanol were added to prevent foaming during borohydride quenching; during this process, a precipitate formed, then dissolved, then reformed as the pH was lowered to 6.0. The resulting suspension was concentrated; the insoluble and soluble portions of the concentrated 4 M hydroxide extract were separated with centrifugation (15,000×g, 15 min), yielding fractions seven and eight, respectively. Fractions were dialyzed and dried with lyophilization. Note that after each extraction, sodium azide was added to a final concentration of 0.05% prior to concentration and dialysis.

Purification of pea fiber arabinan (PFABN): Characterization of pea fiber fractions—Each of the eight fractions was resuspended in water (1 mg/mL) by heating to 90° C. and sonication (Branson Sonifer). Insoluble material was removed by centrifugation (18,000×g, 5 minutes). The soluble material was assayed for protein content (bicinchoninic acid assay; Thermo Scientific; Cat. No.: 23227) using bovine serum albumin as a standard, DNA content (UV-visible absorbance spectroscopy, Denovix DS-11 spectrophotometer) and total carbohydrate content (phenol-sulfuric acid assay, Masuko et al., 2005) using D-glucose as a standard (Table 18). The molecular size of each fraction was measured using an Agilent 1260 high performance liquid chromatography (HPLC) system equipped with an evaporative light scattering detector. An Agilent Bio Sec-5 column (Cat. No.: 5190-2526) and guard were used with water as the mobile phase. Unbranched pullulan was used as length standards (Shodex; Cat. No.: Standard P-82). The monosaccharide composition of each fraction was measured using polysaccharide methanolysis followed by GC-MS (Doco et al., 2001). [1,2,3,4,5,6-²H]-Myo-inositol (CDN Isotopes; Cat. No.: D3019) was used as an internal standard. Two-fold dilutions of free monosaccharide standards (L-arabinose, D-galactose, D-galacturonic acid, D-glucose, D-glucuronic acid, D-mannose, D-rhamnose, D-xylose) were simultaneously derivatized and used to quantify the absolute abundance of each monosaccharide in each fraction. GC-MS peaks were quantified using metaMS (Wehrens et al., 2014). Glycosyl linkage analysis was performed on fractions five, seven, and eight at the Complex Carbohydrate Research Center (University of Georgia) employing previously described methods (Anumula and Taylor, 1992). Fraction eight was enriched in arabinan and designated PFABN.

TABLE 18

| | | | | % Protein | % Carbohydrate | | |
|---|---|---|---|---|---|---|---|
| | | Yield | % | (BCA; | (Phenol/Sulfuric | HPLC | Size |
| Fraction | Fraction | (mg) | Yield | mg/mg) | Acid; mg/mg) | Peaks | (kDa) |
| 1 | Oxalate precipitate | 29.3 | 1.5 | 5.8 | 17.5 | 1 | >200 |
| 2 | Oxalate soluble | 17.9 | 0.9 | 2.9 | 7.0 | 1 | >200 |
| 3 | Carbonate precipitate | 37.6 | 1.9 | 11.1 | 7.1 | 1 | >200 |
| 4 | Carbonate soluble | 40.1 | 2.0 | 41.7 | 15.1 | 1 | >200 |
| 5 | 1M KOH insoluble | 99 | 5.0 | 3.6 | 102.5 | 1 | >200 |
| 6 | 1M KOH soluble | 29.4 | 1.5 | 22.8 | 38.9 | 1 | >200 |
| 7 | 4M KOH insoluble | 99.5 | 5.0 | 0.9 | 77.0 | 1 | >200 |
| 8 | 4M KOH soluble | 181.2 | 9.1 | 2.0 | 80.7 | 1 | >200 |

Purification of pea fiber arabinan (PFABN): Procedure for scaled up isolation of PFABN—The isolation procedure described above was slightly modified to recover gram quantities of PFABN. Raw pea fiber was resuspended at 50 mg/mL in 1 M potassium hydroxide containing 0.5% (wt:wt) sodium borohydride and stirred at room temperature for 24 hours. The suspension was centrifuged (3,900×g, 20 minutes) and the supernatant was discarded. The pellet from the 1M potassium hydroxide extraction was resuspended in 4 M potassium hydroxide containing 0.5% (wt:wt) sodium borohydride (50 mg/mL), and stirred at room temperature for 24 hours. The suspension was centrifuged and the supernatant was collected and neutralized with 4 M acetic acid. Neat ethanol was added [7.5:1 (vol:vol)] and polysaccharide was precipitated at −20° C. Precipitated polysaccharide was isolated by centrifugation (3,900×g, 20 minutes), and rinsed with 250 mL of 80% ethanol (4° C.) three times. The pellet was dried overnight under a dry nitrogen stream. The entire procedure was repeated five times to isolate 51 grams of PFABN (overall yield 22%). Isolated PFABN was pulverized (Spex SamplePrep Freezer/Mill; Metuchen, N.J.; Model 6870) and total carbohydrate content was defined (phenol-sulfuric acid assay).

Gas chromatography-mass spectrometry of neutral monosaccharide composition—Purified PFABN was suspended in water at a concentration of 1 mg/mL and transferred to 8 mm crimp top glass vials (Fisher Scientific; Cat. No.: C4008-632C). 1754 of 2 M trifluoroacetic acid containing 15 ng of D6-myo-inositol was added and the vials were capped with Teflon-coated aluminum caps (Fisher Scientific; Cat. No.: C4008-2A). PFABN was hydrolyzed for 2 hours at 95° C. Samples were then centrifuged (3,200×g, 5 minutes), the supernatant was transferred to a new glass vial and the material was dried under reduced pressure. Samples were subsequently oximated by adding 20 μL of methoxyamine (15 mg/mL pyridine) and incubating the solution overnight at 37° C. 20 μL of MSTFA (N-methyl-N-trimethylsilyltrifluoroacetamide plus 1% TCMS (2,2,2-trifluoro-N-methyl-N-(trimethylsilyl)-acetamide, chlorotrimethylsilane) (Thermo Scientific; Cat. No.: TS-48915) were added and the solution was incubated at 70° C. for one hour. The material was subsequently diluted with 20 heptane before analysis using an Agilent 7890A gas chromatography system coupled with an Agilent 5975C mass spectrometer detector. Employing L-arabinose, D-galactose, D-glucose, D-mannose, D-rhamnose, D-xylose standards, peaks were identified and quantified using metaMS (Wehrens et al., 2014); peak areas were corrected using a D6-myo-inositol standard and quantified using linear fits of two-fold diluted standards.

PFABN linkage analysis—PFABN was enzymatically de-starched using amyloglucosidase and □-amylase (Megazyme; Cat. No. E-AMGFR and E-PANAA, respectively). To do so, PFABN was first resuspended by heating at 95° C. in a solution containing 50 mM sodium malate (pH=6) and 2 mM calcium chloride (5 mg/mL). Based on the manufacturer's measurement of the specific activities of these two enzymes, we added an amount that should be sufficient to degrade all starch within the PFABN fraction within one minute; nonetheless, we allowed degradation to proceed for 4 hours at 37° C. before terminating the reaction by incubation at 95° C. for 20 minutes. Polysaccharide was dialyzed extensively against water and dried by lyophilization. Complete digestion of starch was confirmed with GC-MS analysis of neutral monosaccharides.

Glycosyl-linkage analysis was performed on the de-starched PFABN at the Complex Carbohydrate Research Center (University of Georgia) using previously described methods (Anumula and Taylor, 1992). Briefly, polysaccharide (1 mg) was taken up in dimethyl sulfoxide, permethylated in the presence of NaOH base, hydrolyzed for 2 hours in 2 M trifluoroacetic acid at 121° C., reduced overnight with sodium borohydride and acetylated with acetic anhydride and pyridine. Inositol was used as an internal standard. The resulting partially methylated alditol acetates were analyzed by GC-MS [HP-5890 instrument interfaced with a 5970 mass selective detector using a SP2330 capillary column (30×0.25 mm ID, Supelco) and a temperature program of 60° C. for 1 min, increasing to 170° C. at 27.5° C./minute, and to 235° C. at 4° C./minute with a 2-minute hold, and finally to 240° C. at 3° C./minute with 12-minute hold]. Sugar beet arabinan (Megazyme; Cat. No. P-ARAB) was analyzed simultaneously. The resulting linkage data are presented in Table 16.

Generation of microbiota functional activity biosensors: Synthesis of amine phosphonate beads—Paramagnetic, 10 μm-diameter glass beads (Millipore Sigma; Cat. No.: LSKMAGN01) were incubated at 23° C. overnight in a solution of 20 mM HEPES (pH 7.4) and 100 mM NaCl. Equal molar amounts of (3-aminopropyl)triethoxysilane (ATPS; Sigma Aldrich, Cat. No. 440140) and 3-(trihydroxysilyl)propyl methylphosphonate (THPMP; Sigma Aldrich, Cat. No. 435716) were subsequently added to a suspension of hydrolyzed NHS-ester-activated beads in deionized water (Bagwe et al, 2006; Soto-Cantu and Russo et al, 2012). Beads were derivatized at a density of 5×10⁶/mL and the organosilane reagents were included at 1000-fold excess of what would be required to coat the bead surface (based on 4 silane molecules per nm²; Soto-Cantu and Russo, 2012). The reaction was allowed to proceed for 5 hours at 50° C. with shaking and then terminated with three cycles of washing in water (using a magnet to recover the beads after each wash cycle). Beads were stored at 4° C. in a sterile solution of 20 mM HEPES (pH 7.2) and 100 mM NaCl.

Bead Zeta potential was measured to characterize the extent of modification of the bead surface; Zeta potential was determined for beads reacted with organosilane reagents and beads subjected to surface amine acetylation. Zeta potential measurements were made on a Malvern ZEN3600 instrument using disposable zeta potential cuvettes (Malvern). Beads were resuspended to a concentration of 5×10⁵/mL in 10 mM HEPES (pH 7.2) passed through a 0.22 μm filter (Millipore) and analyzed in triplicate. Measurements were obtained with the default settings of the instrument, using the refractive index of SiO₂ as the material and water as the dispersant.

Generation of microbiota functional activity biosensors: Amine phosphonate bead acetylation—Beads were washed repeatedly with multiple solvents with the goal of resuspending the beads in anhydrous methanol; to do so, beads were washed in water, then methanol, then anhydrous methanol (1 volume equivalent; 5×10⁶ beads/mL). Pyridine (0.5 volume equivalents) was then added as a base followed by acetic anhydride (0.5 volume equivalents). The reaction was allowed to proceed for 3 hours at 22° C. and then terminated by repeated washing in water. Beads were stored in 20 mM HEPES (pH 7.2) and 100 mM NaCl at 4° C.

Generation of microbiota functional activity biosensors: Fluorophore labeling of amine plus phosphonate beads—Beads were labeled with the following N-hydroxysuccinimide ester (NHS)-activated fluorophores: (i) Alexa Fluor 488 NHS ester (Life Technologies; Cat. No.: A20000); (ii) Promofluor 415 NHS ester (PromoKine; Cat. No.: PK-PF415-1-01); (iii) Promofluor 633P NHS ester (PromoKine; Cat. No.: PK-PF633P-1-01) and (iv) Promofluor 510-LSS NHS ester (PromoKine; Cat. No.: PK-PF510LSS-1-01). NHS-activated fluorophores were dissolved in dimethyl sulfoxide (DMSO) at 1 mM. The stock solution of each fluorophore was diluted in DMSO to 10 μM. The fluorophore was conjugated to amine plus phosphonate beads in 20 mM HEPES (pH 7.2) and 100 mM NaCl (3×10⁶ beads/mL reaction; final concentration of fluorophore in the reaction, 100 nM). The reaction was allowed to proceed for 50 minutes at 22° C. and then terminated by repeated washing with water. Beads were stored in 20 mM HEPES (pH 7.2) and 100 mM NaCl at 4° C.

Generation of microbiota functional activity biosensors: Polysaccharide conjugation to fluorophore-labeled amine plus phosphonate beads—Polysaccharides were resuspended at a concentration of 5 mg/mL in 50 mM HEPES (pH 7.8) using heat and sonication. Trimethylamine (TEA, 0.5 equivalent), and 1-cyano-4-dimethylaminopyridinium tetrafluoroborate (CDAP; 1 eq; Sigma Aldrich; Cat. No.: RES1458C) dissolved in DMSO (50 mg/mL) were added to the polysaccharide solution. The optimal concentration of CDAP for polysaccharide activation, without overactivation and aggregation was found to be 0.2 mg/mg of polysaccharide. The polysaccharide/TEA/CDAP solution was mixed for 2 minutes at 22° C. to allow for polysaccharide activation. Fluorophore-labeled amine plus phosphonate beads resuspended in 50 mM HEPES (pH 7.8) were added to the activated polysaccharide solution and the reaction was allowed to proceed for 15 hours at 22° C. (final polysaccharide concentration typically 3.5 mg/mL). Any aggregated beads were disrupted by gentle sonication. Polysaccharide-conjugated beads were reduced by adding 2-picoline borane (1 eq; Sigma Aldrich; Cat. No.: 654213) dissolved in DMSO (10% wt:wt) and incubating the mixture for 40 minutes at 40° C. The reaction was terminated with repeated washing with water. Beads were stored in 20 mM HEPES (pH 7.2) and 100 mM NaCl at 4° C.

Beads were counted using flow cytometry. Typically, 5 μL of a polysaccharide-coated bead solution were added to 200 μL of HNTB [20 mM 4-(2-hydroxyethyl)-1-piperazineethanesulfonic acid (HEPES) (pH=7.4), 100 mM NaCl, 0.01% bovine serum albumin (wt:wt), and 0.01% Tween-20 (wt:wt)] containing CountBright Absolute Counting Beads (Thermo Scientific; Cat. No. C36950). Beads were analyzed using flow cytometry on a FACSAriaIII instrument (BD Biosciences).

Generation of microbiota functional activity biosensors: Quantification of bead-bound polysaccharide—Polysaccharide-degradation from beads was quantified by GC-MS as described above with the following modifications. Polysaccharide-coated beads were counted using flow cytometry. Beads for hydrolysis were transferred to a 96-well skirted PCR plate (Multimax; Cat. No.: 2668; 3-7×10⁴ beads/well) and washed three times in water using a magnet. Beads were resuspended in 175 μL of 2M trifluoroacetic acid containing 15 ng of D6-myo-inositol as an internal standard, and then transferred into 8 mm crimp top glass vials. An aliquot was removed from the vial and flow cytometry was used to determine the number of beads that had been transferred to that vial. The quantity of monosaccharide released from a bead was determined from the linear fit of standards divided by the number of beads transferred into the hydrolysis vial. For quantifying relative polysaccharide degradation, the absolute amount of monosaccharide released from the bead surface was divided by the mass of that monosaccharide quantified on input beads (with results expressed as a percentage).

In vitro growth assays—Bacterial stocks, previously stored at −80° C., were struck onto Brain-heart infusion (BHI; Becton Dickinson) agar plates supplemented with 10% (vol:vol) horse blood. Plates were incubated in an anaerobic growth chamber (Coy Laboratory Products; atmosphere 3% hydrogen, 20% CO2, and 77% N2). Single colonies were picked and grown overnight on a defined Bacteroides minimal medium (McNulty and Gordon, 2013) containing 5 mg/mL D-glucose. Bacteria were then diluted 1:500 (vol:vol) into Bacteroides minimal medium supplemented with a carbon source at a final concentration of 0.5% (wt:wt), and distributed into the wells of a 96-well half-area plate (Costar; Cat. No.; 3696). Plates were sealed with an optically clear membrane (Axygen; Cat. No.; UC500) and growth at 37° C. was monitored by measuring optical density at 600 nm every 15 minutes (Biotek Eon instrument with a BioStack 4). Carbon sources tested include D-glucose, PFABN, SBABN and glucomannan (Megazyme; Cat. No.; P-GLCML). All conditions were tested in quadruplicate. Readings obtained from control wells inoculated with bacteria but lacking a carbon source were averaged, and subtracted from data obtained from carbon-supplemented cultures to generate background subtracted OD600 growth curves.

Gnotobiotic mouse experiments: Colonization—Germ-free male C57BL/6J mice were maintained within flexible plastic isolators under a strict 12 h light cycle (lights on a 0600) and fed an autoclavable mouse chow (Envigo; Cat. No.: 2018S). Animals were colonized with a 14-member microbial community of cultured, sequenced bacterial strains composed of a mixture of type strains [or their Tn mutant library equivalent (Wu et al, 2015; Hibberd et al, 2017)] and strains isolated from the lean co-twin of an obesity discordant twin pair [Twin Pair 1 in Ridaura et al., 2013)]. Bacterial strains were grown to early stationary phase in gut microbiota medium (GMM) or LYBHI medium (Goodman et al., 2011). Monocultures were stored at −80° C. after addition of an equal volume of PBS (pH 7.4) supplemented with 30% glycerol (vol:vol). Gavage pools were prepared (2×10⁶ CFUs per strain; equal volumes of each INSeq library) and introduced into mice using a plastic tipped oral gavage needle. Animals receiving communities with Tn mutant libraries were individually housed in cages containing cardboard shelters (for environmental enrichment).

Five days prior to colonization, mice were switched to a HiSF-LoFV diet. This diet was produced using human foods as described (Ridaura et al., 2013), freeze-dried and milled (D90 particle size 980 μm). The milled diet and each of the three diet supplements, were weighed, and transferred (separately) into sterile screw top containers (Fisher Scientific; Cat. No.; 22-150-244). Diets were sterilized by gamma irradiation (20-50 kilogreys, Steris, Mentor, OH). Sterility was confirmed by culturing material in TYG medium under aerobic and anaerobic conditions. The HiSF-LoFV diet and supplement were combined after transfer into gnotobiotic isolators [raw pea fiber at 10% (wt:wt); PFABN at 2% (wt:wt) and SBABN at 2% (wt:wt)]. Diets were mixed into a paste after adding sterile water (15 mL/30 g of diet). The paste was pressed into a small plastic tray and placed on the floor of the cage. Fresh diet was introduced every two days and in sufficient quantity to allow access ad libitum. Autoclaved bedding (Aspen wood chips; Northeastern Products) was changed at least weekly and immediately following a diet switch.

Gnotobiotic mouse experiments: Gavage and recovery of polysaccharide-coated beads from mice—Each bead type was individually sterilized by washing in 70% ethanol (vol:vol) twice on a magnetic tube stand before resuspension in HNTB. A pool of 10-15×10⁶ beads (2.5-3.75×10⁶ per bead type) in 400 μL of HNTB was prepared for each mouse; 350 μL of the pool were introduced by oral gavage; the remaining 50 □L was analyzed as the input beads (see above). Beads were isolated from the cecums of mice four hours after gavage or from all fecal pellets that had been collected from a given animal during the 3- to 6-hour period following gavage.

Recovered beads were resuspended in 10 mL of HNTB by pipetting and subsequently by vortexing. The resulting slurry was passed through a 100 μm nylon filter (Corning; Cat. No.: 352360). Beads were isolated from the suspension by centrifugation (500×g, 5 minutes) through Percoll Plus (GE Healthcare; Cat. No.: 17544502) in a 50 mL conical tube. Beads were recovered from the bottom of the tube; recovered beads from each animal were distributed into four 1.5 mL sterile tubes and washed at least three times with HNTB on a magnetic tube stand until macroscopic particulate debris from intestinal contents were no longer observed. The material from four tubes were subsequently recombined and beads were stored in HNTB containing 0.01% (wt:wt) sodium azide at 4° C.

Bead types were purified by fluorescence-activated sorting (FACSAriaIII; BD Biosciences). Aliquots of input beads were sorted throughout the procedure to quantify and monitor sort yield and purity. Bead purity typically exceeded 98%. Sorted beads were centrifuged (1,500×g, 5 minutes), the supernatant was aspirated, and beads were transferred into a 0.2 mL 96-well skirted PCR plate. Beads were washed with HNTB using a magnetic plate holder and stored at 4° C. in HNTB plus 0.01% (wt:wt) sodium azide until analysis. Beads were subjected to acid hydrolysis of the bound polysaccharide and the amount of liberated neutral monosaccharides was determined by GC-MS. All samples of a given bead type were analyzed in the same GC-MS run; however, the order of analysis of a given bead type recovered from animals representing different treatment groups was randomized. If sufficient beads were available, each bead type from each animal was analyzed up to three times.

Gnotobiotic mouse experiments: COmmunity PROfiling by sequencing (COPRO-Seq)—DNA was isolated from fecal samples by bead beading with 250 μL 0.1 mm zirconia/silica beads and one 3.97 mm steel ball in 500 μL of 2× buffer A (200 mM Tris, 200 mM NaCl, 20 mM EDTA), 210 μL 20% (wt:wt) sodium dodecyl sulfate, and 500 μL of phenol:chloroform:amyl alcohol (pH 7.9; 25:24:1) for four minutes. 420 μL of the aqueous phase was removed; DNA was purified (QIAquick 96 PCR purification kit; Qiagen) according to the manufacture's protocol and eluted into 10 mM Tris-HCl (pH 8.5). Sequencing libraries were prepared from purified DNA by tagmentation with the Nextera DNA Library Prep Kit (Illumina; Cat. No.: 15028211) and custom barcoded primers (Adey et al., 2010). Libraries were sequenced (Illumina Nextseq instrument, 75-nt unidirectional reads) to a depth 1×10⁶ reads per sample. Reads were demultiplexed and mapped to community member bacterial genomes, 2 ‘spiked-in’ bacterial genomes for absolute abundance calculation, and 2 ‘distractor’ genomes [Faecalibacterium prausnitzii; GenBank assembly accession: GCA_902167865.1; Bifidobacterium longum subsp. infantis; GenBank assembly accession: GCA 902167615.1; Raman et al., 2019], using custom Perl scripts adapted to use Bowtie 2 (Langmead and Salzberg, 2012) (https://gitlab.com/hibberdm/COPRO-Seq).

To calculate bacterial absolute abundance, an aliquot containing a known number of two bacteria strains not encountered in mammalian gut communities or in the diet was ‘spiked-in’ to each fecal sample prior to DNA extraction (Stammler et al., 2016) [30 μL of a 2.22×10⁸ cells/mL suspension of Alicyclobacillus acidiphilus DSM 14558 (GenBank assembly accession: GCA_001544355.1) and 30 μL of a 9.93×10⁸ cells/mL suspension of Agrobacterium radiobacter DSM 30147 (GenBank assembly accession: GCA_000421945.1); Wolf et al., 2019]. COPRO-Seq provides an output counts table that is normalized to the informative genome size of each bacterial genome; this is used to generate a normalized relative abundance table. The calculated relative abundances of the spike-in genomes were 0.40±0.19% and 0.29%±0.16 (mean±s.d.), respectively. For a given taxa i, in sample j, the absolute abundance in genome equivalents per gram of feces was calculated using the normalized relative abundance and the A. acidophilus spike-in (A.a):

$${taxa}_{i , j} = \frac{rel {abundance}_{i , j}}{rel abundance A . {a}_{j}} \times \frac{A . a cells added to {sample}_{j}}{sample mass {( g )}_{j}}$$

To identify bacterial taxa that respond to each diet treatment, absolute abundance data from fecal samples collected after diet supplementation were fit using a linear mixed effects model (Ime4 package; Bates et al., 2015). The dependence of bacterial abundance on ‘diet by day’ was tested. ‘Animal’ was included as a random variable. Tukey HSD p-values from the linear models were corrected for multiple hypotheses (Benjamini and Hochberg, 1995). Estimated marginal means were calculated from linear models (emmeans package) of absolute abundances for each diet group. To simplify visualization of the effects of each diet supplement, estimated marginal mean values were expressed as a ratio of the marginal mean of all mice prior to the diet switch on dpg2. Diet-responsive bacterial strains were defined as those whose absolute abundance was significantly different [p<0.01, linear mixed-effects model (Gaussian); two-way ANOVA with Tukey's HSD, FDR-corrected] in 3 of the 6 total diet comparisons [i.e., (i) HiSF-LoFV vs pea fiber, (ii) HiSF-LoFV vs PFABN, (iii) HiSF-LoFV vs SBABN, (iv) pea fiber vs PFABN, (v) pea fiber vs SBABN, or (vi) PFABN vs SBABN], and the estimated marginal mean of the diet effect was greater than 1.5 for at least one diet-supplemented group.

Tn insertion site sequencing (INSeq)—Multi-taxon INSeq (Wu et al., 2015) was used to simultaneously measure genetic fitness determinants in five Bacteroides sp. (four of which were identified as fiber responsive). Briefly, Mmel digestion cleaves genomic DNA at a site 20-21 bp distal to the restriction enzyme's recognition sequence in the mariner transposon vector. This flanking genomic DNA, and a taxon-specific barcode inserted into the transposon, allow quantitation of each unique insertion mutant member of a given Bacteroides INSeq library.

Purified fecal DNA was processed as previously described (Wu et al., 2015). Genomic DNA was digested with Mmel, size selected, ligated to sample-specific adapter primers, size selected, amplified by PCR, and a specific 131 bp final product isolated from a 4% (wt:wt) MetaPhore (Lonza) DNA gel. Purified DNA was sequenced, unidirectionally, on an Illumina HiSeq 2500 platform (50-nt reads) using a custom primer that captures the species-specific barcode. Quantitation of each insertion mutant's abundance (read counts) was determined using custom software (https://github.com/mengwu1002/Multi-taxon_analysis_pipeline; Wu et al., 2015). Count data were normalized for library depth (within the same species), a pseudo count of 8 was added, and the data were log₂ transformed. Transformed count data from dpg 2 and dpg 6 were used to build linear models (limma package; Ritchie et al., 2015) to identify diet supplement-specific genes that significantly altered bacterial abundance (relative to unsupplemented HiSF-LoFV diet). P-values from the linear models were corrected for multiple hypotheses with the Benjamini-Hochberg method.

Meta-proteomic analysis—The protocol for meta-proteomic analysis of fecal samples has been described in detail in our previous publications (Patnode et al., 2019). Only data from peptides that uniquely map to a single protein were considered for analysis. Summed peptide abundance data for each protein was log 2 transformed. Missing data was imputed to simulate ‘instrument limit of detection’ by calculating the mean and standard deviation of each protein in samples where a protein was detected in more than three mice within a given treatment group. Missing values were imputed as mean minus 2.2 times the standard deviation with a width equal to 0.3 times the standard deviation. For species where greater than 100 proteins were quantified, data were normalized with cyclic loess normalization (limma package). Loess-normalized protein abundance data were then used to build linear models (limma package) to identify diet-supplement-responsive proteins (relative to levels in control mice receiving the unsupplemented HiSF-LoFV diet) at dpg 6. P-values from the linear models were corrected for multiple hypotheses (Benjamini and Hochberg, 1995).

PULs that were upregulated during diet supplementation were identified using geneset enrichment analysis with GAGE (Luo and Woolf, 2009). PUL gene annotations were identical to those employed in Patnode et al. (2019). All genes within a PUL were annotated as a gene set. We required that more than five quantified proteins change in abundance unidirectionally upon diet supplementation in a given PUL for that PUL to be considered. Significantly enriched PULs were identified using a one-sample Z-test; p-values were corrected for multiple hypotheses with the Benjamini-Hochberg method.

TABLE 19
GC-MS analysis of the mass of monosaccharides bound to the surface of
MFABs prior to and after their introduction into gnotobiotic mice
(A1) beads recovered 4 hours post gavage from the ceca

| Diet group | | Input | | | | | | |
|---|---|---|---|---|---|---|---|---|
| Mouse ID | | Input 1 | Input 2 | Input 3 | Input 4 | Input 5 | Input 6 | mean ± SD |
| Ara | A | 4.52 | 4.77 | 5.02 | 4.79 | 4.88 | 4.88 | 4.81 ± 0.17 |
| | B | 22.77 | 21.88 | 20.67 | 19.58 | 20.83 | 20.83 | 21.09 ± 1.1 |
| | C | 0 | 0.15 | 0.15 | 0.4 | 0 | 0 | 0.12 ± 0.16 |
| Glc | A | 0.69 | 0.82 | 0.53 | 0.54 | 0.57 | 0.57 | 0.62 ± 0.12 |
| | B | 0 | 0 | 0 | 0.21 | 0.37 | 0.37 | 0.16 ± 0.18 |
| | C | 0.01 | 0 | 0 | 0 | 0 | 0 | 0 ± 0.01 |
| Man | A | 0 | 0 | 0 | 0 | 0 | 0 | 0 ± 0 |
| | B | 0 | 0 | 0 | 0 | 0 | 0 | 0 ± 0 |
| | C | 0 | 0 | 0 | 0 | 0 | 0 | 0 ± 0 |
| Gal | A | 0.92 | 1.01 | 1 | 0.97 | 1.12 | 1.12 | 1.02 ± 0.08 |
| | B | 2.06 | 1.95 | 1.95 | 1.89 | 2.21 | 2.21 | 2.05 ± 0.14 |
| | C | 0 | 0 | 0 | 0 | 0 | 0 | 0 ± 0 |
| Rha | A | 0 | 0 | 0 | 0 | 0 | 0 | 0 ± 0 |
| | B | 0.42 | 0.41 | 0.36 | 0.28 | 0.46 | 0.46 | 0.4 ± 0.07 |
| | C | 0 | 0 | 0 | 0 | 0 | 0 | 0 ± 0 |
| Xyl | A | 1.5 | 2.43 | 1.54 | 1.3 | 1.58 | 1.58 | 1.66 ± 0.39 |
| | B | 0 | 0 | 0 | 0 | 0 | 0 | 0 ± 0 |
| | C | 0 | 0 | 0 | 0 | 0 | 0 | 0 ± 0 |

Ara = Arabinose, Glc = glucose, Man = mannose,
Gal = galactose, Rha = rhamnose, Xyl = xylose
Amounts of monosaccharides are pg/bead
A = PFABN-coated beads, B = SBABN-coated beads, C = Acetylated control beads

(A2) beads recovered 4 hours post gavage from the ceca

| Diet group | | HiSF-LoFV | | | | | | HiSF-LoFV + 10% pea fiber | | | | | |
|---|---|---|---|---|---|---|---|---|---|---|---|---|---|
| Mouse ID | | 2.0 | 3.2 | 10.0 | 17.0 | 18.0 | mean ± SD | 1.2 | 4.0 | 6.2 | 12.0 | 15.0 | mean ± SD |
| Ara | A | 1.83 | 2.36 | 2.55 | 1.45 | 1.8 | 2 ± 0.45 | 0.94 | | | | | 1.23 ± 0.36 |
| | B | 13.57 | 11.19 | 9.45 | 11.52 | 17.36 | 12.62 ± 3.03 | 8.1 | 0.96 | 1.49 | 1.73 | 1.03 | 8.05 ± 1.33 |
| | C | 0 | 0.44 | 4.23 | 0 | 0 | 1.17 ± 2.05 | 0.29 | 6.45 | 7.95 | 10.12 | 7.65 | 0.32 ± 0.33 |
| Glc | A | 0.88 | 0.52 | 8.06 | 0.43 | 0.4 | 2.06 ± 3.36 | 0.27 | 0.58 | 0 | 0.71 | 0.41 | 0.4 ± 0.21 |
| | B | 0 | 0 | 0 | 0 | 0 | 0 ± 0 | 0 | 0.25 | 0.77 | 0.4 | 0.29 | 0.12 ± 0.26 |
| | C | 0 | 0 | 2.09 | 0 | 0 | 0.52 ± 1.04 | 0 | 0 | 0.58 | 0 | 0 | 0.03 ± 0.08 |
| Man | A | 0 | 0 | 0 | 0 | 0 | 0 ± 0 | 0 | 0.17 | 0 | 0 | 0.2 | 0 ± 0 |
| | B | 0 | 0 | 0 | 0 | 0 | 0 ± 0 | 0 | 0 | 0 | 0 | 0 | 0 ± 0 |
| | C | 0 | 0 | 0 | 0 | 0 | 0 ± 0 | 0 | 0 | 0 | 0 | 0 | 0.09 ± 0.19 |
| Gal | A | 1.09 | 1.18 | 1.37 | 0.82 | 0.73 | 1.04 ± 0.26 | 0.56 | 0.43 | 0 | 0 | 0 | 0.74 ± 0.21 |
| | B | 2.09 | 1.94 | 1.4 | 1.82 | 2.53 | 1.95 ± 0.41 | 1.67 | 0.59 | 0.89 | 1.03 | 0.65 | 1.66 ± 0.33 |
| | C | 0 | 0 | 0 | 0 | 0 | 0 ± 0 | 0 | 1.37 | 1.63 | 2.2 | 1.44 | 0.15 ± 0.34 |
| Rha | A | 0 | 0 | 0 | 0 | 0 | 0 ± 0 | 0 | 0.76 | 0 | 0 | 0 | 0 ± 0 |
| | B | 0.38 | 0.33 | 0.23 | 0.34 | 0.38 | 0.33 ± 0.06 | 0.29 | 0 | 0 | 0 | 0 | 0.26 ± 0.16 |
| | C | 0 | 0 | 0 | 0 | 0 | 0 ± 0 | 0 | 0.25 | 0.32 | 0.42 | 0 | 0.14 ± 0.32 |
| Xyl | A | 0.56 | 0.93 | 2.63 | 0.23 | 0.26 | 0.92 ± 0.99 | 0.24 | 0.72 | 0 | 0 | 0 | 0.2 ± 0.13 |
| | B | 0 | 0 | 0 | 0 | 0 | 0 ± 0 | 0 | 0.16 | 0.29 | 0.33 | 0 | 0.11 ± 0.25 |
| | C | 0 | 0 | 0 | 0 | 0 | 0 ± 0 | | | | | | 3.58 ± 8 |

Ara = Arabinose, Glc = glucose, Man = mannose,
Gal = galactose, Rha = rhamnose, Xyl = xylose
Amounts of monosaccharides are pg/bead
A = PFABN-coated beads, B = SBABN-coated beads, C = Acetylated control beads

(A3) beads recovered 4 hours post gavage from the ceca

| Diet group | | HiSF-LoFV + 10% pea fiber | | | | | | HiSF-LoFV + PFABN | | | | | |
|---|---|---|---|---|---|---|---|---|---|---|---|---|---|
| Mouse ID | | 1.2 | 4.0 | 6.2 | 12.0 | 15.0 | mean ± SD | 1.0 | 4.2 | 6.0 | 7.2 | 9.2 | mean ± SD |
| Ara | A | 0.94 | 0.96 | 1.49 | 1.73 | 1.03 | 1.23 ± 0.36 | 1.58 | 1.5 | 1.67 | 1.86 | 1.22 | 1.56 ± 0.24 |
| | B | 8.1 | 6.45 | 7.95 | 10.12 | 7.65 | 8.05 ± 1.33 | 8.84 | 7.78 | 8.04 | 10.39 | 10.42 | 9.09 ± 1.26 |
| | C | 0.29 | 0.58 | 0 | 0.71 | 0.41 | 0.32 ± 0.33 | 0 | 0.44 | 1.34 | 0.38 | 0 | 0.52 ± 0.5 |
| Glc | A | 0.27 | 0.25 | 0.77 | 0.4 | 0.29 | 0.4 ± 0.21 | 0.51 | 0.29 | 0.47 | 0.38 | 0.39 | 0.41 ± 0.09 |
| | B | 0 | 0 | 0.58 | 0 | 0 | 0.12 ± 0.26 | 0 | 0 | 0 | 0 | 0 | 0 ± 0 |
| | C | 0 | 0.17 | 0 | 0 | 0.2 | 0.03 ± 0.08 | 0 | 0 | 0 | 0 | 0.04 | 0.04 ± 0.09 |
| Man | A | 0 | 0 | 0 | 0 | 0 | 0 ± 0 | 0 | 0 | 0 | 0 | 0 | 0 ± 0 |
| | B | 0 | 0 | 0 | 0 | 0 | 0 ± 0 | 0 | 0 | 0 | 0 | 0 | 0 ± 0 |
| | C | 0 | 0.43 | 0 | 0 | 0 | 0.09 ± 0.19 | 0 | 0 | 0 | 0 | 0 | 0 ± 0 |
| Gal | A | 0.56 | 0.59 | 0.89 | 1.03 | 0.65 | 0.74 ± 0.21 | 0.95 | 0.87 | 0.81 | 1.17 | 0.79 | 0.92 0.15 ± |
| | B | 1.67 | 1.37 | 1.63 | 2.2 | 1.44 | 1.66 ± 0.33 | 1.57 | 1.4 | 1.56 | 1.96 | 1.85 | 1.67 0.23 ± |
| | C | 0 | 0.76 | 0 | 0 | 0 | 0.15 ± 0.34 | 0 | 0 | 0 | 0 | 0 | 0 ± 0 |
| Rha | A | 0 | 0 | 0 | 0 | 0 | 0 ± 0 | 0 | 0 | 0 | 0 | 0 | 0 ± 0 |
| | B | 0.29 | 0.25 | 0.32 | 0.42 | 0 | 0.26 ± 0.16 | 0.27 | 0.26 | 0.27 | 0.3 | 0.3 | 0.28 0.02 ± |
| | C | 0 | 0.72 | 0 | 0 | 0 | 0.14 ± 0.32 | 0 | 0 | 0 | 0 | 0 | 0 ± 0 |
| Xyl | A | 0.24 | 0.16 | 0.29 | 0.33 | 0 | 0.2 ± 0.13 | 0.48 | 0.4 | 0.43 | 0.56 | 0.26 | 0.43 0.11 ± |
| | B | 0 | 0 | 0 | 0.55 | 0 | 0.11 ± 0.25 | 0 | 0 | 0 | 0 | 0 | 0 ± 0 |
| | C | 0 | 17.88 | 0 | 0 | 0 | 3.58 ± 8 | 0 | 0 | 0 | 0 | 0 | 0 ± 0 |

Ara = Arabinose, Glc = glucose, Man = mannose,
Gal = galactose, Rha = rhamnose, Xyl = xylose
Amounts of monosaccharides are pg/bead
A = PFABN-coated beads, B = SBABN-coated beads, C = Acetylated control beads

(A4) beads recovered 4 hours post gavage from the ceca

| Diet group | | Germ free HiSF-LoFV + 10% pea fiber | | | | | |
|---|---|---|---|---|---|---|---|
| Mouse ID | | 7.0 | 8.2 | 9.0 | 14.0 | 16.0 | mean ± SD |
| Ara | A | 5.35 | 3.99 | — | 7.72 | 7.98 | 6.26 ± 1.92 |
| | B | 28.48 | 19.22 | — | 20.3 | 27.5 | 23.87 ± 4.79 |
| | C | 0.49 | 1.48 | — | 0 | 0.48 | 0.61 ± 0.62 |
| Glc | A | 0.42 | 0.49 | — | 0.72 | 0.62 | 0.57 ± 0.14 |
| | B | 0 | 0 | — | 0 | 0 | 0 ± 0 |
| | C | 0 | 0 | — | 0 | 0 | 0 ± 0 |
| Man | A | 0 | 0 | — | 0 | 0 | 0 ± 0 |
| | B | 0 | 0 | — | 0 | 0 | 0 ± 0 |
| | C | 0 | 0 | — | 0 | 0 | 0 ± 0 |
| Gal | A | 1.31 | 1.18 | — | 1.35 | 1.89 | 1.43 ± 0.31 |
| | B | 2.57 | 2.1 | — | 2.1 | 2.46 | 2.31 ± 0.24 |
| | C | 0 | 0 | — | 0 | 0 | 0 ± 0 |
| Rha | A | 0 | 0 | — | 0 | 0 | 0 ± 0 |
| | B | 0.39 | 0.38 | — | 0.37 | 0 | 0.28 ± 0.19 |
| | C | 0 | 0 | — | 0 | 0 | 0 ± 0 |
| Xyl | A | 1.55 | 0.99 | — | 2.48 | 1.99 | 1.75 ± 0.63 |
| | B | 0 | 0 | — | 0 | 0 | 0 ± 0 |
| | C | 0 | 0 | — | 0 | 0 | 0 ± 0 |

Ara = Arabinose, Glc = glucose, Man = mannose,
Gal = galactose, Rha = rhamnose, Xyl = xylose
Amounts of monosaccharides are pg/bead
A = PFABN-coated beads, B = SBABN-coated beads, C = Acetylated control beads

| (B1) beads recovered 6 hours post gavage from feces | | |
|---|---|---|
| Diet group | Input | HiSF-LoFV |

| Mouse ID | | Input 1 | Input 2 | Input 3 | Input 4 | Input 5 | Input 6 | mean ± SD | 1.1 | 3.1 | 4.1 | 5.1 | 11.0 | mean ± SD |
|---|---|---|---|---|---|---|---|---|---|---|---|---|---|---|
| Ara | A | 1.54 | 1.36 | 1.25 | 1.33 | 1.44 | 1.31 | 1.37 ± 0.1 | 0.67 | 0.64 | 0.73 | 0.7 | 0.7 | 0.69 ± 0.03 |
| | B | 0 | 0 | 0.04 | 0 | 0 | 0 | 0.01 ± 0.02 | 0 | 0 | 0 | 0 | 0.1 | 0.02 ± 0.04 |
| Glc | A | 0.1 | 0.16 | 0.22 | 0.19 | 0.15 | 0.07 | 0.15 ± 0.06 | 0.11 | 0.19 | 0.2 | 0.13 | 0.11 | 0.15 ± 0.05 |
| | B | 0.15 | 0.12 | 0.19 | 0.06 | 0.06 | 0 | 0.1 ± 0.07 | 0.1 | 0 | 0.07 | 0 | 0.18 | 0.07 ± 0.07 |
| Man | A | 0.07 | 0 | 0 | 0 | 0 | 0 | 0.01 ± 0.03 | 0 | 0 | 0 | 0 | 0 | 0 ± 0 |
| | B | 0.08 | 0 | 0 | 0 | 0 | 0 | 0.01 ± 0.03 | 0 | 0 | 0 | 0 | 0 | 0 ± 0 |
| Gal | A | 0.35 | 0.72 | 0.27 | 0.28 | 0.28 | 0.27 | 0.36 ± 0.18 | 0.38 | 0.32 | 0.42 | 0.33 | 0.41 | 0.37 ± 0.05 |
| | B | 0 | 0.08 | 0.06 | 0 | 0 | 0 | 0.02 ± 0.04 | 0 | 0 | 0.08 | 0 | 0 | 0.02 ± 0.03 |
| Rha | A | 0 | 0 | 0 | 0 | 0 | 0 | 0 ± 0 | 0 | 0 | 0 | 0 | 0 | 0 ± 0 |
| | B | 0 | 0 | 0 | 0 | 0 | 0 | 0 ± 0 | 0 | 0 | 0 | 0 | 0 | 0 ± 0 |
| Xyl | A | 0.6 | 0.33 | 0.31 | 0.31 | 0.35 | 0.28 | 0.36 ± 0.12 | 0.09 | 0 | 0.09 | 0 | 0 | 0.04 ± 0.05 |
| | B | 0.09 | 0.17 | 0.25 | 0.11 | 0.06 | 0.07 | 0.13 ± 0.07 | 0.13 | 0.2 | 0.06 | 0.1 | 0.23 | 0.15 ± 0.07 |

Ara = Arabinose, Glc = glucose, Man = mannose,
Gal = galactose, Rha = rhamnose, Xyl = xylose
Amounts of monosaccharides are pg/bead
A = PFABN-coated beads, B = Acetylated control beads

(B3) beads recovered 6 hours post gavage from feces

| Diet group | | HiSF-LoFV + pea fiber | | | | | | HiSF-LoFV + PFABN | | | | | | |
|---|---|---|---|---|---|---|---|---|---|---|---|---|---|---|
| Mouse ID | | 2.1 | 8.0 | 11.12 | 15.0 | 17.0 | mean ± SD | 2.5 | 7.0 | 9.0 | 10.0 | 13.0 | 13.5 | mean ± SD |
| Ara | A | 0.57 | 0.57 | 0.52 | 0.49 | 0.55 | 0.54 ± 0.04 | 0.58 | 0.7 | 0.5 | 0.61 | 0.89 | 0.51 | 0.63 ± 0.15 |
| | B | 0 | 0 | 0 | 0 | 0 | 0 ± 0 | 0 | 0 | 0 | 0 | 0 | 0.08 | 0.01 ± 0.03 |
| Glc | A | 0.23 | 0 | 0.19 | 0 | 0.12 | 0.11 ± 0.1 | 0.28 | 0.3 | 0.23 | 0.15 | 0.32 | 0.1 | 0.23 ± 0.09 |
| | B | 0.16 | 0.1 | 0.06 | 0.25 | 0 | 0.11 ± 0.09 | 0.22 | 0.08 | 0 | 0.1 | 0.22 | 0.09 | 0.12 ± 0.09 |
| Man | A | 0 | 0 | 0 | 0 | 0 | 0 ± 0 | 0.12 | 0 | 0 | 0 | 0.18 | 0 | 0.05 ± 0.08 |
| | B | 0 | 0 | 0 | 0 | 0 | 0 ± 0 | 0 | 0 | 0 | 0 | 0 | 0.09 | 0.01 ± 0.04 |
| Gal | A | 0.33 | 0.31 | 0.31 | 0.26 | 0.35 | 0.31 ± 0.03 | 0.37 | 0.52 | 0.35 | 0.44 | 0.69 | 0.34 | 0.45 ± 0.14 |
| | B | 0 | 0 | 0 | 0 | 0 | 0 ± 0 | 0 | 0 | 0 | 0 | 0.08 | 0.11 | 0.03 ± 0.05 |
| Rha | A | 0 | 0 | 0 | 0 | 0 | 0 ± 0 | 0 | 0 | 0 | 0 | 0 | 0 | 0 ± 0 |
| | B | 0 | 0 | 0 | 0 | 0 | 0 ± 0 | 0 | 0 | 0 | 0 | 0 | 0 | 0 ± 0 |
| Xyl | A | 0.08 | 0 | 0.06 | 0 | 0.08 | 0.05 ± 0.04 | 0.19 | 0.22 | 0.11 | 0.15 | 1.21 | 0.07 | 0.33 ± 0.44 |
| | B | 0.12 | 0.08 | 0.09 | 0 | 0 | 0.06 ± 0.05 | 0.35 | 0.09 | 0 | 0.29 | 0.29 | 0.23 | 0.21 ± 0.14 |

Ara = Arabinose, Glc = glucose, Man = mannose,
Gal = galactose, Rha = rhamnose, Xyl = xylose
Amounts of monosaccharides are pg/bead
A = PFABN-coated beads, B = Acetylated control beads

(B3) beads recovered 6 hours post gavage from feces

| Diet group | | HiSF-LoFV + SBABN | | | | | | |
|---|---|---|---|---|---|---|---|---|
| Mouse ID | | 1.5 | 3.5 | 4.5 | 5.5 | 14.0 | 16.0 | mean ± SD |
| Ara | A | 0.61 | 0.57 | 0.52 | 0.58 | 0.52 | 0.53 | 0.55 ± 0.04 |
| | B | 0 | 0 | 0 | 0 | 0 | 0 | 0 ± 0 |
| Glc | A | 0.25 | 0.25 | 0.28 | 0.24 | 0.23 | 0.2 | 0.24 ± 0.03 |
| | B | 0.09 | 0.21 | 0 | 0 | 0 | 0.26 | 0.09 ± 0.12 |
| Man | A | 0.12 | 0 | 0 | 0 | 0 | 0 | 0.02 ± 0.05 |
| | B | 0 | 0 | 0 | 0 | 0 | 0 | 0 ± 0 |
| Gal | A | 0.53 | 0.44 | 0.31 | 0.33 | 0.37 | 0.36 | 0.39 ± 0.08 |
| | B | 0 | 0 | 0 | 0 | 0 | 0.12 | 0.02 ± 0.05 |
| Rha | A | 0 | 0 | 0 | 0 | 0 | 0 | 0 ± 0 |
| | B | 0 | 0 | 0 | 0 | 0 | 0 | 0 ± 0 |
| Xyl | A | 0.39 | 0 | 0.67 | 0.19 | 0 | 0 | 0.21 ± 0.27 |
| | B | 0 | 0.19 | 0 | 0 | 0.15 | 0.28 | 0.1 ± 0.12 |

| | Ara = Arabinose, Glc = glucose, Man = mannose, | |
|---|---|---|
| | Gal = galactose, Rha = rhamnose, Xyl = xylose | |
| | Amounts of monosaccharides are pg/bead | |
| | A = PFABN-coated beads, B = Acetylated control beads | |
| (C1) beads recovered 4 hours post gavage from the ceca | | |
| | Diet group | Input beads |

| Mouse ID | | Input 1 | Input 2 | Input 3 | Input 4 | Input 5 | Input 6 | mean ± SD |
|---|---|---|---|---|---|---|---|---|
| Ara | A | 3.2 | 2.78 | 2.73 | 2.51 | 2.54 | 2.95 | 2.78 ± 0.26 |
| | B | 0.09 | 0.14 | 0.15 | 0.17 | 0 | 0.15 | 0.12 ± 0.06 |
| | C | 2.68 | 2.31 | 2.44 | 2.18 | 2.58 | 2.87 | 2.51 ± 0.25 |
| | D | 0.03 | 0.06 | 0.06 | 0.02 | 0 | 0.12 | 0.05 ± 0.04 |
| Glc | A | 0.46 | 0.34 | 0.25 | 0.31 | 0.32 | 0.58 | 0.38 ± 0.12 |
| | B | 0.88 | 0.85 | 1.3 | 2.02 | 0.96 | 1.19 | 1.2 ± 0.44 |
| | C | 0.95 | 0.61 | 0.79 | 0.65 | 0.72 | 0.79 | 0.75 ± 0.12 |
| | D | 0.18 | 0.44 | 0.21 | 0.16 | 0.12 | 0.41 | 0.26 ± 0.14 |
| Man | A | 0.08 | 0 | 0 | 0 | 0 | 0.12 | 0.03 ± 0.05 |
| | B | 1.06 | 1.12 | 1.42 | 1.35 | 1.19 | 1.27 | 1.24 ± 0.14 |
| | C | 0.9 | 0.66 | 0.85 | 0.69 | 0.72 | 0.83 | 0.78 ± 0.1 |
| | D | 0 | 0 | 0 | 0.03 | 0 | 0.21 | 0.04 ± 0.08 |
| Gal | A | 0.44 | 0.42 | 0.43 | 0.36 | 0.35 | 0.43 | 0.4 ± 0.04 |
| | B | 0.23 | 0.25 | 0.32 | 0.29 | 0.25 | 0.3 | 0.27 ± 0.04 |
| | C | 0.54 | 0.45 | 0.51 | 0.43 | 0.51 | 0.56 | 0.5 ± 0.05 |
| | D | 0 | 0 | 0 | 0.21 | 0 | 0 | 0.03 ± 0.09 |
| Rha | A | 0.18 | 0 | 0.08 | 0.15 | 0.15 | 0.25 | 0.14 ± 0.09 |
| | B | 0 | 0 | 0 | 0 | 0 | 0 | 0 ± 0 |
| | C | 0 | 0 | 0 | 0 | 0 | 0 | 0 ± 0 |
| | D | 0 | 0 | 0 | 0 | 0 | 0 | 0 ± 0 |
| Xyl | A | 0.66 | 0.64 | 0.54 | 0.39 | 0.38 | 0.89 | 0.58 ± 0.19 |
| | B | 0.24 | 0.15 | 0.42 | 1.77 | 0 | 0.66 | 0.54 ± 0.65 |
| | C | 0.37 | 0.32 | 0.48 | 0.29 | 0.41 | 0.44 | 0.39 ± 0.07 |
| | D | 0.13 | 0.15 | 0.68 | 0.22 | 0.07 | 0.5 | 0.29 ± 0.24 |

| | Ara = Arabinose, Glc = glucose, Man = mannose, | |
|---|---|---|
| | Gal = galactose, Rha = rhamnose, Xyl = xylose | |
| | Amounts of monosaccharides are pg/bead | |
| | A = PFABN-coated beads, | |
| | B = GlcMan-coated beads, C = PFABN & GlcMan-coated | |
| | beads, D = Acetylated control beads | |
| (C2) beads recovered 4 hours post gavage from the ceca | | |
| | Diet group | HiSF-LoFV |

| Mouse ID | | 01.0 | 02.0 | 03.0 | 04.0 | 05.0 | 06.0 | 07.0 | 08.0 | mean ± SD |
|---|---|---|---|---|---|---|---|---|---|---|
| Ara | A | 1.88 | 1.93 | 1.71 | 1.61 | 1.74 | 2.13 | 2.05 | 1.64 | 1.84 ± 0.19 |
| | B | 0.19 | 0.18 | 0.16 | — | 0.11 | 0.21 | 0.16 | 0.22 | 0.18 ± 0.04 |
| | C | 1.85 | 2.51 | 2.42 | — | 2.58 | 1.87 | 2.31 | 2.31 | 2.26 ± 0.29 |
| | D | 0 | 0.03 | 0 | 0 | 0.02 | 0.06 | 0 | 0.08 | 0.02 ± 0.03 |
| Glc | A | 0.16 | 0.4 | 0.3 | 0.47 | 1.22 | 0.54 | 0.54 | 0.35 | 0.5 ± 0.32 |
| | B | 0.63 | 0.69 | 0.58 | — | 0.31 | 0.55 | 0.56 | 0.55 | 0.55 ± 0.12 |
| | C | 0.58 | 0.51 | 0.78 | — | 1.49 | 0.47 | 0.46 | 0.55 | 0.69 ± 0.37 |
| | D | 0.25 | 0.21 | 0.06 | 0.11 | 0.05 | 0.15 | 0.16 | 0.18 | 0.15 ± 0.07 |
| Man | A | 0 | 0 | 0 | 0 | 0.12 | 0.16 | 0 | 0.08 | 0.04 ± 0.07 |
| | B | 0.5 | 0.53 | 0.48 | — | 0.35 | 0.49 | 0.55 | 0.5 | 0.49 ± 0.06 |
| | C | 0.53 | 0.47 | 0.53 | — | 0.55 | 0.41 | 0.41 | 0.45 | 0.48 ± 0.06 |
| | D | 0 | 0 | 0 | 0 | 0 | 0 | 0 | 0 | 0 ± 0 |
| Gal | A | 0.36 | 0.47 | 0.41 | 0.45 | 0.53 | 0.61 | 0.53 | 0.39 | 0.47 ± 0.08 |
| | B | 0.4 | 0.37 | 0.32 | — | 0.27 | 0.71 | 0.36 | 0.4 | 0.4 ± 0.14 |
| | C | 0.49 | 0.59 | 0.55 | — | 0.65 | 0.47 | 0.52 | 0.53 | 0.54 ± 0.06 |
| | D | 0 | 0 | 0 | 0 | 0 | 0 | 0 | 0 | 0 ± 0 |
| Rha | A | 0 | 0 | 0 | 0 | 0 | 0 | 0 | 0 | 0 ± 0 |
| | B | 0 | 0 | 0 | — | 0 | 0 | 0 | 0 | 0 ± 0 |
| | C | 0 | 0 | 0 | — | 0 | 0 | 0 | 0 | 0 ± 0 |
| | D | 0 | 0 | 0 | 0 | 0 | 0 | 0 | 0 | 0 ± 0 |
| Xyl | A | 0.16 | 0.39 | 0.26 | 0.47 | 0.31 | 0.75 | 0.38 | 0.32 | 0.38 ± 0.17 |
| | B | 0.54 | 0.34 | 0.39 | — | 0 | 0.26 | 0.12 | 0.13 | 0.25 ± 0.18 |
| | C | 0 | 0 | 0.66 | — | 0.34 | 0.2 | 0.31 | 0.8 | 0.33 ± 0.31 |
| | D | 0.26 | 0.18 | 0 | 0.11 | 0 | 0.21 | 0.19 | 0.19 | 0.14 ± 0.1 |

Ara = Arabinose, Glc = glucose, Man = mannose,
Gal = galactose, Rha = rhamnose, Xyl = xylose
Amounts of monosaccharides are pg/bead
A = PFABN-coated beads, B = GlcMan-coated beads,
C = PFABN & GlcMan-coated beads, D = Acetylated control beads

(C3) beads recovered 4 hours post gavage from the ceca

| | |
|---|---|
| Diet group | HiSF-LoFV + 10% pea fiber |

| | | | | | | | | |
|---|---|---|---|---|---|---|---|---|
| Mouse ID | 09.0 | 10.0 | 11.0 | 13.0 | 14.0 | 15.0 | 16.0 | mean ± SD |

| | | | | | | | | | |
|---|---|---|---|---|---|---|---|---|---|
| Ara | A | 1.21 | 1.24 | 1.16 | 1.08 | 1.49 | 1.39 | 1.44 | 1.29 ± 0.15 |
| | B | 0.16 | 0.22 | — | — | 0.16 | 0.14 | 0.15 | 0.17 ± 0.03 |
| | C | 1.48 | 1.61 | — | — | 1.31 | 1.56 | 1.72 | 1.54 ± 0.15 |
| | D | 0.07 | 0.07 | 0.07 | — | 0.05 | 0.06 | 0.06 | 0.06 ± 0.01 |
| Glc | A | 0.24 | 0.25 | 0.35 | 0.25 | 0.58 | 0.44 | 0.47 | 0.37 ± 0.13 |
| | B | 0.63 | 0.62 | — | — | 1.69 | 1.28 | 0.56 | 0.96 ± 0.5 |
| | C | 0.34 | 0.39 | — | — | 0.74 | 0.41 | 0.44 | 0.46 ± 0.16 |
| | D | 0.08 | 0.18 | 0.28 | — | 0.95 | 0.11 | 0.17 | 0.3 ± 0.33 |
| Man | A | 0 | 0 | 0 | 0 | 0 | 0.56 | 0.36 | 0.13 ± 0.23 |
| | B | 0.47 | 0.46 | — | — | 0.54 | 0.64 | 0.42 | 0.5 ± 0.09 |
| | C | 0.36 | 0.33 | — | — | 0.45 | 0.32 | 0.35 | 0.36 ± 0.05 |
| | D | 0 | 0 | 0 | — | 0 | 0 | 0 | 0 ± 0 |
| Gal | A | 0.41 | 0.36 | 0.37 | 0.38 | 0.51 | 0.54 | 1.41 | 0.57 ± 0.38 |
| | B | 0.35 | 0.35 | — | — | 0.34 | 0.31 | 0.32 | 0.33 ± 0.02 |
| | C | 0.33 | 0.39 | — | — | 0.35 | 0.36 | 0.37 | 0.36 ± 0.02 |
| | D | 0 | 0 | 0.23 | — | 0 | 0 | 0 | 0.04 ± 0.09 |
| Rha | A | 0 | 0 | 0 | 0 | 0 | 0 | 0 | 0 ± 0 |
| | B | 0 | 0 | — | — | 0 | 0 | 0 | 0 ± 0 |
| | C | 0 | 0 | — | — | 0 | 0 | 0 | 0 ± 0 |
| | D | 0 | 0 | 0 | — | 0 | 0 | 0 | 0 ± 0 |
| Xyl | A | 0.31 | 0.12 | 0.46 | 0.46 | 0.44 | 0.41 | 0.4 | 0.37 ± 0.12 |
| | B | 0.4 | 0.45 | — | — | 0.41 | 0.83 | 0.37 | 0.49 ± 0.19 |
| | C | 0 | 0.12 | — | — | 0.5 | 0 | 0.17 | 0.16 ± 0.2 |
| | D | 0.2 | 0.21 | 0.39 | — | 0.32 | 0.24 | 0.2 | 0.26 ± 0.08 |

Ara = Arabinose, Glc = glucose, Man = mannose,
Gal = galactose, Rha = rhamnose, Xyl = xylose
Amounts of monosaccharides are pg/bead
A = PFABN-coated beads, B = GlcMan-coated beads,
C = PFABN & GlcMan-coated beads, D = Acetylated control beads

(D) Two-way ANOVA
Polysaccharide utilization during colocalization on a bead surface.

| | |
|---|---|
| Monosaccharide = Mannose | Monosaccharide = Arabinose |

| Source of | % total of | | Source of | % total of | |
|---|---|---|---|---|---|
| variation | variation | P-value | variation | variation | P-value |
| Interaction | 13.03 | 0.007 | Interaction | 1.56 | 0.15 |
| Diet group | 8.87 | 0.02 | Diet group | 50.56 | <0.0001 |
| Bead type | 49.06 | <0.0001 | Bead type | 31.20 | <0.0001 |

What is claimed is:

1. A composition comprising a plurality particles of one type or a plurality of particles of more than one type, each type comprising a core comprising a tag, a unique compound of interest or a combination of compounds of interest (“the particle-bound compound(s) of interest”) and a unique label, wherein the particle-bound compound(s) of interest are stably attached to the core

2. The composition of claim 1, wherein the particle-bound compound(s) of interest remain substantially unaltered during transit through an intestinal tract of a subject that lacks a gut microbiota.

3. The composition of claim 1 or 2, wherein the tag for each particle type is paramagnetic material and the core further comprises a silica coating.

4. The composition of claim 1 or 2, wherein the tag for each particle type is a paramagnetic metal oxide and the core further comprises a coating, wherein the coating comprises an organosilane.

5. The composition of any one of claim 1, 2, 3, or 4, wherein the unique particle-bound compound(s) of interest for each particle type are a drug or a biomolecule.

6. The composition of claim 5, wherein at least one particle type comprises two or more drugs, two or more biomolecules, or a drug and a biomolecule.

7. The composition of claim 5, wherein the biomolecule is a carbohydrate, a lipid, a nucleic acid, a protein, or a derivative thereof.

8. The composition of claim 7, wherein the biomolecule is obtained from a food ingredient.

9. The composition of claim 7, wherein the biomolecule is a glycan or a derivative thereof.

10. The composition of any one of the preceding claims, wherein the particle-bound compound(s) of interest are stably attached to the core by a biotin-avidin interaction.

11. The composition of any one of claims 1 to 9, wherein the particle-bound compound(s) of interest are stably attached to the core by Schiff base formation and reductive amination.

12. The composition of claim 4, wherein the coating comprises an alkoxysilane or halosilane; and wherein the unique particle-bound compound(s) of interest for each particle type comprises a glycan or a glycan derivative.

13. The composition of claim 12, wherein at least one particle type comprises two or more glycans or derivatives thereof.

14. The composition of claim 12 or 13, wherein the glycan derivative is a CDAP-activated glycan.

15. The composition of any one of the preceding claims, wherein one type of particle comprises a unique combination of glycans or derivatives thereof obtained from a fiber preparation.

16. The composition of claim 15, wherein the fiber preparation is selected from a citrus pectin preparation, a pea fiber preparation, a citrus peel preparation, a yellow mustard preparation, a soy cotyledon preparation, an orange fiber preparation, an orange peel preparation, a tomato peel preparation, a low molecular weight inulin preparation, a potato fiber preparation, an apple pectin preparation, a sugar beet fiber preparation, an oat hull fiber preparation, an acacia extract preparation, a high molecular weight inulin preparation, a barley beta-glucan preparation, a barley bran preparation, an oat beta-glucan preparation, an apple fiber preparation, a rye bran preparation, a barley malted preparation, a wheat bran preparation, a wheat aleurone preparation, a maltodextrin preparation, a psyllium preparation, a cocoa preparation, a citrus fiber preparation, a tomato pomace preparation, a rice bran preparation, a chia seed preparation, a corn bran preparation, a soy fiber preparation, a sugar cane fiber preparation, a resistant starch 4 preparation.

17. The composition of claim 16, wherein the fiber preparation is selected from a citrus pectin preparation, a citrus fiber preparation, a high molecular weight inulin preparation, a pea fiber preparation, a sugar beet fiber preparation, a soy cotyledon preparation, a yellow mustard bran preparation, and a barley fiber preparation.

18. The composition of claim 17, wherein the fiber preparation is a pea fiber preparation.

19. The composition of any one of the preceding claims, wherein one type of particle comprises a pea fiber arabinan.

20. The method of claim 19, wherein the pea arabinan is a compound of formula (I): 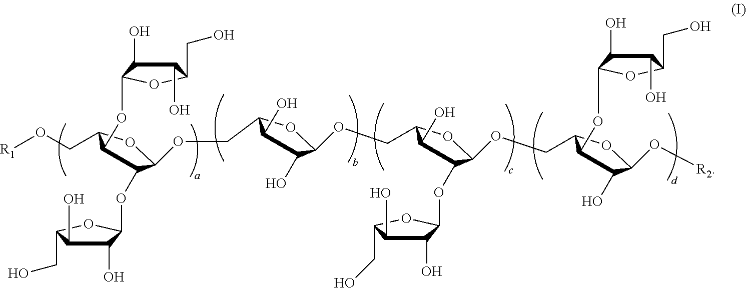
wherein a is about 0.1 to about 0.3, b is about 0.4 to about 0.6, c is about 0.1 to about 0.4, d is about 0.04 to about 0.06; and
wherein R₁ and R₂ are each independently selected from H, a glycosyl, a sugar moiety (modified or not), an oligosaccharide (branched or not), or a polysaccharide (branched or not), and a polysaccharide containing galacturonic acid, galactose, and rhamnose.

21. The composition of any one of the preceding claims, wherein the label is a fluorophore.

22. A method for measuring a gut microbiota's functional activity, the method comprising:
(a) orally administering to a subject a composition comprising a plurality of particles comprising (i) a core comprising a tag, (ii) a compound of interest or a combination of compounds of interest (“the particle-bound compound(s) of interest”), and (iii) an optional label,
wherein the particle-bound compound(s) of interest are stably attached to the core; and
wherein structural information and/or amount of the particle-bound compound(s) of interest is known (the “input data”);
(b) recovering particles from biological material obtained from the subject; and
(c) identifying structural changes to the recovered particle-bound compound(s) of interest and/or measuring the amount of the recovered particle-bound compound(s) of interest (the “recovered data”) and determining the difference between the recovered data and the input data.

23. The method of claim 22, wherein the composition is a composition of any one of claim 1.

24. A method for measuring a gut microbiota's functional activity, the method comprising:
(a) orally administering to a subject a composition comprising a plurality of retrievable particles of more than one type, each type of retrievable particle comprising (i) a core comprising a tag, (ii) a compound of interest or a combination of compounds of interest (“the particle-bound compound(s) of interest”), and (iii) a unique label,
wherein the particle-bound compound(s) of interest are stably attached to the core, and
wherein structural information and/or amount of the particle-bound compound(s) of interest is known (the “input data”);
(b) recovering particles from biological material obtained from the subject and then separating the recovered particles by type; and
(c) for each type of particle, identifying structural changes to the recovered particle-bound compound(s) of interest and/or measuring the amount of the recovered particle-bound compound(s) of interest (the “recovered data”) and determining the difference between the recovered data and the input data.

25. The method of 24, wherein the composition is a composition of any one of claims 1 to 21.

26. The method of claim 22, 23, 24, or 25, wherein the particles are recovered from one or more fecal samples from the subject.

27. The method of claim 26, wherein the subject is a human.

28. The method of claim 22, 23, 24, or 25, wherein the particles are recovered from one or more fecal or cecal samples from the subject, and the subject is a germ-free mouse colonized with a collection of gut microorganisms.

29. The method of claim 28, wherein the collection of gut microorganisms is an intact, uncultured gut microbiota from a human subject.

30. The method of any one of claims 22 to 29, wherein the method further comprises quantifying at least one additional aspect of the subject's gut microbiota, the additional aspect of the subject's gut microbiota selected from group consisting of, abundance of proteins encoded by one or more bacterial PULs, abundance of all Bacteroides species, abundance of subset Bacteroides species, proportional representation of all Bacteroides species, proportional representation of a subset Bacteroides species, and microbial metabolites.

31. A method to measure a change in functional activity of a gut microbiota, the method comprising
(a) at a first time, measuring functional activity of a gut microbiota according to the method of any one of claims 22 to 30;
(b) at a second time, repeating the measurement of step (a); and
(c) calculating the difference between the values obtained from step (b) and step (a).

32. The method of claim 31, wherein the subject is administered a food, a food ingredient, a drug, a dietary supplement, or an herbal remedy after step (a) but before step (b).

33. The method of claim 32, wherein the subject is administered a food and the food is a microbiota-directed food.

34. The method of claim 32, wherein the subject is administered a food ingredient and the food ingredient is a fiber preparation.

35. The method of claim 32, wherein the subject is administered a dietary supplement and the dietary supplement is a prebiotic, a probiotic, or a combination thereof.

36. The method of claim 32, wherein the subject is administered a drug and the drug is an antibiotic or a chemotherapeutic agent.

37. Use of a composition of any one of claims 1 to 19 in a subject.

38. The use of claim 37, wherein the subject is a human.

39. The use of claim 37, wherein the subject is a germ-free mouse colonized with a collection of gut microorganisms.

40. The use of claim 29, wherein the collection of gut microorganisms is an intact, uncultured gut microbiota from a human subject.
